(19) United States
(12) Patent Application Publication
(10) Pub. No.: US 2016/0299973 A1
(43) Pub. Date: Oct. 13, 2016

(54) Interactive Internet Interfaces

(71) Applicant: Ralph Willard Oakeson, Riverton, UT (US)

(72) Inventor: Ralph Willard Oakeson, Riverton, UT (US)

(21) Appl. No.: 15/095,712

(22) Filed: Apr. 11, 2016

Related U.S. Application Data
(60) Provisional application No. 62/196,386, filed on Jul. 24, 2015.
(60) Provisional application No. 62/146,193, filed on Apr. 10, 2015.

(51) Int. Cl. G06F 17/30; G06F 17/27

(52) U.S. Cl. CPC G06F 17/30864; G06F 17/30554; G06F 17/2705

(57) ABSTRACT

The internet is a system of infrastructure and content almost beyond comprehension and it continues to expand. The internet is experienced largely one page at a time and usually by only what an internet service provider is willing to offer based on a word or phrase. This common experience is no longer adequate for the evolving internet. This invention recognizes the internet now requires more Content User interaction. Disclosed is a Semi-Simple Search interface, including the choice to use domain extensions, to provide more search criteria input for more specific searches, more useful search results presentation, or their combinations. Also disclosed are results organized and manipulated for Custom Page Ones, More Page Ones, And More Top Of Page One Positioning, and individual search item prioritization. As such the Content User is able to initiate a more specific search, organize and modify search results to achieve more preferred and relevant results association, and use modified results to train a more accurate subsequent search. Content Providers have more first pages, more top of first pages of favorable positioning, and more visibility opportunities. Content Managers gain greater relevance with an improved internet experience for Content Users and more favorable paid and organic positioning for Content Providers.

### CROSS-REFERENCE TO RELATED APPLICATIONS

This non-provisional patent application claims the priority of U.S. Provisional Application No. 62/196,386 with Confirmation Number 9961 and title “Domain Extension Search and Sort, and Improved User Interface” filed on Jul. 24, 2015, the entire contents and substance of which are hereby incorporated in total by reference. Note this is the same submission as the Provisional Application No. 62/146,193 except the addition of the first eight pages of content.

This non-provisional patent application claims the priority of U.S. Provisional Application No. 62/146,193 with Confirmation Number 8851 and title “More Internet Search Page Ones and Alterable Internet Search Results” filed on Apr. 10, 2015, the entire contents and substance of which are hereby incorporated in total by reference.

### STATEMENT REGARDING FEDERALLY SPONSORED RESEARCH OR DEVELOPMENT

Not applicable.

### REFERENCE TO A SEQUENCE LISTING

Not Applicable.

### COPYRIGHT STATEMENT

All of the material in this patent document is subject to copyright protection under the copyright laws of the United States and other countries. The copyright owner has no objection to the reproduction of a patent, patent application, or invention disclosure if retained as a complete document as published by the copyright owner, government, or found in a government record. Otherwise all other copyright provisions whatsoever are reserved.

### BACKGROUND OF THE INVENTION

This non-provisional patent application claims the priority of U.S. Provisional Application No. 62/196,386 with Confirmation Number 9961 and title “Domain Extension Search and Sort, and Improved User Interface” filed on Jul. 24, 2015, the entire contents and substance of which are hereby incorporated in total by reference. Note this is the same submission as the Provisional Application No. 62/146,193 except the addition of the first eight pages of content.

This non-provisional patent application claims the priority of U.S. Provisional Application No. 62/146,193 with Confirmation Number 8851 and title “More Internet Search Page Ones and Alterable Internet Search Results” filed on Apr. 10, 2015, the entire contents and substance of which are hereby incorporated in total by reference.

### FIELD OF THE INVENTION

A more effective Internet search interface to increase search result specificity from additional and more specific search criteria followed by more sorted and interactive search result formatting.

### Problem Statement

Even at 25 years attributed to the existence of the public internet emerging in the 1990s, its potential continues to evolve and seemingly accelerate. Around the year 2000 the internet began to burgeon as we know it today¹. From the first website in 1990¹, at the time of this writing, there is now over 1,061,219,163 websites ² with over 2,776,550,214 searches ² per day from just one leading search engine. As the internet continues to settle in, it has been reported that through its expansive growth as many as 75% of websites registered are inactive. ³ The growth of the internet has occurred due to increased experience, understanding, and critical junctions of infrastructure, intuitive interfaces, increased content, better commerce and payment systems, better understanding of advertising, more online entertainment, and among other elements that have facilitated its popular acceptance among individuals, businesses, education institutions, churches, governments, and more. Often the growth discussed is viewed through a North American lens, but today internet usage must be considered from a global context, such as: Asia 48.4% of users, North and South America 21.8% of users, and Europe 19%, Africa 9.8%, and Oceania at 0.9%. Each day, a little over 40% of the global population is using the internet. (Reference 1—http://royal.pingdom.com/2008/04/04/how-we-got-from-1-to-162-million-websites-on-the-internet/, Apr. 6, 2015) (Reference 2—http://www.internetlivestats.com/internet-users/, Apr. 6, 2015) (Reference 3—http://www.dailymail.co.uk/sciencetech/article-2759636/Number-websites-hits-BILLION-counting-Tracker-reveals-new-site-registered-SECOND.html, Apr. 6, 2015).

Despite its size and current growth, the internet is still moving through its infancy and adolescence. Almost any measure of the internet shows more than a doubling of most any attribute in just the next 2 to 3 years ⁴. Each day is a type of new beginning for such a vast infrastructure of so many known and unknown facets. Consider some recent new beginnings: (1) New suffixes beyond .com, .gov, .org, .info, etc. are emerging to include .club, .guru, .nija, .expert, etc. and dozens to hundreds more, make this being a new beginning. (2) More internet capable devices means that content on the internet is more immediately available and useful, this is a new and emerging beginning. (3) More devices means that content on the internet needs to be responsive to conform to different platforms or built for different platforms, making this another a new beginning. (4) Better internal hardware such as more memory, more compact design, faster processors, better battery power sources, and more extends use of the internet at the infrastructure to user device levels. (5) It is a new beginning that digital advertising spend on the internet will approach $60,000,000,000 in 2015 and surpass other media spend. ⁵ (6) Recent U.S. Federal Trade Commission (FCC) about Net Neutrality has the potential of changing the unfettered character of the internet by classifying it as a utility, another new beginning. Many more such examples exist which simply reinforce that the internet continues to be an evolving and dynamic system at the infrastructure or Content Manager to Content User levels. Key to this observation is recognizing that largely all the internet growth is in the elements and things of the internet. What seems not to have evolved is the effectiveness of the Content User experience and the Content Provider experience of the internet. (Reference 4—http://motherboard.vice.com/blog/the-next-five-years-of-explosive-internet-growth-in-seven-graphs, Apr. 6, 2015) (Reference 5—http://www.emarketer.com/Article/US-Digital-Ad-Spending-Will-Approach-60-Billion-This-Year-with-Retailers-Leading-Way/1012497).

For the Content User, there appears to be two primary segments of the internet. The first is the Internet. This refers to the broader worldwide web and necessitates the use of the Content Managers general internet search engine. Commonly, these would be known as: Google, Bing, Yahoo, Ask, AOL, WOW, WebCrawler, and many more. These search engines include or interface with all the infrastructure, protocols and algorithms, policies, and more to find and present a search result. These Content Managers provide access to the general content of the internet based upon a keyword search term or keyword search phrase, and as such Content Managers or search engine providers struggle to provide relevant content to Content Users with the little information they have for a search criteria. Content Users are served information on the Internet and the Internet continues to show some utility, but this is partly because the Content User is unaware of a better and more effective internet experience, as well as being unaware of even potentially better content they may not be seeing. Practically, Content Users are bombarded with too many irrelevant websites, often a smattering of websites hoping two or three are relevant to give a sense of search accuracy, use of past searches as a guide to what may or may not be relevant today, all search results are thrown together by some Content Manager priority, and other less than favorable results and experiences. Content Users are increasingly sensing a lack of search control and results control.

The second segment within the internet accessed by the Content User is the Content Provider intranet websites and content. Once on these sites, either by indirect general search engine use or direct URL search, these sites are not usually reliant on the general internet search engines for intranet navigation. A Content Provider intranet websites can be a simple single page website, multiple page website, to a large information or product websites of national or multi-national corporations. Some of the larger websites can use their own search protocols or behave like Content Manager search engines in searching their own databases. It will be shown that some of the better Content User Internet experience, or really intranet experience, is with the more interactive Content Provider websites.

Content Providers find the internet possibly the most challenging of all as they seek to be found in such a largely populated information space. Content Providers are on the internet to be found, and practically that means showing up on page one of the search results. As listed above ⁶ the difference in being in the first spot is 34.4% clicks, 2nd with 17.0% clicks, 3rd with 11.4% clicks, 4th with 7.7% clicks, 5th with 6.2% clicks, 6th with 5.1% clicks, 7th with 4.0% clicks, 8th with 3.5% clicks, 9th with 2.8% clicks, and 10th with 2.7% clicks, and the first position on the second pages having 1.1% clicks and it dropping to 0.3% for the last item of the second page. In other words, if a Content Provider is not in the first half of the first page, then there is little chance of being seen. Another study ⁷ shows that the significance of being on the first screen means receiving 80.3% views compared to being on the second half of the first page receiving just 19.3% of views. Having more pages creates more top of pages for Content Providers to more top of mind to Content Users. More favorable and meaningful marketing opportunities on the web invites more willingness to spend on advertisements. This then incentivizes Content Managers to make necessary improvements, in addition to wanting to provide an improved Internet experience.

Practically considered, when there are 1,200,000,000 total pages, or even 25% of that as active websites being 250,000,000 total websites, or even just consider a 1000 websites in a search area, or maybe just consider there to be 100 websites in a search area, and so on, there are still only 5 top positions. The internet becomes a difficult environment from which to be noticed as a Content Provider, whether the purpose is for commercial or non-commercial purposes. Essentially, the vast majority of Content Providers remain unknown on the internet. Content Managers struggle to provide relevant information with limited direct input and limited space to return results. What is needed are more page ones seen as legitimate by the Content User to give more legitimate opportunities for Content Providers. There are various ways of creating legitimate page ones which is the content of this disclosure. (Reference 6—http://www.gravitateonline.com/google-search/2nd-place-1st-place-loser-seriously, Apr. 6, 2015) (Reference 7—http://conversionxl.com/19-things-we-can-learn-from-numerous-heatmap-tests/, Apr. 6, 2015.)

Content managers struggle to grasp the totality of available information on the internet and provide what is believed to be relevant content to the Content User and fairness to Content Providers among billions of websites and trillions of webpages. As such, Content Managers invest heavily to create search engine algorithms and protocols to seek the most relevant information to provide the Content User with nothing more than a few keywords. The likelihood of providing specifically relevant information is degrading and getting less relevant as the internet expands. If two points make a line or give a direction, what is missing to know the direction of the Content User's intent is more direct input and interaction from the Content User. Content Managers continue to rely on the first point as being the initial keyword or phrase and then assemble the second point from the same keywords or phrases or past search history and internet usage. This approach breaks down as Content User interests and needs change rapidly and devices may be shared among different Content Users with again different needs and interests. As Content Managers seek to discern Content user preferences to assume search relevance, the algorithm remains unaware of the moment by moment variability within and between Content Users when asking for just one search criteria input. With or without changing login credentials, algorithms then return potentially dramatically irrelevant content. Briefly extending the discussion further, a third or more point of reference creates an area or a third or more Content User input would provide very much more specific guidance to the Content Manager to provide more relevant search results. Again, what is missing, especially with the rapidly expanding infrastructure and content of the internet, is more direct interaction with the internet search interface by the Content User to guide Content Managers in providing more relevant information.

The days of euphoria and intrigue about the internet and a willingness to make-do with the evolving platform have now past. Although there may not be direct connection to the above discussed Content User experience, but for the first time perceived internet usage is down ⁸. Further it is reported that blogging is down on the internet and may be a reflection of Content Provider frustration, or use of other platforms. ⁹ The internet is now more of a tool that is increasingly essential to individuals, businesses, organizations, schools, governments, and more. There is no more tolerance for a continuation of less than effective internet search interfaces and internet result formats. What is needed is an internet use experience that evolves with the expansive growth of all other aspects of the internet. (Reference 8—http://www.slashgear.com/forrester-survey-shows-first-ever-decline-in-internet-usage-17252480/, Apr. 6, 2015) (Reference 9—http://www.theatlantic.com/technology/archive/2015/02/what-blogging-has-become/386201/)

The following disclosure addresses various means of providing greater control and effectiveness of the internet search and results to Content Users, Content Providers, and Content Managers.

### STATE OF THE ART ASSESSMENT

Despite the advances of the internet search interfaces, search results, and search result formats are often little more than a “take it or leave it” or “you can have any color as long as it is black (experientially speaking).” In an age of micro-customization, information power, etc., the internet needs to be more responsive and relevant.

Ultimately, the internet is evolving into a vast store of information to facilitate entertainment, commerce, education, news, and so many other purposes. Likely by a combination of intentional and unintentional actions Content Managers have retained a simplistic Content User search interface and results format. That may have been important during the initial phases of Internet and Content User evolution. However, today Content Users are capable of one, two, or a little more additional search interface criteria inputs as well as more interactive search result format choices because of Content User increased digital and device experience and sophistication. That sophistication has increased as proven by use of many different devices, hundreds of available apps and programs of a wide range of interfaces, various intranet search platforms, and long established internet search experience. The simplicity remaining with Content Manager search engine interfaces and search result formats is now limiting access to the true vastness and potential of the internet.

Despite all the talent and investment among Content Managers to increase search result relevance and address other search engine and infrastructure tasks, the sophistication of their algorithms and protocols to provide relevant content remains unsatisfactory and diminishing as the vastness and complexity of the internet continues to increase. In part, this is because the focus of the talent and investment by Content Managers continues to be misdirected. Too much attention is given to assuming, discerning, and guessing Content User intent, instead of simply asking the Content User for one, two, or other limited number of additional search engine criteria inputs. In general, among all that has changed with the internet, Content User input options and control choices have remained stagnant. As a result the internet is becoming less relevant and less viable than it could be.

The significance of the Content User interface is not always relevant, as there are different ways to use the internet. Two such include a direct search and indirect search. Direct search is referred to here as locating a well established or well branded website where the URL is known or can be closely guessed and relevance is not a concern. The second, an indirect search where the Content User relies on the general internet search engine of the Content Manager and their algorithms and protocols to return relevant results. Given the direct or indirect search methods introduced, the typical Content User of the internet is not an advanced search specialist and relies upon three primary actions to reach the internet information they desire. The first is their choice of keyword or keyword phrase that guides Content Manager protocols and algorithms to provide some content. The second is to tweak keywords once seeing returned results and performing another search. A third is to look through more search result pages provided by the Content Manager search results, with results presented in an order of which the rationale is unknown to the Content User. Many Content Manager do provide an advanced search, but these are too involved for the vast majority of Content Users, and anyway, the Content Manager does not seem to handle very well such a vast array search criteria as well. Emerging is a search interface standard now somewhere in the middle of these search interface and input platforms.

Content Managers are challenged to be relevant to attract users and advertisers. Content Managers have provided limited additional search tools for the typical Content User. There are no secondary search criteria fields and no post search result manipulation. One such tool that is emerging is search by topics as shown in FIG. 1, such as images, news shopping videos, etc. Shown are examples of www.ask.com 110, www.bing.com 120, www.google.com 130, and www.yahoo.com 140. Often these topical sites are less developed and often more cosmetic or lack searchable substance. It is almost as if they are simply preprogrammed content, hot trends, news of the day, etc. It is more a set of offerings by the service provider to address a visual stimulus, cursory entertainment, or other superficial service. What is missing is real search capability equivalent to that of what is known to be the web, or search of the total internet database. Throughout this and other document sections, brand and trade names are listed as search and result examples. It is recognized that these are proprietary trademarks and brand names, but are used in this document as simply examples gained from public sources.

Subject or topic level search is emerging at the website or intranet level. FIG. 2 shows two such examples. One representation is www.Bestbuy.com 210 that shows once on their intranet website the Content User has the opportunity to search within a category to further define relevance, rather than search their complete database where most content would be irrelevant. Important to this type of search is the two step process offered. Initial search terms identify and return what an algorithm would consider relevant based upon item description, but in reality was not yet the information and category of interest of the Content User. The desired level of specificity is achieved by additional Content User input within the existing search results, not another full search with different search terms seeking the same specificity. The second level identification at the Content User level provides a valuable additional directive to search algorithms. www.craigslist.org 220 is a second example. In this case the totality of the search is usually by a defined category and then content listed in a chronological order. What this example of intranet state of the art shows is that content can be categorized in one or more groups in depth and breadth and then searched to assist in improved search relevance.

An important third example of current state of the art is the ability of the Content User to input priority or select among search choices. FIG. 3 shows two such examples. www.hp.com Compare Box 310 and www.lowes.com selection button 320 both show that within their intranet website that Content Users may select among various choices and have those selections set in a relationship that allows for more facile assessment among the choices. This level of Content User interaction adds control and improves relevancy to the internet experience, or in this case the intranet experience. What is missing on the internet is this same level of control at the search engine or Content Manager level.

Another relevant and recent advancement in popular internet usage is the introduction of new domain extensions. Listed in Table 1 below are Common U.S. extensions that have been used for years through the development of the internet. Also shown in Table 1 is a sample list of the existence of country specific domain extensions.

TABLE 1

| Common U.S. | | Example of Country | |
|---|---|---|---|
| Domain Suffixes | | Domain Suffixes | |
| Domain | | Domain | |
| Suffix | Meaning | Suffix | Country |
| .com | Commercial | .ad | Andorra |
| .net | Network | .ae | United Arab Emirates |
| .org | Organization | .ag | Antigua and Barbuda |
| .edu | Educational | .ai | Anguilla |
| .biz | Business | .al | Albania |
| .gov | Government | .am | Armenia |
| .mil | Military | .ar | Argentina |
| .info | Information Source | .at | Austria |
| .name | Personal Name | .au | Australia |
| .me | Personal Websites | .aw | Aruba |
| .tv | Television Station | .ba | Bosnia-Herzegovina |
| .us | United States (see below) | .be | Belgium |

| | | |
|---|---|---|
| .mobi | Designed for Mobile Phones | and other remaining country codes. |

For reasons of personal, business, and other interests, as well as to overcome the growing limitations of available domain names with a limited set of domain extension there has been agreement among internet regulatory authorities and associations to release a host of new extensions. An initial release of such domain extensions is listed in Table 2.

TABLE 2
American Culture Oriented Newly Released Or Pending
Domain Extensions

| | | | |
|---|---|---|---|
| .academy | .credit | .inc | .republican |
| .accountant | .creditcard | .indians | .rest |
| .accountants | .cricket | .industries | .restaurant |
| .active | .cruise | .ink | .retirement |
| .actor | .cruises | .institute | .review |
| .ads | .dad | .insurance | .reviews |
| .adult | .dance | .insure | .rich |
| .africa | .data | .international | .rio |
| .agency | .date | .investments | .rip |
| .airforce | .dating | .ira | .rocks |
| .amsterdam | .dds | .irish | .rodeo |
| .analytics | .deal | .islam | .room |
| .apartments | .dealer | .ismaili | .rsvp |
| .app | .deals | .istanbul | .rugby |
| .arab | .degree | .jewelry | .run |
| .architect | .delivery | .kid | .sale |
| .army | .democrat | .kids | .salon |
| .art | .dental | .kim | .save |
| .arte | .dentist | .kinder | .scholarships |
| .associates | .desi | .kitchen | .school |
| .attorney | .design | .kiwi | .science |
| .auction | .dev | .land | .scot |
| .audible | .diamonds | .house | .search |
| .audio | .diet | .lat | .seat |
| .author | .digital | .latino | .secure |
| .auto | .direct | .law | .security |
| .autos | .directory | .lawyer | .services |
| .baby | .discount | .lease | .sex |
| .band | .diy | .legal | .sexy |
| .bank | .docs | .life | .shoes |
| .bar | .doctor | .lifeinsurance | .shop |
| .barcelona | .dog | .lifestyle | .shopping |
| .bargains | .doha | .lighting | .show |
| .baseball | .domains | .limited | .silk |
| .basketball | .dot | .limo | .singles |
| .beauty | .download | .link | .site |
| .beer | .drive | .live | .ski |
| .beknown | .dubai | .living | .soccer |
| .berlin | .durban | .llc | .social |
| .best | .earth | .llp | .software |
| .bet | .eat | .loan | .solar |
| .bible | .eco | .loans | .solutions |
| .bid | .ecom | .london | .song |
| .bike | .education | .lotto | .soy |
| .bingo | .email | .love | .spa |
| .bio | .energy | .ltd | .space |
| .black | .engineer | .luxury | .sport |
| .blackfriday | .engineering | .madrid | .sports |
| .blog | .enterprises | .mail | .spreadbetting |
| .blue | .equipment | .management | .stockholm |
| .boats | .esq | .map | .storage |
| .bom | .estate | .market | .store |
| .book | .eus | .marketing | .stream |
| .booking | .events | .markets | .studio |
| .boston | .exchange | .mba | .study |
| .bot | .expert | .med | .style |
| .boutique | .exposed | .media | .sucks |
| .box | .express | .medical | .supplies |
| .broadway | .fail | .melbourne | .supply |
| .broker | .faith | .memorial | .support |
| .brussels | .family | .men | .surf |
| .budapest | .fan | .menu | .surgery |
| .build | .fans | .miami | .swiss |
| .builders | .farm | .mls | .sydney |
| .business | .fashion | .mobile | .systems |
| .buy | .feedback | .mom | .taipei |
| .buzz | .film | .money | .tattoo |
| .bzh | .finance | .mortgage | .tax |
| .cab | .financial | .moscow | .taxi |
| .cafe | .fish | .motorcycles | .team |
| .call | .fishing | .mov | .tech |
| .cam | .fit | .movie | .technology |
| .camera | .fitness | .movistar | .tennis |
| .camp | .flights | .music | .theater |
| .capetown | .florist | .mutual | .theatre |
| .capital | .flowers | .mutualfunds | .tickets |
| .car | .food | .navy | .tips |
| .cards | .football | .network | .tires |
| .care | .forsale | .new | .today |
| .career | .forum | .news | .tokyo |
| .careers | .foundation | .ngo | .tools |
| .cars | .free | .ninja | .top |
| .casa | .fund | .nyc | .tour |
| .case | .furniture | .online | .tours |
| .cash | .futbol | .organic | .town |
| .cashbackbonus | .gallery | .paris | .toys |
| .casino | .game | .partners | .trade |
| .catering | .games | .parts | .trading |
| .catholic | .garden | .party | .training |
| .center | .gay | .pay | .translations |
| .ceo | .ged | .persiangulf | .trust |
| .cfd | .gent | .pet | .tube |
| .charity | .gift | .pets | .tunes |
| .chat | .gifts | .pharmacy | .university |
| .cheap | .gives | .phd | .uno |
| .christmas | .giving | .phone | .vacations |
| .church | .glass | .photo | .vegas |
| .city | .global | .photography | .ventures |
| .cityeats | .gold | .photos | .vet |
| .claims | .golf | .pics | .video |
| .cleaning | .graphics | .pictures | .villas |
| .click | .gratis | .pink | .vip |
| .clinic | .green | .pizza | .vision |
| .clothing | .gripe | .place | .vodka |
| .cloud | .grocery | .plumbing | .vote |
| .club | .group | .poker | .voting |
| .coach | .guide | .porn | .voto |
| .codes | .guitars | .press | .voyage |
| .coffee | .guru | .prime | .wales |
| .college | .hair | .productions | .watch |
| .cologne | .hamburg | .prof | .watches |
| .community | .health | .promo | .web |
| .company | .healthcare | .properties | .webcam |
| .compare | .help | .property | .webs |
| .computer | .helsinki | .pub | .website |
| .comsec | .here | .quebec | .wed |
| .condos | .hiphop | .racing | .wedding |
| .construction | .hiv | .radio | .wiki |
| .consulting | .hockey | .realestate | .win |
| .contact | .holdings | .realtor | .wine |
| .contractors | .holiday | .realty | .work |
| .cooking | .homes | .recipes | .works |
| .cool | .horse | .red | .world |
| .corsica | .hospital | .rehab | .xyz |
| .country | .host | .rent | .yoga |
| .coupon | .hosting | .rentals | .yokohama |
| .coupons | .hotel | .repair | .zip |
| .courses | .hotels | .report | .zone |

By independent development, this disclosure suggests a secondary benefit of additional domain names is the ability to parse internet content by categories defined by domain extensions. That is to offer additional search criteria that for the inclusion or exclusion of a particular domain extension or set of domain extensions. Domain extensions may be used on the search results side by sorting result based upon a domain extension or group of related domain extensions. Another current application is the use restriction of certain domain extensions by qualified individual or organizational entities. For example, the pharmacy industry is a highly regulated market, and now more so with online pharmacies. As a means of showing validation of an online pharmacy's trust and legitimacy, the .pharmacy (dot pharmacy) domain extension is now only permitted to be used by qualified entities. The same might be said of government entities that qualify to use .gov. Other domain extensions such as .edu is restricted for qualified educational institutions, .org which is somewhat associated with non-profit organization, and other examples.

There is emerging some hints of the utility of a domain extension in improving the internet search and results experience. The National Association of Boards of Pharmacy provides a public awareness campaign for Verified Internet Pharmacy Practice Sites (VIPPS). This campaign encourages consumers to only use verified internet pharmacies associated with the .pharmacy (dot pharmacy) domain extension. This campaign does not suggest searching by .pharmacy (dot pharmacy) but states to “look for” the .pharmacy (dot pharmacy) domain extension. See general reference 10 and general reference 11. Missing from this Associations campaign and awareness is the concept of and ability provided from Content Managers to be able to search by .pharmacy (dot pharmacy) rather than simply search their internal list of verified pharmacies with any domain extension.

Another step in the direction of recognizing the value of the domain extension for general internet usage has been general non-enabling discussions and statement about new domain extension equivalence or preference over older domain extensions. In 2014 Bill Hartzer, Strategic Online Marketing Consultancy, reported currently known industry sentiment about new domain extensions. He stated “According to Matt Cutts [a respected Google engineer] and Duane Forrester [a respected Bing Senior Project Manager] whether or not its an old TLD or a new gTLD [generic Top Level Domains], it can rank in the search results. There is not extra search engine ranking weight given to a certain domain name or TLD (or gTLD). Further reported is the follow Matt Cutts statement “Google has a lot of experience in returning relevant web pages, regardless of the top-level domain (TLD). Google will attempt to rank new TLDs appropriately, but I don't expect a new TLD to get any kind of initial preference over .com, and I wouldn't bet on that happening in the long-term either. If you want to register an entirely new TLD for other reasons, that's your choice, but you shouldn't register a TLD in the mistaken belief that you'll get some sort of boost in search engine rankings.” Bill Hartzer summarizes his understanding from top industry spoke people “I don't expect any extra boost from Google for having a certain domain name.” Todd Malicoat reported in earlier in 2012 on a related discussion about Exact Match Domain (EMD) that reach into the inclusion of domain extensions. He reports Matt Cutts reports “ . . . we have been thinking about adjusting that mix a little bit and sort of turning the knob down within the algorithm so that given two different domains, it wouldn't necessarily help you as much to have a domain with a bunch of keywords in it.” See reference 12. Todd Malicoat summarizes his awareness of the internet search engine environment with a list of 10 best practices. The second element on this list states “2. Skip the second level TLD's—.mobi/.travel/.info isn't worth it.” See reference 13. Ultimately, informed industry Content Manager staff and informed industry authors consistently state and report teachings against the use of domain extensions as a search input criteria or use of the domain extension as a search result format guide. Further, they fail to recognize the benefits and utility of incorporating one or more domain extensions in search, search retrieval, and search results presentation and parsing, and other uses, and any of their combinations. As such their mention, but non-enabling statements dismiss the necessary detail to appreciate the potential that the domain extension would have as applied to a variety of Content User, Content Provider, and Content Manager related functions. Actually, the discussion of this paragraph is a demonstration of in-the-box thinking where persons having at least ordinary skill in the art fail to recognize the unique utility of the distinction of a “.” (period or dot) followed by a string of characters (letters, numbers, symbols, etc.) and the computer or code identification, use, sorting, classification, and other manipulation in a search, within the infrastructure of the internet, or as results from a search.

Again, intentionally and in cases unintentionally, Content Managers have retained the internet at the Content User level as ultimately simplistic enough that Content Users often struggle for finding the information they truly desire. Too simplistic that the Content User is unable to secondarily interact with the search findings to further refine it, broaden it, capture it, and more. As such, many search result findings can be absurd. As an example, a search for a general lawn rake was made with a dominate search engine. The first result was to buy the rake from www.Amazon.com, even though there is a Home Depot less than a half mile away. Amazon is a great vendor, but for many it is absurd to suggest purchasing and shipping a lawn rake across the country. The point is there is no means for the Content User to remove or reprioritize such an unhelpful search result to a particular Content User to improve a meaningful search result. Search engines and internet infrastructure as a whole do not see and recognize such absurdity, and what is immediately obvious to the Content User. The search engine simply follows protocol and algorithm rules, such as www.Amazon.com is a trusted and authoritative site so it is safe to present it as a search result, it generates high Content User traffic so Content User should like it under these search terms, Amazon does offer the item, and more. All may be factually correct, but practically useless, and adds the increasing absurdity and diminishing utility of the internet.

In this same example just discussed, the top five searches were Home Depot, Lowes, Walmart, and TruGreen lawn fertilizing company. Another question is, will search simply return the largest vendor, largest industry player in a search sector, etc. If a Content User is looking for these large and universally known vendors, then they will simply go to www.homedepot.com, www.walmart.com, etc. One of the central features of the internet is to gain access to the unusual, the previously unknown, the little guys, etc. If the Content User is interested in a smaller vendor or simply information (types of rakes, durability of design, etc.), the search results in this example would be nearly useless. Further many of the other results that followed the top six search results began to be off topic of a lawn rake. Additionally, the paid ads for lawn rakes also included Home Depot, Lowes, Walmart, TruGreen, and other vendors that are already in the organic search. Having nearly all organic search results and then nearly all paid results presented being of the same organizations is not helpful, too simplistic, and increasingly useless and absurd. Yet, there is little the Content User can do.

Needed is a next generation internet experience for the Content User and Content Provider that manages and utilizes the ever evolving internet content and infrastructure. A key element of this disclosure for the Content User is the concept to “just ask” and “stop assuming.” Just ask for a little more input on the search engine interface to gain more specific results and just ask for a little more flexibility in how search results are delivered and even manipulated to fit the needs of the Content User. Content Providers want a fair and more viable platform. They need more opportunity to be visible on the limited first page real estate, whether that is by organic search results or by paid advertisement. Content Provides in cases are looking for results, and again the days of tolerating poor marketing performance on the internet are past. Content Manager likewise must seek to evolve with the untamed internet to remain relevant by search engine interfaces, search results formats, and underlying search protocols and algorithms that provide a more viable internet experience the for Content User and the Content Provider.

This disclosure is about providing simple increased options to Content Users by Content Managers or search engine providers. These few increased options will provide Content Users with more specifically tailored initial search criteria for better search results, increasingly important with the ever and rapid expansion of internet content. These few increased option also provide search results with better content parsing and organization, some quick alterations, reprioritizations, use alterations for a new search, save searches, and more. What is most amazing about the internet is its content. What has not been so amazing about the internet is how that content is identified and delivered.

### BRIEF SUMMARY OF THE INVENTION

Interactive Internet Interfaces—Better Search Criteria Control and Better Search Results Format Control. Briefly described, the invention comprises solutions for transforming the internet experience and to the next generation of viability for Content Users, Content Providers, and Content Manager grouped among the following primary subjects.

Content User related disclosures are first summarized.

Additional search input criteria by Content Users is disclosed to achieve greater search specificity and to minimize current Content Manager assumptions. Required is more than a single search criteria field commonly used with today's internet search criteria engine interfaces. Although most Content Managers provide an advanced search engine interface, they are often too involved for most Content Users. Disclosed is a Semi-Simple Search or search engine interface where a second, third, or few additional search criteria inputs can be entered to more specifically guide the search process. Disclosed are various formats of including additional search criteria input with a text field, dropdown selector, others, and there combinations.

Domain extension use is disclosed as one contributor to the Semi-Simple Search interface for more than one search input criteria. The domain extension can be used within the current single keyword field or as an additional input field that accepts text input or another predefined input from a dropdown menu or other mechanism. The domain extension may be used solely as a search criteria, solely as a results parsing and grouping criteria, or a combination of both.

Appropriate use of biographic, geographic, and performance metrics is also disclosed to be information associated with a domain name as a type of additional signature or profile to assist in search specificity support and results formatting support. Currently an individual, a sole proprietorship, an organization, and up to the largest corporations and educational institutions simply need to arbitrarily select a .com, .org, .net, etc. domain extension and register for a domain name and accompanying URL with little more than a name and phone number. Lost is the opportunity to collect more descriptive information associated with the domain name for use to improve search content specificity and then deliver those results in a more parsed, grouped, and useful manner.

Search result format innovations are also disclosed to improve upon the current format of all results listed on a single sequence of pages to listing results on two or more separated search result page strings or results grouped by sections within a single results page string with locators to move to the relevant page of the string for a particular group. Parsing search results is disclosed as either an automated process by the Content Managers search engine and predefined criteria, automated by the search engine with Content User criteria, manually by the Content User after a search or with a subsequent search, other means, or any of their combinations. An improved Content User experience results when like search result items are associated as it adds another form of clarity and information accessibility given the vastness of the internet.

Single search result item parsing, reprioritization, relocating, hiding, deleting, and other manipulations are disclosed. Beyond simply moving bulk search result information into like groups on different page string tabs or grouped within a page string there is the issue of the individual search result item. Disclosed is the ability of the Content User to continually improve upon the first and any number of subsequent page search results by moving more relevant search results for that particular Content User to the top of the page string, of the single search result string or any separate grouped results parsed onto separate tabs. Ultimately the search result becomes increasingly personal, relevant, and meaningful to the Content User and their internet experience.

Defining new search criteria from the newly reprioritized search page is disclosed as a next level is search criteria input and definition to increase search result specificity and relevance. A benefit of the Content User refining and relocating the individual search results such that the first and any number of subsequent pages become increasing relevant is to search the internet again based on what the Content User demonstrated as being particularly relevant to them at that moment. A further disclosure is to save the search results on a page string for recall as well as save the refined search criteria. Again, increasing the relevance and usability of the internet for each particular Content User.

Content Provider related disclosures are summarized as follows.

More page ones and more page one positions of equivalent merit are created as a result of parsing and sorting like internet search result (.gov, .bigbox, .pizza or .club separated from other restaurants, .edu, etc.) onto separate result page string tabs or groups within a single result page string. There will only be more than one first page if the first page of each category is nearly similar in potential relevance. For example, if a Content User is looking for a authentic pizza restaurant it is easier to go to the .pizza tab than search through all restaurants listed in the single page string of .com and all other extensions (.gov—pizza is to high calorie, .edu—pizza culinary school, .org—donate pizza to a shelter, .com—mom's best pizza recipe, etc.). The .pizza tab becomes as relevant and maybe even more meaningful as the original .com page string, and such is the case with any additional page string and their associated page one and position one. More equivalent page ones and page one positions provide more opportunity for Content Providers to be seen by organic or paid positioning. It is irrational to continue to believe the vastness of the internet can be made available on one page one or page string. Even the creation of one, two, or a few more additional page strings with each containing their own page one and page one Content Provider position remains irrational, but a vast improvement to the current single page format.

Moving to position one or another higher page position on a page one by Content User search result manipulation, hiding, moving, and other methods is disclosed as a next innovation for the next Content Provider in line to move forward into Content User visibility. Such is the case for organics search results as previously summarized, but now paid advertisement or positions can be filled by the next relevant Content Provider as the Content User moves or excuses another less relevant or less preferred paid Content Provider from their view. Increased traffic to increased relevant screen positions provides Content Managers with increased revenues by offering increased visibility opportunities to Content Providers. Ultimate, Content Providers achieve a better internet use and participation experience by being more visible. Further, whether by organic search or paid positioning, a Content Provider gains the ability to choose which tab best serves their need (.club tab, .auto tab, .gov tab, .edu tab, etc.), further improving their real and perceived benefit from participating on the internet.

The Internet is a remarkable infrastructure that is now a part of world societies. As the internet advances in infrastructure, access, speed, content, and other components, the weakness of the internet becomes more evident. That weakness is the search interface, search specificity, search result delivery and format, Content Provider visibility, among other use and participation experiences. This invention discloses meaningful and transformational advancements to improve Content User experience and Content Provider participation. This disclosure is critical to the Content Manager as they only remain viable with the continued evolution of the internet and the growing expectations of commercial and non-commercial Content Users and Content Providers.

### BRIEF DESCRIPTION OF THE SEVERAL VIEWS OF THE DRAWING

Current state of internet interfaces.

FIG. 1—Search Engine Examples—Four images of the top internet search engines showing their similarities and limitations by use of the single keyword search field, no other input available, and some limited topical options.

FIG. 2—Intranet Criteria Buttons—Two images show that the limitation of internet searching need not exist as intranet sites show searches using more granular capabilities to get a more specific result that could be used with internet searching.

FIG. 3—Intranet Action Buttons—Two images showing the lack of internet search interaction is not shared with intranet search interaction where there is selection, comparison, and manipulation of search data that could similarly be extended to internet search results.

Semi-Simple Search interface.

FIG. 4—Simple Search—An example of a simple internet or intranet search or a single keyword search criteria field. This simple search is typically provided by search engine and Content Managers.

FIG. 5—Semi-Simple Search—An example of a semi-simple search characteristic of a primary keyword search criteria field and one or more pre-set or Content User determined additional search criteria, with the characteristic of being largely simple and largely intuitive with an expected result understood.

FIG. 6—Semi-Simple Search—Domain Extensions—An example of a semi-simplified initial internet search criteria screen that incorporates the use of a primary keyword input field as well as two additional keyword input fields and two domain extension search criteria fields as representative of added search criteria detail yet without loss of simplicity.

More page ones.

FIG. 7—More Meaningful Page Ones—An example of creating more than one meaningful first page by separating search result into categories that remain compelling to view, therefore also creating meaningful and favorable multiple top of first page organic and paid advertisement positioning, as well as providing more control and simplicity.

Sorting and separating internet search results.

FIG. 8—Interactive Search And Separated Search Results—An example of a more interactive search and search result screen showing how a semi-simple layout can provide parsing search result into multiple and meaningful pages, increased search specificity, prioritization of search results, and more capabilities improve internet use experience and viability.

FIG. 9—Main Page, Interactive Search, and Separated Search Results—An example of even greater interactive search and search result screen while maintaining a useful yet semi-simple layout and in this case the ability to reprioritize organic search results and advertisement as well as disposition organic search results and paid advertisements to transform the first page into a more relevant first page as search results and paid advertisements are view and manipulated.

FIG. 10—Best Page, Interactive Search, Reprioritized Search Results With Relevance Indicator—An example of the Best Sites page or a second first page of the FIG. 7 Main Search first page, in this case showing how reprioritization and disposition of organic search items and paid advertisements has create a much more meaningful first page and a more meaningful internet use experience, while maintaining a semi-simple search and search results environment.

FIG. 11—Best Page, Interactive Search, Reprioritized Search and Results Without Relevance Indicator—An example of the Best Sites page or a second first page of the FIG. 7 Main Search first page, in this case showing how reprioritization and disposition of organic search items and paid advertisements has create a much more meaningful first page and a more meaningful internet use experience, while maintaining a semi-simple search and search results environment.

Search and sort results by biographical and performance data.

FIG. 12—Gathering Biographical And Performance Data—A block diagram showing how at the time of domain or email registration, renewal, or verification that additional information can be gathered to assist in search results selection, but also disposition of search results by similarity among search results.

FIG. 13—Migration Of Domain Names From Generic Domain Extensions To More Descriptive Domain Extensions

FIG. 14—Increase Advertising Fees With More Advertisements In More Favorable Advertising Positions.

Basic Content User added search criteria.

FIG. 15—Search Screen Interactive Interface=Domain Extension with flow chart and system image.

FIG. 16—Search Screen Interactive Interface=Keyword..Domain Extension with flow chart and system image.

Additional search criteria in the same search input field and separate search input fields.

FIG. 17—Search Screen Interactive Interface=Keyword+Pre-Set Domain Extension with flow chart and system image.

FIG. 18—Search Screen Interactive Interface=Keyword+User-Set Domain Extension+User Set Domain Extension (Same Input Field) with flow chart and system image.

FIG. 19—Search Screen Interactive Interface=Keyword+User-Set Domain Extension (Separate Input Fees) with flow chart and system image.

FIG. 20—Search Screen Interactive Interface=Keyword+Pre-Set Domain Extension+User Set Domain Extension with flow chart and system image.

Content User second keyword input field with domain extension input field.

FIG. 21—Search Screen Interactive Interface=Keyword+User-Set Keyword with flow chart and system image.

FIG. 22—Search Screen Interactive Interface=Keyword+User Set Keyword+Pre-Set Domain Extension with flow chart and system image.

FIG. 23—Search Screen Interactive Interface=Keyword+User-Set Keyword+User-Set Domain Extension with flow chart and system image.

FIG. 24—Search Screen interactive Interface=Keyword+User-Set Keyword+Pre-Set-Set Domain Extension+User Domain Extension with flow chart and system image.

Results sorting using a keyword and domain extension.

FIG. 25—Results Interactive Interface+Keyword.Domain Extension=Main with flow chart and system image.

Main keyword input field with a pre-set Content Manager domain extension input.

FIG. 26—Results Interactive Interface+Keyword+Pre-Set Domain Extension=Main with flow chart and system image.

FIG. 27—Results Interactive Interface+Keyword+Pre-Set Domain Extension=Main+Group with flow chart and system image.

FIG. 28—Results Interactive Interface+Keyword+Pre-Set Domain Extension=Main+Separate with flow chart and system image.

FIG. 29—Results Interactive Interface+Keyword+Pre-Set Domain Extension=Main+Group+Separate with flow chart and system image.

Main keyword input field with a Content User domain extension input field.

FIG. 30—Results Interactive Interface+Keyword+User-Set Domain Extension=Main flow with chart and system image.

FIG. 31—Results Interactive Interface+Keyword+User-Set Domain Extension=Main+Group with flow chart and system image.

FIG. 32—Results Interactive Interface+Keyword+User-Set Domain Extension=Main+Separate with flow chart and system image.

FIG. 33—Results Interactive Interface+Keyword+User-Set Domain Extension=Main+Group+Separate with flow chart and system image.

Main keyword input field with a Content Manager pre-set domain extension and Content User domain extension input fields.

FIG. 34—Results Interactive Interface+Keyword+Pre-Set Domain Extension+User Set Domain Extension=Main with flow chart and system image.

FIG. 35—Results Interactive Interface+Keyword+Pre-Set Domain Extension+User Set Domain Extension=Main+Group with flow chart and system image.

FIG. 36—Results Interactive Interface+Keyword+Pre-Set Domain Extension+User Set Domain Extension=Main+Separate with flow chart and system image.

FIG. 37—Results Interactive Interface+Keyword+Pre-Set Domain Extension+User Set Domain Extension=Main+Group+Separate with flow chart and system image.

Use of second Content User keyword field and Content Manager pre-set domain extension.

FIG. 38—Results Interactive Interface+Keyword+User Keyword+Pre-Set Domain Extension=Main with flow chart and system image.

FIG. 39—Results Interactive Interface+Keyword+User Keyword+Pre-Set Domain Extension=Main+Group with flow chart and system image.

FIG. 40—Results Interactive Interface+Keyword+User Keyword+Pre-Set Domain Extension=Main+Separate with flow chart and system image.

FIG. 41—Results Interactive Interface+Keyword+User Keyword+Pre-Set Domain Extension=Main+Group+Separate with flow chart and system image.

Main keyword input field with Content User keyword input field and Content User domain extension input field.

FIG. 42—Results Interactive Interface+Keyword+User Keyword+User-Set Domain Extension=Main with flow chart and system image.

FIG. 43—Results Interactive Interface+Keyword+User Keyword+User-Set Domain Extension=Main+Group with flow chart and system image.

FIG. 44—Results Interactive Interface+Keyword+User Keyword+User-Set Domain Extension=Main+Separate with flow chart and system image.

FIG. 45—Results Interactive Interface+Keyword+User Keyword+User-Set Domain Extension=Main+Group+Separate with flow chart and system image.

Main keyword input field, Content User keyword input field, Content Manager pre-set domain extension input field, and Content User domain extension input fields.

FIG. 46—Results Interactive Interface+Keyword+User Keyword+User-Set Domain Extension+Pre-Set Domain Extension=Main with flow chart and system image.

FIG. 47—Results Interactive Interface+Keyword+User Keyword+User-Set Domain Extension+Pre-Set Domain Extension=Main+Group with flow chart and system image.

FIG. 48—Results Interactive Interface+Keyword+User Keyword+User-Set Domain Extension+Pre-Set Domain Extension=Main+Separate with flow chart and system image.

FIG. 49—Results Interactive Interface+Keyword+User Keyword+User-Set Domain Extension+Pre-Set Domain Extension=Main+Group+Separate with flow chart and system image.

### DETAILED DESCRIPTION OF THE INVENTION

To improve clarity and immediacy in locating information the following is a table of contents

A. Principles Of The Invention

B. Narrative Description (containing its own table of contents)

C. Drawing Description

D. Comment elements, Terminology, and Definitions

E. General Guidance

F. Paragraph Format Of The Claims

### PRINCIPLES OF THE INVENTION

The driving principles of the Interactive Internet are based on the human experience. The ability of the Content User and Content Provider to more directly influence their internet experience by offering more input to algorithms starving for relevancy guidance.

The specific code, software, algorithms, hardware, etc. are less important than the experience. The software and hardware will change over time and the approach to achieve the experience will vary. It is the outcome in experience for the Content User and the Content Provider to be given more controls to reclaim, enhance, and transform relevance and value of the internet is what is needed.

The Content Manager is participating in a fluid field that transforms constantly. To remain relevant the Content User and Content Provider experience needs to be positive and productive or interest will shift to other Content Managers, especially those that improve the Content User and Content Provider internet experience and viability of the internet for their individual purposes. Further, additional services, more favorable positioning, more control, greater flexibility, saved searches, and more provide reasons and opportunity for more and greater revenue to the Content Manager.

The principles applied to this invention are market forces. The best experience, the best value, and a viable result will compel Content Users, Content Providers, and Content Managers to make choices in their interaction with the internet. What is needed is a new, more flexible, and more viable internet experience which is disclosed herein.

### DRAWING DESCRIPTION

The inventions and improvements of this disclosure are interrelated as one invention to a more productive internet experience by Content Users, Content Providers, and Content Managers. The inventions and improvements of this disclosure are multi-facetted in moving the Internet experience into a more controllable, relevant, productive, and ultimately viable and satisfying experience.

The internet is evolving in content and hardware, but the cleverness of millions of man-hours and millions of dollars in seeking to make the internet more intuitive, more machine intelligent, more discerning of legitimate content, and otherwise more clever is simply not keeping pace with the simple expectation of users, the content of the internet, and the potential of the system. What is missing is more Content User input. It is irrational to believe that a word, phrase or question can always provide enough information to satisfy the specific interests of a Content User at that moment, and often unrelated to previous internet searches.

To provide clarity, the tables below show the interrelationship between specific figure disclosures and major variations addressed. Each specific disclosure focuses upon its unique innovations, features, and utility in contributing to increased Content User internet search control and internet search results control and clarity. Note that the figures and disclosures herein are provide only by way of example, not intending to be limited to what is explicitly disclosed, but encompassing the fullest implicit interpretations, scope, and relevant variations that would be acknowledged by a person having ordinary skill in the art. Further, an innovation, feature, and utility discussed in one specific figure may be specifically available in another and be well within the scope of the explicit and implicit disclosure and intent of this total disclosure of Interactive Internet Interfaces.

The table that directly follows is more of a list of tables and indicated associations in addressing similar disclosure content.

TABLE 3

| FIG | Action | Disclosure | Comment |
|---|---|---|---|
| 1 | Image | Search Engine Examples | |
| 2 | Image | Intranet Criteria Buttons | |
| 3 | Image | Intranet Action Buttons | |
| 4 | Search | Simple Search-Keywords | |
| 5 | Search | Semi-Simple Search-Keywords | |
| 6 | Search | Semi-Simple Search-Keywords And | |
| | | Domain Extensions | |
| 7 | Results | Parsing Tabs For More Page ones | |
| 8 | Results | Parsing Tabs And Ranked Search Results | |
| 9 | Results | Parsing Tabs And Ranked Search | |
| | | Results-Main Page String | |
| 10 | Results | Parsing Tabs and Ranked Search | |
| | | Results-Best Page String | |
| 11 | Results | Parsing Tabs And Ranked Search | |
| | | Results-Best Page String | |
| 12 | Results | More Favorable Content Provider | |
| | | Ad Positions | |
| 13 | Criteria | Domain Name and URL Association With | |
| | | Biographic And Other Data | |
| 14 | Criteria | Updating Existing Domain Names and | |
| | | URLs With More Descriptive Data | |

The table that specifically follows shows figures more specifically directed towards disclosures of the Semi-Simple Search Interface and major innovations, features, and utility. Other variations are possible, but that represented by figures relative to this table are major alterations to express the scope and choice encompassed by the Semi-Simple Search Interface.

TABLE 4
Figure Interrelationship
Semi-Simple Search Interface For Criteria Control

| | | | | Criteria | Criteria | | | | |
|---|---|---|---|---|---|---|---|---|---|
| | | Criteria | Criteria | Domain | Domain | Results | | | |
| | | Keyword | Keyword | Extension | Extension | Main | Results | Results | |
| | | Input | Input | Input | Input | Page | Grouped | Separate | |
| | | Field | Field | Field | Field | String | Page | Page | |
| | | Content | Content | Content | Content | All Or | String | String | |
| | | User | User | User | Manager | Left Over | Common | One | |
| FIG. | Action | Defined | Defined | Defined | Pre-Set | Criteria | Criteria | Criteria | Comments |
| 15 | Search | | | X | | | | | |
| 16 | Search | K.DomEx | | X | | | | | |
| 17 | Search | X | | | X | | | | |
| 18 | Search | X | | X | | | | | |
| 19 | Search | X | | X | | | | | Same Fields |
| 20 | Search | X | | X | X | | | | Separate Fields |
| 21 | Search | X | X | | | | | | |
| 22 | Search | X | X | | X | | | | Separate Fields |
| 23 | Search | X | X | X | | | | | |
| 24 | Search | X | X | X | X | | | | |

The table that follows clarifies the relationship between figures focused on the clarity, effectiveness, utility, and experience to the Content User by innovative presentation, parsing, and sorting of internet search results. Integrally related to how internet search results are organized is linked to Content User and Content Manager directives guided by the Semi-Simple Search Interface or protocols present elsewhere that guide internet search results formats. As such listed in the following table are both search criteria and results criteria and their associated outcomes.

TABLE 5
Figure Interrelationship
Influence Of Search Criteria On Search Result Presentation And Parsing

| | | | | Search | Search | | | | |
|---|---|---|---|---|---|---|---|---|---|
| | | Search | Search | Domain | Domain | Results | | | |
| | | Keyword | Keyword | Extension | Extension | Main | Results | Results | |
| | | Input | Input | Input | Input | Page | Grouped | Separate | |
| | | Field | Field | Field | Field | String | Page | Page | |
| | | Content | Content | Content | Content | All Or | String | String | |
| | | User | User | User | Manager | Left Over | Common | One | |
| FIG. | Action | Defined | Defined | Defined | Pre-Set | Criteria | Criteria | Criteria | Comments |
| 25 | Results | K.DomEx | | | | | Grouped | | |
| 26 | Results | X | | | X | Main | | | |
| 27 | Results | X | | | X | Main | Grouped | | |
| 28 | Results | X | | | X | Main | | Separate | |
| 29 | Results | X | | | X | Main | Grouped | Separate | |
| 30 | Results | X | | X | | Main | | | |
| 31 | Results | X | | X | | Main | Grouped | | |
| 32 | Results | X | | X | | Main | | Separate | |
| 33 | Results | X | | X | | Main | Grouped | Separate | |
| 34 | Results | X | | X | X | Main | | | |
| 35 | Results | X | | X | X | Main | Grouped | | |
| 36 | Results | X | | X | X | Main | | Separate | |
| 37 | Results | X | | X | X | Main | Grouped | Separate | |
| 38 | Results | X | X | | X | Main | | | |
| 39 | Results | X | X | | X | Main | Grouped | | |
| 40 | Results | X | X | | X | Main | | Separate | |
| 41 | Results | X | X | | X | Main | Grouped | Separate | |
| 42 | Results | X | X | X | | Main | | | |
| 43 | Results | X | X | X | | Main | Grouped | | |
| 44 | Results | X | X | X | | Main | | Separate | |
| 45 | Results | X | X | X | | Main | Grouped | Separate | |
| 46 | Results | X | X | X | X | Main | | | |
| 47 | Results | X | X | X | X | Main | Grouped | | |
| 48 | Results | X | X | X | X | Main | | Separate | |
| 49 | Results | X | X | X | X | Main | Grouped | Separate | |

The detailed description of figures follows. In most figures there is both a disclosure of the guiding methods and the relevant system apparatus. Numerous variations are possible, and that which is disclosed are but a few explicit example, with the figures and associated disclosures not intended to be limiting to the fullest interpretation and associated features encapsulated by the inventive sparks and leaps of the specific and general disclosures herein.

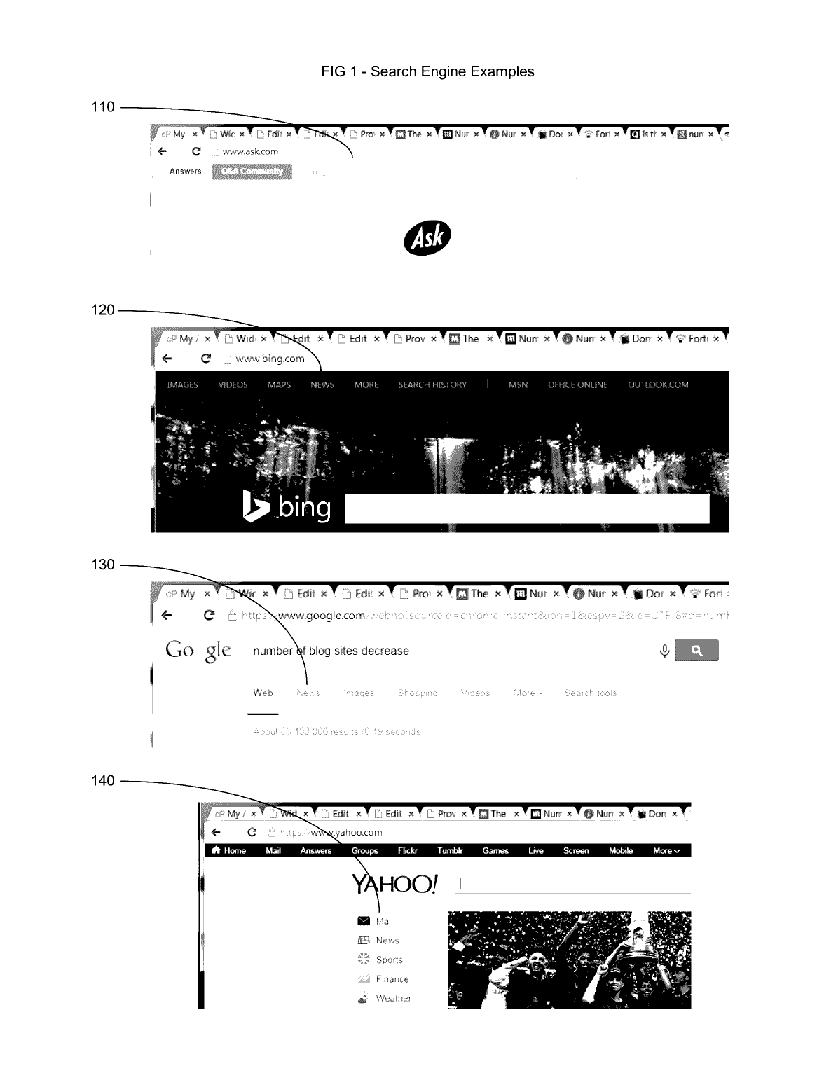

FIG. 1—Search Engine Examples

FIG. 1 provides four images of the top internet search engines showing their similarities and limitations by use of the single keyword search field, no other input available, and some limited topical options. www.ask.com, 110, www.bing.com 120, www.google.com 130, and www.yahoo.com 140 all show the typical simple search criteria and opportunity available today on the internet. With simple keywords that are today more of a phrase or sentence there is an expectation to obtain the most relevant information on the internet. A recent experience with one of these mentioned sites suggested a rake be purchased through www.Amazon.com. For many Content Users that suggestion is absurd, and the Content Manager appears incompetent. The internet needs a better internet interface to access the vast amount of valuable and not so valuable information. Additionally shown is the presence of topical fields, but often more for entertainment and browsing than simple searching.

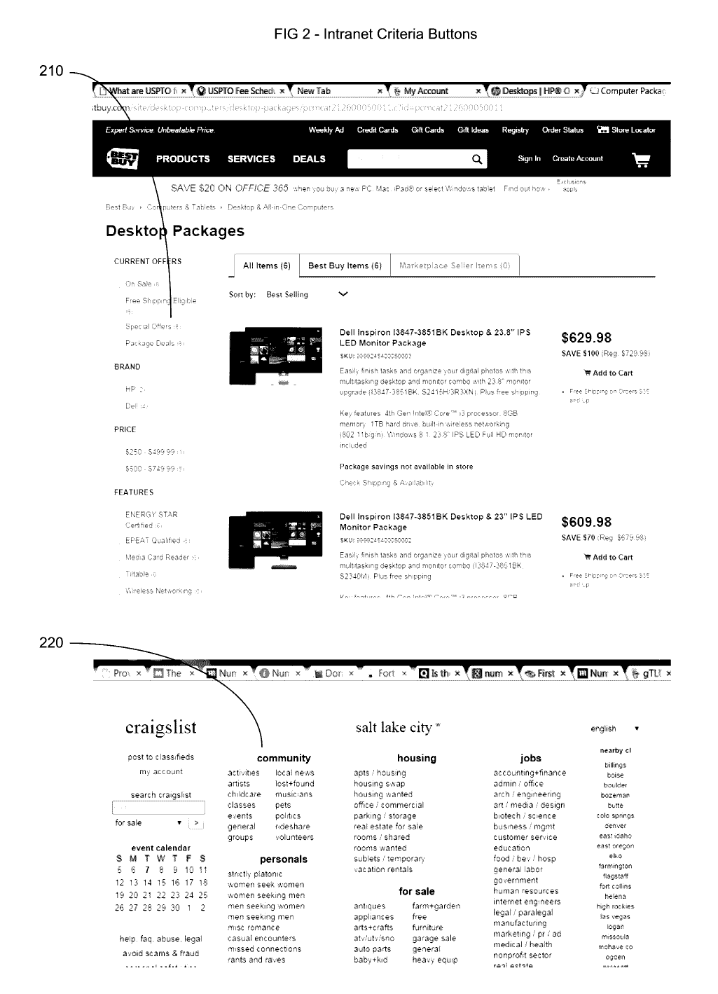

FIG. 2—Intranet Criteria Buttons

FIG. 2 shows two images show that the limitation of internet searching need not exist as intranet sites show searches using more granular capabilities to get a more specific result that could be used with internet searching. www.BestBuy.com 210 shows an intranet using secondary search criteria, but not also associated with the keyword search criteria. Missing is the ability to keyword search and use the secondary criteria. www.craigslist.org 220 shows the use of categories to open lists of Content Provider determined location in chronological order. Missing is the ability to search within the list.

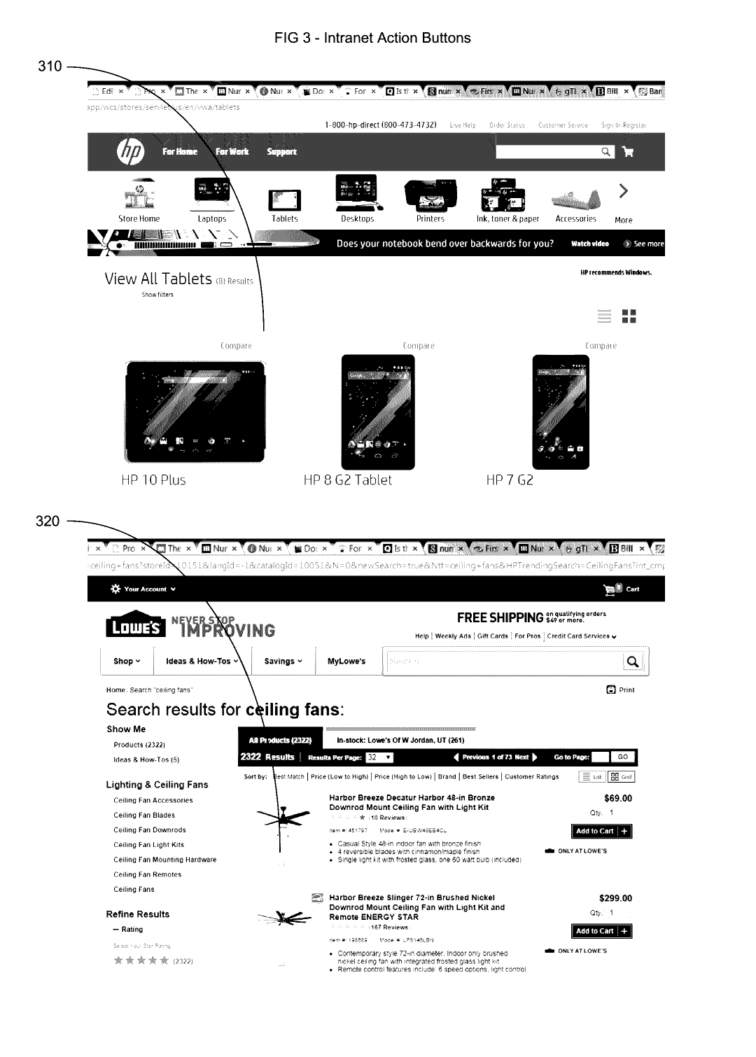

FIG. 3—Intranet Action Buttons

FIG. 3 shows two images showing the lack of internet search interaction is not shared with intranet search interaction where there is selection, comparison, and manipulation of search data that could similarly by extended to internet search results. www.HP.com 310 and www.Lowes.com 320 shows the use of an interactive field in an intranet for simple comparison. What is missing is the use of the interactive button in conjunction with the search field.

Currently the simple search or the use of a single keyword search field to direct the entirety of the internet experience is inadequate. It leaves too many simple and available variables unknown that could readily and more accurately direct internet results. The Semi-Simple Search provides that additional insight, but not at the level of advanced search methodologies that often requires more than populous search knowledge and is often intimidating to populous Content Users. Needed is something simple, but a little more guiding yet still largely intuitive, and not complex and intimidating. This Semi-Simple Search platform includes, but is not limited to maintaining the typically known and primary keyword search field, and one or more additional keyword fields, domain extension fields, inclusion or exclusion search criteria choices, weighting factors assigned to search criteria, guidance on parsing search results among one or more search result pages, and more. What is characteristic of the Semi-Simple Search platform is the presence of the typical keyword search field and one or more additional search criteria made available by the Content Manager or equivalently the search engine or search protocol. The additional input field may accept any characters or symbols, word or collection of word text, lists, button choice, check box selection, wire or wireless connectivity, and other means. The form of the additional search input field may change from page to page after a search or for other means. These one or more additional search criteria are expected to be present with the primary keyword search field and all jointly executed upon indicating a search request. These criteria need not be executed simultaneously, but they may be executed simultaneously, sequentially, or any simultaneous or sequential search criteria combination. The one or more additional search criteria may appear on the search results page as a first appearance or if appeared with the typical keyword search field initially and as expected, they will follow through with subsequent search result pages. The one or more search criteria need not remain the same search criteria through all subsequent pages, but may change based upon preference, need, content, or any other determining factor.

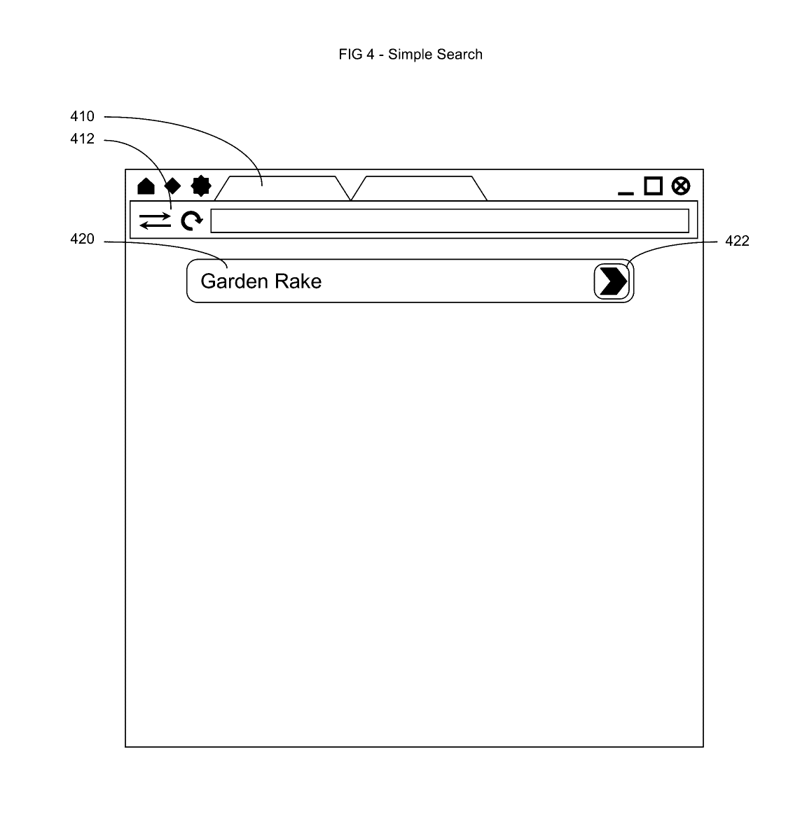

FIG. 4—Simple Search

FIG. 4 is an example of a simple internet or intranet search or a single keyword search criteria field. This simple search is typically provided by search engine and Content Managers. The active page tab 410 is associated with the simple search and is an indicator of somewhat independent content. General search engine functions and URL bar universally included in 412 as simply recognizing common elements among search engines. The simple search 420 criteria field is for keyword input. The search 422 button takes the keywords, terms, phrase or sentence and calls for a search. Ironic about the internet that with over 1,200,000,000 web pages just one search field has remained as seemingly sufficient. Not all agree.

Described was a method for searching and separating internet search results sites by use of one or more domain extensions. Here disclosed, described, and claimed is the method and system using any one or more search criteria within the primary keyword search field or any one or more additional search field and criteria. Much like the specificity of a domain extension, any additional inclusion or exclusion of a word, words, phrase, symbol, abbreviation, numbers, alphanumeric combination, specific geographic, biographic, performance, industry specific term, product specific, and other information may be used to create a more specific and valuable internet search result than the current single keyword field. The keyword field and the advanced search platform of many search engines may be used to achieve more specific internet search results, but most are unaware of advanced search methodologies, and the benefit of an advances search goes underutilized. A purpose of this disclosure is the use of a semi-simplified search platform that is largely intuitive and can be used by today's internet Content Users to achieve the benefit of a more specific internet search criteria set. Disclosed and claimed is the use of the primary keyword and one or more additional search criteria to increase the specificity and accuracy of an internet search. The one or more additional search criteria is most intuitively added with one or more additional search criteria field for additional keywords, phrases, numbers, symbols, domain extensions, and any such other input by text field or area, list, radio button, check box, drop down, clickable text, range of choice, or by any such means as recognizable by Content Users.

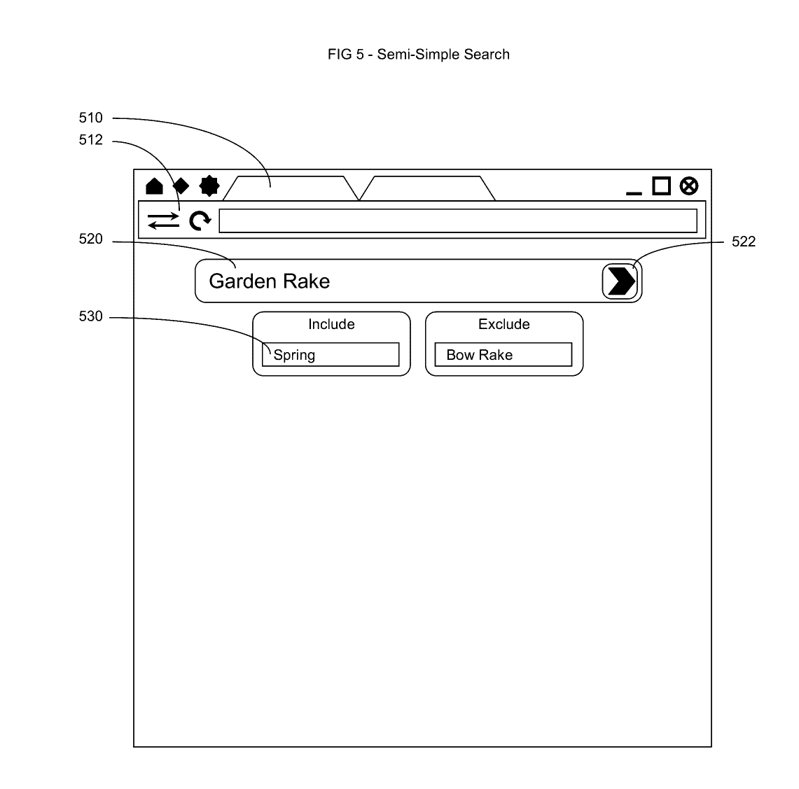

FIG. 5—Semi-Simple Search

FIG. 5 is an example, and not limited to this example, of a semi-simple search characteristic of a primary keyword search criteria field and one or more pre-set or Content User determined additional search criteria, with the characteristic of being largely simple and largely intuitive with an expected result understood. The active page tab 510 is associated with the simple search and is an indicator of somewhat independent content. General search engine functions and URL bar universally included in 512 as simply recognizing common elements among search engines. The simple search 520 criteria field is for keyword input. The search 522 button takes the keywords, terms, phrase or sentence and calls for a search. The additional content search criteria 530 create a semi-simple search platform that brings added definition to a search. That definition can be gained in a single and complex search query, but such knowledge and skill is outside populous use. Important with this FIG. 5 is to observe that the additional content search criteria is intuitive and does not constitute and advanced search, yet also not a simple single keyword search. By way of example only, the input criteria fields 530 show a field requesting inclusion of search results with a particular keyword as well as a field allowing for the exclusion of search results with a different keyword. Note that in this and all other cases the Content User may include a keyword in both 530 additional fields, one 530 additional field, no 530 additional field or any of their combinations and the search will continue and results displayed. A search may be conducted with input in any one search criteria field and any of their combinations. A Semi-Simple Search may also contain just one, two, or a few additional search criteria input field, rather than the two shown in this disclosure.

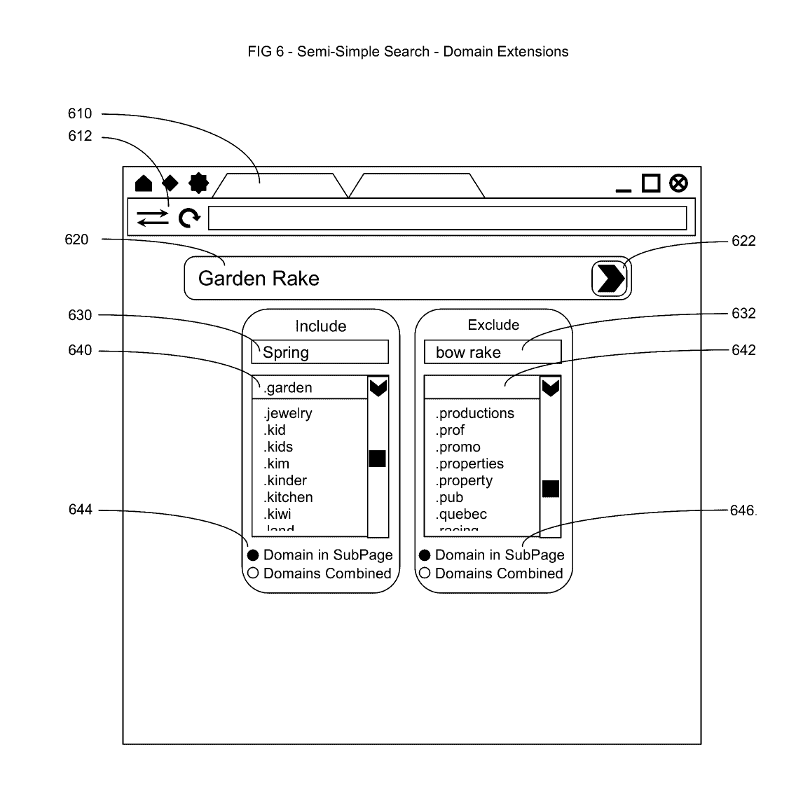

FIG. 6—Semi-Simple Search—Domain Extensions

FIG. 6 is an example, and not limited to this example, of a semi-simplified initial internet search criteria screen that incorporates the use of a primary keyword input field as well as two additional keyword input fields and two domain extension search criteria fields as representative of added search criteria detail yet without loss of simplicity. This disclosure is only presented as an example, and without limitation of other embodiments. The active page tab 610 is associated with the simple search and is an indicator of somewhat independent content. General search engine functions and URL bar universally included in 612 as simply recognizing common elements among search engines. The simple search 620 criteria field is for keyword input. The search 622 button takes the keywords, terms, phrase or sentence and calls for a search. The additional content search criteria for included keywords 630 provides for additional guidance as to what to include, and additional content search criteria for excluded keywords 632 provides intuitive insight of what can be excluded with the addition of the word. I this case a bow rake was listed and desirous to be excluded from the search results. As the disposition indicator shows to place the search excluding bow rakes on a separate internet search results page it is as if almost three searches in one, because the bow rake was not wanted in the search results, but there is a little interest in bow rakes generally. Another format would be to exclude bow rakes without any disposition indication and the bow rakes would not appear in any list, as they are excluded. The additional content search criteria for included domain extensions 640 provides for additional guidance as to what to include. The inclusion of the domain will provide a means to separate the search into two search result pages so as not to lose the general search, but also have the benefit of a more focused search. The Additional content search criteria for excluded domain extensions 642 provides intuitive insight of what can be included with the addition of the domain included. The additional content search criteria disposition 644 shows that the entire internet will be searched and that two search result pages will be created. One search result page will contain all search results from all domains except the .garden domain that will be included in its own search results page. The inclusion of the domain Additional content search criteria for excluded domain extensions 642 provides intuitive insight of what can be excluded with the addition of the domain extension. In this case no domain extension was listed for exclusion. The additional content search criteria disposition 646 shows that the entire internet will be searched and that a third search result pages will be created showing the excluded items based on the keyword exclusion search. Almost three searches in one, because the bow rake was not wanted in the search results, but there is a little interest in bow rakes generally. Another format would be to exclude bow rakes without any disposition indication and the bow rakes would not appear in any list, as they are excluded. Created is a semi-simple search platform that is largely intuitive, but with a little use becomes facile and understood. Combine this semi-simple search platform with the ability to then parse search results from one internet search list to another, then user experience beings to be meaningful. In this case no domain extension is being called for exclusion so all domain extension will be searched. Creating a semi-simple search platform brings added definition to a search.

What is still missing from the internet generally, in any platform is the reduced user functionality that is accustom to desktop based wordprocessing, spreadsheets, and other programs. In other words, the lack of control and options. The internet search with its one search criteria field and then the take it or leave it results may be the worst such example, especially given the vast amount of available information. One element of control is to manually create additional internet search result pages. The identification of specific domain extensions to separate from the general search results in an automatic form with the return of search results is disclosed and claimed.

Disclosed, described, and claimed is not only the creation of more pages, but more pages of substantially equal relevance providing more page one first favorable first positions and more first page top of page favorable positions for organic and paid positioning. Disclosed here is a method and system to not just create the page, but to create the favorable positioning. As previously stated the difference between being on page one and all other pages is nearly 98.5% activity to 1.5% activity (an that and that is generous). The difference between the top positions of the first page and the lower positions of the first page is staggering. The visibility of top positions on page one, and other top of page one position is also noticeable. Every Content Provider knows they need to be on page one and in the first five or so positions. Given now over 1.2 billion websites, or even 10,000 in an area, or 100 in an area, when there is only a top five favorable positions the ability to occupy one of those sites is nearly impossible. Compounding this is the presence of government, big box retail, wiki sites, definition sites, etc. that by search engine protocols earn and are given these preferred sites, even though they may not be relevant to the interest of the Content User. Moving prominent sites, groups of similar sites, high brand recognized sites, and other criteria to additional search result pages creates more page ones. Creating more page one is not just creating another page, although it includes that as well. Where generally create during any search it is selectively moving to additional internet search result pages content and sites that still show relevance to the Content User. Ideally the additional search result pages will be of substantially equivalent value as the main or general internet search result page. Such sites include government sites, big retail, definitions, encyclopedias, and such. By way of example and not to be limiting to other applications, a .gov additional search result page would have substantially equivalent value as the general internet search result page, if the Content User was interested in government websites. There would be no hesitation to view such a page and in fact it would be seen as having high value as all government content on the subject would be conveniently located in one location without other confounding information. For a Content Provider, there is no page one positioning on this .gov additional internets search result page as it is populated by government websites. However, it has removed the usual top spot from being held by the government website in the general internet search result page. Further there is also a hierarchy of paid advertisement favorability and this .gov additional internet search result page does create more paid advertisement favorable positioning and focused viewers that may be favorable to advertising specifically on a .gov, .edu, .org, etc. specific additional internet search result page. In another example, if the Content User is looking to purchase a household item then going to another page to view Menards, Home Depot, Ace Hardware, Wal-Mart, Amazon, and other big retail stores does not diminish the main search results or the additional search results page. Because of that, then not there are two substantially equal and valuable page ones for organic and paid content. Where a search many not include big retail then the organic positioning on each page one will be more available to smaller organic search Content Providers. When sorting websites occurs by other domain extensions such as .health, .fitness, .auto, .club, etc. then there are additional search result pages with additional and substantially equivalent page ones because they wanted to see .health, .clothing, .pharmacy, etc. and there for more favorable additional position ones and additional top of page one favorable positioning. Disclose and claimed is the creation of additional search result pages and resultant additional favorable first positions on the first page, and additional favorable top of page one positions.

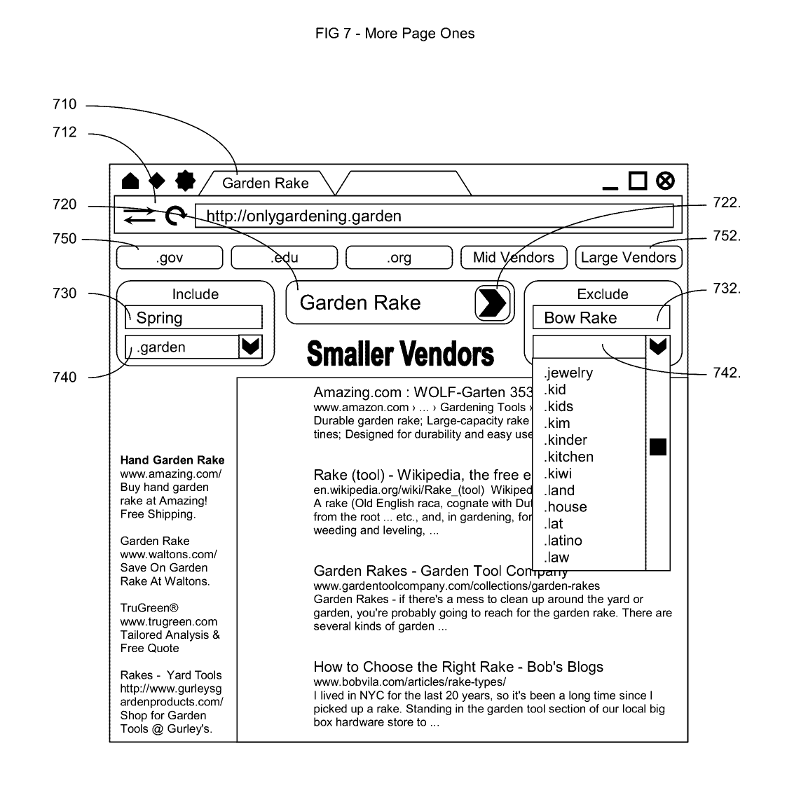

FIG. 7—More Meaningful Page Ones

FIG. 7 is an example, and not limited to this example, of creating more than one meaningful first page by separating search result into categories that remain compelling to view, therefore also creating meaningful and favorable multiple top of first page organic and paid advertisement positioning, as well as providing more control and simplicity. The active page tab 710 is associated with the simple search and is an indicator of somewhat independent content. General search engine functions and URL bar universally included in 712 as simply recognizing common elements among search engines. The simple search 720 criteria field is for keyword input. The search 722 button takes the keywords, terms, phrase or sentence and calls for a search. The additional content search criteria for included keywords 730 provides for additional guidance as to what to include, and additional content search criteria for excluded keywords 732 provides intuitive insight of what can be excluded with the addition of the word. I this case a bow rake was listed and desirous to be excluded from the search results. The additional content search criteria for included domain extensions 740 provides for additional guidance as to what to include. The inclusion of the domain will provide a means to separate the search into two search result pages so as not to lose the general search, but also have the benefit of a more focused search. The Additional content search criteria for excluded domain extensions 742 provides intuitive insight of what can be excluded with the addition of the domain extension. In this case no domain extension was listed for exclusion. Almost three searches in one, because the bow rake was not wanted in the search results, but there is a little interest in bow rakes generally. Additional search result page or subpage 750 shows a pre-set additional search criteria that separated out all .gov, .edu, and .org domain extensions from the general search. Ironically, these are significantly searched domain extensions and so the fact that they have been parsed into their own additional internet search results pages or subpages does not detract from their visibility. The Content User knows exactly where to go for these authoritative sites. Additionally Large Vendor subpage 752 and companion Mid Vendor subpage remove these groups of vendors from the garden rake search. If the Content User is wanting to look at a Menards for their garden rake then they would simply go to the Large Vendor subpage and happily find them listed well in the search. What has additionally happened is that six page ones of meaningful and substantial equivalence have been created. This provides more first page and first position Content Provider organic positioning and paid advertiser positioning. The Content User is pleased the search results are more naturally organized and results are more easily found. Organic and Paid Advertising Content Providers are more pleased because there is more opportunity for more favorable positioning on a page one and that all page ones are of substantial equivalence. A note is that the main page states Small Vendors so that by clicking on the Large Vendor button the Large Vendors will be shown on the main screen and the Small Vendors will take the small subpage button. This example need not be limited to this specific method, such as more than one search results page may be open at a time, but this simple example show one way by which multiple pages can interact. Again, a little familiarity, well within the boundaries of the complexity of smart phones, tablets, and other electronics brings about dramatic improvement of the internet.

For the manual separation of domain extensions a page creation button, clickable area, or function can be used to open a new internet page or a tab and page connected to the main search page in a manner deemed appropriate by Content Managers or even a new and somewhat independent tab. By way of example, not intended to be limiting, such methods may include dragging and dropping a site; clicking on a radio button or click box that is identified with the new search result page; adding the new search result page address or some local or system abbreviation or name, number, letter, or their combination in a field associated with the site; or other Content User created or system created identifier and path. Once a page is identified for disposition, that page may be populated with search results having a certain criteria at that time as we are frequently accustom with other programs. It may also be moved with a subsequent action, such as a local refresh, a new search, a parse function, and other such functionality. Any combination of separation is available to an additional internet search result page. With an additional search result page, then individual internet search results may be directed to that page. Directing individual search result sites to the page may include various methods. Such pages could be essentially blank and waiting for a drag and dropped individual internet search result site to be relocated, or a set of individual internet search results to be selected from a main search and move over upon selection or upon a subsequent action, such as parse, search, refresh, or the like. The manually created additional page could be created at the time of the primary search and use search criteria to move such found and retrieved items to the separate identified internet search result page or pages. The criteria may a single domain extension, or multiple domain extensions, or keywords and domain extensions, or random favorite or effective sites, or any of these singly or in combination or other methods of distribution. A note about advertising is that the manually created additional search result pages may be blank from advertisers as well, or loaded with advertisers willing to populate a blank page temporarily, but upon identification of the first loaded site, then the nature and type of paid advertisers will also appropriately populate automatically or with a subsequent action of a search, parse, refresh, update, or the like.

In addition to manually created pages, pages may be created and populated more automatically by Content Manager defined criteria (.gov, edu, .org, .bigbox, etc.), or from Content User specified criteria on the initial search interface page, subsequent search interface page, or any combination. What is disclosed and claimed is the creation of one or more additional internet search pages by direct Content User action and subsequent action to populate the page by selection, drag and drop and other disclosed means. What is disclosed and claimed is the indirect creation of additional search results pages based on initial search criteria and then automatically populated as part of search result item retrieval and presentation to the different appropriate pages based on Content User indicated preference, hierarchy, or other specific search criteria. What is disclosed and claimed are the creations of separate search result pages as defined by the Content Manager for usual and regular search results. Further disclosed and claimed is the combination of Content User direct and indirect as well as Content Manager separate result page creation and any of their combinations.

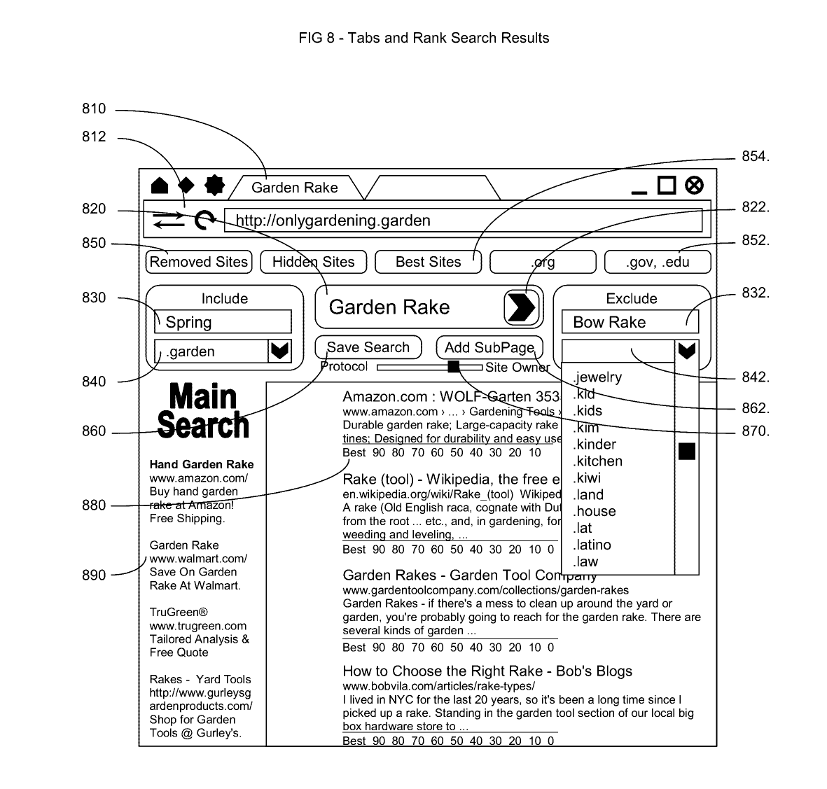

FIG. 8—Interactive Search and Separated Search Results

FIG. 8 is an example, and not limited to this example, of a more interactive search and search result screen showing how a semi-simple layout can provide parsing search result into multiple and meaningful pages, increased search specificity, prioritization of search results, and more capabilities improve internet use experience and viability. The active page tab 810 is associated with the simple search and is an indicator of somewhat independent content. General search engine functions and URL bar universally included in 812 as simply recognizing common elements among search engines. The simple search 820 criteria field is for keyword input. The search 822 button takes the keywords, terms, phrase or sentence and calls for a search. The additional content search criteria for included keywords 830 provides for additional guidance as to what to include, and additional content search criteria for excluded keywords 832 provides intuitive insight of what can be excluded with the addition of the word. I this case a bow rake was listed and desirous to be excluded from the search results. The additional content search criteria for included domain extensions 840 provides for additional guidance as to what to include. The inclusion of the domain will provide a means to separate the search into two search result pages so as not to lose the general search, but also have the benefit of a more focused search. The Additional content search criteria for excluded domain extensions 842 provides intuitive insight of what can be excluded with the addition of the domain extension. In this case no domain extension was listed for exclusion. Almost three searches in one, because the bow rake was not wanted in the search results, but there is a little interest in bow rakes generally. Additional search result page or subpage 850 shows a pre-set additional search criteria that separated out all .gov, .edu, and .org domain extensions from the general search. Ironically, these are significantly searched domain extensions and so the fact that they have been parsed into their own additional internet search results pages or subpages does not detract from their visibility. The Content User knows exactly where to go for these authoritative sites. Additionally Large Vendor subpage 852 and companion Mid Vendor subpage remove these groups of vendors from the garden rake search. If the Content User is wanting to look at a Menards for their garden rake then they would simply go to the Large Vendor subpage and happily find them listed well in the search. What has additionally happened is that six page ones of meaningful and substantial equivalence have been created. This provides more first page and first position Content Provider organic positioning and paid advertiser positioning. The Content User is pleased the search results are more naturally organized and results are more easily found. Organic and Paid Advertising Content Providers are more pleased because there is more opportunity for more favorable positioning on a page one and that all page ones are of substantial equivalence. A note is that the main page states Small Vendors so that by clicking on the Large Vendor button the Large Vendors will be shown on the main screen and the Small Vendors will take the small subpage button. Lastly on this subject it can be seen that the drawing depicts the Main Search page. By clicking on the Best Sites 854 the sites the Content User change as most relevant are collected and can be simultaneously viewed, saved, and researched. A dramatic improvement in the Content User internet experience. This example need not be limited to this specific method, such as more than one search results page may be open at a time, but this simple example show one way by which multiple pages can interact. The Save Search 860 button is available on each screen such that each search can be saved, much like Favorites found on most search engines. The Add SubPage 862 button is a means for Content User created additional internet search result pages for the Content User to create search landings or to post-search move search results to a high search value added page. The search protocol parameter 870 slider represents the type of relevance interface that allows Content Users to tweak the search while maintaining the same search parameters. In this case the search weighs parameters provided by the Content Provider above search protocols established by the Content Manger and their search engine. One or more of these search protocol parameter relevancy interfaces can be provided as with all features discussed. Another key feature of an improved internet search experience is the ability to indicate with a relevancy indicator 880 how the Content User feels the individual internet search result site relates to their immediate needs. Here the relevance interface is a list of percentages from not relevant or a 0% to a best relevant or 100%. Moving the relevance interface will either immediately move the item to a position that now represents it Content User ranking or a subsequent search will be needed and the item will fall into its specifically indicated ranking in the new search result list. Important about any Content User input such as with the search parameter protocol relevancy interface or the organic search result relevance interface the search protocol or search engine learns more about what is currently relevant to the Content User and their next search will improve its general relevance. Again, a little familiarity, well within the boundaries of the complexity of smart phones, tablets, and other electronics brings about dramatic improvement of the internet. Also listed as is commonly seen are Content Provider paid advertisements 890. The ability to tailor search results also brings greater Content User satisfaction and internet relevance.

With regards to log in of the Content Manager or the search engine by the Content User, one purpose might be that the content user never searched for children's clothing so a search result would not return that as part of the search criteria. Further the reason to save the search criteria of the Content User is that the search criteria may be specifically refined from manipulating and dispositioning previously returned search results. As such, the results are not just what the algorithm would return, but are specific to the Content User. In cases the Content User's page one and page two may be specifically identified search results moved into a particular order on the pages from the result of previous searches that would likely be unable to be reassembled by another search. Further the log in allows the Content User to manipulate the page in a way that works best for them. This might include choosing how many additional search criteria fields they wish to have and what type of additional search criteria fields. Such as drop downs, radio buttons, second or third keyword field, or other Content User interfaces and inputs. Further the Content User may set up the page to have a .gov, .org, .pharmacy, etc. additional pages as standard pages. Content Managers seeking to improve the Content user's experience begin to allow movement and rearrangement of web page components or even removal of web page components. Tailorability and personalization of the internet interface may include but is not limited to advertisements to the right or the left, to change the screen highlight color, change the background, to place an image of their choice in a box or scroll location that is present during their log in session, to see advertisements for the first few minutes and then be removed for a set number of minutes, or other variations to change the use experience for each Content User. All of these features being saved for each individual user and returned with log in. As multiple users may be on a single internet interface or computer, the ability to log in for searching allows for a more personal and tailored experience.

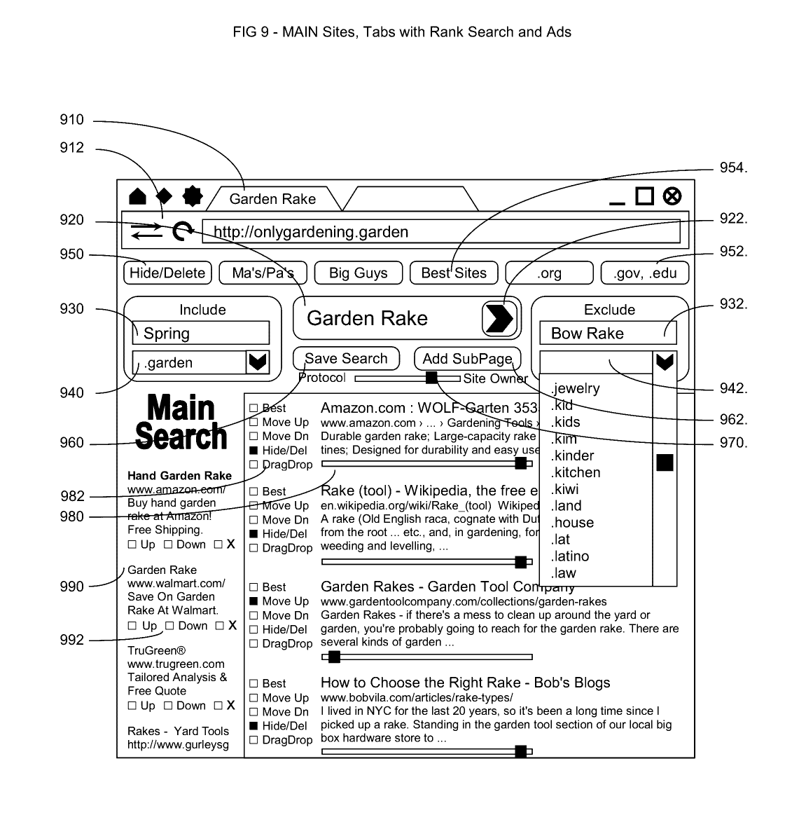

FIG. 9—Main Page, Interactive Search, and Separate Search Results

FIG. 9 is an example, and not limited to this example, of even greater interactive search and search result screen while maintaining a useful yet semi-simple layout and in this case the ability to reprioritize organic search results and advertisement as well as disposition organic search results and paid advertisements to transform the first page into a more relevant first page as search results and paid advertisements are view and manipulated. The active page tab 910 is associated with the simple search and is an indicator of somewhat independent content. General search engine functions and URL bar universally included in 912 as simply recognizing common elements among search engines. The simple search 920 criteria field is for keyword input. The search 922 button takes the keywords, terms, phrase or sentence and calls for a search. The additional content search criteria for included keywords 930 provides for additional guidance as to what to include, and additional content search criteria for excluded keywords 932 provides intuitive insight of what can be excluded with the addition of the word. I this case a bow rake was listed and desirous to be excluded from the search results. The additional content search criteria for included domain extensions 940 provides for additional guidance as to what to include. The inclusion of the domain will provide a means to separate the search into two search result pages so as not to lose the general search, but also have the benefit of a more focused search. The Additional content search criteria for excluded domain extensions 942 provides intuitive insight of what can be excluded with the addition of the domain extension. In this case no domain extension was listed for exclusion. Almost three searches in one, because the bow rake was not wanted in the search results, but there is a little interest in bow rakes generally. Additional search result page or subpage 950 shows a pre-set additional search criteria that separated out all .gov, .edu, and .org domain extensions from the general search. Ironically, these are significantly searched domain extensions and so the fact that they have been parsed into their own additional internet search results pages or subpages does not detract from their visibility. The Content User knows exactly where to go for these authoritative sites. Additionally Large Vendor subpage 952 and companion Mid Vendor subpage remove these groups of vendors from the garden rake search. If the Content User is wanting to look at a Menards for their garden rake then they would simply go to the Large Vendor subpage and happily find them listed well in the search. What has additionally happened is that six page ones of meaningful and substantial equivalence have been created. This provides more first page and first position Content Provider organic positioning and paid advertiser positioning. The Content User is pleased the search results are more naturally organized and results are more easily found. Organic and Paid Advertising Content Providers are more pleased because there is more opportunity for more favorable positioning on a page one and that all page ones are of substantial equivalence. A note is that the main page states Small Vendors so that by clicking on the Large Vendor button the Large Vendors will be shown on the main screen and the Small Vendors will take the small subpage button. Lastly on this subject it can be seen that the drawing depicts the Main Search page. By clicking on the Best Sites 954 the sites the Content User change as most relevant are collected and can be simultaneously viewed, saved, and researched. A dramatic improvement in the Content User internet experience. This example need not be limited to this specific method, such as more than one search results page may be open at a time, but this simple example show one way by which multiple pages can interact. The Save Search 960 button is available on each screen such that each search can be saved, much like Favorites found on most search engines. The Add SubPage 962 button is a means for Content User created additional internet search result pages for the Content User to create search landings or to post-search move search results to a high search value added page. The search protocol parameter 970 slider represents the type of relevance interface that allows Content Users to tweak the search while maintaining the same search parameters. In this case the search weighs parameters provided by the Content Provider above search protocols established by the Content Manger and their search engine. One or more of these search protocol parameter relevancy interfaces can be provided as with all features discussed. Another key feature of an improved internet search experience is the ability to indicate with a relevancy indicator 980 how the Content User feels the individual internet search result site relates to their immediate needs. Here the relevance interface is a slider. Moving the relevance interface will either immediately move the item to a position that now represents it Content User ranking or a subsequent search will be needed and the item will fall into its specifically indicated ranking in the new search result list. Important about any Content User input such as with the search parameter protocol relevancy interface or the organic search result relevance interface the search protocol or search engine learns more about what is currently relevant to the Content User and their next search will improve its general relevance. Another aspect of improving internet viability to the Content User is the ability to disposition 982 organic search results on an individual basis to tailor or improve the main search results or any subpage search results. Here the Content User will be able to indicate the search result individual item or site is a best site for inclusion into a best collection, move up if a more suitable and relevant result, move down if less relevant, or hide and delete to a Hide and Delete 950 button, as well as activate a drag and drop feature to move the individual search result item to any location in the same main internet search result page or additional subpage. Key to the disposition field 982 is the ability to alone, or just the relevancy indicator 980, or a combination of relevancy indicator 980 and disposition field 982 to indicate to the Content Managers search engine and search protocol that the Content User would like more or less of that type of individual search result items or sites based on the relevance indicator position or the position of the individual search result site on the page or subsequent pages. A field (not shown) could be provide to indicate to the search engine how many individual internet search result sites should be considered as those from which a search should emulate. The power of a little Content User input to improve upon the search results is remarkable. Also listed as is commonly seen are Content Provider paid advertisements 890. An additional significant element to the Content Users internet experience and viability is the ability to disposition paid Content Provider advertisements 992. In this case the Content Provider paid advertisement can be moved up in priority and relevance or down or deleted. These simple choices allow for the consolidation of the most relevant resources on the page of focus for the Content User. Important to realize is as a Content Provider paid advertisement is moved down another moves up. When a Content Provider paid advertisement is deleted then room is made on the page for another advertisement to enter. This is good news for the Content User as additional resources are made available. It is good news for the Content Provider as more Content Providers experience greater visibility as with the creation of more and substantially equivalent first pages with different category subpages. This Content Provider paid advertisement disposition is also good for the Content Manger as they have more advertisements hitting at more favorable positions. This leaders to a better Content Provider exposure experience and may allow the Content Manager to charge the higher premium for the more favorable advertising position. And yet again, there are more Content User interfaces, but the semi-simplicity remains. With a little familiarity, well within the boundaries of the complexity of smart phones, tablets, and other electronics brings about dramatic improvement of the internet. The ability to tailor search results also brings greater Content User satisfaction and internet relevance.

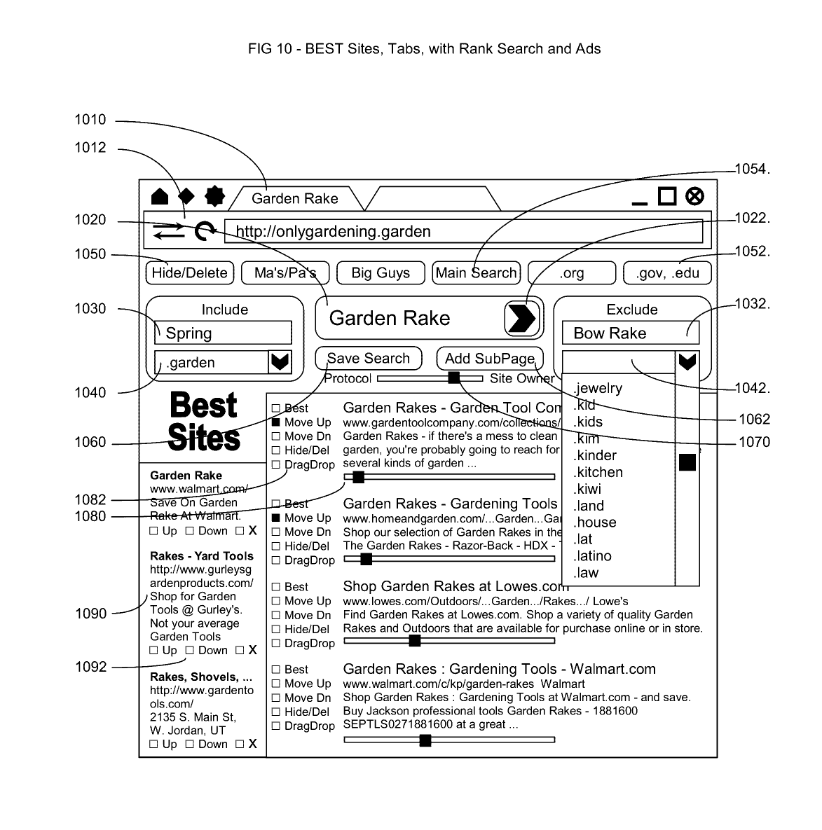

FIG. 10—Best Page, Interactive Search, Reprioritized Search Results with Relevance Indicator.

FIG. 10 is an example, and not limited to this example, of the Best Sites page or a second first page of the FIG. 7 Main Search first page, in this case showing how reprioritization and disposition of organic search items and paid advertisements has create a much more meaningful first page and a more meaningful internet use experience, while maintaining a semi-simple search and search results environment. The active page tab 1010 is associated with the simple search and is an indicator of somewhat independent content. General search engine functions and URL bar universally included in 1012 as simply recognizing common elements among search engines. The simple search 1020 criteria field is for keyword input. The search 1022 button takes the keywords, terms, phrase or sentence and calls for a search. The additional content search criteria for included keywords 1030 provides for additional guidance as to what to include, and additional content search criteria for excluded keywords 1032 provides intuitive insight of what can be excluded with the addition of the word. I this case a bow rake was listed and desirous to be excluded from the search results. The additional content search criteria for included domain extensions 1040 provides for additional guidance as to what to include. The inclusion of the domain will provide a means to separate the search into two search result pages so as not to lose the general search, but also have the benefit of a more focused search. The Additional content search criteria for excluded domain extensions 1042 provides intuitive insight of what can be excluded with the addition of the domain extension. In this case no domain extension was listed for exclusion. Almost three searches in one, because the bow rake was not wanted in the search results, but there is a little interest in bow rakes generally. Additional search result page or subpage 1050 show a pre-set additional search criteria that separated out all .gov, .edu, and .org domain extensions from the general search. Ironically, these are significantly searched domain extensions and so the fact that they have been parsed into their own additional internet search results pages or subpages does not detract from their visibility. The Content User knows exactly where to go for these authoritative sites. Additionally Large Vendor subpage 1052 and companion Mid Vendor subpage remove these groups of vendors from the garden rake search. If the Content User is wanting to look at a Menards for their garden rake then they would simply go to the Large Vendor subpage and happily find them listed well in the search. What has additionally happened is that six page ones of meaningful and substantial equivalence have been created. This provides more first page and first position Content Provider organic positioning and paid advertiser positioning. The Content User is pleased the search results are more naturally organized and results are more easily found. Organic and Paid Advertising Content Providers are more pleased because there is more opportunity for more favorable positioning on a page one and that all page ones are of substantial equivalence. A note is that the main page states Small Vendors so that by clicking on the Large Vendor button the Large Vendors will be shown on the main screen and the Small Vendors will take the small subpage button. Lastly on this subject it can be seen that the drawing depicts the Main Search page. By clicking on the Best Sites 1054 the sites the Content User change as most relevant are collected and can be simultaneously viewed, saved, and researched. A dramatic improvement in the Content User internet experience. Not specifically shown, but included in the scope of this disclosure is the ability provided by the Content Manager to the Content User to create or form new tabs or links to a new page string of any designation, not just Best Sites. As such, these additional page strings also become meaningful and equivalent to the main page string, or other grouped or separated page strings as it contains expressly what the Content User defines as most relevant. Creating page strings, saving page strings to preserve the specific content, saving search criteria best associated with the content of a page string that will bring forward all or similar results in a subsequent search, other such actions, and any of their combinations is encompassed by this disclosure. A type of directory and file (page string) system is also a format example, but not limited to this and other explicitly stated examples. This example need not be limited to this specific method, such as more than one search results page may be open at a time, but this simple example show one way by which multiple pages can interact. The Save Search 1060 button is available on each screen such that each search can be saved, much like Favorites found on most search engines. The Add SubPage 1062 button is a means for Content User created additional internet search result pages for the Content User to create search landings or to post-search move search results to a high search value added page. The search protocol parameter 1070 slider represents the type of relevance interface that allows Content Users to tweak the search while maintaining the same search parameters. In this case the search weighs parameters provided by the Content Provider above search protocols established by the Content Manger and their search engine. One or more of these search protocol parameter relevancy interfaces can be provided as with all features discussed. Another key feature of an improved internet search experience is the ability to indicate with a relevancy indicator 1080 how the Content User feels the individual internet search result site relates to their immediate needs. Here the relevance interface is a slider. Currently the fact that a Content User clicks on and opened an item on the internet does not provide insight into their interest and the items relevance. The Content User may simply just click on every item to see what they are. What is needed is the Content Users specific feedback on that item, an ad, a piece of content, etc. What Content Managers need to do is simply ask for more guidance. Moving the relevance interface will either immediately move the item to a position that now represents it Content User ranking or a subsequent search will be needed and the item will fall into its specifically indicated ranking in the new search result list. Important about any Content User input such as with the search parameter protocol relevancy interface or the organic search result relevance interface the search protocol or search engine learns more about what is currently relevant to the Content User and their next search will improve its general relevance. Another aspect of improving internet viability to the Content User is the ability to disposition 1082 organic search results on an individual basis to tailor or improve the main search results or any subpage search results. Here the Content User will be able to indicate the search result individual item or site is more a main internet search result page site (as it is currently on the best sites page), move the site up as it is more relevant or favored, move the site down as it is less relevant, or hide and delete to a Hide and Delete 1082 button, as well as activate a drag and drop feature to move the individual search result item to any subpage or position on the main search page list. Key to the disposition field 1082 is the ability to alone, or just the relevancy indicator 1080, or a combination of relevancy indicator 1080 and disposition field 1082 to indicate to the Content Managers search engine and search protocol that the Content User would like more or less of that type of individual search result items or sites based on the relevance indicator position or the position of the individual search result site on the page or subsequent pages. A field (not shown) could be provide to indicate to the search engine how many individual internet search result sites should be considered as those from which a search should emulate. The power of a little Content User input to improve upon the search results is remarkable. Also listed as is commonly seen are Content Provider paid advertisements 1090. An additional significant element to the Content Users internet experience and viability is the ability to disposition paid Content Provider advertisements 1092. In this case the Content Provider paid advertisement can be moved up in priority and relevance or down or deleted. These simple choices allow for the consolidation of the most relevant resources on the page of focus for the Content User. Important to realize is as a Content Provider paid advertisement is moved down another moves up. When a Content Provider paid advertisement is deleted then room is made on the page for another advertisement to enter. This is good news for the Content User as additional resources are made available. It is good news for the Content Provider as more Content Providers experience greater visibility as with the creation of more and substantially equivalent first pages with different category subpages. This Content Provider paid advertisement disposition is also good for the Content Manger as they have more advertisements hitting at more favorable positions. This leaders to a better Content Provider exposure experience and may allow the Content Manager to charge the higher premium for the more favorable advertising position. And yet again, there are more Content User interfaces, but the semi-simplicity remains. With a little familiarity, well within the boundaries of the complexity of smart phones, tablets, and other electronics brings about dramatic improvement of the internet. The ability to tailor search results also brings greater Content User satisfaction and internet relevance.

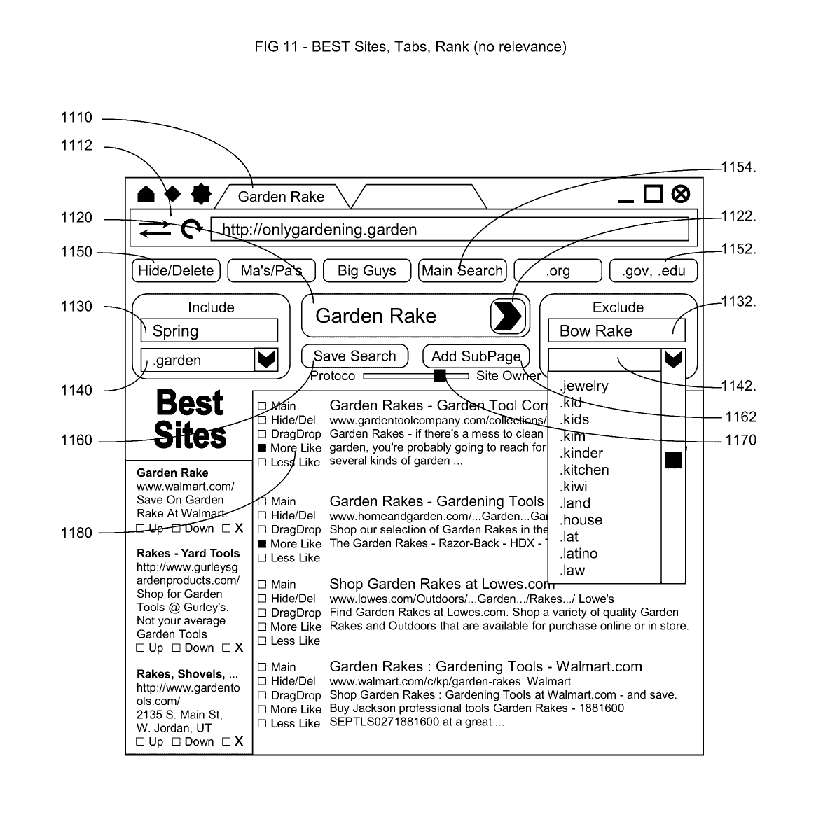

FIG. 11—Best Page, Interactive Search, Reprioritized Search and Results without Relevance Indicator

FIG. 11 is an example, and not limited to this example, of the Best Sites page or a second first page of the FIG. 7 Main Search first page. In this case showing how reprioritization and disposition of organic search items and paid advertisements has create a much more meaningful first page and a more meaningful internet use experience, while maintaining a semi-simple search and search results environment. The active page tab 1110 is associated with the simple search and is an indicator of somewhat independent content. General search engine functions and URL bar universally included in 1112 as simply recognizing common elements among search engines. The simple search 1120 criteria field is for keyword input. The search 1122 button takes the keywords, terms, phrase or sentence and calls for a search. The additional content search criteria for included keywords 1130 provides for additional guidance as to what to include, and additional content search criteria for excluded keywords 1132 provides intuitive insight of what can be excluded with the addition of the word. I this case a bow rake was listed and desirous to be excluded from the search results. The additional content search criteria for included domain extensions 1140 provides for additional guidance as to what to include. The inclusion of the domain will provide a means to separate the search into two search result pages so as not to lose the general search, but also have the benefit of a more focused search. The Additional content search criteria for excluded domain extensions 1142 provides intuitive insight of what can be excluded with the addition of the domain extension. In this case no domain extension was listed for exclusion. Almost three searches in one, because the bow rake was not wanted in the search results, but there is a little interest in bow rakes generally. Additional search result page or subpage 1150 show a pre-set additional search criteria that separated out all .gov, .edu, and .org domain extensions from the general search. Ironically, these are significantly searched domain extensions and so the fact that they have been parsed into their own additional internet search results pages or subpages does not detract from their visibility. The Content User knows exactly where to go for these authoritative sites. Additionally Large Vendor subpage 1152 and companion Mid Vendor subpage remove these groups of vendors from the garden rake search. If the Content User wants to look at Menards for their garden rake then they would simply go to the Large Vendor subpage and happily find them listed well in the search results. What has additionally happened is that six page ones of meaningful and substantial equivalence have been created. This provides more first page and first position Content Provider organic positioning and paid advertiser positioning. The Content User is pleased the search results are more naturally organized and results are more easily found. Organic and Paid Advertising Content Providers are more pleased because there is more opportunity for more favorable positioning on a page one and that all page ones are of substantial equivalence. A note is that the main page states Small Vendors so that by clicking on the Large Vendor button the Large Vendors will be shown on the main screen and the Small Vendors will take the small subpage button. Lastly on this subject it can be seen that the drawing depicts the Main Search page. By clicking on the Best Sites 1154 the sites the Content User changed as most relevant are collected and can be simultaneously viewed, saved, and researched. A dramatic improvement in the Content User internet experience. This example need not be limited to this specific method, such as more than one search results page may be open at a time, but this simple example shows one way by which multiple pages can interact. The Save Search 1160 button is available on each screen such that each search can be saved, much like Favorites found on most search engines. This save search may include saving the search criteria, saving a newly defined search criteria based upon the first one, two, or a few pages, saving save the first one, two, or any number of search result pages, or any of their individual or combinations. The Add SubPage 1162 button is a means for Content User created additional internet search result pages for the Content User to create search landings or to post-search move search results to a high search value added page. This high relevance search result item page can again be saved, the collective search criteria defined the collected items can be saved, and their combination. The search protocol parameter 1170 slider represents the type of relevance interface that allows Content Users to tweak the search while maintaining the same search parameters. In this case the search weighs parameters provided by the Content Provider above search protocols established by the Content Manger and their search engine. One or more of these search protocol parameter relevancy interfaces can be provided as with all features discussed. Another aspect of improving internet viability to the Content User is the ability to disposition organic search results on an individual basis to tailor or improve the main search results or any subpage search results. Here the Content User will be able to indicate the search result individual item or site is a main internet search result page site (it is currently on the best internet search result site page), or hide and delete to a Hide and Delete 1180 button, as well as activate a drag and drop feature to move the individual search result item to any subpage or position on the main search page list. Key to the disposition field 1180 is the ability to indicate to the Content Managers search engine and search protocol that the Content User would like more or less of that type of individual search result item or site. The power of a little Content User input to improve upon the search results is remarkable.

Further to move the internet from a present and past experience to a present and future experience. To reach into the future, means that the Content User begins to provide insight into what is of interest to them not just at the moment of a search, but during the viewing process when the Content Manager is offering ads and other content. The present is confined to the immediate keywords and search criteria that are indicated by the Content User and the time within the immediate vicinity of that search. The future is indicated by more subtle internet interaction. Offering Content User Interfaces with ads is a way to sense the current tastes, interests, and needs of the Content User. To offer ads with relevance indicators, disposition indicators, and other interactive interfaces invites the Content User to interact at one additional level with their internet experience. For instance, it has previously been disclosed that as paid ads show up with an internet search that a disposition or relevance interface would move the ad up, down, hide, delete, or provide some other indicator of interest or relevance. As an ad is moved higher than other ads are moved lower. As an ad is hidden or deleted then another ad is moved into the place where the initial ad once resided. Ultimately, the first page, second page, etc. contains the most relevant information and is now a more valued source of information for the Content User. This is not just scrolling through ads like various banner ads, but meaningful sorting for relevance and other disposition. In this case there is a focus on dispositioning remarking ads, display ads, pop up ads, banner ads, and other Content Manager determined advertising. These ads can be placed in a rotation that cycles through a select number of ads, but more interesting is noticeably or subtlety offering to Content Users the opportunity to interact with the ad and tell the Content Manager if the ad is relevant, of interest, would like more of the same, not of interest, and more. The result of this interaction is interaction. The Content Manager gets new insight into the interests of the Content User from a different source. Not from just a search, but from an impression perspective. Further the ad is seen. The ad invites interaction. If the ad is preserved that reinforces the ads relevance. If the ad is put into a later, wait, or some other temporary status then the ad gains relevance. If the ad is indicated to be of value, liked, more thinking of, etc. then the ad gains great relevance. If the ad is dismissed, hidden, deleted or some other more terminal disposition, then the Content Provider is able to focus their dollars on a more suitable audience. The Content Manager may choose to increase add frequency where there is interest, may choose to increase ad value and price where there is greater interest, or decrease frequency and pricing where less interest is indicated. As ads are eliminated it is an opportunity for the Content Manager to introduce more ads and more relevant ads from more Content Providers and increase ad revenues, and increase Content Provider satisfaction and reinvestment. Again, for the Content User the internet experience becomes more valued or at least more tolerable, instead of being irrelevant and an increasingly display of protocol and algorithm stupidity. Fundamentally, the problem with the internet is that it fails to interact with the Content User. It fails to ask if it is providing relevant information. Just one, two, three, or so on small question, test, assessments asked of the Content User during the internet experience would vast increase the ability of the protocols and algorithms of the Content Manager to more accurate delivery content of interest and need to the Content User. Just mentioned is the use of a type of physiological testing or assessment on the internet with the user. One of the banner ads, display ads, remarketing ads pop up ads, or there space or other website location could be devoted to directly asking the Content User at that moment about the quality of the search or other criteria to them resupply content automatically by Content User request. The testing for relevance could be direct or indirect, but a little Content User input would improve the value of the internet experience for Content Users, Content Providers, and for the competitiveness of the Content Managers.

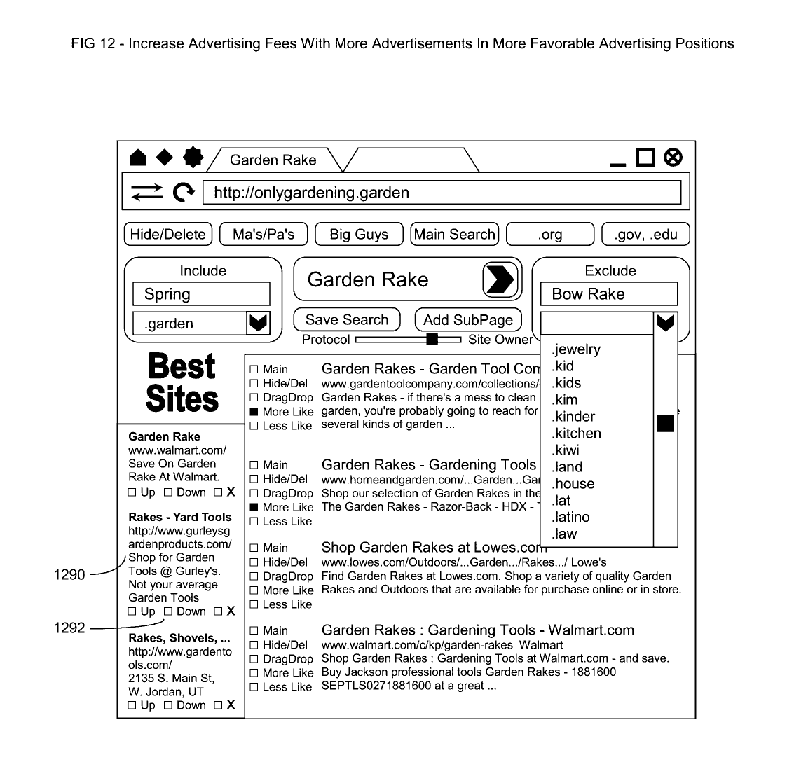

FIG. 12—Increase Advertising Fees with More Advertisements in More Favorable Advertising Positions

FIG. 12 is an example, and not limited to this example, of the increase in advertising fees with more advertisements in more favorable advertising positions. FIG. 12 is a duplicate of FIG. 11 with the focus on two additional elements 1290, and 1292. To reduce duplication and add simplicity, the reference back to FIG. 11 is recommended for description of other elements of this figure. Disclosed and listed are a version of Content Provider paid advertisements 1290 as may be commonly known. An additional significant element to the Content User's internet experience and viability is the ability to disposition paid Content Provider advertisements 1292. In this case the Content Provider paid advertisement can be moved up or down in priority and relevance or deleted. These simple choices allow for the consolidation of the most relevant resources on the page of focus for the Content User. Important to realize is as a Content Provider paid advertisement is moved down another moves up. When a Content Provider paid advertisement is deleted or hidden then room is made on the page for another advertisement to enter. This is good news for the Content User as additional resources are made available. It is good news for the Content Provider as more Content Providers experience greater visibility as with the creation of more and substantially equivalent first pages with different category subpages. This Content Provider paid advertisement disposition is also good for the Content Manger as they have more advertisements hitting at more favorable positions. This leads to a better Content Provider exposure experience and may allow the Content Manager to charge the higher premium for the more favorable advertising position. The representations in this example of the simple checkbox for up, down, or delete is simply an example, not intended to be a limitation. The type of indictor may vary as long as it achieves the function of indicating preference, relevance, positioning, removal, hiding, deleting, or other manipulation, and any of their combinations. What is disclosed is the disposition of an advertisement to collect or group the most relevant paid advertisements for a Content User and remove less relevant content. This action differs from potential actions of just eliminating a paid advertisement for another paid advertisement to take its place, but to begin adding relevance, interest, preference, collection, and even saving those advertisements as part of the saving function of the interface. The many features disclosed can respond immediately to the Content User, respond with a subsequent action such as a new search or refresh, may occur manually by moving one or more selected items directly, or other like mechanisms, and any of their combinations. And yet again, there are more Content User interfaces, but the semi-simplicity remains. With a little familiarity, well within the boundaries of the complexity of smart phones, tablets, and other electronics brings about dramatic improvement of the internet. The ability to tailor search results also brings greater Content User satisfaction and internet relevance.

Another class of information absent in providing improved search and separation is the use of Content Provider information. Discussed has been the use of domain extensions and additional keywords, and other additional criteria for use to separate results within or from the main internet search results. However, domain extensions and keywords do not carry with them information unassociated with an internet presence. It is true that it can be deduced from internet sales that Wal-Mart, Home Depot, Amazon, Ebay, etc. are large enterprises. It is true that Content Managers can gather information on traffic to a site, clicks on a site, and other such Content User behavior. However, not all information about a Content Provider is known by the domain name, current domain name registration information, and internet related behavior, except for a few more public organizations. What is needed is for individuals (suggest optionally) and businesses, organizations, educational institutions, and such to provide more geographical, biographical, and performance information. By way of example and not intending to be limited by the examples, beyond searching and sorting by domain extension, additional internet search result pages could separate companies by revenues such as over $500 million dollars, and between $25-$500 million dollars and $0-$25 million. If a company wishes to identify themselves as minority owned, then a search could include retrieving and separating search results by this or other criteria. Geographical data is often already provided by the address and area code that is associated with the domain name or email address as specific identifiers. However, expanded information such as being local, state, region, national, or global could be added. Other geographical criteria could be requested. Biographical data could include year of establishment, number of employees, leadership structure, role of minorities, charitable activities, diversity, greenness, and other character traits. Performance is most readily ascribed to revenue or a range of revenue, but could be that sold in total, in stores, online, overseas, and other distinctions. These self ascribed and verifiable claims provide another means of ranking and positioning on the internet. For instance it is recognized that searching a subject and then returning a page of businesses that are minority owned or operated, ascribed to a level of environmental behavior, etc. would be valuable to many Content Users. What is disclosed and claimed is the use of geographic, biographic, performance, or their combinations for search efficiency and separation of internet search results.

By way of example, but not limited to these specific examples, biographical information and data also includes descriptive words or phrases about the person or entity. Again, for instance even though an entity may use the domain extension .gov, .org, .edu, .club, .auto, .restaurant, etc. it does not tell much about the entity. Other data may be included and associated with the biographical data. Content Managers or other governing bodies may find it helpful to request ten descriptive words may be sufficient to more fully describe the person or entity associated with a domain name and its domain extension, such as for a restaurant: north side, dinner only, no take out, sit down, no buffet, minority owned, female managed, etc. as highlights the proprietor wants emphasized in a search. The Content Manager may assess that having the domain name and domain extension Content Provider, owner, or registrant to prioritize from one to ten, with one being the most important factor for characterizing the properties and information associated with the domain name and domain extension. As another example, an educational entity may further describe themselves beyond their size and revenue, etc. in up to ten descriptive words as: private, math oriented, west side, individual tutoring, year round, etc. Governing bodies may determine a person or organization may describe themselves in as many descriptors as they wish as single words, phrases, paragraphs, or any of their combinations, or limit such additional descriptions to any limited numbers. The benefit of such additional information is the more specific parsing of search results into more meaningful organizations.

These additional biographical descriptors or any form of differentiation among individual or organizational entities on the internet the Content Manager may offer on the Semi-Simple Search Interface options to the Content User asking how the search results should be presented, such as: smallest to largest, by proximity, by product description, public or private, minority owned, or other biographic, demographic, and performance data, and any of their combinations. These sortings and organization within a page string or across separate or grouped page strings may be defined by the Content User, Content Manager, based upon the frequency of the information returned, and any of their combinations. On the Semi-Simple Search Interface there simply may be checkboxes, radio buttons, input fields, drop down lists, and any other form of designation input as to how the Content User wishes the information to be sorted within a page string, across page strings, in groups or separately, other designations, or any of their full or partial present or absent combinations. With regard to the frequency of a items in a search results, when looking for a restaurant, internet search results may automatically sort restaurants by formality of the environment, and then because there are so many pizza restaurants, the Content Managers algorithms and protocols may automatically or self-choose to sort out all pizza restaurants on a different page string or all starting at some point on one page string as a section for pizza, even with a possible page string heading. Such self sorting is a form of Content Manager Pre-Set domain or keyword sorting, parsing, or search results presentation.

As further examples of the organization and presentation disclosed herein in this specific disclosure and generally within this disclosure document, whether from additional biographical information, performance information, demographic data, domain extensions, frequency of Content User use, favorites or preferred of the Content User, or other Content User or Pre-Set and auto generated Content Manager criteria, other designators, and any of their full or partial present or absent combination the sorting of internet search results may be parsed within a page string, across grouped page strings, separate page strings, catch-all page strings, or any other of their combinations. Within a page string the internet search results may be grouped through the pages. To assist in locating these associated parsed internet search results items there may be a type of table of contents within the page string, external to the page string, immovable within the page string where other items scroll below it, any other form of location, or any of their combinations. This table of contents may additionally have the possible feature of taking a Content User directly to that associated group of results. A further example of presenting and parsing search results is the presence of sorting section or associated internet search results by title. For clarity, take the restaurant example, within a page string the internet search results may be organized with heading such as Classic American, Italian, Mexican, Tia, Pizza, etc. Disclosed is bringing utility and order to the vastness of internet content by more Content User interactive and oriented internet search interface and internet search results presentation to create a more effective internet user experience.

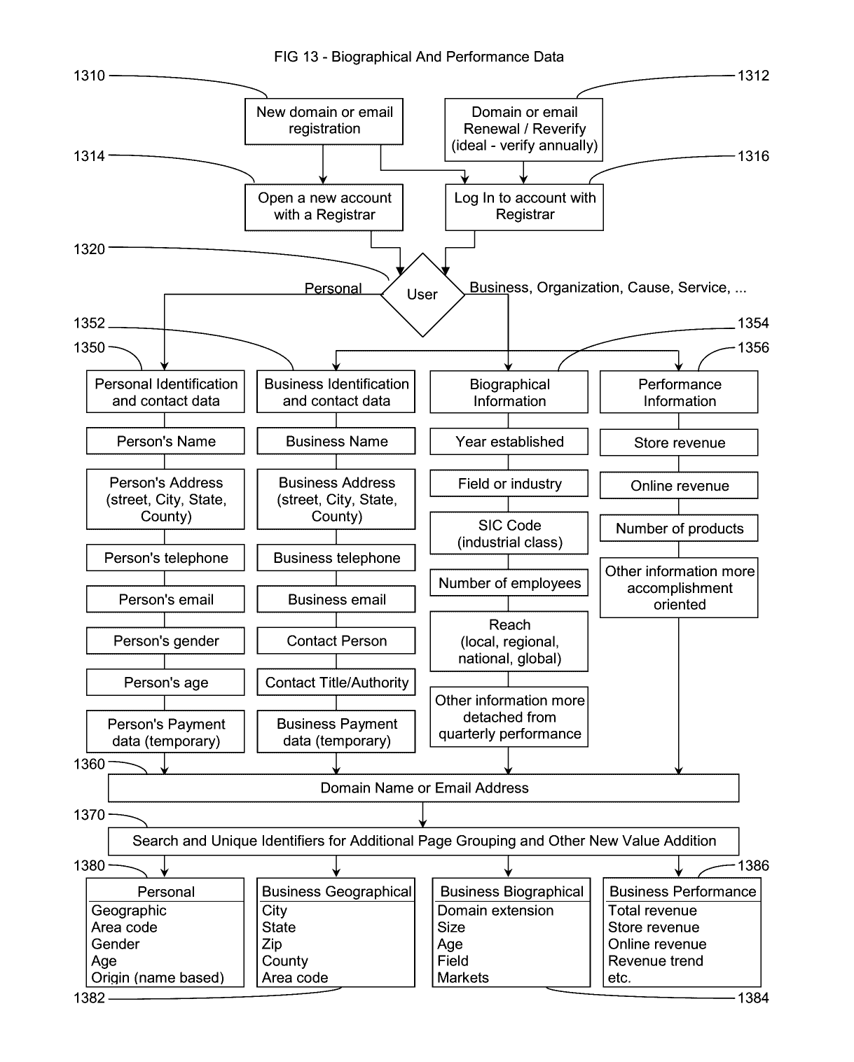

FIG. 13—Gathering, Search Use and Search Results Use of Biographic and Performance Data

FIG. 13 is an example, and not limited to this example, of identifying information or identifiers or a person, business, or organization. Disclosed is the gathering biographical, demographic, geographic, and performance data represented by a flow chart for use in internet search criteria, search specificity, search information retrieval, and search results presentation and parsing. A flow chart showing how at the time of domain or email registration 1310, renewal 1312, or verification 1312 that additional information can be gathered to assist in search results selection, but also disposition of search results by similarity among search results items. At the time of new domain or email registration 1310 this can occur by opening a new account with any participating registrar 1312 or the Content User may return to an existing registrar 1316 where they have an account. For a domain name or email address renewal or verification 1314 it is presumed that there is an existing relationship with a registrar 1316 that is currently serving or supporting the domain name or email account. Once the Content User has access to a registration, renewal, or verification portal the Content User make a user identify 1320 declaration that the domain name, email address, other communication media, or document and information sharing provider is for personal or business use. The various forms of communication mentioned will be referred to as domain names and email addresses, but understood to be inclusive of any form of communication applicable to the gathering and use of additional information to improve search, retrieval, and results display and distribution. When referring to a person, this means a non-commercial use of the domain name and email address. When referring to a business, this means a business, an organization, a government entity, educational institution, articles, books, images, or other non-person activity that is for commercial or non-commercial use purposes. In this embodiment only personal and business categories have been identified, but other categories may be used to be more representative of the content being shared, such as personal, business, government, new, articles, images, entertainment, and a variety of others, and any of their combinations. The biographic, demographic, and performance data needed from an individual and a business can be different in what is required and what is elective. It is foreseeable that different levels of internet service preference may be provided or granted based upon the amount of information elected to be offered. For businesses, the more information made available, the more preferential may be the search and results ranking or visibility, lower cost registration or support services, higher priority service, faster service, a special classification such as a verified site, lower ad costs or other fees, and other incentives, and any of their combinations. Content Managers, registrant, or other domain name and email address service provider will likely and eventually know by the volume and nature of domain name and email address traffic if the domain name and email address are being used representative of their registration. For instance a personal registration with personal identification 1350 type information that is showing use as a business would cause the registration to be given notice of correction and then if the information or registration is not brought into accurate reflection of the use of the domain name if the information then there may be some degradation of service or other incentive to bring the registration in line with business registration requirements. There are any number of reasons that a person may use a domain name and email address for business, organization, or other non-personal function. These non-personal function domain names and email addresses would begin to require more business like registration. Note that the information sought may be, but is not expected to be made public, and if made public there would be an expectation for most personal and some specific business information to be allowed to be held in private, or expressed by ranges, shown by proximity, or other generalities, and any of their combinations. For a personal declaration 1320 the information sought or required would include the information of the personal identification heading and column 1350 and include as example, but not limited to: contact data, name, address, telephone numbers, email addresses, gender, age, payment data even if temporary or other information such as race, heritage, education, skills, hobbies, or other individual characteristics, and any of their combinations. Businesses would also have information that can be sought or required to include business identification information 1352, business biographical information 1354, and business performance information 1356. Information related to Business identification 1352 may include as example, but not limited to: contact data, business name, address, telephone, email address, contact person, contact person title and authority, business payment data even if temporary, and a variety of other information, and their combinations. Business biographical information 1354 may include as example, but not limited to: the year the business was established, the field or industry of the business, SIC code or description, number of employees, reach or market areas, any other of a variety of non-performance information, and any of their combinations. Business performance information 1356 may include as example, but not limited to: business revenues from a store or location, online or other non-location based revenues, number of products, product type and description, and any number of various other performance identifiers, and any of their combinations. Whether a personal or business registration, renewal, or verification completed with the sought and required information provide then the domain name and email address is granted 1360. Indicated is the association of this information now to the domain name and email address. The domain name is a common term that represents the domain name, a URL, or any other internet or intranet address for a website, blog, article, data, or any internet content to which biographic, demographic, performance, other data, and any combination can then be used to add additional search recognition criteria, retrieval criteria, and results sort and organization criteria. The newly gained or updated biographic, demographic, geographic, and performance data can now be used to increase search specificity and search results organization 1370. That search specificity and search results will be guided by personal information 1380, business geographic information 1382, business biographic and demographic information 1384 and business performance information 1386. Undoubtedly as the form of communication changes, the specific example of using a domain name or email address my extend to other forms of communication be they texting, instant messaging, video, webinars, conference calling, phone numbers, or other communication based media. The ever increasing vastness of content, infrastructure, use, and other dimensions of the internet require better approaches to gain greater specificity, accuracy, and relevance of information searched, retrieved, and manner of results presentation. Needed are more type of known information about each internet piece of content to be able to more specifically assess its merits for retrieval and how it will be parsed and presented as a search result. A feature of this disclosure is that this more specific and more identifying information will be gathered at new domain name registration, but will eventually be updated during renewal registrations that are expected to occur every one or two years. Where an organization may pay multiple years in advance, a verification request and requirement may be necessary to update domain name and email address new identifying information requirements much earlier than their renewal schedule my require. As such, in the course of two or three years, the entirety of the internet may be updated with the new standards of enhanced specificity in personal and business biographic, demographic, geographic, and performance data to vastly improve search specificity and retrieval performance as well as results parsing and presentation on a main page or by more specific groupings or separate page string offerings.

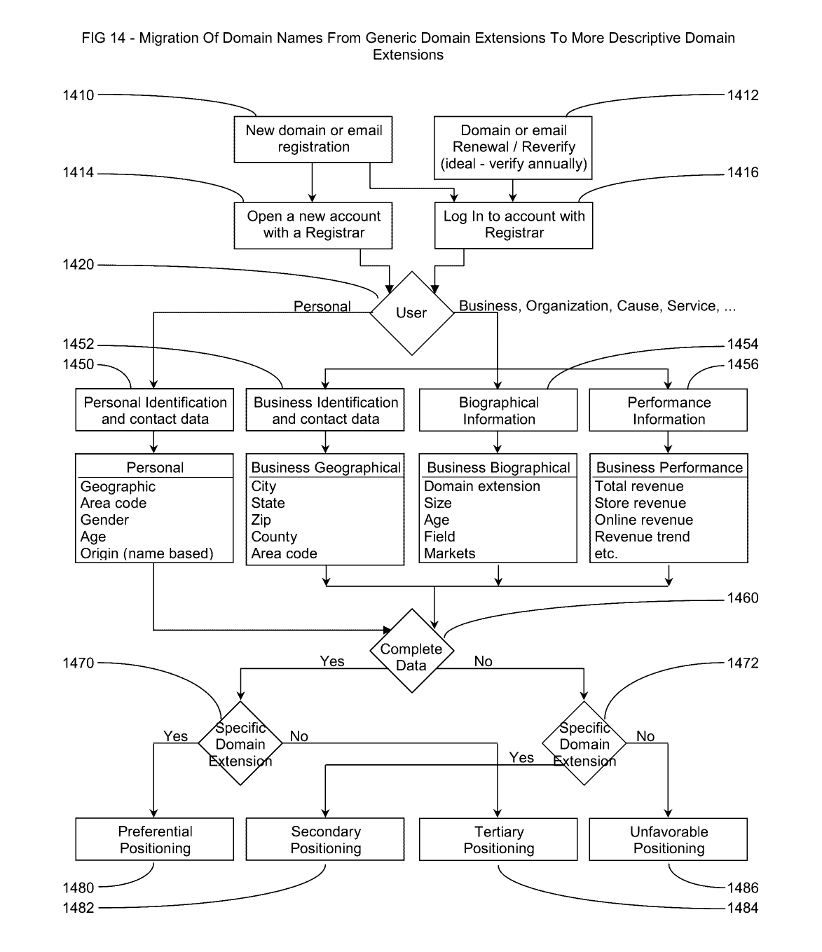

FIG. 14—Migration of Domain Names from Generic Domain Extensions to More Descriptive Domain Extensions.

FIG. 14 is an example, and not limited to this example, of migrating current domain names from generic domain extensions to more descriptive domain extensions. Here a generic domain extension is .com, .org, .co, .net, .info, and others. It is recognized that an organization may be best identified with a .org domain extension, and if that is the case then that identifier will remain appropriate, unless there is another more suitable domain extension currently available or that becomes available in the future. This is applicable to other generic domain extensions. Further, any domain extension may become generic if it becomes used for non-relevant persons and entities, if the population of the domain extension becomes disproportionately large and more specific search and results display would benefit from its current use being parsed among other domain extensions, or for other reasons of efficiency, organization, clarity, improved commerce, improved non-commercial use, and any of their combinations. At any time Content Managers and other internet operators may collectively decide to migrate domain extension holders to other domain extensions for the purposes of internet management. In any case where domain extensions or other equivalent identifier management influence needs to be exerted onto the internet this disclosure remains applicable and useful. Domain extension migration begins at the time of domain or email registration 1410, renewal 1412, or verification 1412. At this time additional information can be gathered to assist in search results selection, but also disposition of search results by similarity among search results items as previously disclosed. Disclosed here is the use of domain and email address registration, renewal, or verification as events to migrate the domain name and email address to a more descriptive domain extension. The terms domain extension and email address are representative of any communication media that uses a distinctive descriptor that can be used to organize that communication. At the time of new domain or email registration 1410 this can occur by opening a new account with any participating registrar 1412 or the Content User may return to an existing registrar 1416 where they have an account. For a domain name or email address renewal or verification 1414 it is presumed that there is an existing relationship with a registrar 1416 that is currently serving or supporting the domain name or email account. Once the Content User has access to a registration, renewal, or verification portal the Content User make a user identify 1420 declaration that the domain name, email address, other communication media, or document and information sharing provider is for personal or business use. The various forms of communication mentioned will be referred to as domain names and email addresses, but understood to be inclusive of any form of communication applicable to the gathering and use of additional information to improve search, retrieval, and results display and distribution. When referring to a person, this means a non-commercial use of the domain name and email address. When referring to a business, this means a business, an organization, a government entity, educational institution, articles, books, images, or other non-person activity that is for commercial or non-commercial use purposes. In this embodiment only personal and business categories have been identified, but other categories may be used to be more representative of the content being shared, such as personal, business, government, new, articles, images, entertainment, and a variety of others, and any of their combinations. The biographic, demographic, and performance data needed from an individual and a business can be different in what is required and what is elective. Once a personal or business declaration has been made then the sought elective and required information is gathered. The newly gained or updated biographic, demographic, geographic, and performance data can now be used to increase search specificity and search results organization. That search specificity and search results will be guided by personal information 1450, business geographic information 1452, business biographic and demographic information 1454 and business performance information 1456. The gathering and updating of information associated with domain names and email addresses has been more completely disclosed in FIG. 13, with its disclosure remaining relevant in this FIG. 14 disclosure where applicable. With complete registration, renewal, or verification of information associated with a domain name and email address then there is the association of the domain extension. Previously in FIG. 13 disclosure the specific domain extension associated with a particular domain extension was not relevant. The FIG. 13 disclosure may use the domain extension, but other biographic, demographic, geographic, and performance data would be more specific to search, retrieval, and results presentation. FIG. 14 discloses the particular use of an appropriately associated domain extension for search, search retrieval, and search results presentation. Because of the particular focus on the domain extension, it is imperative that the domain extension be representative of the major collective features expressed in the biographic, demographic, and performance data. For instance if a business is a legal firm then .com is not the most appropriate domain extension, but .lawyer would be preferred, ideal, and even required. FIG. 14 discloses non-compulsory to near compulsory methods to suggest, persuade, and even near force individuals and businesses to re-associate them self or their businesses with a more appropriate domain extension. This is done during the registration, renewal, or verification process by letting domain name and email address holders by direct or indirect methods that their ranking or services on the internet or within that particular media's channel will have more or less preferential treatment based on the degree of compliance to the ideal standard. With awareness that increased disclosure of biographic, demographic, geographic, and performance data 1460 there will be a preferential Content Manager and other internet service provider treatment the individual or business can choose the degree to which they provide sought and required information. Similarly, then follows the awareness that use of a more descriptive domain extension will add to more preferential positioning on the internet or within the specific media of a communication. If an individual chooses and can answer “yes” to full disclosure 1460 and can answer “yes” to use of a specific domain extension 1470 then they achieve preferential positioning 1480 on the internet or in their communication media. A Specific Domain Extension means the use of a TLD/gTLD that is more specifically associated with the domain name, URL address, email, or other electronic address or designator. It may mean using .com, .auto, .MBA, .pharmacy, .edu, .org, or any other TLD/gTLD or other specific domain extension which best represent the nature of the individual or organization. Using a domain extension that is more representative of the individual or organization is one way to organize the content of the internet and can be seen as more advantageous, but not imperative, than simply associating all individuals and organization to the same catch-all domain extensions, such as .com, .org, .net, or others. Similarly if they answer “yes” to the having chosen a complete data disclosure 1460 but “no” to the use of a more specific domain extension 1470 then they will receive tertiary positioning service and priority 1484 on the internet or their other communication media in search, search retrieval, and search result disposition or equivalent for other media. The individual or business may not know the exact deprioritization they will experience, but it is likely to be evident that they are not receiving preferential positioning or other service support. Continuing on, if an individual or business chooses “no” to provide a full biographic, demographic, geographic, and performance data disclosure 1460 and then can answer “yes” to the use of a more specific and descriptive domain extension 1472, then they will receive a secondary-like internet positioning 1482 or like sub-preferential positioning in another media's communication channel. Lastly, if an individual or business choose “no” to provide full identifying disclosure 1460 and also chooses “no” to using a more descriptive and specific domain extension 1472 then they will know their ranking for search identification, search retrieval, and search result positioning and disposition will receive the least and most unfavorable positioning 1486 of all. A domain extension may relate to more than one domain name, such as .restaurant and .club may be similar. As disclosed elsewhere internet search results may be grouped on a common page string by domain extensions or a separation of those results on separate page strings by domain extension or other criteria. Grouped page strings means an intermingling of internet search results with the page strings domain extensions or such domain extensions may be sorted within the page string by domain extension or other criteria and be identified by a table of contents, section title, simply a change in the domain extension or other criteria, other designation, or their combinations. As domain extensions may be related, such related domain extensions would have a natural second priority of association with a primary domain extension or criteria sought. This is important now, but becomes increasingly important as domain extension proliferate and become more granular and somewhat similar but different. Further as some domain extensions become popular and other do not find favor with the public, but the Content Provider likes their domain extension, then rational associations still become meaningful without taking away from the concept of using domain name sorting and parsing to bring clarification and utility. For instance .club may have surfaced as the most used and popular, but .nightclub is also available. The regular association of these domain extensions does not violate or diminish the idea of a page string identified for .club. Further a Content Provider may indicate where association is primarily, secondarily, tertiarily, and so on desired. By way of example, a Content Provider may wish the preferential benefits of being sorted as a .club, but does not want to be left out of .restaurant Content User interest. The Content Provider may then indicate .restaurant as a secondary affiliation to their domain name using .club. Such secondary or other priority association may be accomplished by Content Managers or domain extension authorities offering such primary, secondary, and other association as part of the biographic or other data collection and association with the domain extension, by payment of an association fee so a Content Provide does not feel limited to just one domain extension or category as domain extension proliferate, by generally accepted protocol that for instance .restaurant and .club among other domains already are given some association, that when .restaurant is selected that Content Manager Pre-Set domain extensions would then populate the other most relevant domain extensions, such as by way of example and not limited to this example .restaurant page string would then also produce .club page string, .pizza page string, .takeout page string, .fastfood page string, etc. and any of their combinations in grouped page strings. As a second example, but not limited to this example, domain extensions may evolve to include type of food and sorting results by .mexicanfood, there could be .americanfood, .italianfood, .mediterrainianfood, .etc, and any of their combinations in grouped page strings. Disclosed are systems of rational association of domain extensions where prudent without violation of the idea of domain extension parsing to bring utility and clarity. In summary such association may be by close kinship among domain extensions (.club and .nightclub), by a method of fee payment to buy association if desired by a Content Provider (a search for, by natural association (if search for italianfood, then page strings for .mexicanfood, .greekfood, etc.) may also occur by Content User defined or Content Manager Pre-Set domain extension grouped or separate page strings. The use of preferential, secondary, tertiary, and unfavorable positioning and any criteria is only arbitrary is simply an example the degree or whether there is preferential or not preferential treatment of a TLD or gTLD domain extension or because of the presences of biographic and other such information is a choice and may vary by Content Manager or other internet authority. These favorable internet services and categories and levels of preference may be affected more or less by other factors, is not intended to be strict classification although they may be, and otherwise is an example, but not limited to this example of how to suggest, persuade, and near compel migration from more generic domain extensions and email addresses to more specific and useful domain extensions and email addresses.

Much like benefits described with the increased specificity of the domain extension as a means for improving searching and separating of search results for better search accuracy and results accessibility, so is the same benefit achieved with any additional search criteria. Beyond the benefit of increased search accuracy the use of an additional keyword input or other input field provides criteria to direct the separation and parsing of search results into more content related groups such as vitamin D instead of just vitamins, more content provider related groups such as mail order vendors and not supermarkets, more type of content related groups such as articles on vitamin D and not just web based opinion, and more. What is disclosed and claimed is the use of one or more additional search criteria for separating search results automatically as a result of the search or subsequently by an additional action or search. Separating search results includes grouping within the page or pages series of a search result, separating one or more additional internet search result pages, or a combinations.

Initially for reasons of difficulty in finding remaining available domain names, but now for branding purposes, general interest, and other reasons the addition of more domain name extensions have been made available. The current list has expanded from a traditional handful to several hundred, and with more than a thousand to be shortly expected. It would be further expected that this list will grow over time. Disclosed is the use of one or more domain extensions to search the internet for more specific and accurate internet search results. y way of example only, and not intended to be limiting in any manner, in the U.S., the three or four most frequently used domain extensions are commercial (.com), non-commercial or organization (.org), government (.gov), education (.edu), and network systems (.net). Other domain extensions are emerging in their use such as United Kingdom (.uk), Canada (.ca) and others. These domain extensions have a natural following in the case of country domain extensions and others. The use of .com is disproportionately used become there has been no other viable choice. As described earlier, over the last many months other domain extensions have been released. With new domain extensions such as .auto, .club, .clothing, .fitness, .health, .food, .lawyer, and more there is real opportunity to provide more accurate search results and request more specific search results. Disclosed, described, and claimed is the method and system using the primary keyword search criteria field in combination with one or more additional keyword or character and symbol search criteria input field, non-character or symbol keyword search input criteria (selector, radio button, pre-defined, external wired or wireless, etc.), the use of domain extensions, and any combination with or without these or any input means. The use of one or more domain extensions is not specific and may be included in the primary keyword search criteria field as an appendage to the keyword, an additional keyword(s), the keyword itself, the use of additional provided search criteria fields, subsequent searches using the domain extension or other domain extensions, and other single or combination uses of one or more domain extensions. The addition of the any additional search criteria, especially a core classification such as a domain extension will have great impact on the improvement of search results and search results display and formatting.

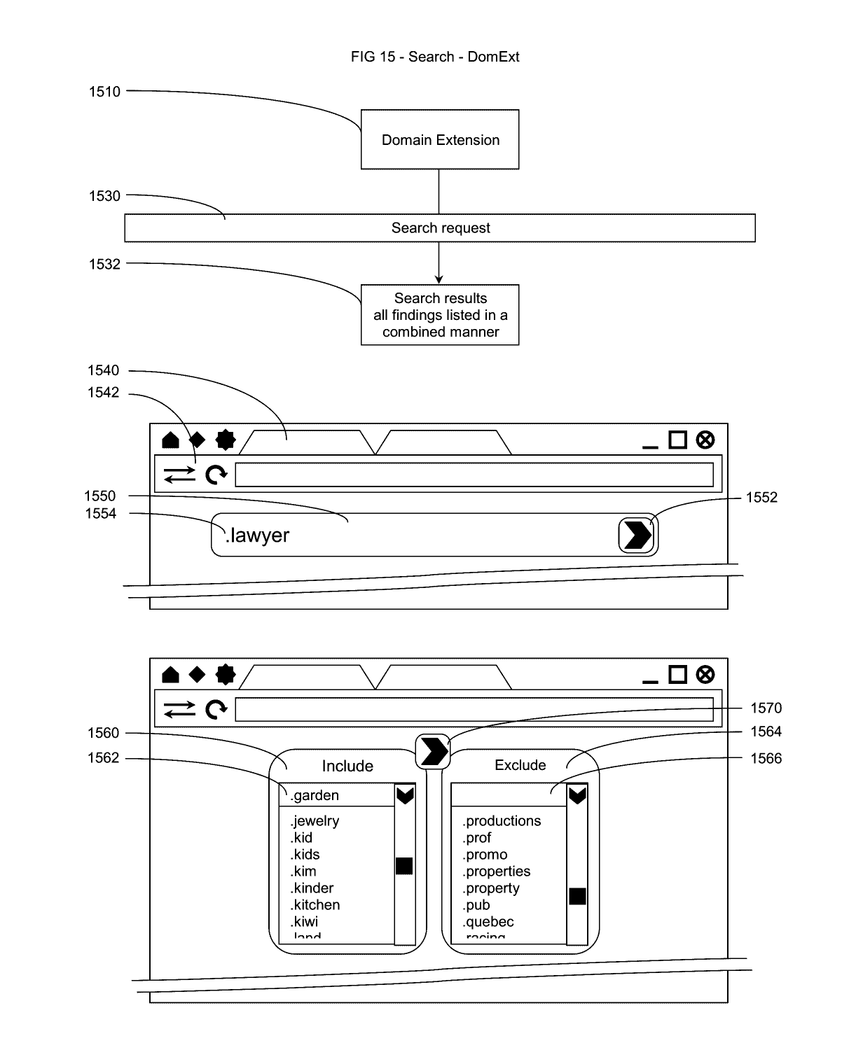

FIG. 15—Search—DExt

FIG. 15 is an example, and not limited to this example, of a Semi-Simple Search interface containing a .(dot)Domain Extension. Shown is a method of searching the internet by domain extension and two illustrations of an apparatus like structure for entry of the domain extension.

The method of domain extension use is as straight forward as the use of the domain extension as the keyword. One or more Domain Extensions 1510 are placed in a search field by any means be that a keyword typed into a field as is currently commonly known, by a drop down menu, a list, by a word fill format from a first few characters entered, by other means, or any of their combination. The Search Request 1530 is made and the Search Results 1532 are published. Current and normal review of search results can follow. Advanced review and parsing of search results can follow as outlined in the totality of this disclosure. As there is no further specificity than the domain extension, the search results are expected to be published on the main page sting. It is possible by the addition of biographical, performance, demographic, etc. data associated with domain extensions that the results could be parsed and placed onto other grouped or separate pages strings for improved results utility.

The general Webpage Tab 1540 and general Webpage Tools 1542 are shown to create a type of webpage context. Important is that with each current search engine there is a Keyword Search Term Field 1550, and a Search Request 1552 button. In this field is often written the keywords for a search. Because of the vastness of the internet keywords have evolved into strings of keywords or even phrases to be more specific with each search. This disclosure retracts back from that position to the use of one or more keywords being one or more Domain extensions 1554. In this case the domain extension 1554 is placed in the field by the action of typing and may require completing the word or could be auto filled or populated as described above. Regardless of the method of entry, the search keyword is a domain extension characterized by .keyword or .(dot)domain extension. Also shown is a variation of a system for entering one or more domain extensions in the next image. The context is already set and known as a webpage on a tab with its various tools. Given the expected vastness and continued introduction of domain extensions, most Content Users will be unfamiliar with available domain extensions that are currently available or which domain extensions have recently been added or removed. A list, a drop down menu, populating the word with initial typed letters, the screen offering like suggestions, and other input formats, and any of their combinations is captured within this graphic as a way of aiding Content Users in knowing their options for domain extension searching. The graphic specifically shows an Inclusion 1560 field and a list of Domain Extensions 1562 from which one or more domain extensions may be selected to include in the search. Upon selection or identification within the list or populated from the selection of names from a list, then there can be the Search Request 1570 performed. A list means any compilation of domain extension that may be a list, copy paste, hyperlinked, drop down, check box, or any other selection from a list of domain extensions. Also in this illustration by way of example only and not a necessary component of the system, or the system is complete as one embodiment with just a selection of what domain extension shall be searched. There should be no other results from a domain extension search but that which is included in the domain extension, but given search errors, search confusion, liberties by Search Providers, and other means, the Content User may seek to Exclude 1566 Domain Extensions 1568 that are not desired and then call for a Search Request 1570. In this system the search may be for domain extension to include, domain extensions to exclude, or a combination of domain extensions to include and exclude.

The search may be conducted by when any field contains a search input criteria keyword. It is recognized that the use of a domain extension casts a very broad net of a variety of subjects. The utility of a .domain extension as a keyword may be limited, but this disclosure acknowledges this as a starting point in the use of domain extensions for search criteria, search identification, search retrieval, and search results presentation and distribution. What is important is that regardless of the means by which a domain extension is readied for search, the use of one or more domain extensions as the search criteria is what is disclosed and captured.

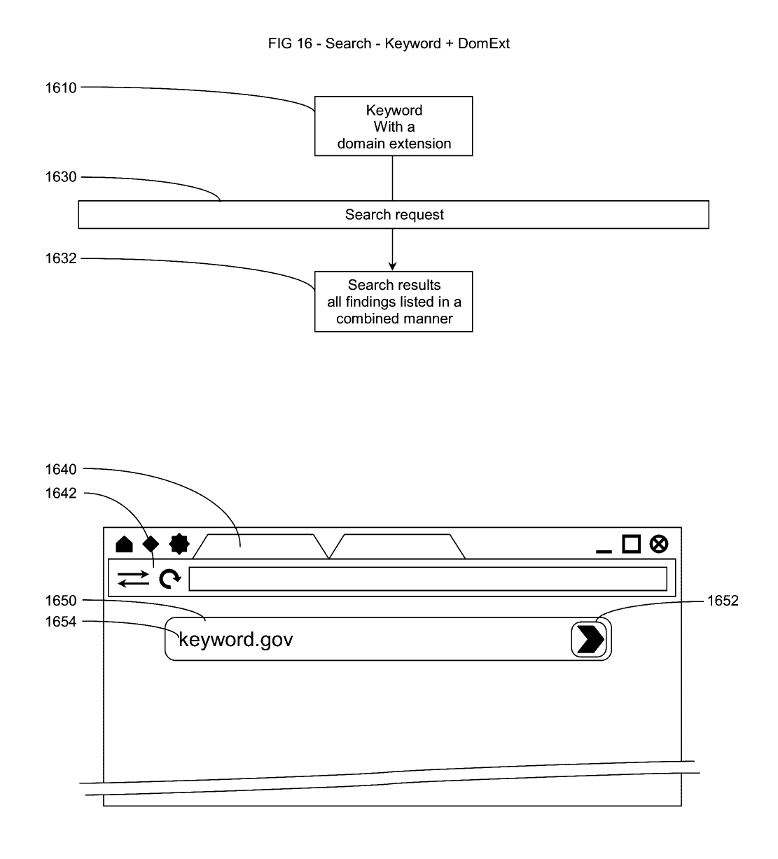

FIG. 16—Search—KW.User DomExt (Same Input Field)

FIG. 16 is an example, and not limited to this example, of a Semi-Simple Search interface interface containing a keyword.domain extension or keyword.(dot)domain extension. Shown is a method of searching the internet by a keyword.domain extension and two illustrations of an apparatus like structure for entry of the domain extension. Adding a keyword to the use of a domain extension as the search criteria brings added specificity to the search criteria, search location, search retrieval, and search results presentation.

As the .(dot)domain extension is expected to cast a very broad search request across multiple topics, the keyword.domain extension or keyword.(dot)domain extension is likely to cast a very narrow search result. That is it would be expected that the search results would only return results that matched keyword.(dot)domain extension exactly or a near derivative. The method includes using a keyword with domain extension or keyword.(dot)domain 1610, followed by the search request 1630, producing search results 1632. As stated the search results will be influenced in this case from a combination of the keyword and the domain extension.

The system of FIG. 16 shows the system context of the general Webpage Tab 1640 and general Webpage Tools 1642. Further there is the common primary keyword input field 1650 with the representation of the search request field 1652. Disclosed is the inclusion of the combination keyword and domain extension 1654 or keyword.domain extension or also for clarity keyword.(dot)domain extension. In this case the specific example, but not a limiting example, is keyword.gov. Upon selection of the search request field 1652 the search will be conducted based upon the Content User given internet search criteria of a keyword and domain extension. This example shows one keyword.domain extension search criteria, but there may be more than one keyword.domain extensions criteria used at once.

Where there is a need to include some text or characters prior to the domain name, that has been referred to as a keyword, it is also feasible to use any established search criteria such as the use of the question mark to substitute for a character, the use of wildcard asterisk characters, or other surrogate character as simply an element of the domain extension or considered a keyword or part of the keyword 1654. Whether results returned are narrow and limited or retain a broader character is a matter of internet content and search engine protocols. Disclosed here is the use of a keyword.domain combination for search criteria, search result presentation, and any of their combinations.

Further disclosure of the Semi-Simple Search interface follows whether all search terms are Content User defined internet search criteria inputs, Content Manager Pre-Set defined internet search criteria fixed inputs, Content Manager Pre-Set defined internet search criteria variable inputs based upon Content User search criteria inputs, or any of their combinations. Although previously defined, the keyword field may accept any character, symbol, number, domain extension, by direct or indirect means, by interface or remotely by a physical tethered or by wireless untethered connection, and any of their combinations. Further when referring to input fields be it the keyword input field or other type of input fields as elsewhere herein defined, the keyword, Content User keyword, Content User Domain Extension, and Content Manager Pre-Set Domain Extensions may be the same input field, separate input fields, or any of their combinations. Further, what is disclosed here is only by way of example and not intended to be a limitation, for instance and for brevity the Semi-Simple Search interface may include a main keyword input field, one or more additional keyword input fields, one or more Content Manager Pre-Set Domain Extension criteria, and one or more additional Content User Domain Extension input fields, and any of their combinations to define the desired search criteria. The keyword field may be a keyword field, drop down list, radio button, scrolls, or other direct and indirect inputs, and as elsewhere defined, and any of their combinations. If not explicitly noted or displayed, it is implied that none, some, all, or any of the previously disclosed functionality of internet search interface and internet search results interface functionality and manipulations, biographical and performance data, geographical data, and all other disclosures, and any of their combinations may be incorporated and used to improve search and result display specificity, relevance, clarity, and utility.

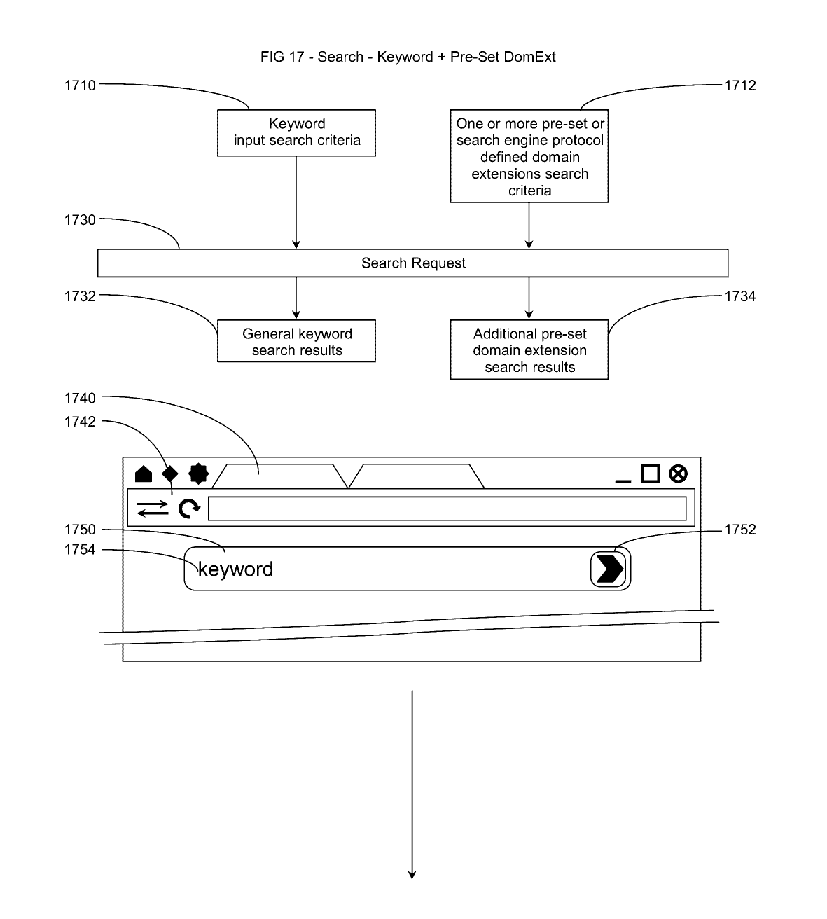

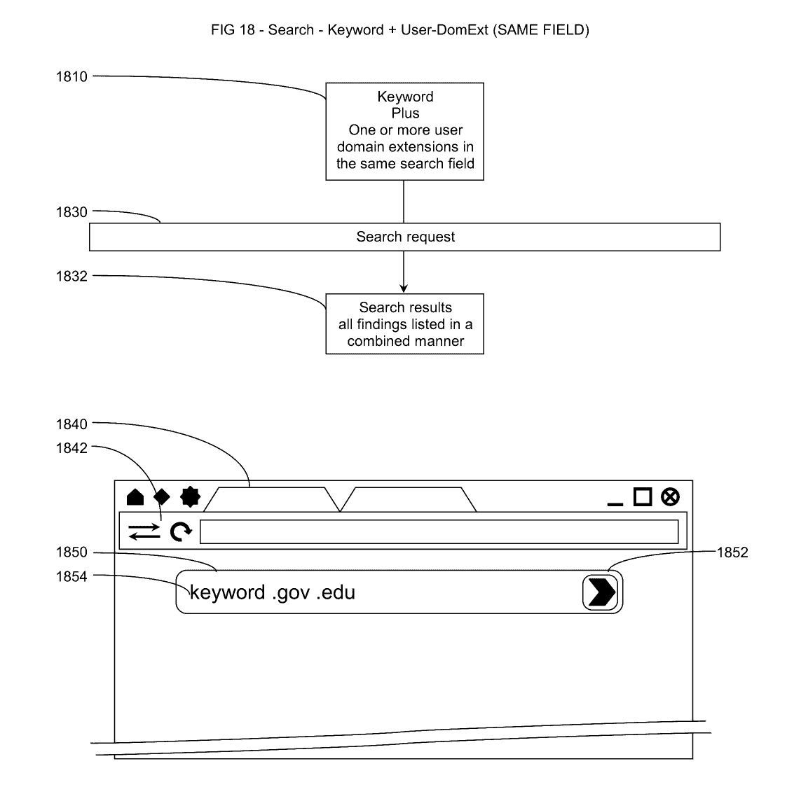

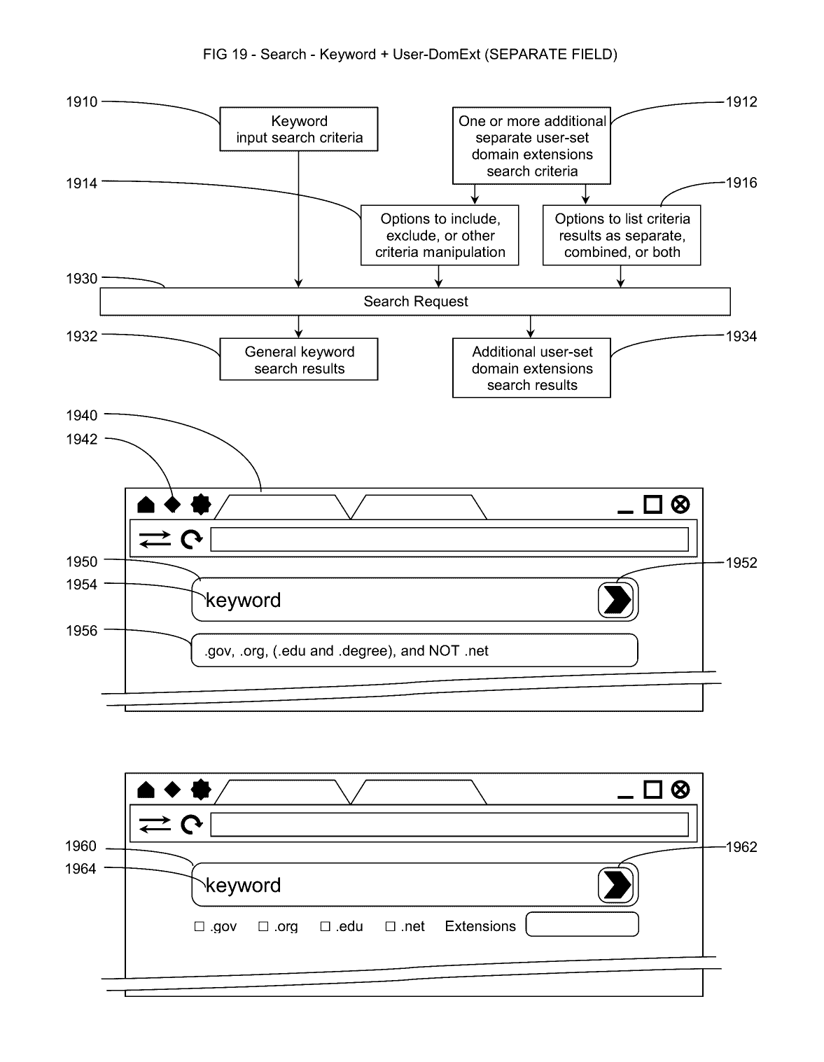

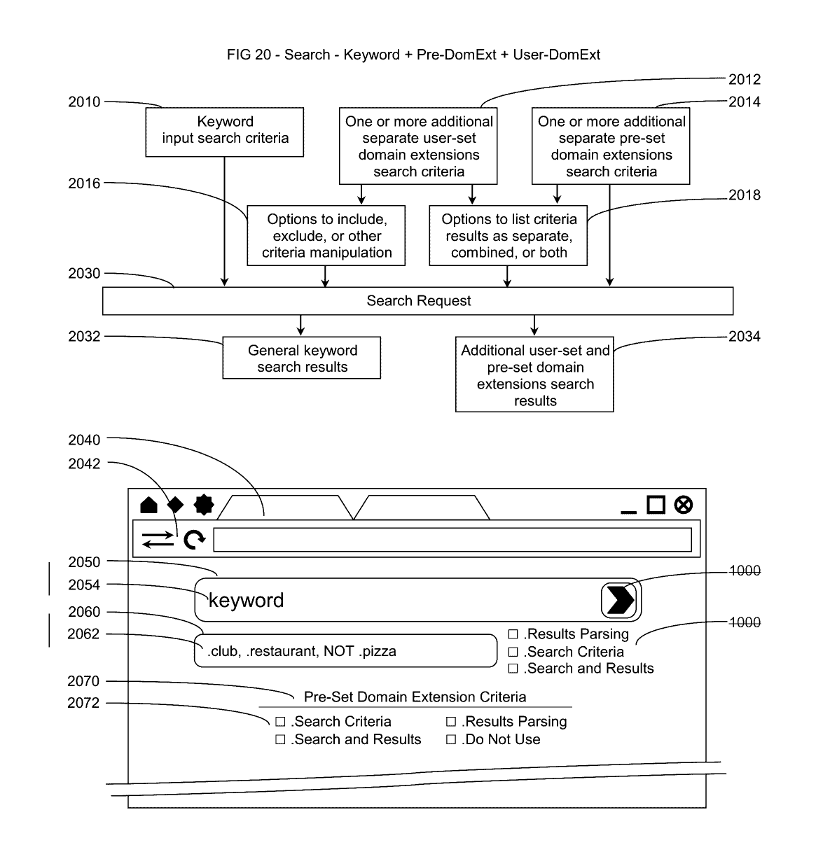

FIG. 17, FIG. 18, FIG. 19, and FIG. 20 disclose a Semi-Simple Search interface focused on the use of domain extensions. That is a Semi-Simple Search interface containing a keyword search field, a Content Manager Pre-Set Domain Extension, a Content User Domain Extension, and any of their combinations.

FIG. 17—Search—KW+PreS DExt

FIG. 17 is an example, and not limited to this example, of a Semi-Simple Search screen using a keyword and Pre-Set Domain extension disclosed as illustrated by a flow chart and system apparatus image. This disclosure is similar to that of FIG. 16 with two primary alterations. Firstly, although there is a keyword and domain extension used for internet search criteria and internet search results display, the keyword and domain extension are not directly combined as a type of single keyword. As such, this search is expected to be more encompassing of internet content as the keyword and domain extension will be operating more independently than that expressed in FIG. 16, but need not be. The second deviation from the example of FIG. 16 is that the one or more domain extension is Content Manager defined, rather than Content User defined. As such the Semi-Simple Search Interface appears to be operated by a single search criteria input field, but in reality there may be one or more additional domain extension operating as internet search criteria, internet search result display criteria, and any of their combinations as well. Further the example shows just one keyword, but the keyword as elsewhere defined may be one or more word, words, phrase, characters, numbers, symbols, other input, and any of their combinations.

The method includes using a Content User internet search criteria keyword 1710 and one or more Content Manager pre-set defined internet search criteria domain extension 1712 (not shown in the apparatus), followed by the search request 1730, and returning internet search results based upon the keyword criteria 1732, the one or more domain extension criteria 1734 (not shown in the apparatus), and any of their combinations. Shown separately to emphasize the contribution of each, the search and search results are the combined result of the Content User defined keyword 1710 and one or more Content Manager pre-set defined domain extensions 1712 or the combination of all search criteria. If the Content User only wishes the influence of the keyword, in this configuration the Content Manager pre-set criteria could not be removed or nullified, unless such an option to deactivate, nullify, or otherwise remove the influence of the Content Manager pre-set internet search criteria, and also potentially their use for internet search results display criteria, is offered. This disclosure include the option for the Content Manager to allow for the inclusion or exclusion of the use of any pre-set domain extension as part of the search criteria, results presentation criteria, or both, or any combination of some or all being included or excluded. This options to deactivate, nullify, or otherwise remove the influence of the Content Manager pre-set internet search criteria and its potential use for internet search result display criteria applied to this and other examples, figures, and disclosures herein of this application.

The system or apparatus of FIG. 17 shows the system context of the general Webpage Tab 1740 and general Webpage Tools 1742. Further there is the common primary keyword input field 1750 with the representation of the search request field 1752. Disclosed is the inclusion of the Content User defined keyword 1754. Disclosed is the use of a single keyword, but as previously disclosed more than one keyword may be used. With the search called by use of the search request field, button, or activator 1752, the system calls for an internet content search based upon the Content User defined keyword internet search criteria 1754 and the Content Manager pre-set internet search criteria, not seen in this representation in the system, but represented as integral to the search process by method component 1712. The potential use of these same criteria for results display criteria will be examined later, but applicable to this disclosure.

FIG. 18—Search—KW+User DExt+User DExt (Same Input Field)

FIG. 18 is an example, and not limited to this example, and incorporates all relevant disclosures herein, of a Semi-Simple Search Screen with three key features: (1) a primary Content User keyword search criteria input field for one or more of any Content User defined keyword and keyword phrase, (2) one or more Content User defined domain extensions, (3) any of their full or partial present or absent criteria input combinations, and (4) placed in the same input field and represented by a flow chart and system apparatus image. This disclosure differs from FIG. 17 by allowing Content User rather than Content Manager defined domain extension search criteria. Shown is a method of searching the internet by domain extension and two illustrations of an apparatus like structure for entry of the keyword and domain extension.

Disclosed in this method is a Content User keyword search criteria 1810 and one or more Content User defined internet search criteria domain extension 1810. In this case each of these search criteria are defined from a single input rather than defined as separate input fields, which will be disclosed later. This representation of a single search criteria input being representative of a system with only a single input field, although this is simply one variation and how the disclosure is represented, but is not limiting the various embodiments available. With Content User defined keyword and domain extension criteria defined, the search request 1830 my follow, and internet search results returned 1832 based upon the keyword criteria 1810, the one or more domain extension criteria 1810, and any of their combinations. The keyword and domain extension are shown combined, reflecting the apparatus single search criteria input field, but the input criteria may be considered to be operating independently as one or more keywords or one or more domain extensions.

The system or apparatus of FIG. 18 shows the system context of the general Webpage Tab 1840 and general Webpage Tools 1842. Further there is the common primary keyword input field 1850 with the representation of the search request field 1852. Disclosed is the inclusion of the Content User defined keyword 1854. Again, represented here is the inclusion of one search criteria input field, but this is simply one embodiment where the Semi-Simple Search Interface accounts for one or more to a few such criteria input fields. With the search called by use of the search request field, button, or activator 1852, the system calls for an internet content search based upon the Content User defined keyword and domain extension internet search criteria 1854. The potential use of these same criteria for results display criteria will be examined later, but applicable to this disclosure.

FIG. 19—Search—KW+User DExt (Separate Input Fields)

FIG. 19 is an example, and not limited to this example, and incorporates all relevant disclosures herein, of a Semi-Simple Search Screen Interface with three primary features: (1) main keyword search criteria input field for Content User defined one or more keywords and (2) one or more Content User Domain Extension in a separate fields as a specific example, and (3) any of their full or partial present or absent criteria input combinations shown in a flow chart and system apparatus image. This disclosure differs from FIG. 18 by allowing the Content User two input fields for use with potentially different search criteria, but not necessarily.

Disclosed in this method is one or more Content User keyword search criteria 1910 and one or more Content User defined internet search criteria domain extension 1912. A specific feature of this disclosure that is a relevant possibility to any of the disclosures within this document's many disclosures is the ability to have inclusive or exclusive search criteria 1914. In this case as there are separate fields for the two types of search criteria and as such they are represented as more independent of the other, although the fact that the method separates these is not the key and necessary feature of the disclosure. Specifically disclosed here is the potential to use the domain extensions as search criteria only, or as criteria for search results presentation or parsing, or in any of their combinations 1916. This feature may be explicitly represented in various disclosures of this document, but regardless this is a potential feature of all disclosures as each disclosure is but one example of other possibilities within the scope of the respective disclosure. With Content User defined one or more keyword and one or more domain extension criteria defined, the search request 1930 may follow, and internet search results returned based upon the keyword criteria 1932, the one or more domain extension criteria 1934, and any of their combinations. These are shown separately here simply to reinforce the separate search criteria input fields and nature of the criteria, but this is for discussion purposes only where the search criteria may be processed at any stage sequentially, simultaneously, combined, separated, any other manner, and any of their combinations.

The system or apparatus of FIG. 19 shows the system context of the general Webpage Tab 1940 and general Webpage Tools 1942. Further there is the common primary keyword input field 1950 with the representation of the search request field 1952. Disclosed is the inclusion of the Content User defined keyword 1954. Further disclosed is a separate search criteria input 1956, available like the first search criteria field for any type of keyword or domain extension or dedicated to one or the other. In this disclosure the second search criteria field is being used for the Content User defined domain extensions. Note that this domain extension search criteria input field may accept inclusive terms and exclusive terms or terms to include in the search and terms not to return with the search or to exclude. Naturally the use of inclusive and exclusive terms may be used in either or both of the search criteria input fields. With the search called by use of the search request field, button, or activator 1952, the system calls for an internet content search based upon the Content User defined keyword and domain extension internet search criteria in input fields 1950 and 1956.

As previously mentioned and disclosed in method 2018, any of the search criteria may be used for internet searching, search results presentation and parsing, or any of their combination. For instance, take that the first internet search input field 2050 are the search keywords, phrases, and domain extensions as this total document disclosure defines, and the second input field 2056 represents criteria not used for the internet search, but for internet search result presentation and parsing. The Content User in this cases wishes for the results to be parsed into a main search results page string with additional search result page strings of .gov, .org, and .edu. .gov as a search criteria, or any of the domain extensions as a search criteria, but they may be reserved for search results presentation and parsing. That is the results of say keyword search and the inclusion of the domain extension .club may return information from such a search

Disclosed is the principle of a Semi-Simple Search Interface with one or more Content User keyword and one or more Content User domain extension search criteria inputs used for directing the search process, search results presentation and parsing, or any potential combination. Represented are two of many forms that this principle may be executed as a system or apparatus. Show is a second example relying on the description previously provided in this disclosure, but now with checkboxes of major domain extensions, and a field for another domain extension criteria for search, results presentation, or any of their combinations. Disclosed here is the use of check boxes, but naturally any other input means is acceptable to include by way of example, but not limited to these examples as an input field, check boxes, radio buttons, drop down lists, filled in criteria with a few characters entered, spoken entry input, other means, and any of their combinations.

Disclosed is increased options and search effectiveness communicated intuitively to the Content User by the presence of an additional search criteria input field. In this example there is the inclusion of one additional search criteria input field, but this and other disclosures are also encompassing of the concept of the Semi-Simple Search Interface with one or more to a few search criteria input fields, but less than the number of search criteria inputs associated with an Advanced Search Interface. The potential use of these same criteria for results display criteria will be examined later, but applicable to this disclosure.

FIG. 20—Search—KW+PreS DExt+User DExt

FIG. 20 is an example, and not limited to this example, and incorporates all relevant disclosure herein, of a Semi-Simple Search Screen Interface with four primary disclosures: (1) a primary keyword search criteria input fields for one or more Content User defined keywords, (2) one or more Content User defined domain extension search criteria inputs, (3) one or more Content Manager Pre-Set domain extension input criteria, and (4) any of their full or partial present or absent criteria input combinations shown as a flow chart and as an apparatus system image. This disclosure differs from FIG. 19 by the addition of the one or more Content Manager Pre-Set domain extensions.

Disclosed in this method is one or more Content User keyword search criteria 2010 and one or more Content User defined internet search criteria domain extension 2012. Further included is the incorporation of one or more Content Manager Pre-Set domain extensions search criteria 2014. A specific feature of this disclosure that is a relevant possibility to any of the disclosures within this document's many disclosures is the ability to have inclusive or exclusive search criteria 2016. In this case as there are separate fields for the two types of search criteria and as such they are represented as more independent of the other, although the fact that the method separates these is not the key and necessary feature of the disclosure. Specifically disclosed here is the potential to use the domain extensions as search criteria only, or as criteria for search results presentation or parsing, or in any of their combinations 2018. This feature may be explicitly represented in various disclosures of this document, but regardless this is a potential feature of all disclosures as each disclosure is but one example of other possibilities within the scope of the respective disclosure. With Content User defined one or more keyword, one or more Content User domain extension, and one or more Content Manager Pre-Set criteria defined, the search request 2030 may follow, and internet search results returned based upon the keyword criteria 2032, the one or more of the Content User and Content Manager domain extension criteria 2034, and any of their combinations. As in other and all cases where there are Content Manager pre-set defined criteria, such criteria may or may not be allowed to be deactivated, nullified, or other Content User choice. Consideration of the Content Manager Pre-Set criteria not being active is within the scope of this disclosure as well as other disclosures herein. These are shown separately here simply to reinforce the separate search criteria input fields and nature of the criteria, but this is for discussion purposes only where the search criteria may be processed at any stage sequentially, simultaneously, combined, separated, any other manner, and any of their combinations.

The system or apparatus of FIG. 20 shows the system context of the general Webpage Tab 2040 and general Webpage Tools 2042. Further there is the common primary keyword input field 2050 with the representation of the search request field 2052. Disclosed is the inclusion of the Content User defined keyword 2054. Further disclosed is a separate search criteria input 2060, available like the first search criteria field for any type of keyword or domain extension or dedicated to one or the other. In this disclosure the second search criteria field is being used for the Content User defined domain extensions. Note that this domain extension search criteria input field may accept inclusive terms and exclusive terms or terms to include in the search and terms not to return with the search or to exclude. Naturally the use of inclusive and exclusive terms may be used in either or both of the search criteria input fields. In this disclosure, but applicable with any of the disclosures within this document is the option to use the second field input criteria for searching only, results presentation only, or search and results purposes. This specific example is not limited to this disclosure, but may take other forms that use these or other methods of criteria input and criteria selection on a criteria specific level, group level as shown here, or any of their combinations. This disclosure additionally includes the Content Manager Pre-Set domain extensions 2070. The specific domain extensions may be shown, may not be shown, or the option provided the Content User to see, select, or otherwise interact with the Content Manager Pre-Set domain extensions. Whether shown and known or not shown and unknown, here the Content User may select how they want the Content Manager Pre-Set criteria to be used, in this case with check boxes 2072. Although not limited to these choices, shown is search only, results parsing only, search and results, and do not use the pre-set domain extensions at all. With the search called by use of the search request field, button, or activator 2052, the system calls for an internet content search based upon the Content User defined keyword and domain extension internet search criteria in input fields 2050 and 2056, as well as Content Manager Pre-Set domain extension internet search criteria inputs and use selections, and any of their combinations.

Disclosed is increased options and search effectiveness communicated intuitively to the Content User by the presence of an additional search criteria input field combined with Content Manager Pre-Set domain extensions. In this example there is the inclusion of one additional search criteria input field, but this and other disclosures are also encompassing of the concept of the Semi-Simple Search Interface with one or more to a few search criteria input fields, but less than the number of search criteria inputs associated with an Advanced Search Interface. The potential use of these same criteria for results display criteria will be examined later, but applicable to this disclosure.

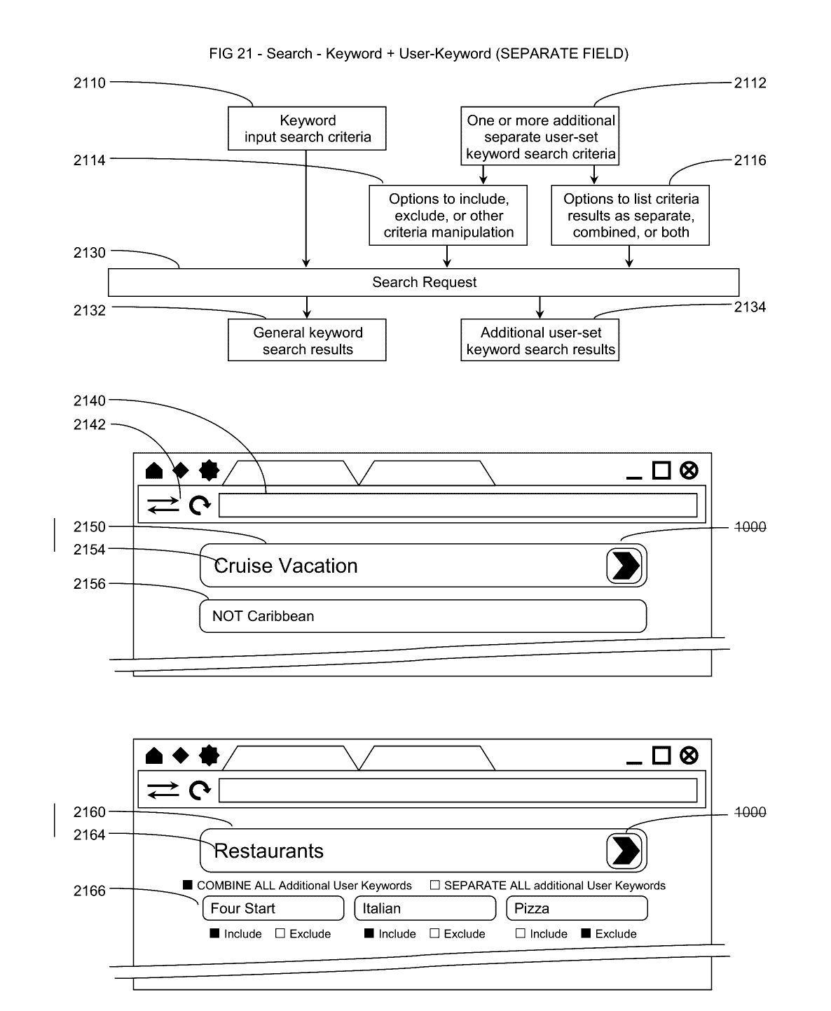

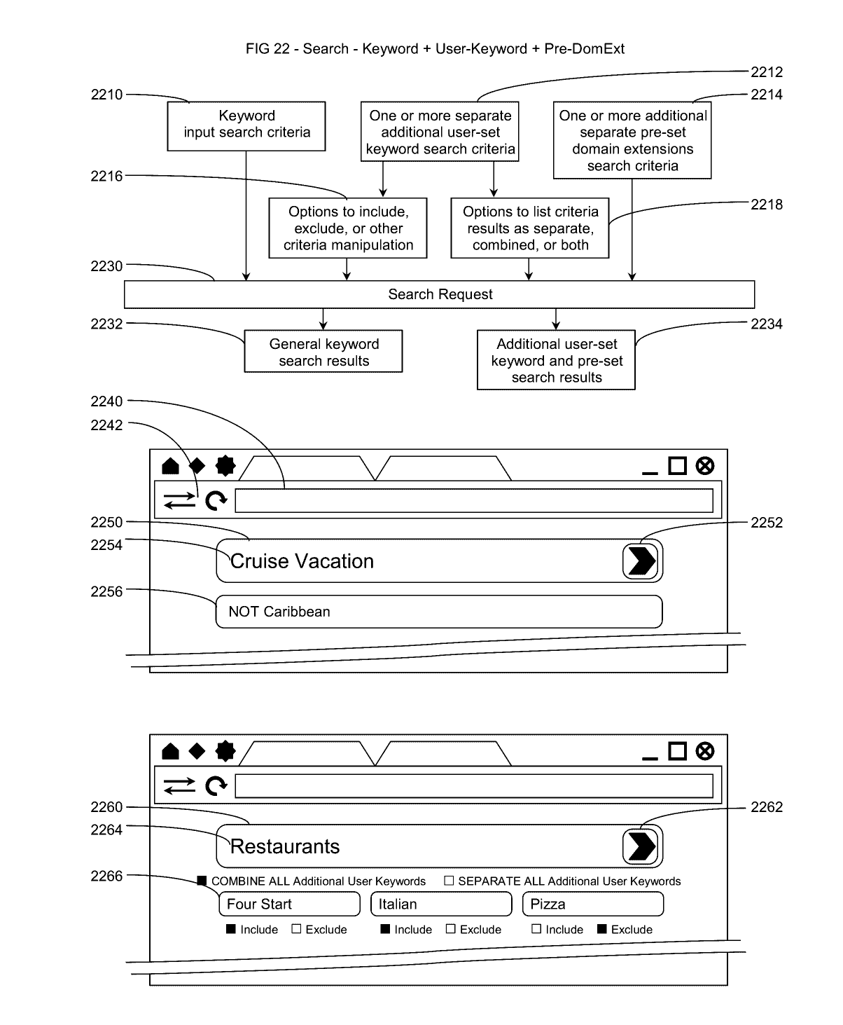

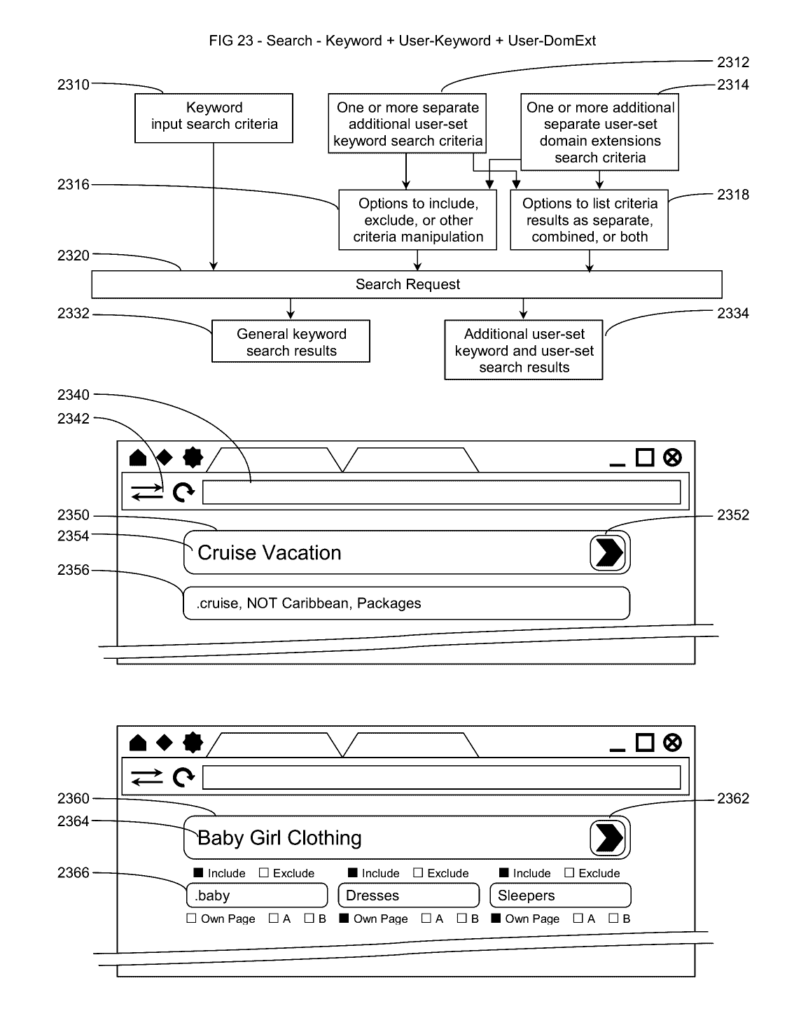

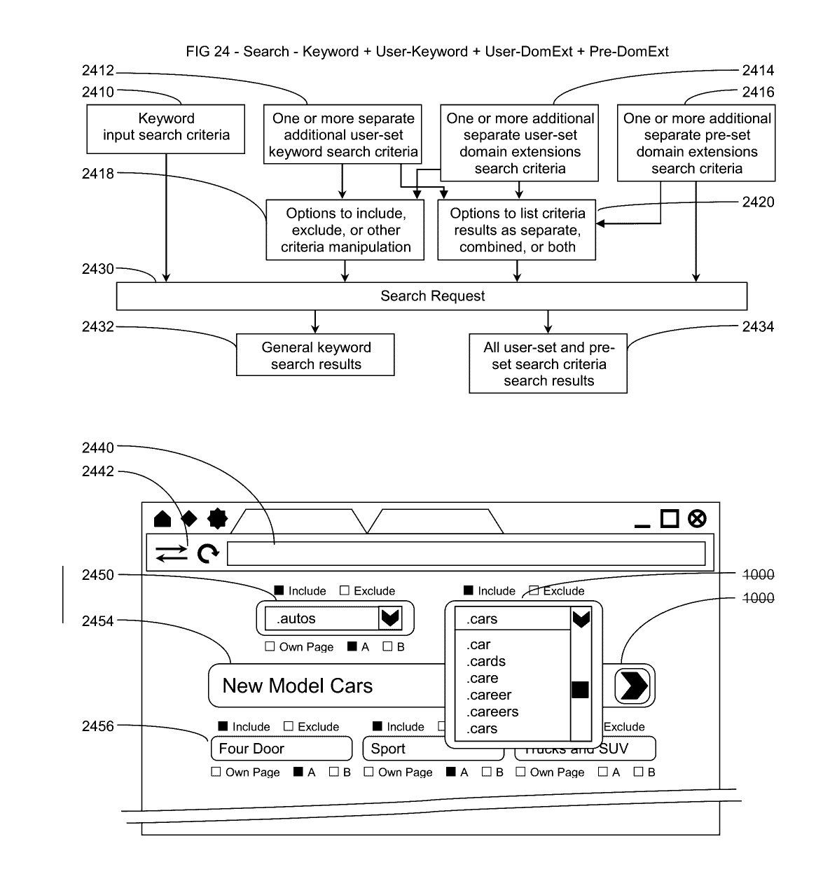

FIG. 21, FIG. 22, FIG. 23, and FIG. 24 disclose a Semi-Simple Search interface focused on the use of an additional Content User keyword field. That is a Semi-Simple Search interface containing a keyword search field, a second Content User keyword search criteria input field, a Content Manager Pre-Set Domain Extension, a Content User Domain Extension, and any of their combinations. Expressed by this set of disclosures is the significant additional search specificity available with just one, two, or a few additional criteria. Consider one or two of the examples included in the figures that follow. For instance, one example is in FIG. 23 which includes what might be a typical keyword phrase of “Baby Girl Clothing.” From this phrase what will the search engine return? Would the results be a dress, pant and shirt, leggings, sleeper, and on. Needed is that second, third, or a few other criteria. In this case “dresses” and “sleepers” were stated as that additional criteria to also include a focus in the area of .baby or .(dot)baby domain extension. The Content Manager's search engine algorithm and protocol benefit tremendously from the direction provided by even just one of these additional search criteria. This is a spark of this innovation. That is the significance of just one additional, two additional, or a few additional criteria to return more specific, more accurate, and greater access into the internet total content. Could this be done in a single primary keyword input field? Yes, but most Content Users do not know Boolean or other advanced search criteria. Further, it is not always clear how to draft a more complex search input criteria. Having one, two, or a few additional input fields allows for a more stepwise process to building a better search criteria. For instance, a first thought is “baby girl clothing.” Wanted is really a baby girl dress, but that may not have been the first thought. The next criteria gives an opportunity to think, oh yes, it would be helpful to be more specific, such as “dresses.” Needed in the ever increasingly complex internet and ever and rapidly expanding internet content is search criteria that is capable of more specific criteria to extract a more accurate response. Advanced search interfaces are too complicated and undesirable. The current single simple search interface is too simplistic and compromises too much accuracy. The spark of this disclosure is realizing the power and benefit of just one additional criteria, two additional criteria, or a few additional criteria. What the industry has pursued is not just asking for that additional input, but seeking increased capability of search algorithms and protocols to infer more from the single search input field and from previous internet activity. Unfortunately, a Content User's intent this moment on the internet may not be the Content User's intent just the moment before. Needed, is to just ask for that one, two, or a few additional search criteria. The Semi-Simple Search Interface is that balance needed. Disclosed in the immediately following figures is the methods and system apparatus examples that show that additional search criteria may be in the form of one, two, or a few additional inputs as Content User, Content Manager, or both defined keyword; domain extensions; any string of characters, numbers, or symbols; and any of their combinations to extract a more available value from the internet or even intranets. Of course the specific representations that follow are examples, and not intended to be limited to these specific disclosures, but encapsulating of the broader inventive leaps and principles.

FIG. 21—Search—KW+User KW

FIG. 21 is an example, and not limited to this example and incorporates all relevant disclosures herein, of a Semi-Simple Search Screen Interface with three primary features: (1) a main keyword search criteria input field for one or more keywords, (2) one or more additional Content User defined Keyword search criteria input fields, and (4) any of their full or partial present or absent criteria input combinations shown in a flow chart and system apparatus image. This disclosure represents multiple criteria input fields as another embodiment of the Semi-Simple Search Interface for the incorporating keywords. Keep in mind that keywords are define as a word, words, phrase, characters, symbols, numbers, other signals if electronic code, other means, and any of their combinations. One such combination is one or more domain extension as well.

Disclosed in this method is one or more Content User keyword search criteria 2110 and one or more Content User defined internet search keyword criteria input field 2112. A specific feature of this disclosure that is a relevant possibility to any of the disclosures within this document's many disclosures is the ability to have inclusive or exclusive search criteria 2114. In this case as there are separate fields for the two types of search criteria and as such they are represented as more independent of the other, although the fact that the method separates these is not the key and necessary feature of the disclosure. Specifically disclosed here is the potential to use two keyword fields for search criteria only, or as criteria for search results presentation or parsing, or in any of their combinations 2116. This feature may be explicitly represented in various disclosures of this document, but regardless this is a potential feature of all disclosures as each disclosure is but one example of other possibilities within the scope of the respective disclosure. With Content User defined one or more keyword in the first input field 2150 and one or more keyword in the one or more other criteria input field 2154, the search request 2130 may follow, and internet search results returned based upon keyword criteria 2132, keyword criteria 2134, and any of their combinations, where this also include no combination in this and other disclosures in this document. These are shown separately here simply to reinforce the separate search criteria input fields and nature of the criteria, but this is for discussion purposes only where the search criteria may be processed at any stage sequentially, simultaneously, combined, separated, any other manner, and any of their combinations.

The system or apparatus of FIG. 21 shows the system context of the general Webpage Tab 2140 and general Webpage Tools 1942. Further there is the common primary keyword input field 2150 with the representation of the search request field 2152. Disclosed is the inclusion of the Content User defined keyword 2154. Further disclosed is a second and separate search criteria input 2156, available like the first search criteria field for any type of keyword for combined, separate, uniquely dedicated, or other purpose, or any of their combinations. In this disclosure the second search criteria field is being used to exclude a search results. Note that this keyword criteria input field may accept inclusive terms and exclusive terms or terms to include in the search and terms not to return with the search or to exclude. Naturally the use of inclusive and exclusive terms may be used in either or both of the search criteria input fields. With the search called by use of the search request field, button, or activator 2152, the system calls for an internet content search based upon the Content User defined keyword and domain extension internet search criteria in input fields 2150 and 2156. As previously mentioned and disclosed in method 2116, any of the search criteria may be used for internet searching, search results presentation and parsing, or any of their combination

Introduced by this disclosure is the use of multiple criteria input fields as more specifically shown by the lower image of FIG. 21, and again these being just two of many examples of embodiments available within this disclosure. In addition to having the context as previously discussed as a Semi-Simple Search Interface, show specifically is the primary keyword input field 2160 containing a keyword 2164 representative of any form of available keyword and the search request button or interface 2162. Disclosed is the principle of a Semi-Simple Search Interface with one or more Content User keyword and one or more Content User domain extension search criteria inputs used for directing the search process, search results presentation and parsing, or any potential combination. Shown is an example of multiple input fields 2166 and associated typical choices of use control. Specifically in this case is the choice to combine the keywords for search purposes and results presentation purposes, to separate out search results by each separate criteria, or any of their combinations. Also specifically shown by way of example, but in all of these cases not limited to these examples in the option to include or exclude the keyword in the search results. Other options can naturally be added and fit within the scope of this disclosure and the concept of the Semi-Simple Search Interface.

Disclosed is increased options and search effectiveness communicated intuitively to the Content User by the presence of an additional search criteria input field. Communicated is the increased effectiveness of the search by increased Content User search options, yet not so many choices and requirement as to become too complicated. One, two, to a few additional input criteria goes a long way to improved internet search effectiveness and internet search result presentation.

FIG. 22—Search—KW+User KW+PreS DExt

FIG. 22 is an example, and not limited to this example, and incorporates all relevant disclosure herein, of a Semi-Simple Search Screen Interface with four features: (1) main keyword search criteria Content User input field for one or more keywords, (2) additional keyword search criteria Content User input fields with one or more keywords, (3) Content Manager Pre-Set domain extension criteria, and (4) any of their full or partial present or absent criteria input combinations shown as a flow chart and as an apparatus system images. This disclosure differs from by the addition of the one or more Content Manager Pre-Set domain extensions

Disclosed in this method is one or more Content User keyword search criteria 2210 and one or more Content User defined internet search criteria domain extension 2212. Further included is the incorporation of one or more Content Manager Pre-Set domain extensions search criteria 2214. A specific feature of this disclosure that is a relevant possibility to any of the disclosures within this document's many disclosures is the ability to have inclusive or exclusive search criteria 2016. In this case as there are separate fields for the two types of search criteria and as such they are represented as more independent of the other, although the fact that the method separates these is not the key and necessary feature of the disclosure. Specifically disclosed here is the potential to use the domain extensions as search criteria only, or as criteria for search results presentation or parsing, or in any of their combinations 2218. This feature may be explicitly represented in various disclosures of this document, but regardless this is a potential feature of all disclosures as each disclosure is but one example of other possibilities within the scope of the respective disclosure. With Content User defined one or more keywords in a primary input field, one or more Content User keywords in one or more other keyword input fields, one or more Content Manager Pre-Set criteria defined, and any of their combinations the search request 2230 may follow. The internet search results returned 2032 based upon the given search criteria. Search results are returned based upon the one or more primary keywords, one or more other secondary keyword inputs, and one or more Content Manager Pre-Set domain extensions, and any of their combinations 2234. Search result presentation will be treated further with other disclosures, but search results may be all presented on a main page string, associated in rational groups, or presented separately based upon any keyword or Content Manager Pre-Set domain extension 2234. As in other and all cases where there are Content Manager pre-set defined criteria, such criteria may or may not be allowed to be active or deactivated, nullified, or other Content User choice. Consideration of the Content Manager Pre-Set criteria not being active is within the scope of this disclosure as well as other disclosures herein. Some criteria are shown separately simply to reinforce the separate search criteria input fields and nature of the criteria, but this is for discussion purposes only where the search criteria may be processed at any stage sequentially, simultaneously, combined, separated, any other manner, and any of their combinations.

The system or apparatus of FIG. 22 shows the system context of the general Webpage Tab 2240 and general Webpage Tools 2242. Further there is the common primary keyword input field 2250 with the representation of the search request field 2252. Further show in the Content User one or more keyword input 2054 and in this case exemplifying exclusion of search results associated with this keyword. Further disclosed is a separate search criteria input 2256, available like the first search criteria field for any type of keyword or domain extension or dedicated to one or the other or dedicated to one purpose or the other such as one for search criteria and one for results presentation and parsing criteria. Here there is an emphasis on an additional keyword input field and each being for additional search effectiveness with each contributing to search input criteria.

Introduced by this disclosure is the use of multiple criteria input fields as more specifically shown by the lower image of FIG. 22, and again these being just two of many examples of embodiments available within this disclosure. In addition to having the context as previously discussed in this disclosure as a Semi-Simple Search Interface, shows specifically is the primary keyword input field 2260 containing a keyword 2264 representative of any form of available keyword and the search request button or interface 2262. Shown is an example is a focus on search control and specificity with multiple input fields 2266. By way of example, and not limited to this specific disclosure of multiple search inputs, is the inclusion of options on how that criteria will be used as associated with keyword input fields 2260. One set of options being to treat the keywords in a combined or separate manner. Another option is whether a particular keyword will be included in search results or used to exclude certain items from the search results. Other similar option as explicitly disclosed or inferred and included within the envelop of alternatives of this disclosure may also be included.

Disclosed is the principle of a Semi-Simple Search Interface with one or more Content User primary keyword input fields, one or more additional Content User keyword input fields, with one or more Content Manager Pre-Set domain extensions used for directing the search process, search results presentation and parsing, or any potential combination, but without the complexity of the Advanced Search Interface. The focus of this disclosure being on search control, options, and increased effectiveness communicated simply and intuitively to the Content User. Further incorporated is the Content Manager Pre-Set domain extensions. The potential use of these same criteria for results display criteria will be examined later, but applicable to this disclosure.

FIG. 23—Search—KW+User KW+User DExt

FIG. 23 is an example, and not limited to this example, incorporates all relevant disclosure herein, of a Semi-Simple Search Screen Interface with four features: (1) main keyword search criteria Content User input field for one or more keywords, (2) one or more additional keyword search criteria Content User input field with one or more keywords, (3) one or more Content User defined domain extension criteria, and (4) any of their full or partial present or absent criteria input combinations shown as a flow chart and as an apparatus system images. This disclosure differs from by the previous figure by the addition of the Content User defined domain extensions and removal of the Content Manager Pre-Set domain extensions.

Disclosed in this method is a primary keyword search criteria input field 2310, one or more Content User defined internet search keyword input fields 2312, one or more Content User defined domain extensions 2314, and any of their combinations. A specific feature of this disclosure that is a relevant possibility to any of the disclosures within this document's many disclosures is the ability to have inclusive or exclusive search criteria 2316. In this case as there are separate fields for the types of search criteria and as such they are represented as more independent of the other as method elements, although the fact that the method separates these is not the key and necessary feature of the disclosure. Specifically disclosed here is the potential to use the domain extensions as search criteria only, or as criteria for search results presentation or parsing, or in any of their combinations 2318. This feature may be explicitly represented in various disclosures of this document, but regardless this is a potential feature of all disclosures as each disclosure is but one example of other possibilities within the scope of the respective disclosure. With Content User defined one or more keywords in a primary input field, one or more Content User keywords in one or more other keyword input fields, one or more Content User defined domain extension criteria, and any of their full or partial presence or absence combinations the search request 2330 may follow. The internet search results returned 2332 based upon the given search criteria. Search results are returned based upon the one or more primary keywords, one or more other additional keyword inputs, and one or more Content User domain extension criteria, and any of their combinations 2334. Search result presentation will be treated further with other disclosures, but search results may be all presented on a main page string, associated in rational groups, or presented separately based upon any keyword or Content User defined domain extension criteria 2234. Some criteria are shown separately simply to reinforce the separate search criteria input fields and nature of the criteria, but this is for discussion purposes only where the search criteria may be processed at any stage sequentially, simultaneously, combined, separated, any other manner, and any of their combinations.

The system or apparatus of FIG. 23 shows the system context of the general Webpage Tab 2340 and general Webpage Tools 2342. Further there is the common primary keyword input field 2350 with the representation of the search request field 2352. Shown is the Content User one or more keyword input 2354. Also disclosed is one or more additional search criteria input fields 2356 and in this case exemplifying search criteria with inclusion of a domain name, exclusion of keyword, and inclusion of a keyword. Any of these open criteria input fields are available for any type of keyword or domain extension or dedicated to one or the other or dedicated to one purpose or the other such as one for search criteria and one for results presentation and parsing criteria

Introduced by this disclosure is the use of multiple criteria input fields as more specifically shown by the lower image of FIG. 23, and again these being just two of many examples of embodiments available within this disclosure. In addition to having the context as previously discussed in this disclosure as a Semi-Simple Search Interface, this illustration shows specifically a primary keyword input field 2360 containing a keyword 2364 representative of any form of available keyword and the search request button or interface 2362. Further disclosed in this example is a focus on search control and specificity with multiple input fields 2366 and associated controls. By way of example, and not limited to this specific disclosure of multiple search inputs, is the option to include or exclude the search term 2366 from retrieved results, as well as whether to parse results on its own page, or on a group or separate page A or group or separate page B 2366. These options are only provided by way of example, and without limitation, as other similar options as explicitly disclosed or inferred are included within the envelop of alternatives of this disclosure.

Disclosed is the principle of a Semi-Simple Search Interface with one or more Content User primary keyword input fields for one or more keywords, one or more additional Content User keyword input fields for one or more keywords, one or more Content User defined domain extensions input fields for one or more domain extension inputs, and any of their full or partial present or absent combinations used for directing the search process, search results presentation and parsing, or any potential combination, but without the complexity of the Advanced Search Interface. The focus of this disclosure being on search control, options, and increased effectiveness communicated simply and intuitively to the Content User. The potential use of these same criteria for results display criteria will be examined later, but applicable to this disclosure.

FIG. 24—Search—KW+User KW+PreS DExt+User DExt

FIG. 24 is an example, and not limited to this example, incorporates all relevant disclosure herein, of a Semi-Simple Search Screen Interface with five features: (1) main keyword search criteria Content User input field for one or more keywords, (2) one or more additional keyword search criteria Content User input field with one or more keywords, (3) one or more Content User defined domain extension criteria, (4) one or more Content Manager Pre-Set domain extensions, and (5) any of their full or partial present or absent criteria input combinations shown as a flow chart and as an apparatus system images. This disclosure differs from by the previous figure by the addition of the Content Manager Pre-Set domain extensions.

Disclosed in this method is a primary keyword search criteria input field 2410 for one or more keywords, one or more Content User defined internet search keyword input fields 2412 for one or more keywords, one or more Content User defined domain extensions specific input fields 2414 for one or more domain extensions, one or more Content Manager Pre-Set domain extensions and any of their full or partial present or absent combinations. The fact that there are specific Content User domain extension input fields is simply an example of the type of input fields available, but domain extensions are not limited from being added to other fields. A specific feature of this disclosure that is a relevant possibility to any of the disclosures within this document's many disclosures is the ability to have inclusive or exclusive search criteria 2418. In this case as there are separate fields for the types of search criteria and as such they are represented as more independent of the other as method elements, although the fact that the method separates these is not the key and necessary feature of the disclosure. Specifically disclosed here is the potential to use the domain extensions as search criteria only, as criteria for search results presentation, use all or some for each action, parsing, or in any of their full or partial present or absent combinations 2420. This feature may be explicitly represented in various disclosures of this document, but regardless this is a potential feature of all disclosures as each disclosure is but one example of other possibilities within the scope of the respective disclosure. With Content User defined one or more keywords in a primary input field, one or more Content User keywords in one or more other keyword input fields, one or more Content User defined domain extension criteria, the presence of Content Manager Pre-Set domain extensions, and any of their full or partial presence or absence combinations the search request 2430 may follow. The internet search results returned 2432 based upon the given search criteria. Search results are returned based upon the one or more primary keywords, one or more other additional keyword inputs, and one or more Content User domain extension criteria, one or more Content Manager Pre-Set domain extensions, and any of their combinations 2434. Search result presentation will be treated further with other disclosures, but search results may be all presented on a main page string, associated in rational or irrational groups, or presented separately based upon any keyword or domain extension criteria 2234. Depicted specifically is that the Content Manager Pre-Set domain extensions are just that, pre-set and non-interactive to the Content User. However, this is one example of variations to this disclosure and other disclosures with Content Manager Pre-Set domain extensions, and that is such Content Manager Pre-Set domain extensions may be made know, made available for deactivation or activation, or other action, or not made know and not made available for Content User interaction and manipulation. The primary concept is that the Content Manager may interject pre-set domain extension criteria. This criteria may be used for searching, retrieval, and search results presentation all on a main page string, some or all divided into group page strings, or some or all place on separate page strings, or any full or partial present or absent combination. Some criteria are shown separately simply to reinforce the separate search criteria input fields and nature of the criteria, but this is for discussion purposes only where the search criteria may be processed at any stage sequentially, simultaneously, combined, separated, any other manner, and any of their combinations.

The system or apparatus of FIG. 24 shows the system context of the general Webpage Tab 2440 and general Webpage Tools 2442. The Semi-Simple Search Interface has features added to direct keyword searching in one or more locations with intuitive features for the use and purpose of the keyword as well as domain extension inclusion with associated use and purpose features. First represented is the domain extension input field 2450 and 2456. The expanded drop down list of domain extension input field 2456 is an example of how a Content User might be aware of what domain extensions are available for use. Associated with domain extension input fields 2450 and 2456 are check boxes to include the results associated with the domain extension in the search results or to exclude them from the search results. Additionally, the domain extension input field 2450 and 2456 are also associated with options on the results presentation or parsing using the domain extension to include parsing onto its own separate page string, on a group or separate page string A, or on a group or separate page string B. A and B page strings may be grouped or separate depending upon whether or not another domain extension is associated with that same option. Also included on the Semi-Simple Search Interface is the common primary keyword input field 2454 capable of one or more keywords and also showing the representation of the search request field 2452. Also disclosed is one or more additional search criteria input fields 2456 and in this case exemplifying search criteria with inclusion of listed keywords. In this specific example, there are also features associated with the Content User one or more additional keyword input fields 2456 to have the option to include or exclude the search results using that keyword from the retrieved results. As with other input fields, these one or more additional Content User keyword input fields 2456 also feature options for results distribution to include parsing to the keywords own page string, a group or separate A page string, a group or separate B page string, or any available combinations. Any of these open criteria input fields are available for any type of keyword or domain extension or dedicated to one or the other or dedicated to one purpose or the other such as one for search criteria and one for results presentation and parsing criteria.

Disclosed is the principle of a Semi-Simple Search Interface with one or more Content User primary keyword input fields for one or more keywords, one or more additional Content User keyword input fields for one or more keywords, one or more Content User defined domain extensions input fields for one or more domain extension inputs, one or more Content Manager Pre-Set domain extensions, and any of their full or partial present or absent combinations used for directing the search process, search results presentation and parsing, or any potential combination, but without the complexity of the Advanced Search Interface. The focus of this disclosure being on search control, options, and increased effectiveness communicated simply and intuitively to the Content User. The potential use of these same criteria for results display criteria will be examined later, but applicable to this disclosure.

Described is the release of hundreds and likely hundreds more of domain extensions for various reasons. Currently in the U.S., the three or four most frequently returned domain extension are government (.gov), non-commercial or organizational (.org), education (.edu), and network systems (.net). The domain extension commercial (.com) is most widely used as it is recognized as the default domain extension as currently few other domain extensions provide relevance. As such, .com is the most widely used and therefore associated with the most returned search results. In fact, all domain extension associated with a domain name are all returned in the same search results creating a mix of related and unrelated results that more domain extensions could rectify. This can readily been seen in several ways. Try any search and you will get a host of .com responses, and it is not uncommon for a federal or state government sponsored site to be listed near the top of the search results. This is predictable because so many subjects are now addressed by our federal and state governments that such a search response would apply. Additionally, government sites are authoritative, get high traffic so rise in general relevance, are verifiable, and satisfy many other favorable criteria of the search engine. The problem is, the Content User may be completely disinterested in a government website or several government websites. This does not just happen with government websites, but almost any search will have in its first few positions a Wikipedia site, dictionaries, big retailers, and other sites that generate inherent traffic that also meet many favorable search engine criteria and therefore also rank high on the first page. What is needed is to get these too common and often irrelevant pages out of the way and let other potentially more relevant and more interesting sites to surface. For instance, all government websites may be identified to appear on a .gov search result page. The page could be accessed by means of a separate high level tab or clickable text, typing text, button or box, sign, or other access portal. Similarly, education (.edu), organizations (.org), large retailers (for example .bigretail, .box, .bigbox, or other), and other distinct information sources could and should be identified for alternative reporting. Each domain extension could be listed along on its own Internet search result page, or combined by some reasonable relationship such as .gov and .edu, or all identified domain extensions combined on one additional search results page, or any combination of single or multiple criteria additional search result pages. Again, disclosed and claimed is the use of domain extensions as a search criteria. Disclosed and claimed is the use of domain extensions to separate, sort, parse, or otherwise disposition sites having identified domain extension as a group within an internet search result page, to an additional search results page specific to a domain extension, an additional search result page containing all sites identified by a set of domain extensions, or any combination of a single or multiple domain extension containing additional internet search result pages. Further disclosed and claimed is that the disposition of sites of identified domain extensions may occur as a part of the search command and returned results automatically separated to said page or pages, or the results of domain extension identified for separation may be separated by subsequent action whether that is another search command, parse command, drag and drop to a page, clicking on some page choice associated with each internet search result site followed by a command, or by other method.

Although previously defined, throughout the below discussion focused on internet search results, yet also applicable to the previous discussion about internet search criteria, as well as the totality of disclosures in this disclosure document, and any of their combinations, the following discussion is applicable. The keyword field may accept any character, symbol, number, domain extension, by direct or indirect means, by interface or remotely by a physical tethered or by wireless untethered connection, and any of their combinations. Further when referring to input fields be it the keyword input field or other type of input fields as elsewhere herein defined, the keyword, Content User keyword, and Content User Domain Extension may be the same input field, separate input fields, or any of their combinations. The keyword field may be a keyword field, drop down list, radio button, scrolls, or other direct and indirect inputs, and as elsewhere defined, and any of their combinations.

It is important to acknowledge that throughout the below discussion focused on internet search results, yet also applicable to the previous discussion about internet search criteria, as well as the totality of disclosures in this disclosure document, and any of their combinations, that where applicable, one disclosure, innovation, adaptation may be applied to any of the specific disclosures. This application has taken an exhaustive approach to show variations to be explicit, but not to be used as limitations. Features of one specific disclosure may be included in another or removed as to the preference of the Content Manager or designer of the Semi-Simple Search Interface or Semi-Simple Results page with search features and results manipulation features. As previously disclosed the primary keyword input field may also treat keywords inclusive or exclusive in what is reported as search results. Further, the keywords from the primary and additional input fields may also be used as criteria not just for search purposes, but for internet search results presentation, parsing, and organization. It is a primary purpose of the Content Manager Pre-Set domain extensions to be used for internet search result presentation, parsing, and organizing. Although not shown, it is well within this disclosure that the Content Manager Pre-Set domain extensions may also be given the options of being inclusive or exclusive as to what is included in search results, being treated as a search criteria or not, being used as only a search results presentation and parsing criteria or also search criteria, being given Content User interaction and control, and any of their full or partial present or absent combinations. Again, Content Manager Pre-Set domain extensions, and that is such Content Manager Pre-Set domain extensions may be made know, made available for deactivation or activation, or other action, or not made know and not made available for Content User interaction and manipulation. This discussed variability of keyword and domain extensions applies to any keyword input and domain extension input field as well as to any keyword or domain extension. Again a keyword may also be a domain extension, and for that matter a domain extension may be a keyword, but for clarity a keyword will be considered no to contain the .(dot) format of the domain extensions. What is stated is that the domain extension may act as a keyword. What is also stated is that the keyword may be used for parsing internet search results into grouped page strings or separate page strings. The primary concept is that the Content Manager may interject pre-set domain extension criteria. It is a given that the Content User defined domain extensions may be used for any internet search, retrieval, and results presentation purposes and any of their combinations. Some criteria are shown separately simply to reinforce the separate search criteria input fields and nature of the criteria, but this is for discussion purposes only where the search criteria may be processed at any stage sequentially, simultaneously, combined, separated, any other manner, and any of their combinations. Any of the criteria may be used for searching, retrieval, and search results presentation all on a main page string, some or all divided into group page strings, or some or all place on separate page strings, or any full or partial present or absent combination. The primary keywords, additional keywords, and Content User and Content Manager defined domain extensions just discussed may be explicitly represented in various disclosures of this document, but regardless these are potential features of all disclosures as each disclosure is but one example of other possibilities within the scope of the respective disclosure.

By only reinforcement, but explicitly and implicitly implied throughout the totality of this disclosure is the interweaving of all applicable disclosures one into another as choose to be associated. For example, immediately previously discussion have focused on the Semi-Simple Search Interface for more internet search control and accuracy. Woven within that discussion is the inclusion of domain extensions, the use of biographical information, the concept of a Semi-Simple interface, and other content of this disclosure. Other examples related to the following discussions about internet search result presentation, parsing, and organization. That is although not explicitly stated within each figure's detailed discussion, but explicitly stated here and implicitly implied and within the scope of the totality of this disclosure is the incorporation of the Semi-Simple interface for the search results page, use of biographical or performance data to influence internet search results parsing, and incorporation of other specific disclosure, and any of their combinations. The innovations presented in this total disclosure may be explicitly or implicitly applicable one within another specific disclosure.

The discussion that follows focuses on internet search results and presenting them to the Content User on a main page string with no differentiation among criteria, parsed on to grouped page strings with two or more criteria of keywords or domain extensions, parsed onto separate page string of one criteria of a keyword or domain extension, or any of their full or partial present or absent combinations. Any means and any location as to how these combined page string internet search results, parsed page string internet search results, and any of their combinations are encompassed by any specific disclosure example or the totality of this disclosure document. Meaning, that a main page string, combined page string, separate page strings, or any of their combinations may be presented as tabs, button, windows, dropdowns, checkboxes, links, pages, scrolls, lists, input fields, panels, images, and other currently used and not yet known, and any of their combinations. Often shown in the following figures is the use of a tab or button on the Semi-Simple Search Interface in a results return section. However, this is just a choice and access to the main page string if not just the first list of finding on the primary results return page string, grouped page strings, and separate page strings as other choices could be new webpages or other forms of access as listed. What is disclosed is simply one of many examples of how results can be represented and accessed on the figures that follow.

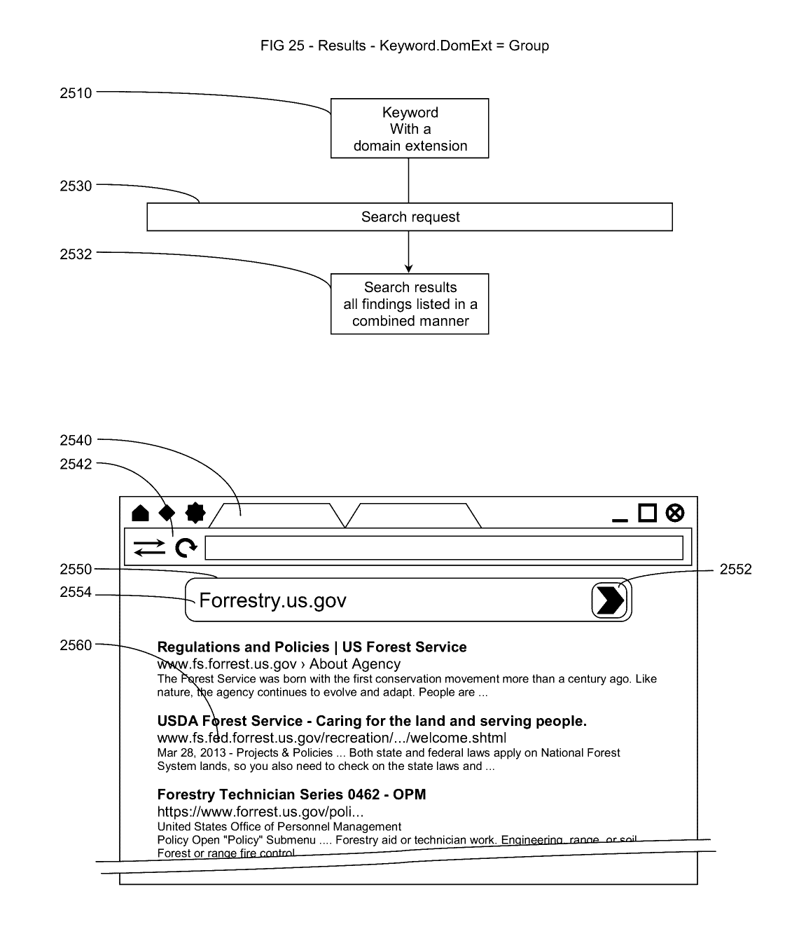

FIG. 25—Results—KW.User DExt=Main (Same Input Field)

FIG. 25 is an example, and not limited to this example, of a Semi-Simple Search interface containing a keyword.domain extension or keyword.(dot)domain extension. Shown is a method in the form of a flow chart for searching the internet by a keyword.domain extension and an illustration representing the Semi-Simple Search Interface and with post-search retrieved results. Adding a keyword to the use of a domain extension as the search criteria brings added specificity to the search criteria, search location, search retrieval, and search results presentation.

FIG. 25 discloses incorporating the use of a keyword merged with a domain extension 2510, such as keyword.domain for search criteria and results display criteria. The search request 2530 then returns relevant internet search results and displays them in a combine single results page string 2532. This search may be narrow with the specificity of a keyword with a domain extension, but the concept is a method of domain extension inclusion in a search criteria. As the .(dot)domain extension is expected to cast a very broad search request across multiple topics, the keyword.domain extension or keyword.(dot)domain extension is likely to cast a very narrow search result. That is it would be expected that the search results would only return results that matched keyword.(dot)domain extension exactly or a near derivative. The method includes using a keyword with domain extension or keyword.(dot)domain 1610, followed by the search request 1630, producing search results 1632. As stated the search results will be influenced in this case from a combination of the keyword and the domain.

The system apparatus of FIG. 16 by way of example and not limited to this example, an illustration of how a keyword with a domain extension might be used in a search and with retrieved search results. As a reference, the illustration shows an active webpage tab 2540 with general search engine functions and URL bar 2512 as common elements among search engines. Also universal among search engines is the simple search field 2550 and search request button 2552 Disclosed in the inclusion of the combination keyword and domain extension 2554 or keyword.domain extension or also for clarity keyword.(dot)domain extension. In this case the specific example, but no a limiting example, is keyword.gov. Upon selection of the search request field 1652 the search will be conducted based upon the Content User given internet search criteria of a keyword and domain extension. This example shows one keyword.domain extension search criteria, but there may be more than one keyword.domain extensions criteria used at once. Represented as retrieved search results 2560 is a list of items showing the forest.us.gov keyword and domain extensions. As there is no further specificity than the keyword.domain extension, the search results are expected to be published on the main page sting as represented in the illustration. It is possible by the addition of biographical, performance, demographic, etc. data associated with domain extensions that the results could be parsed and placed onto other grouped or separate pages strings for improved results utility.

Whether results returned are narrow and limited or retain a broader character is a matter of internet content and search engine protocols. Disclosed here is the use of a keyword.domain combination for search criteria, search result presentation, and any of their combinations.

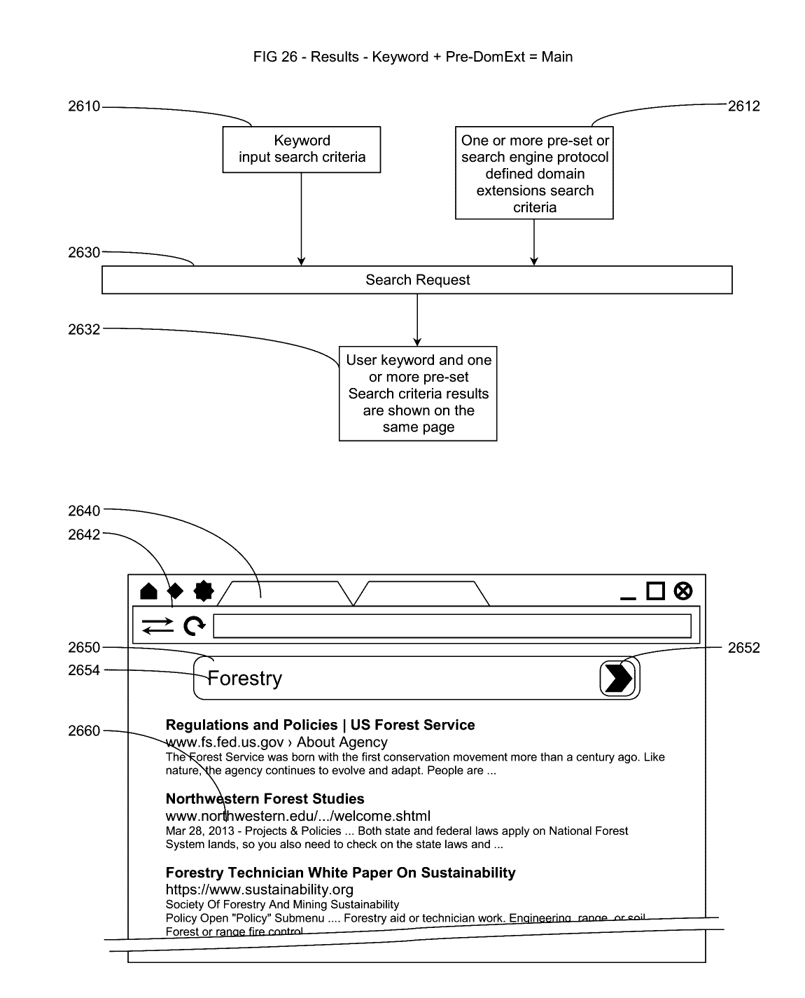

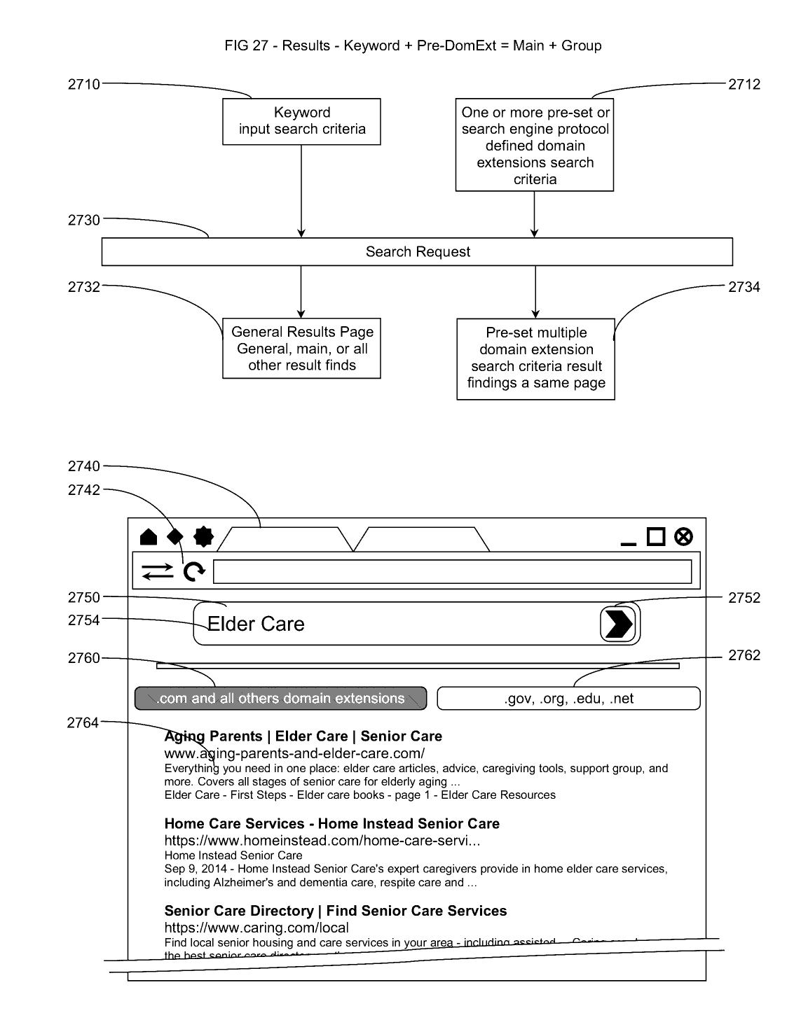

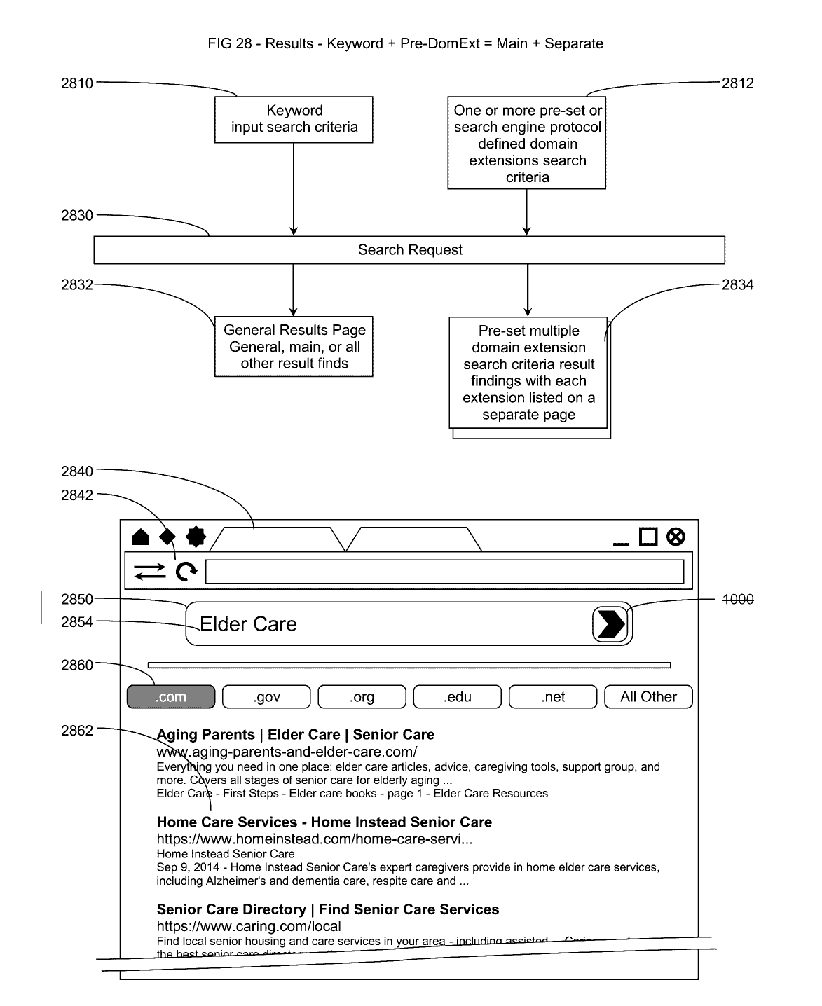

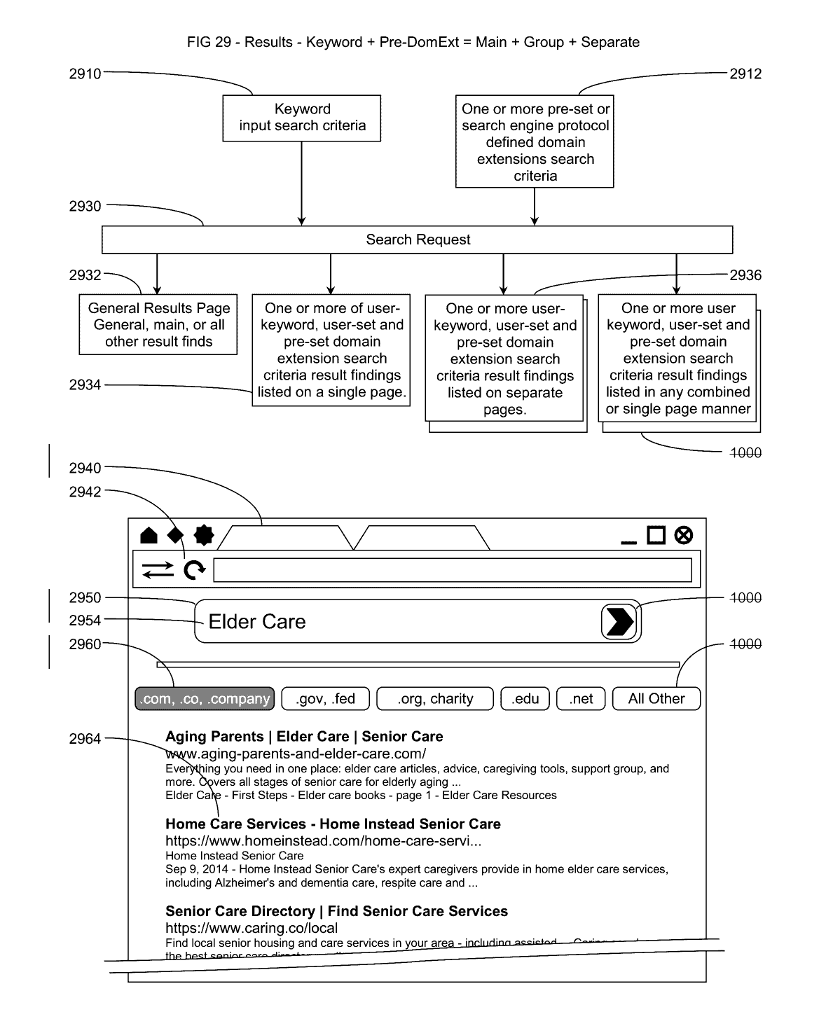

FIG. 26, FIG. 27, FIG. 28, and FIG. 29 show common elements of a Semi-Simple Search interface with two search criteria inputs. The search interface provides a simple Content User defined keyword input field and a Content Manager defined Pre-Set Domain Extension.

The search criteria of the Content User Keyword input criteria is undoubtedly known to the Content User to direct the internet search. The Content Manager determined Pre-Set Domain Extension choices also direct the internet search and may be known or unknown to the Content User. The Content Manager Pre-Set Domain Extension may be one, two, a few, or many domain extensions identified and used simultaneously, sequentially, or any of their combination for the purpose of search criteria or results distribution criteria. Domain extensions known to the Content User may be represented by a list or display of any sort visible to the Content User showing all, most important, or some domain extensions before, after, or at anytime through the use of the Semi-Simple Search engine interface and results pages and screens. Unknown Content Manager Domain Extension search input and search result distribution criteria may not be shown to the Content User, except that search results may be sorted, parsed, or otherwise distributed and any of their combinations to a single domain extension search result page string, grouped domain extension search result page string, or any of their combination. As a result of the distribution of search results it may be evident to the Content User of one, some, or all of the Pre-Set Domain Extension criteria being used by the Content Manager. The results of the simple Content User Keyword input field and the Content Manager Pre-Set Domain Extension search criteria is a Semi-Simple Search defined by two input criteria. Further, what is disclosed here and herein throughout this disclosure is only by way of example and not intended to be a limitation, for instance and for brevity the Semi-Simple Search interface may include a main keyword input field, one or more additional keyword input fields, one or more Content Manager Pre-Set Domain Extension criteria, and one or more additional Content User Domain Extension input fields, and any of their combinations to define the desired search criteria. Where appropriate these search criteria input fields may be used to organize and distribute internet search results within a search result page string, in search result page strings with grouped criteria, in search results page strings of separate and individual criteria, or any of their combinations.

The search results from the Content User Keyword and Content Manager Pre-Set Domain Extension search criteria will be parsed by either the keyword input criteria or domain extension input criteria. Exemplified here is the embodiment of the search results being formatted by all results from all keyword and domain extensions being combined in a main search result page string, formatted by groups of domain extension search results page strings, separate domain extension search results page strings, and any combination of these search results distribution formats. The result of separating internet search results is the Content User's increased access to more, more organized, and more understandable ever increasing internet content. By way of example, knowing that the many government or .gov related content is located in one particular page string easily guides the Content User to internet search result sites that are authoritative with regard to regulations, policies, consumer protections and safety, and more. This is now immediately separated from commercial internet content that may seek to mimic, seek to be government-like authoritative, or other like intent. The same can be said for a .org search results page string that separates out organization with less commercial interest and more social goodwill, education, support, and other non-profit type principles. Further the same could be said for separating out educational institutions, research articles, large corporate entities, small corporate entities, individual, or other distinguishing characteristics of internet search results that are now simply grouped together that lacks clarity and hides valued potential search results. As displayed search results may be separated as described or grouped by any combination.

The following four figures provide specific examples of the Content User Keyword input search criteria and Content Manager Pre-Set Domain Extension search criteria.

FIG. 26—Results—KW+PreS DExt=Main

FIG. 26 is an example, and not limited to this example, and incorporates all relevant disclosure herein, of a Semi-Simple Search Screen Interface including: (1) a primary keyword input field for one or more keywords, (2) one or more Content Manager defined domain extensions, and (3) any of their combinations as previously more specifically defined. This disclosure specifically addresses solutions incorporating internet search result formats using: (1) a main page string as previously more specifically defined. The combination of the features of the Semi-Simple Search Interface and the more organized internet search result formats is a more Content User control, more accurate search results, and more effective results. The focus of this disclosure is the primary keyword input field with Content Manager Pre-Set domain extensions with results reported on the main page string.

Disclosed in this method is a primary keyword search criteria input field 2610 for one or more keywords, one or more Content Manager Pre-Set domain extensions 2612 and any of their full or partial present or absent combinations. Alterations and variations in contribution of the primary keyword input field and keywords and Content Manager Pre-Set domain extensions has been previously addressed. With Content User defined one or more keywords in a primary input field, the presence of Content Manager Pre-Set domain extensions, and any of their full or partial present or absent combinations the search request 2630 may follow and internet search results returned. A main page string 2632 of internet search results is populated with all internet search results from all search criteria.

The system apparatus is shown, and as a reference the illustration shows an active webpage tab 2640 with general search engine functions and URL bar 2642 as common elements among search engines. Also universal among search engines is the simple search field 2650 and search request button 2652. Shown in this disclosure is the presence of a Content User defined single keyword 2654. When referring to a webpage tab to access a page string this tab could be any means of access to a page string such as by example, but not limited to the following: a tab, button, just a word in a field, checkboxes, radio buttons, new independent page strings, parent-child or directory dependent page strings, any clickable image or entity, a scroll, windows, screens, a look up, dropdown, file and directory system, other like methods, and any of their combinations. There could be one main page to any combination of main page string, grouped page strings, separate individual page strings of a low number to a large number of separations. A word as discussed above could be any set of characters, numbers, symbols, and any of their combinations.

Shown are internet search results listed in the main page string 2660. Further shown in this specific disclosure is that regardless of Content Manager Pre-Set domain extensions, all search results are displayed in the same main page string listing 2660. It is reinforced that the primary keyword input field may accept any set of characters, numbers, symbols, and their combinations to include the formation of a domain extension. Further Content Manager Pre-Set domain extensions may be a standard or somewhat more fixed set across any search criteria, such as .gov, .org, others, and any of their combinations. This more fixed set may change at any frequency by the Content Manager or influenced by search criteria. Additionally content Manager Pre-Set domain extensions may be more dynamically selected from any existing domain extension, TLDs, gTLDs, or other designators based upon search criteria so that search results are sorted in more rational page strings and tabs, expectedly but not necessary, to be even more relevant, effective, and useful for the Content Manager. Content Manager Pre-Set domain extensions for search, retrieval, and results organization may be any combination of domain extensions, designators, TLDs, gTLDs, other designators of any property of standard, fixed, somewhat fixed, dynamic, directly connected to search criteria, indirectly connected to search criteria, and any of their combinations. This establishment of the Content Manager Pre-Set domain extensions applies to all general and specific disclosures herein.

This disclosure expresses the principle of a Content User defined keyword with Content Manager Pre-Set defined domain extensions. The purpose of the Semi-Simple Search Interface is not to limit search capability, such that the Content Manager Pre-Set defined domain extensions would limit what is displayed as search results or limit the scope of the search. What is disclosed is there are various reasons and uses of the Content Manager Pre-Set domain extensions in this specific disclosure and additional Content User keywords and domain extensions in other specific disclosures. In this case, one such application is separating search results within the main page string by domain extensions with or without a table of contents. A form of this organization may be two pages of .com, two pages of .gov, two pages or .edu, and so on. The disclosure of two pages is arbitrary and may be one, two, three, or more pages per domain extension with the more pages being feasible with a table of contents that could be clicked and moved to each domain extension section. This disclosure provides for a more Content User controlled internet experience and more effective internet search result experience.

FIG. 27—Results—KW+PreS DExt=Main+Group

FIG. 27 is an example, and not limited to this example, incorporates all relevant disclosure herein, of a Semi-Simple Search Screen Interface including: (1) a primary keyword input field for one or more keywords, (2) one or more Content Manager defined domain extensions, and (3) any of their combinations as previously more specifically defined. This disclosure specifically addresses solutions incorporating internet search result formats using: (1) a main page string and (2) grouped page strings, and (3) any of their combinations as previously more specifically defined. The combination of the features of the Semi-Simple Search Interface and the more organized internet search result formats is a more Content User control, more accurate search results, and more effective results. This disclosure differs from the previous by the inclusion of parsing internet search results on a main page string and grouped page strings.

Disclosed in this method is a primary keyword search criteria input field 2710 for one or more keywords, one or more Content Manager Pre-Set domain extensions 2712 and any of their full or partial present or absent combinations. Alterations and variations in contribution of the primary keyword input field and keywords and Content Manager Pre-Set domain extensions has been previously addressed. With Content User defined one or more keywords in a primary input field, the presence of Content Manager Pre-Set domain extensions, and any of their full or partial present or absent combinations the search request 2730 may follow and internet search results returned. A main page string 2732 of internet search results is populated with, all, some, left over, odd, outlier, or other results not categorized by other criteria, and any of their combinations. It is possible that there may not be a main page string of results at all, but whether there is or is not is within the scope of this and other disclosures herein. A grouped page string 2734 directs that any combination of two or more criteria from any keyword or domain extension are listed on a single page string creating one or more grouped page strings. Further included within the scope of this disclosure is any form of combination of a main page string and grouped page strings of search results presentation, parsing, and organizing.

The system apparatus is shown, and as a reference the illustration shows an active webpage tab 2740 with general search engine functions and URL bar 2742 as common elements among search engines. Also universal among search engines is the simple search field 2750 and search request button 2752. Shown also is the Content User defined two keyword phrase 2754 written in an inclusive form to return search results.

More specific to the return of the internet search results disclosed in this figure is the presence of two groups of page strings. In this disclosure the keywords bring forward search results that are parsed by Content Manager Pre-Set defined domain extensions. One grouped page string is a type of main page string that includes all .com and all other domain extension not otherwise included in the second page string 2760. This is a type of main or catch-all grouped page string. The second grouped page string shows it is composed of four domain extensions of .gov, .org, .edu, and .net 2762. Shown is that the .com and all other domain extensions 2760 is highlighted or selected and as such the associated internet search results item listing 2764 is shown. The result is a more effective search with one or more additional search criteria input and more utility and clarity with a separation of internet search results by largely commercial and non-commercial internet listings. This specific choice of separation is just an example, but not intended to be a limiting example as group among a main page and one or more grouped pages may take various forms.

It is apparent how the Semi-Simple Search Interface and related search results interface now become much more effective and useful for the Content User. Made available is the ability to quickly seek results specifically associated with their search request by topic in this case identified by the Content Manager Pre-Set domain extensions. This disclosure provides for a more Content User controlled internet experience and more effective internet search result experience.

FIG. 28—Results—KW+PreS DExt=Main+Separate

FIG. 28 is an example, and not limited to this example, and incorporates all relevant disclosure herein, of a Semi-Simple Search Screen Interface including: (1) a primary keyword input field for one or more keywords, (2) one or more Content Manager defined domain extensions, and (3) any of their combinations as previously more specifically defined. This disclosure specifically addresses solutions incorporating internet search result formats using: (1) a main page string, (2) separate page strings, and (3) any of their combinations as previously more specifically defined. The combination of the features of the Semi-Simple Search Interface and the more organized internet search result formats is a more Content User control, more accurate search results, and more effective results. This disclosure differs from the previous by the inclusion of parsing internet search results on a main page string and separated page strings.

Disclosed in this method is a primary keyword search criteria input field 2810 for one or more keywords, one or more Content Manager Pre-Set domain extensions 2812 and any of their full or partial present or absent combinations. Alterations and variations in contribution of the primary keyword input field and keywords and Content Manager Pre-Set domain extensions has been previously addressed. With Content User defined one or more keywords in a primary input field, the presence of Content Manager Pre-Set domain extensions, and any of their full or partial present or absent combinations the search request 2830 may follow and internet search results returned. A main page string 2832 of internet search results is populated with, all, some, left over, odd, outlier, or other results not categorized by other criteria, and any of their combinations. It is possible that there may not be a main page string of results at all, but whether there is or is not is within the scope of this and other disclosures herein. One or more separate page strings 2834 is disclosed to occur for any one criteria parsed onto their own separate page string as identified for a particular keyword or domain extension from any source. Further included within the scope of this disclosure is any form of combination of a main page string and separate page strings of search results presentation, parsing, and organizing.

The system apparatus is shown, and as a reference the illustration shows an active webpage tab 2840 with general search engine functions and URL bar 2842 as common elements among search engines. Also universal among search engines is the simple search field 2850 and search request button 2852. Shown also is the Content User defined two keyword phrase 2854 written in an inclusive form to return search results. These mentioned fields are just one example of how a Content Manager may choose to build their Semi-Simple Search interface for the original search interface or as in this case returned with search results on the page string.

More specific to the return of the internet search results disclosed in this figure is the presence of two keywords with resulting internet search results items listings parsed across multiple separate page strings plus a main page string containing all search results not parsed onto the separate page strings. Noticed is that the search criteria 2854 and Semi-Simple Search Interface do not specify a domain extensions, but search results are shown to be separated on a .com, .gov, .org, .edu, and .net page strings 2860 and including a catch all main page string. As such, it is concluded that the Content Manager Pre-Set domain extensions include .com, .gov, .org, .edu, and .net. Shown is the selection of the .com separated page string 2860 and associated internet search results items listing 2862.

Internet search results items listings parsed among separate page strings are sensed as equivalent by the Content User. This occurs as the Content User is provided better clarity as to which tab and page string would contain the information of interest to them. For instance, to a Content User searching for Elder Care a .gov page string may be the most important to them for government opinion, benefits, or programs. Similarly a Content User may see content for them equally important contained in .org, .edu, or other domain extensions. As such the content is equivalent, the first pages are equivalently important, and the first and first few page positions on each separated page string are also equivalent. All of these features represent increased specificity, accuracy, utility, and clarity from the ever increasing internet in capability and content. This disclosure provides for a more Content User controlled internet experience and more effective internet search result experience.

FIG. 29—Results—KW+PreS DExt=Main+Group+Separate

FIG. 29 is an example, and not limited to this example, and incorporates all relevant disclosure herein, of a Semi-Simple Search Screen Interface including: (1) a primary keyword input field for one or more keywords, (2) one or more Content Manager defined domain extensions, and (3) any of their combinations as previously more specifically defined. This disclosure specifically addresses solutions incorporating internet search result formats using: (1) a main page string, (2) grouped page strings, (3) separate page strings, and (4) any of their combinations as previously more specifically defined. The combination of the features of the Semi-Simple Search Interface and the more organized internet search result formats is a more Content User control, more accurate search results, and more effective results. This disclosure differs from the previous by the inclusion of parsing internet search results on a main page string, and both grouped page strings and separated page strings.

Disclosed in this method is a primary keyword search criteria input field 2910 for one or more keywords, one or more Content Manager Pre-Set domain extensions 2912 and any of their full or partial present or absent combinations. Alterations and variations in contribution of the primary keyword input field and keywords and Content Manager Pre-Set domain extensions has been previously addressed. With Content User defined one or more keywords in a primary input field, the presence of Content Manager Pre-Set domain extensions, and any of their full or partial present or absent combinations the search request 2930 may follow and internet search results returned. A main page string 2932 of internet search results is populated with, all, some, left over, odd, outlier, or other results not categorized by other criteria, and any of their combinations. It is possible that there may not be a main page string of results at all, but whether there is or is not is within the scope of this and other disclosures herein. One or more grouped page string 2934 stating that any combination of two or more criteria from any keyword or domain extension are listed on a single page string creating one or more grouped page strings. One or more separate page string 2936 is disclosed to occur for any one criteria parsed onto their own separate page string as identified for a particular keyword or domain extension from any source. A further reinforcement that any combination of grouped or separate page string formats 2938 may occur as designated by one or more Content User keywords and Content Manager Pre-Set domain extensions, and any of their combinations. 2934, 2936, and 2938 show a full inclusion of Content User-Set and Content Manager Pre-Set options, but in this disclosure only the Content Manager Pre-Set features are active. Presented is the availability of user-set options, but Further included within the scope of this disclosure is any form of combination of a main page string, grouped page strings, and separate page strings of search results presentation, parsing, and organizing.

The system apparatus is shown, and as a reference the illustration shows an active webpage tab 2940 with general search engine functions and URL bar 2942 as common elements among search engines. Also universal among search engines is the simple search field 2950 and search request button 2952. Shown is the inclusion of Content User defined keywords in an inclusive form. Shown also is the Content User defined two keyword phrase 2954 written in an inclusive form to return search results. As previously defined a keyword is any set of characters, numbers, and symbols to include the formation of a domain extension.

More specific to the return of the internet search results disclosed in this figure is the presence of the search results from the two keyword phrase search criteria being separated and parsed among grouped page strings 2960 with more than one domain extension associated on the page string, single domain extensions separated on a single page strings 2960, and a main or catch all page string 2962. As the Semi-Simple Search Interface did not offer domain extension the parsing into domain extension is based on page strings as a result of Content Manager Pre-Set domain extensions and associations. Content Manager Pre-Set domain extensions may exist whether or not there are Content User options to interface with these or other domain extensions. Another instructive disclosure unmarked is the inclusion of general results returned under the main page string button or tab called All Others and contains all other search results not included on other page strings or not under another tab. Specifically shown is the association into a grouped page string of commercial based domain extensions 2960 with .com, .co, and .company. 2960 also shows a government grouped page string with .gov and .fed, a non-profit grouped page string with .org and the keyword charity, a single domain extension of .edu on a separate page string, as well as .net associated finding on a separate page string. Again, also follows in the collection of all other search results under the main page string or All Other pages string 2962. Specifically shown is the selection of the .com, .co. and .company grouped page string tab and associated internet search results items listing 2964.

It is apparent how the Semi-Simple Search Interface and related search results interface becomes much more effective and useful for the Content User. This disclosure provides for a more Content User controlled internet experience and more effective internet search result experience.

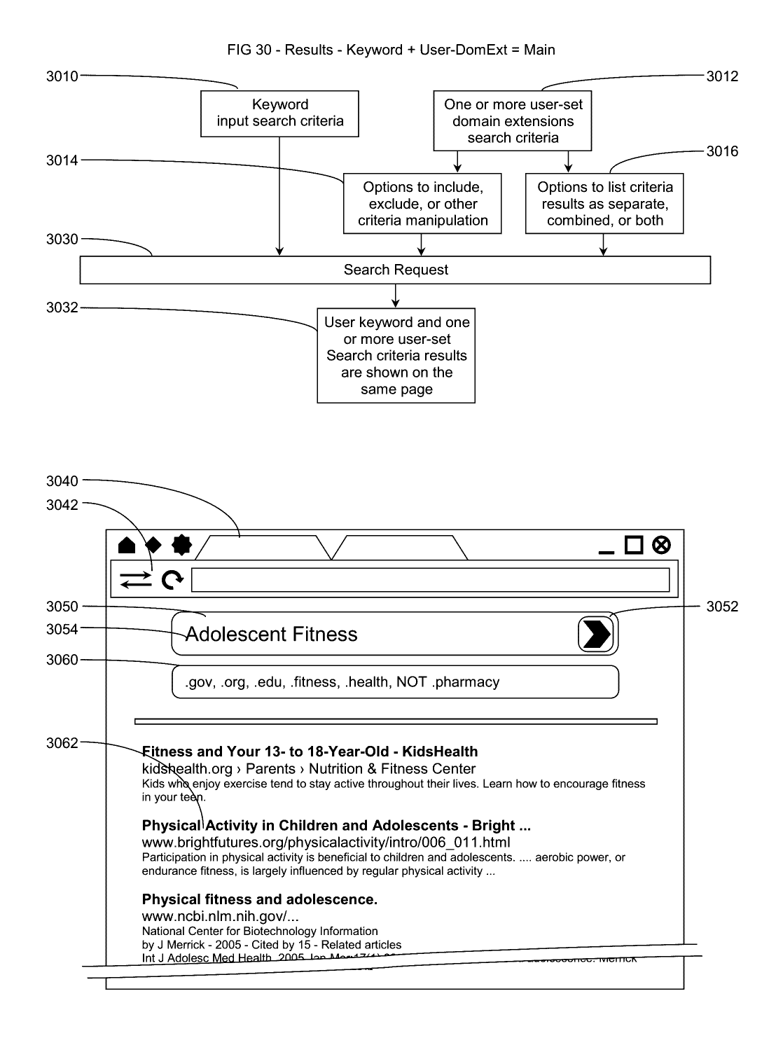

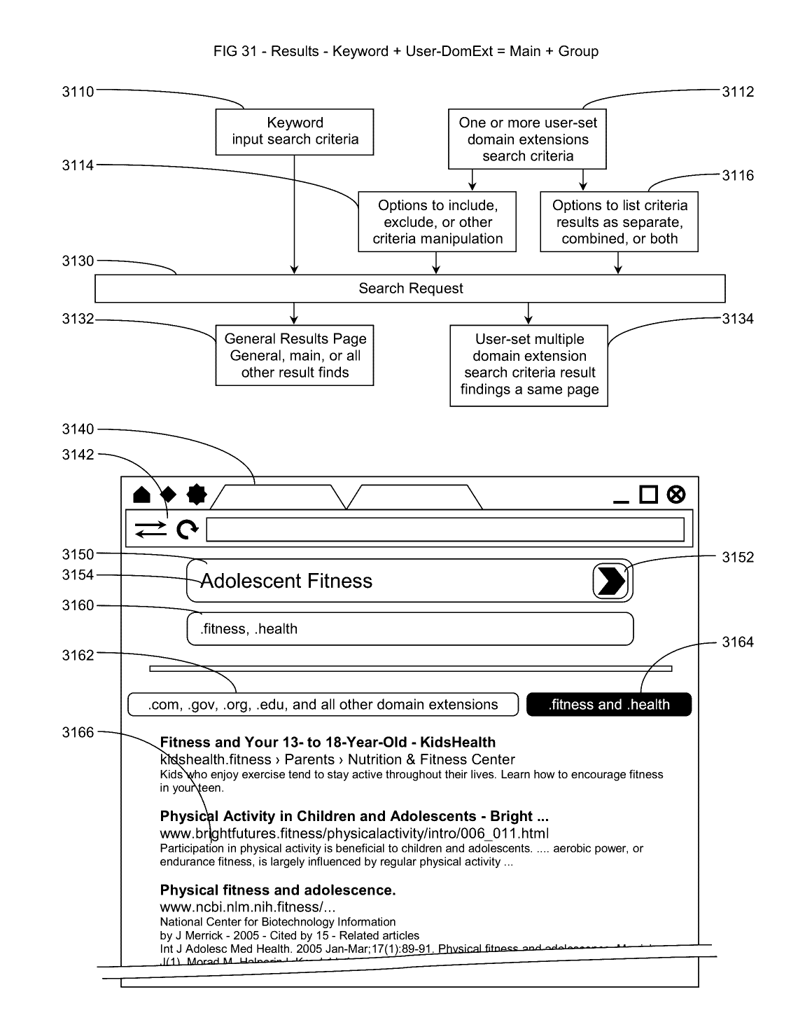

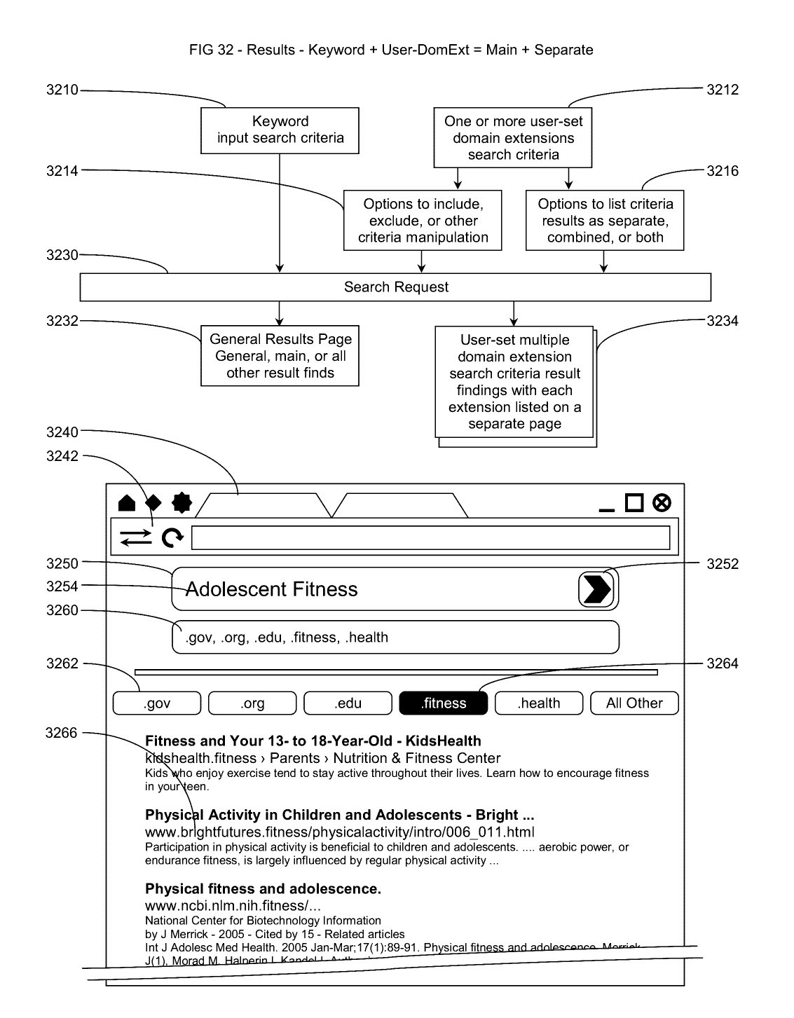

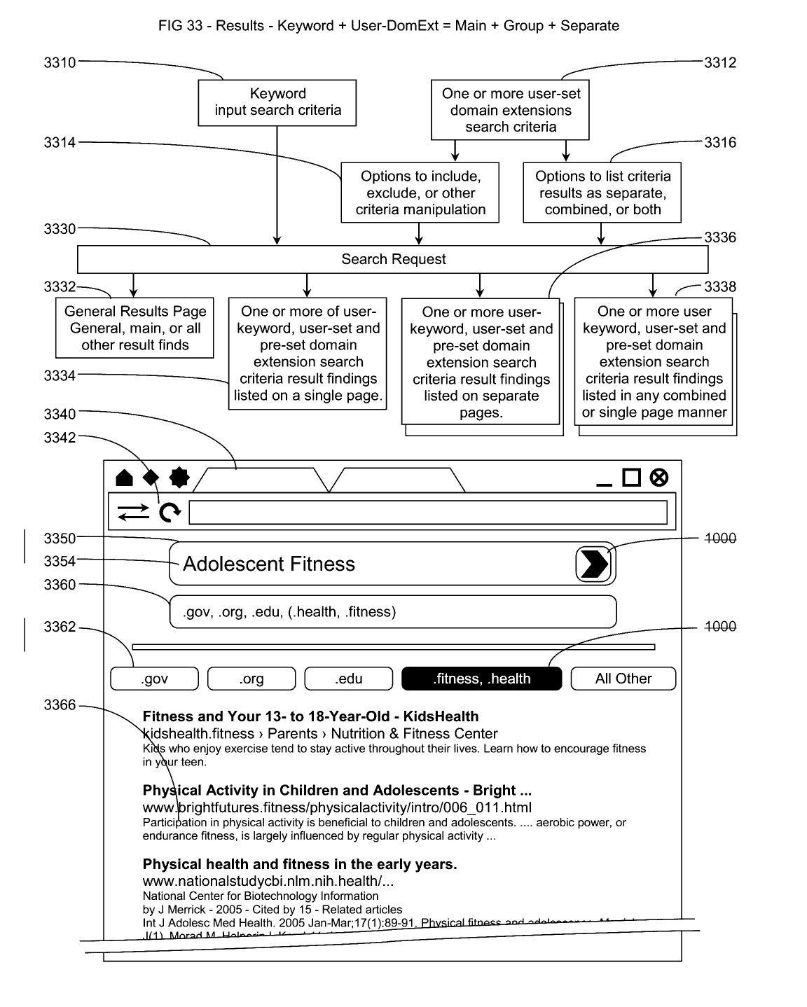

FIG. 30, FIG. 31, FIG. 32, and FIG. 33 show common elements of a Semi-Simple Search interface with two search criteria inputs. The search interface provides a simple Content User defined keyword input field and a Content User defined Domain Extension.

The search criteria of the Content User Keyword input criteria is undoubtedly known to the Content User to direct the internet search. The Content User determined Domain Extension choices also direct the internet search and in this case are defined by the Content User to meet their specific interests. The Content User Domain Extension may be one, two, a few, or many domain extensions identified and used simultaneously, sequentially, or any of their combination for the purpose of search criteria or results distribution criteria. In the following disclosure all domain extensions are known and defined by the Content User may be represented by a list or display of any sort visible to the Content User showing all, most important, or some domain extensions before, after, or at anytime through the use of the Semi-Simple Search engine interface and results pages and screens. A form of this disclosure may also hide away one, some, or all Content User Domain Extension search input and search result distribution criteria may not be shown to the Content User, except that search results may be sorted, parsed, or otherwise distributed and any of their combinations to a single domain extension search result page string, grouped domain extension search result page string, or any of their combination. This may be done to form a simplification of search result presentation, in such a case as the Content User added many domain extensions or more domain extensions than can be clearly reported or beyond available internet search result pages string locations or slots for presentation, if such a limitation exists as all. As a result of the distribution of search results it may be evident to the Content User of one, some, or all of the Content User Domain Extension criteria being used by the Content User and then managed by the Content Manager. The results of the simple Content User Keyword input field and the Content User Domain Extension search criteria is a Semi-Simple Search defined by two input criteria in one or more input fields.

The search results from the Content User Keyword and Content User Domain Extension search criteria will be parsed by either the keyword input criteria or domain extension input criteria. Exemplified here is the embodiment of the search results being formatted by all results from all keyword and domain extensions being combined in a main search result page string, formatted by groups of domain extension search results page strings, separate domain extension search results page strings, and any combination of these search results distribution formats. The result of separating internet search results is the Content User's increased access to more, more organized, and more understandable ever increasing internet content. By way of example, knowing that the many government or .gov related content is located in one particular page string easily guides the Content User to internet search result sites that are authoritative with regard to regulations, policies, consumer protections and safety, and more. This is now immediately separated from commercial internet content that may seek to mimic, seek to be government-like authoritative, or other like intent. The same can be said for a .org search results page string that separates out organization with less commercial interest and more social goodwill, education, support, and other non-profit type principles. Further the same could be said for separating out educational institutions, research articles, large corporate entities, small corporate entities, individual, or other distinguishing characteristics of internet search results that are now simply grouped together that lacks clarity and hides valued potential search results. As displayed search results may be separated as described or grouped by any combination.

The following four figures provide specific examples of the Content User Keyword input search criteria and Content User Domain Extension search criteria.

FIG. 30—Results—KW+User DExt=Main

FIG. 30 is an example, and not limited to this example, and incorporates all relevant disclosure herein, of a Semi-Simple Search Screen Interface including: (1) a primary keyword input field for one or more keywords, (2) one or more additional Content User defined domain extension input fields for one or more domain extensions, (3) any of their combinations as previously more specifically defined. This disclosure specifically addresses solutions incorporating internet search result formats using: (1) a main page string as previously more specifically defined. The combination of the features of the Semi-Simple Search Interface and the more organized internet search result formats is a more Content User control, more accurate search results, and more effective results. This disclosure differs from the previous by the removal of the Content Manager Pre-Set domain extensions and inclusion of Content User defined domain extensions with results reported on the main page string.

Disclosed in this method is a primary keyword search criteria input field 3010 for one or more keywords, one or more Content User defined domain extensions specific input fields 3012 for one or more domain extensions, and any of their full or partial present or absent combinations. The fact that there are specific Content User domain extension input fields is simply an example of the type of input fields available, but domain extensions are not limited from being added to other fields. The application of the indicated inputs shows that the primary keyword has a direct relationship on the internet search and search results formatting, that the one or more Content User defined domain extensions have the option for being included or excluded 3014 from internet search results as well as being used to parse internet search results to the main page string 3016. Alterations and variations in contribution of the primary keyword input field and keywords and Content User defined domain extensions has been previously addressed. With Content User defined one or more keywords in a primary input field and one or more Content User defined domain extension criteria, and any of their full or partial present or absent combinations the search request 3030 may follow and internet search results returned. A main page string 3032 of internet search results is populated with all internet search results from all search criteria.

The system apparatus is shown, and as a reference the illustration shows an active webpage tab 3040 with general search engine functions and URL bar 3042 as common elements among search engines. Also universal among search engines is the simple search field 3050 and search request button 3052. Shown also is two keywords in the primary keyword input field 3054, both in inclusive or results returning format. Further disclosed on the Semi-Simple Search Interface and in this case a Semi-Simple Search interface on the internet search results page is the presence of a one or more multiple keyword input fields 3060 shown in this case to contain multiple Content User domain extensions. The use of one or more additional keyword type input field is just one example of how a Content Manager may choose to build their Semi-Simple Search interface for the original search interface or as in this case returned with search results. In this specific disclosure the keywords in the primary keyword input field and the domain extensions in the one or more additional input field are inclusive to provide search results. An exception is that NOT .(dot)pharmacy in the one or more additional input fields 3060 is not inclusive or shows that .pharmacy associated results will not be returned with search results. Further although on the page string method 3016 indicate the ability to parse results by domain extension, in this particular disclosure the internet search results items listings are combined on the main page string 3062.

It is apparent how the Semi-Simple Search Interface and related search results interface now become much more effective and useful for the Content User. This disclosure provides for a more Content User controlled internet experience and more effective internet search result experience.

FIG. 31—Results—KW+User DExt=Main+Group

FIG. 31 is an example, and not limited to this example, and incorporates all relevant disclosure herein, of a Semi-Simple Search Screen Interface including: (1) a primary keyword input field for one or more keywords, (2) one or more additional Content User defined domain extension input fields for one or more domain extensions, (3) any of their combinations as previously more specifically defined. This disclosure specifically addresses solutions incorporating internet search result formats using: (1) a main page string and (2) grouped page strings, and (3) any of their combinations as previously more specifically defined. The combination of the features of the Semi-Simple Search Interface and the more organized internet search result formats is a more Content User control, more accurate search results, and more effective results. This disclosure differs from the previous by the inclusion of parsing internet search results on a main page string and grouped page strings.

Disclosed in this method is a primary keyword search criteria input field 3110 for one or more keywords, one or more Content User defined domain extensions specific input fields 3112 for one or more domain extensions, and any of their full or partial present or absent combinations. The fact that there are specific Content User domain extension input fields is simply an example of the type of input fields available, but domain extensions are not limited from being added to other fields. A specific feature of this disclosure that is a relevant possibility to any of the disclosures within this document's many disclosures is the ability to have inclusive or exclusive search criteria 3114. The application of the indicated inputs is shown that the primary keyword has a direct relationship on the internet search, that the one or more Content User defined domain extensions have the option for being included or excluded 3316 from internet search results as well as domain extensions being used to parse internet search results to the main page string, grouped page strings or separate page strings 3116, and having a direct influence upon internet search and results formatting. Alterations and variations in contribution of the primary keyword input field and keywords, additional input fields and keywords, and Content User defined domain extensions has been previously addressed. With Content User defined one or more keywords in a primary input field, one or more Content User defined domain extension criteria, and any of their full or partial present or absent combinations the search request 3130 may follow and internet search results returned. A main page string 3132 of internet search results is populated with, all, some, left over, odd, outlier, or other results not categorized by other criteria, and any of their combinations. It is possible that there may not be a main page string of results at all, but whether there is or is not is within the scope of this and other disclosures herein. A grouped page string 3134 stating that any combination of two or more criteria from any keyword or domain extension are listed on a single page string creating one or more grouped page strings. Further included within the scope of this disclosure is any form of combination of a main page string and grouped page strings of search results presentation, parsing, and organizing.

The system apparatus is shown, and as a reference the illustration shows an active webpage tab 3140 with general search engine functions and URL bar 3142 as common elements among search engines. Also universal among search engines is the simple search field 3150 and search request button 3152. Shown also is the Content User defined two keyword phrase 3154 written in an inclusive form to return search results. Further disclosed on the Semi-Simple Search Interface and in this case a Semi-Simple Search interface on the internet search results page is the presence of a one or more multiple Content User defined or Content User-Set domain extension input fields 3160 with one or more domain extensions. In this case there are displayed two domain extensions in an inclusive format.

The example of this disclosure shows that with a search call 3152 that internet search results are parsed and presented into two grouped page strings. One is the main page string 3162 that is shown to contain various domain extensions, but essentially represents all internet search results from keywords and domain extension not parsed out as .fitness and .health grouped page string 3164. Shown is the highlighted .fitness and .health page string tab 3164 showing internet search results items listing 3166. These mentioned fields are just one example of how a Content Manager may choose to build their Semi-Simple Search interface for the original search interface or as in this case returned with search results on the page string.

It is apparent how the Semi-Simple Search Interface and related search results interface now become much more effective and useful for the Content User. Made available is the ability to quickly seek results specifically associated with their search request by topic they identify or identified by the Content Manager. This disclosure provides for a more Content User controlled internet experience and more effective internet search result experience.

FIG. 32—Results—KW+User DExt=Main+Separate

FIG. 32 is an example, and not limited to this example, and incorporates all relevant disclosure herein, of a Semi-Simple Search Screen Interface including: (1) a primary keyword input field for one or more keywords, (2) one or more additional Content User defined domain extension input fields for one or more domain extensions, (3) any of their combinations as previously more specifically defined. This disclosure specifically addresses solutions incorporating internet search result formats using: (1) a main page string, (2) separate page strings, and (3) any of their combinations as previously more specifically defined. The combination of the features of the Semi-Simple Search Interface and the more organized internet search result formats is a more Content User control, more accurate search results, and more effective results. This disclosure differs from the previous by the inclusion of parsing internet search results on a main page string and separated page strings.

Disclosed in this method is a primary keyword search criteria input field 3210 for one or more keywords, one or more Content User defined domain extensions specific input fields 3212 for one or more domain extensions, and any of their full or partial present or absent combinations. The fact that there are specific Content User domain extension input fields is simply an example of the type of input fields available, but domain extensions are not limited from being added to other fields. A specific feature of this disclosure that is a relevant possibility to any of the disclosures within this document's many disclosures is the ability to have inclusive or exclusive search criteria 3214. The application of the indicated inputs is shown that the primary keyword has a direct relationship on the internet search, that the one or more Content User defined domain extensions have the option for being included or excluded 3216 from internet search results as well as domain extensions being used to parse internet search results to the main page string, grouped page strings or separate page strings 3216, and having a direct influence upon internet search and results formatting. Alterations and variations in contribution of the primary keyword input field and keywords, additional input fields and keywords, and Content User defined domain extensions has been previously addressed. With Content User defined one or more keywords in a primary input field, one or more Content User defined domain extension criteria, and any of their full or partial present or absent combinations the search request 3230 may follow and internet search results returned. A main page string 3232 of internet search results is populated with, all, some, left over, odd, outlier, or other results not categorized by other criteria, and any of their combinations. It is possible that there may not be a main page string of results at all, but whether there is or is not is within the scope of this and other disclosures herein. A separate page string 3234 is disclosed to occur for any one criteria parsed onto their own separate page string as identified for a particular keyword or domain extension from any source. Further included within the scope of this disclosure is any form of combination of a main page string and separate page strings of search results presentation, parsing, and organizing.

The system apparatus is shown, and as a reference the illustration shows an active webpage tab 3240 with general search engine functions and URL bar 3242 as common elements among search engines. Also universal among search engines is the simple search field 3250 and search request button 3252. Shown also is the Content User defined two keyword phrase 3254 written in an inclusive form to return search results. Further disclosed on the Semi-Simple Search Interface and in this case a Semi-Simple Search interface on the internet search results page is the presence of a one or more multiple domain extension input fields 3260. Further in this disclosure all the domain extensions are shown to be inclusion, but could be made exclusive. These mentioned fields are just one example of how a Content Manager may choose to build their Semi-Simple Search interface for the original search interface or as in this case returned with search results on the page string.

More specific to the return of the internet search results disclosed in this figure is the presence of separate page strings and the main or All Other page string 3262. Shown are multiple Content User defined domain extensions for searching, parsing, or any other combinations onto separate tabs and page strings in this case being .gov, .org, .edu, .fitness, .health, and the main or All Others page string. Further disclosed is the selection of the .fitness page string tab 3264. By selecting this .fitness tab page string what is displayed are the internet search results item list 3266 for .fitness related search results. Again, immediately disclosed is the utility of greater Content User control, greater internet search results accuracy, and better Content User experience with more rational internet search results items organization.

It is apparent how the Semi-Simple Search Interface and related search results interface now become much more effective and useful for the Content User. Made available is the ability to quickly seek results specifically associated with their search request by topic they identify or identified by the Content User. In this specific case that means internet search results parsed across multiple page strings with access tabs that create additional control and top level categorization, while also including a catch all page string. This disclosure provides for a more Content User controlled internet experience and more effective internet search result experience.

FIG. 33—Results—KW+User DExt=Main+Group+Separate

FIG. 33 is an example, and not limited to this example, and incorporates all relevant disclosure herein, of a Semi-Simple Search Screen Interface including: (1) a primary keyword input field for one or more keywords, (2) one or more additional Content User defined domain extension input fields for one or more domain extensions, (3) any of their combinations as previously more specifically defined. This disclosure specifically addresses solutions incorporating internet search result formats using: (1) a main page string, (2) grouped page strings, (3) separate page strings, and (4) any of their combinations as previously more specifically defined. The combination of the features of the Semi-Simple Search Interface and the more organized internet search result formats is a more Content User control, more accurate search results, and more effective results. This disclosure differs from the previous by the inclusion of parsing internet search results on a main page string, and both grouped page strings and separated page strings.

Disclosed in this method is a primary keyword search criteria input field 3310 for one or more keywords, one or more Content User defined domain extensions specific input fields 3312 for one or more domain extensions, and any of their full or partial present or absent combinations. The fact that there are specific Content User domain extension input fields is simply an example of the type of input fields available, but domain extensions are not limited from being added to other fields. A specific feature of this disclosure that is a relevant possibility to any of the disclosures within this document's many disclosures is the ability to have inclusive or exclusive search criteria 3314. The application of the indicated inputs is shown that the primary keyword has a direct relationship on the internet search, that the one or more Content User defined domain extensions have the option for being included or excluded 3316 from internet search results as well as domain extensions being used to parse internet search results to the main page string, grouped page strings or separate page strings 3316, and having a direct influence upon internet search and results formatting. Alterations and variations in contribution of the primary keyword input field and keywords, additional input fields and keywords, and Content User defined domain extensions has been previously addressed. With Content User defined one or more keywords in a primary input field, one or more Content User defined domain extension criteria, and any of their full or partial present or absent combinations the search request 3330 may follow and internet search results returned. A main page string 3332 of internet search results is populated with, all, some, left over, odd, outlier, or other results not categorized by other criteria, and any of their combinations. It is possible that there may not be a main page string of results at all, but whether there is or is not is within the scope of this and other disclosures herein. A grouped page string 3334 stating that any combination of two or more criteria from any keyword or domain extension are listed on a single page string creating one or more grouped page strings. One or more separate page string 3336 is disclosed to occur for any one criteria parsed onto their own separate page string as identified for a particular keyword or domain extension from any source. A further reinforcement that any combination of grouped or separate page string formats 3338 may occur as designated by the Content User keywords, domain extensions, and any of their combinations from a particular or any of the input fields. 3334, 3336, and 3338 show a full inclusion of Content User-Set and Content Manager Pre-Set options, but in this disclosure only the Content User-Set features are active. This disclosure example is focused on Semi-Simple Search Interface input criteria and internet search results parsing criteria that is Content User focused. Further included within the scope of this disclosure is any form of combination of a main page string, grouped page strings, and separate page strings of search results presentation, parsing, and organizing.

The system apparatus is shown, and as a reference the illustration shows an active webpage tab 3340 with general search engine functions and URL bar 3342 as common elements among search engines. Also universal among search engines is the simple search field 3350 and search request button 3352. Shown also is the Content User defined two keyword phrase 3354 written in an inclusive form to return search results. Further disclosed on the Semi-Simple Search Interface and in this case a Semi-Simple Search interface on the internet search results page is the presence of a one or more keyword, domain extension, and any of their combination input fields 3354 and 3360. Here the focus is on additional search criteria and search result parsing and sorting by Content User defined domain extensions. A simple one or more additional input field is shown to add greatly to the specificity, control, and utility in accuracy and sorting of internet search results.

More specific to this disclosure is the parsing and presentation or sorting of internet search results among five page strings available through tabs .gov, .org, .edu, .fitness and .heath, and a main page string or catch-all page string in this case titled All Others. This embodiment of the disclosure shows that these page strings were Content User defined in the one or additional input field 3362. Further that each page string is as important and legitimate as the next. That is if the Content User was interested in .gov related internet search results for adolescent fitness in this case then that page string, the first page of that page string, and the first positions of that page string, the advertisements of that page string would be as important as the current practice of including all search results on a single page string, but much more organized and specific. Also disclosed is the association of .health, and .fitness to form a grouped association of internet search results under a common tab 3364 and as it is selected as the active page string then shown is the internet search results .health and .fitness items listing 3366. These mentioned fields are just one example of how a Content Manager may choose to build their Semi-Simple Search interface for the original search interface or as in this case returned with search results on the page string.

It is apparent how the Semi-Simple Search Interface and related search results interface now become much more effective and useful for the Content User. Made available is the ability to achieve more accurate results as defined by the Content User and to see those results presented in a more effective and useful form. This disclosure provides for a more Content User controlled internet experience and more effective internet search result experience.

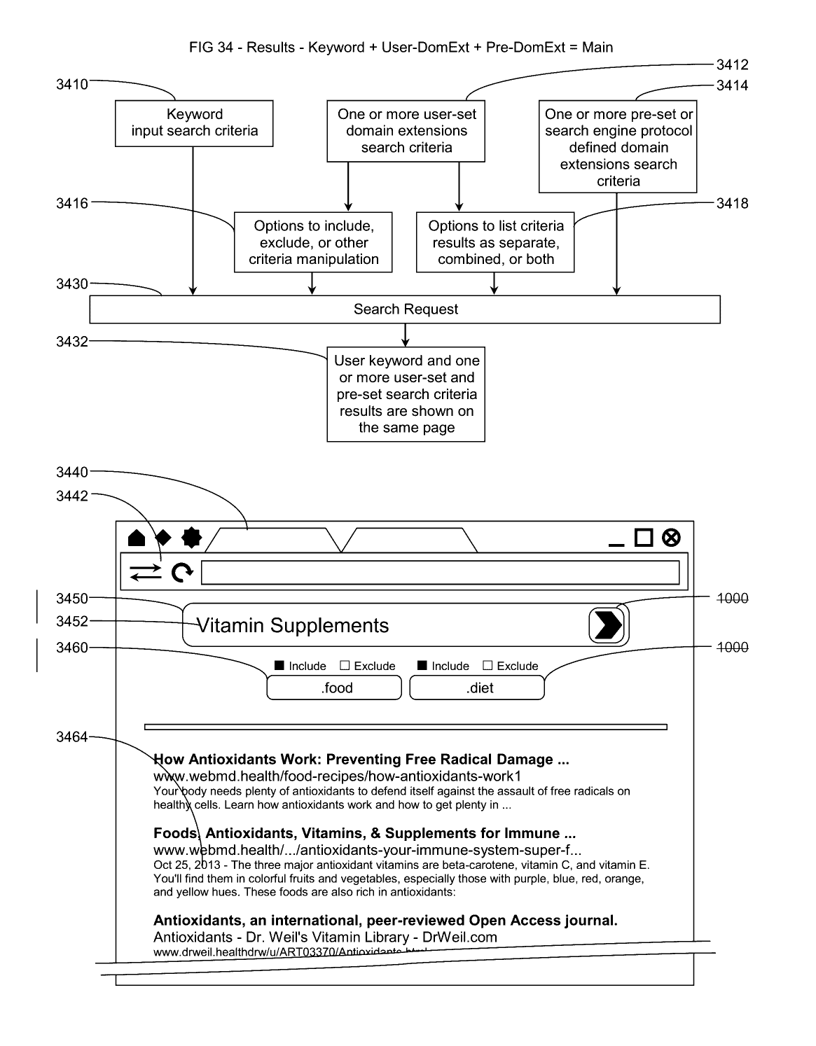

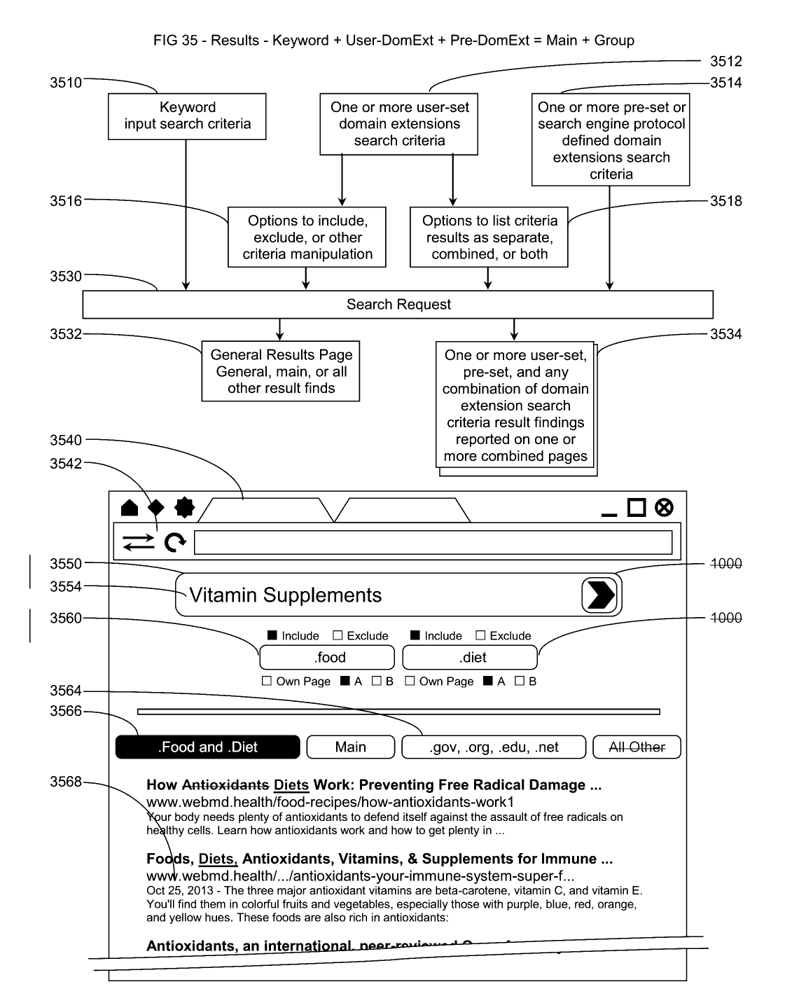

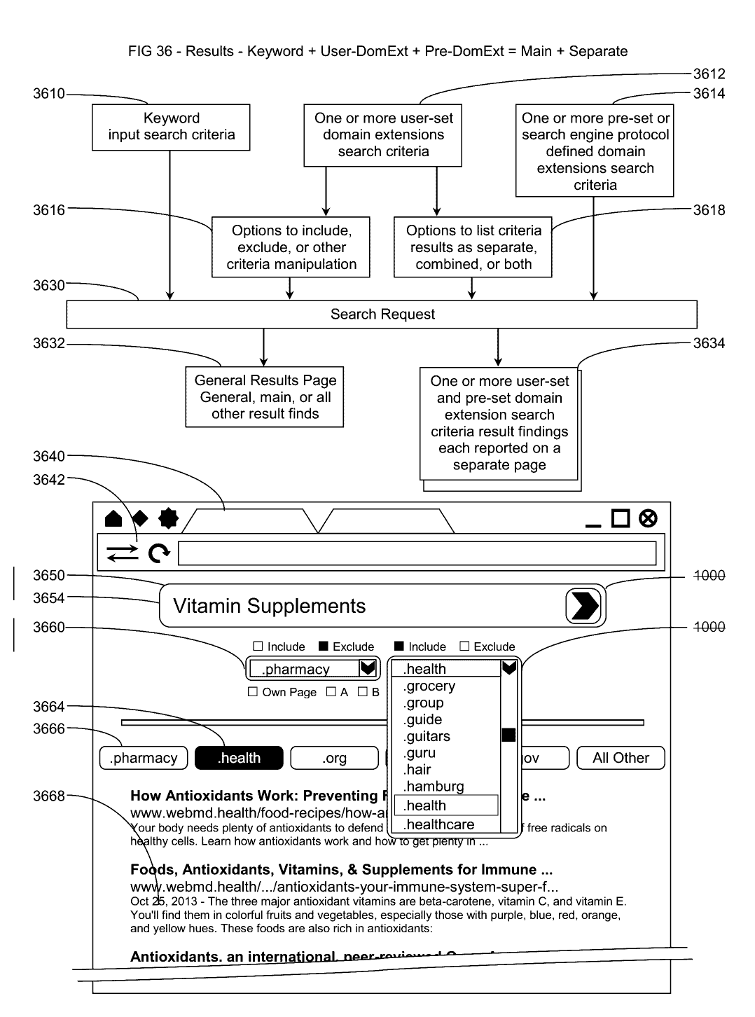

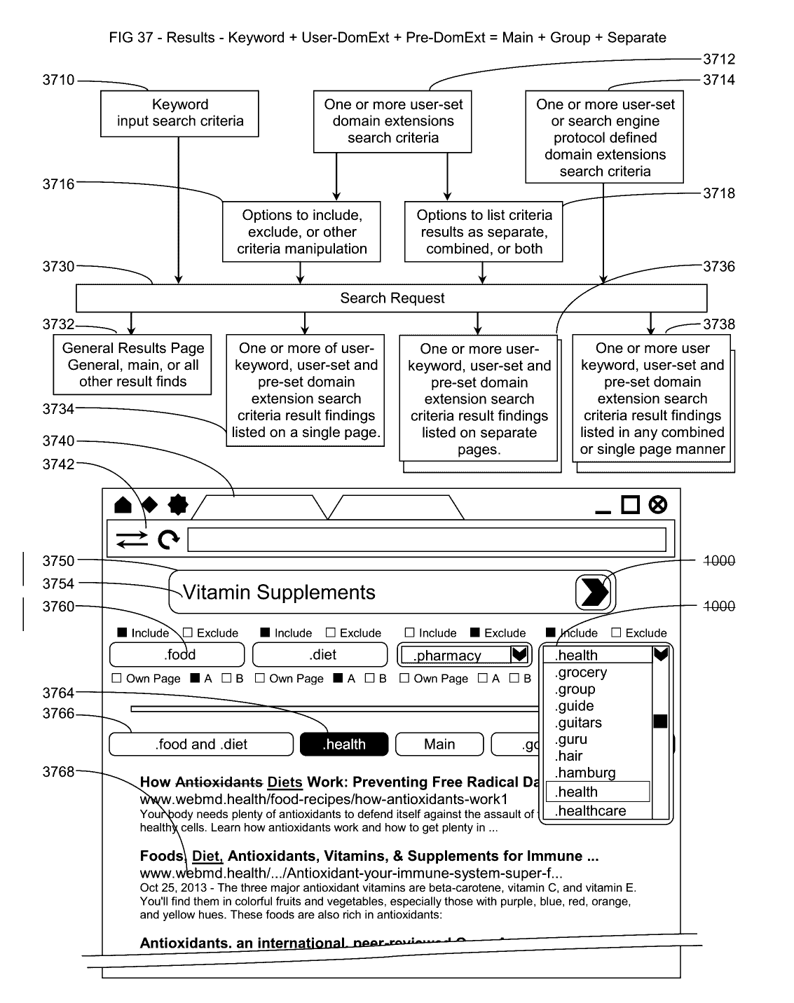

FIG. 34, FIG. 35, FIG. 36, and FIG. 37 show common elements of a Semi-Simple Search interface with two search criteria inputs. The search interface provides a simple Content User defined keyword input field Content Manager Pre-Set Domain Extensions, and a Content User defined Domain Extensions.

The search criteria of the Content User Keyword input criteria is undoubtedly known to the Content User to direct the internet search. The Content Manager determined Pre-Set Domain Extension choices also direct the internet search and may be known or unknown to the Content User. The Content User determined Domain Extension choices also direct the internet search and in this case are defined by the Content User to meet their specific interests. Use of domain extensions by the Content Manager Pre-Set Domain Extension and Content User Domain Extension may be one, two, a few, or many domain extensions identified and used simultaneously, sequentially, or any of their combination for the purpose of search criteria or results distribution criteria. Only one domain extension may be used if the Content User chooses not to use a domain extension search criteria. Such a search criteria reverts to the Content User Keyword and Content Manager Pre-Set Domain Extension embodiment. Such would be the case in any search circumstance that the Content User may chose or neglect to add any additional search criteria. In the following disclosure domain extensions may be known or unknown by the Content User. It is feasible and expected that there may be duplicates may occur, and in such a case will simply be combined together, or tell the Content Manager search result protocols to separate out and highlight that domain extension, or other meet the Content User's expectation. The Content Manager Pre-Set Domain Extensions and Content User Domain Extensions may be represented by a list or display of any sort visible to the Content User showing all, most important, or some domain extensions before, after, or at anytime through the use of the Semi-Simple Search engine interface and results pages and screens. A form of this disclosure may also hide away one, some, or all Content Manager Pre-Set Domain Extensions search input criteria, Content User Domain Extension search input criteria, any of their combinations. Search result distribution criteria may not be shown to the Content User, except that search results may be sorted, parsed, or otherwise distributed and any of their combinations to a single domain extension search result page string, grouped domain extension search result page string, or any of their combination. This may be done to form a simplification of search result presentation, in such a case as the Content Manager and Content User added many domain extensions or more domain extensions than can be clearly reported or beyond available internet search result pages string locations or slots for presentation, if such a limitation exists as all. As a result of the distribution of search results it may be evident to the Content User of one, some, or all of the Pre-Set Domain Extension criteria and Content User Domain Extension criteria being used by the Content User and then managed by the Content Manager. The results of the simple Content User Keyword input field, the Content Manager Pre-Set Domain Extension search criteria, and the Content User Domain Extension search criteria is a Semi-Simple Search defined by two input criteria in one or more input fields.

The search results from the Content User Keyword, Content Manager Pre-Set Domain Extension, and Content User Domain Extension search criteria will be parsed by either the keyword input criteria or domain extension input criteria. Exemplified here is the embodiment of the search results being formatted by all results from all keyword and domain extensions being combined in a main search result page string, formatted by groups of domain extension search results page strings, separate domain extension search results page strings, and any combination of these search results distribution formats. The result of separating internet search results is the Content User's increased access to more, more organized, and more understandable ever increasing internet content. By way of example, knowing that the many government or .gov related content is located in one particular page string easily guides the Content User to internet search result sites that are authoritative with regard to regulations, policies, consumer protections and safety, and more. This is now immediately separated from commercial internet content that may seek to mimic, seek to be government-like authoritative, or other like intent. The same can be said for a .org search results page string that separates out organization with less commercial interest and more social goodwill, education, support, and other non-profit type principles. Further the same could be said for separating out educational institutions, research articles, large corporate entities, small corporate entities, individual, or other distinguishing characteristics of internet search results that are now simply grouped together that lacks clarity and hides valued potential search results. As displayed search results may be separated as described or grouped by any combination.

The following four figures provide specific examples of the Content User Keyword input search criteria, Content Manager Pre-Set Domain Extension search criteria, and Content User Domain Extension search criteria.

FIG. 34—Results—KW+PreS DExt+User DExt=Main

FIG. 34 is an example, and not limited to this example, and incorporates all relevant disclosure herein, of a Semi-Simple Search Screen Interface including: (1) a primary keyword input field for one or more keywords, (2) one or more additional Content User defined domain extension input fields for one or more domain extensions, (3) one or more Content Manager defined domain extensions, and (4) any of their combinations as previously more specifically defined. This disclosure specifically addresses solutions incorporating internet search result formats using: (1) a main page string as previously more specifically defined. The combination of the features of the Semi-Simple Search Interface and the more organized internet search result formats is a more Content User control, more accurate search results, and more effective results. This disclosure differs from the previous by the inclusion of Content User defined domain extensions and Content Manager Pre-Set domain extensions with results reported on the main page string.

Disclosed in this method is a primary keyword search criteria input field 3410 for one or more keywords, one or more Content User defined domain extensions specific input fields 3412 for one or more domain extensions, one or more Content Manager Pre-Set domain extensions 3414 and any of their full or partial present or absent combinations. A specific feature of this disclosure that is a relevant possibility to any of the disclosures within this document's many disclosures is the ability to have inclusive or exclusive search criteria 3416. Additionally, the Content User defined domain extensions are shown to be available as search criteria, results presentation criteria, or any full or partial present or absent combinations 3418. A main page string 3432 of internet search results is populated with all internet search results from all search criteria.

The system apparatus is shown, and as a reference the illustration shows an active webpage tab 3440 with general search engine functions and URL bar 3442 as common elements among search engines. Also universal among search engines is the simple search field 3450 and search request button 3452. Shown also is the Content User defined two keyword phrase 3454 written in an inclusive form to return search results. Further disclosed on the Semi-Simple Search Interface and in this case a Semi-Simple Search interface on the internet search results page is the presence of a one or more domain extension input fields 3460 and 3462, and in this case an open format allowing for direct character input to build the domain extensions. Note that in this example the domain extension input fields are accompanied by options to include the criteria in search results or exclude the criteria. In this disclosure both are treated as inclusive and will show on the search results main page string 3464. These mentioned fields are just one example of how a Content Manager may choose to build their Semi-Simple Search interface for the original search interface or as in this case returned with search results on the page string as shown in the internet search result main page string listing 3464.

Not specifically numbered, but present in the illustration are other informative features descriptive of the disclosure. Important to consider is the presence of the Content Manager Pre-Set domain extensions that in this disclosure are not shown on the Semi-Simple Search Interface and not shown on the Semi-Simple Search results page string interface. Nevertheless, the Content Manager Pre-Set domain extensions are included in the internet search results main and only page string 3464. Although more basic, the .food and .diet domain extension provide added control and emphasis for the Content User.

FIG. 35—Results—KW+PreS DExt+User DExt=Main+Group

FIG. 35 is an example, and not limited to this example, and incorporates all relevant disclosure herein, of a Semi-Simple Search Screen Interface including: (1) a primary keyword input field for one or more keywords, (2) one or more additional Content User defined domain extension input fields for one or more domain extensions, (3) one or more Content Manager defined domain extensions, and (4) any of their combinations as previously more specifically defined. This disclosure specifically addresses solutions incorporating internet search result formats using: (1) a main page string and (2) grouped page strings, and (3) any of their combinations as previously more specifically defined. The combination of the features of the Semi-Simple Search Interface and the more organized internet search result formats is a more Content User control, more accurate search results, and more effective results. This disclosure differs from the previous by the inclusion of parsing internet search results on a main page string and grouped page strings.

Disclosed in this method is a primary keyword search criteria input field 3510 for one or more keywords, one or more Content User defined domain extensions specific input fields 3512 for one or more domain extensions, one or more Content Manager Pre-Set domain extensions 3514 and any of their full or partial present or absent combinations. The fact that there are specific Content User domain extension input fields is simply an example of the type of input fields available, but domain extensions are not limited from being added to other fields. This specific disclosure indicates primary keyword input has a direct relationship on the internet search criteria, that the one or more Content User defined domain extensions have the option for being included or excluded 3516 from internet search results as well as showing the option to being used to parse internet search results to the main page string, grouped page strings or separate page strings 3520, and lastly shown is that the Content Manager Pre-Set domain extensions having a direct influence upon internet search criteria and search results formatting. Alterations and variations in contribution of the primary keyword input field and keywords, additional input fields and keywords, Content User defined domain extensions, and Content Manager Pre-Set domain extensions has been previously addressed. With Content User defined one or more keywords in a primary input field, one or more Content User defined domain extension criteria, the presence of Content Manager Pre-Set domain extensions, and any of their full or partial present or absent combinations the search request 3530 may follow and internet search results returned. A All other pages string or main page string 3532 of internet search results is populated with, all, some, left over, odd, outlier, or other results not categorized by other criteria, and any of their combinations. It is possible that there may not be a main page string of results at all, but whether there is or is not is within the scope of this and other disclosures herein. A grouped page string 3534 stating that any combination of two or more criteria from any keyword or domain extension are listed on a single page string creating one or more grouped page strings. Further included within the scope of this disclosure is any form of combination of a main page string and grouped page strings of search results presentation, parsing, and organizing.

The system apparatus is shown, and as a reference the illustration shows an active webpage tab 3540 with general search engine functions and URL bar 3542 as common elements among search engines. Also universal among search engines is the simple search field 3550 and search request button 3552. Shown also is the Content User defined two keyword phrase 3554 written in an inclusive form to return search results. Further disclosed on the Semi-Simple Search Interface and in this case a Semi-Simple Search interface on the internet search results page is the presence of a one or more free form Content User defined domain extension input fields 3560 and 3562. Further in this disclosure the domain extension input fields are accompanied by options to include the criteria in search results or exclude the criteria from returned search results. Further disclosed is the option as to how the internet search results will be presented or parsed on to the main page string and grouped page strings A and B. These mentioned fields are just one example of how a Content Manager may choose to build their Semi-Simple Search interface for the original search interface or as in this case returned with search results on the page string.

More specific to the return of the internet search results disclosed in this figure is the presence of two keywords parsed on the .(dot)food and .diet grouped page string 3566. Further in this disclosure is the combination of the Content Manager Pre-Set domain extensions grouped on a tab and page strive showing .gov, .org, .edu, and .net 3566. Also shown in this disclosure is the selection of the .food and .diet tab and associated internet search results items listings of the .food and .diet 3568. Not specifically numbered, but present in the illustration are other informative features descriptive of the disclosure. One such is unmarked but inclusion of general results returned under the Main button or tab and page string containing all other search results not included on other page strings or not under another tab. Lastly, there is the presence of a blank tab or an empty page string as there were no other grouped criteria by the Content User defined keywords or domain extensions and nor from the Content Manager Pre-Set domain extensions.

It is apparent how the Semi-Simple Search Interface and related search results interface now become much more effective and useful for the Content User. Made available is the ability to quickly seek results specifically associated with their search request by topic they identify or identified by the Content Manager. This disclosure provides for a more Content User controlled internet experience and more effective internet search result experience.

FIG. 36—Results—KW+PreS DExt+User DExt=Main+Separate

FIG. 36 is an example, and not limited to this example, and incorporates all relevant disclosure herein, of a Semi-Simple Search Screen Interface including: (1) a primary keyword input field for one or more keywords, (2) one or more additional Content User defined domain extension input fields for one or more domain extensions, (3) one or more Content Manager defined domain extensions, and (4) any of their combinations as previously more specifically defined. This disclosure specifically addresses solutions incorporating internet search result formats using: (1) a main page string, (2) separate page strings, and (3) any of their combinations as previously more specifically defined. The combination of the features of the Semi-Simple Search Interface and the more organized internet search result formats is a more Content User control, more accurate search results, and more effective results. This disclosure differs from the previous by the inclusion of parsing internet search results on a main page string and separated page strings.

Disclosed in this method is a primary keyword search criteria input field 3610 for one or more keywords, one or more Content User defined internet search keyword input fields 3612 for one or more keywords, one or more Content User defined domain extensions specific input fields 3614 for one or more domain extensions, one or more Content Manager Pre-Set domain extensions 3616 and any of their full or partial present or absent combinations. The fact that there are specific Content User domain extension input fields is simply an example of the type of input fields available, but domain extensions are not limited from being added to other fields. A specific feature of this disclosure that is a relevant possibility to any of the disclosures within this document's many disclosures is the ability to have inclusive or exclusive search criteria 3616. This disclosure indicates the primary keyword has a direct relationship on the internet search criteria, that the one or more additional Content User defined domain extensions have the option for being included or excluded 3616 from internet search results as well as being included or excluded in their use to parse internet search results to the main page string, grouped page strings, separate page strings, or any of their combinations 3618, and lastly shown is the Content Manager Pre-Set domain extensions having a direct influence upon internet search results formatting. Elsewhere it has been disclosed that any keyword or domain extension from any source could be used as an internet search criteria or internet search result parsing and sorting criteria. Alterations and variations in contribution of the primary keyword input field and keywords, additional input fields and keywords, Content User defined domain extensions, and Content Manager Pre-Set domain extensions has been previously addressed. With Content User defined one or more keywords in a primary input field, one or more Content User defined domain extension criteria, the presence of Content Manager Pre-Set domain extensions, and any of their full or partial present or absent combinations the search request 3630 may follow and internet search results returned. A main page string 3632 of internet search results is populated with, all, some, left over, odd, outlier, or other results not categorized by other criteria, and any of their combinations. It is possible that there may not be a main page string of results at all, but whether there is or is not is within the scope of this and other disclosures herein. A separate page string 3634 is disclosed to occur for any one criteria parsed onto their own separate page string as identified for a particular keyword or domain extension from any source. Further included within the scope of this disclosure is any form of combination of a main page string and separate page strings of search results presentation, parsing, and organizing.

The system apparatus is shown, and as a reference the illustration shows an active webpage tab 4840 with general search engine functions and URL bar 3642 as common elements among search engines. Also universal among search engines is the simple search field 3650 and search request button 3652. Shown also is the Content User defined two keyword phrase 3654 written in an inclusive form to return search results. Further disclosed on the Semi-Simple Search Interface and in this case a Semi-Simple Search interface on the internet search results page is the presence of a one or more multiple keyword input fields 3660 and one or more multiple Content User definable domain extension input fields 3662, and in this case allowing for direct character input to build the domain extension or select from a drop down list. Note that in this example the keyword and domain extension input fields are accompanied by options to include the criteria in search results or exclude the criteria, as well as options on how the internet search results will be presented or parsed on to the main page string or separate page strings. These mentioned fields are just one example of how a Content Manager may choose to build their Semi-Simple Search interface for the original search interface or as in this case returned with search results on the page string.

More specific to the return of the internet search results disclosed in this figure is the presence of two keywords each parsed on their separate .health or .(dot)health pages string 3664 and separate .pharmacy page string 3666. The .health page string tab is highlighted and as such the internet search results items listing 3668 for the .heath page string is shown. Not specifically numbered, but present in the illustration are other informative features descriptive of the disclosure is the presence of the .org, .gov, and one other domain extension not visible. As these domain extensions were not Content User defined, not shown on the Semi-Simple Search Interface, they are associated with the Content Manager Pre-Set domain extensions. It is not a requirement that the Content Manager Pre-Set domain extensions be shown or not shown on the Semi-Simple Search Interface, such a designation is within this specific disclosure and the totality of this document, and not showing them is simply a Content Manager as how to treat their Pre-Set domain extension. Lastly shows is the All Other tab which contains all search results not included under the other mentioned tabs and page strings.

It is apparent how the Semi-Simple Search Interface and related search results interface now become much more effective and useful for the Content User. Made available is the ability to quickly seek results specifically associated with their search request by topic they identify or identified by the Content Manager. This disclosure provides for a more Content User controlled internet experience and more effective internet search result experience.

FIG. 37—Results—KW+PreS DExt+User DExt=Main+Group+Separate

FIG. 37 is an example, and not limited to this example, and incorporates all relevant disclosure herein, of a Semi-Simple Search Screen Interface including: (1) a primary keyword input field for one or more keywords, (2) one or more additional Content User defined domain extension input fields for one or more domain extensions, (3) one or more Content Manager defined domain extensions, and (4) any of their combinations as previously more specifically defined. This disclosure specifically addresses solutions incorporating internet search result formats using: (1) a main page string, (2) grouped page strings, (3) separate page strings, and (4) any of their combinations as previously more specifically defined. The combination of the features of the Semi-Simple Search Interface and the more organized internet search result formats is a more Content User control, more accurate search results, and more effective results. This disclosure differs from the previous by the inclusion of parsing internet search results on a main page string, and both grouped page strings and separated page strings.

Disclosed in this method is a primary keyword search criteria input field 3710 for one or more keywords, one or more Content User defined internet search keyword input fields 3712 for one or more keywords, one or more Content User defined domain extensions specific input fields 3714 for one or more domain extensions, one or more Content Manager Pre-Set domain extensions 3716 and any of their full or partial present or absent combinations. The fact that there are specific Content User domain extension input fields is simply an example of the type of input fields available, but domain extensions are not limited from being added to other fields. A specific feature of this disclosure that is a relevant possibility to any of the disclosures within this document's many disclosures is the ability to have inclusive or exclusive search criteria 3716. This disclosure indicates the primary keyword has a direct relationship on the internet search criteria, that the one or more additional Content User defined domain extensions have the option for being included or excluded 3716 from internet search results as well as being included or excluded in their use to parse internet search results to the main page string, grouped page strings, separate page strings, or any of their combinations 3718, and lastly shown is the Content Manager Pre-Set domain extensions having a direct influence upon internet search results formatting. Elsewhere it has been disclosed that any keyword or domain extension from any source could be used as an internet search criteria or internet search result parsing and sorting criteria. Alterations and variations in contribution of the primary keyword input field and keywords, additional input fields and keywords, Content User defined domain extensions, and Content Manager Pre-Set domain extensions has been previously addressed. With Content User defined one or more keywords in a primary input field, one or more Content User defined domain extension criteria, the presence of Content Manager Pre-Set domain extensions, and any of their full or partial present or absent combinations the search request 3730 may follow and internet search results returned. A main page string 3732 of internet search results is populated with, all, some, left over, odd, outlier, or other results not categorized by other criteria, and any of their combinations. It is possible that there may not be a main page string of results at all, but whether there is or is not is within the scope of this and other disclosures herein. A grouped page string 3734 stating that any combination of two or more criteria from any keyword or domain extension are listed on a single page string creating one or more grouped page strings. A separate page string 3736 is disclosed to occur for any one criteria parsed onto their own separate page string as identified for a particular keyword or domain extension from any source. A further reinforcement that any combination of grouped or separate page string formats 3738 may occur as designated by the Content User keywords and domain extensions or Content Manager Pre-Set or otherwise designated keywords and domain extensions. Further included within the scope of this disclosure is any form of combination of a main page string, grouped page strings, and separate page strings of search results presentation, parsing, and organizing.

The system apparatus is shown, and as a reference the illustration shows an active webpage tab 3740 with general search engine functions and URL bar 3742 as common elements among search engines. Also universal among search engines is the simple search field 3750 and search request button 3752. Shown also is the Content User defined two keyword phrase 3754 written in an inclusive form to return search results. Further disclosed on the Semi-Simple Search Interface and in this case a Semi-Simple Search interface on the internet search results page is the presence of a one or more multiple Content User definable domain extension free form input fields 3760 and one or more multiple Content User definable domain extension input fields 3762 using in this case direct character input to build the domain extension or select from a drop down list. Note that in this example the domain extension input fields 3760 and 3762 are accompanied by options to include the criteria in search results or exclude the criteria, as well as options on how the internet search results will be presented or parsed on to the main page string, grouped page strings, or separate page strings. These mentioned fields are just one example of how a Content Manager may choose to build their Semi-Simple Search interface for the original search interface or as in this case returned with search results on the page string.

More specific to the return of the internet search results disclosed in this figure is the presence of two keywords parsed on the .food or .(dot)food and .diet grouped page string 3766, the domain extension .health as a single or separate page string 3764 and associated .health internet search result listings 3768. Not specifically numbered, but present in the illustration are other informative features descriptive of the disclosure. One includes the .pharmacy domain extension that is noted for exclusion or any results identified with a pharmacy, or presumably but not necessarily a drug, not to be shown and so there is no single or group page string and any associated results should not be showing even on the main page string. Another instructive disclosure unmarked is the inclusion of general results returned under the Main button or tab and containing all other search results not included on other page strings or not under another tab. Lastly, there is the presence of the .gov or .(dot)gov tab that does not show an option elsewhere on the Semi-Simple Search Interface and is therefore presumed to have been a Content Manager Pre-Set domain extension and contains search results collected that are all government related.

It is apparent how the Semi-Simple Search Interface and related search results interface now become much more effective and useful for the Content User. This disclosure provides for a more Content User controlled internet experience and more effective internet search result experience. Significant is the parsing and sorting of results into more similar organized results to add clarity and utility.

A focus of this disclosure has been on the use of additional search criteria not only to locate internet content more specifically, but more particularly to organize and display internet search results in more clear and useful manner in groups in a single or main page string of internet search results or across grouped or separate internet search results page strings. Central to this has been the inclusion of one or more Content Manager Pre-Set Domain Extension, a Content User Domain Extension, or their combination. Note that the inclusion of the domain extension is not solely for the purpose of parsing, sorting, and separating internet search results but are also available as internet search criteria.

Disclosed also is the use of one or more additional keyword internet search criteria interface input options to increase the specificity of the internet search content identification and the search result display and distribution. The specificity of a keyword, tends to, but not exclusive and limited to, aiding more in increasing search specificity than in search results parsing, but both search and results formatting may benefit. A keyword may be a word, symbol, phrase, domain extension, any string of characters, numbers, input directly or indirectly from another device or means, and any of their combinations may be used to enhance internet search and internet search result display and distribution. One, two, or a few additional keyword inputs for search and search result applications may be through the same input field, such as the usual one keyword input field, one or more additional keyword input fields, or their combination of input fields, and combinations of one or more keywords in one or more keyword input fields. The additional keyword input, like the domain extension input, may be used by the Content Managers search engine and results display protocols and algorithms using all inputs simultaneously, sequentially, if certain conditions become present or are not present, automatically or by Content User selection, and any of their combinations. Further, keywords, additional keywords, domain extensions, and their combinations may be used for inclusive or positive search and results display or for exclusion, negative, or no search and search result display, or any of their combinations. Inclusive or positive search and search results usage means that all keywords and domain extensions will be used to affirmatively seek and display the content associated with the keyword, domain extension, and their combinations. Exclusive or negative search and search result usage means that keywords, domain extensions, and their combinations identified as exclusive or negative for a search or search result use will be remove, dismissed, hidden, deleted, separated from, or other mechanism to not associated with the inclusive or positive keyword, domain extension, or their combination search and search results use. As disclosed in the previous statement, the exclusion of internet content or content display may use any mechanism that removes or deprioritized the excluded content from the Content User by not presenting excluded results at all, associating them with search results on the same page strings as otherwise relevant results but in an exclusive manner, or separating excluded search results on different page strings, or any of their combinations. Inclusive and exclusive criteria may be handled or implemented in search actions or search result actions simultaneously, sequentially, automatically, by subsequent Content Manager or Content User action, or any of their combinations, and any combinations of this description or other combinations of disclosures (not shown, deprioritized, etc.) relevant to inclusion or exclusion of keywords, domain extensions, or their combinations. The statement of keywords, domain extensions, or their combinations refers to the singular or plural of these inputs, such as just one keyword, two or more keywords, one domain extension, two or more domain extensions, and their combinations whether they are provided by the Content Manager or Content User or any of their combinations.

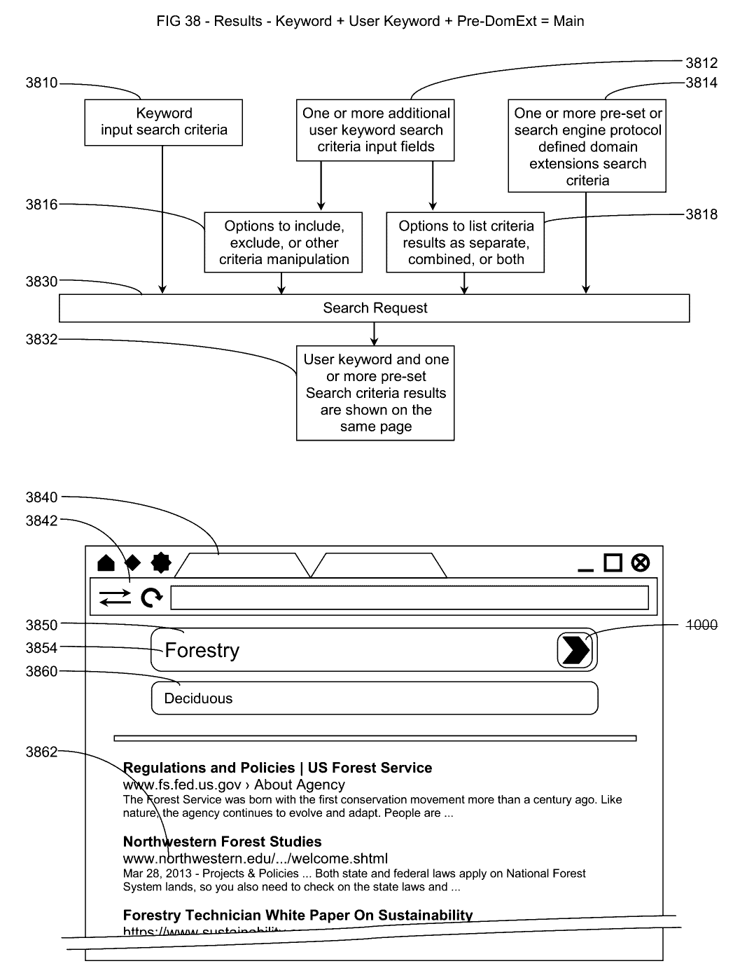

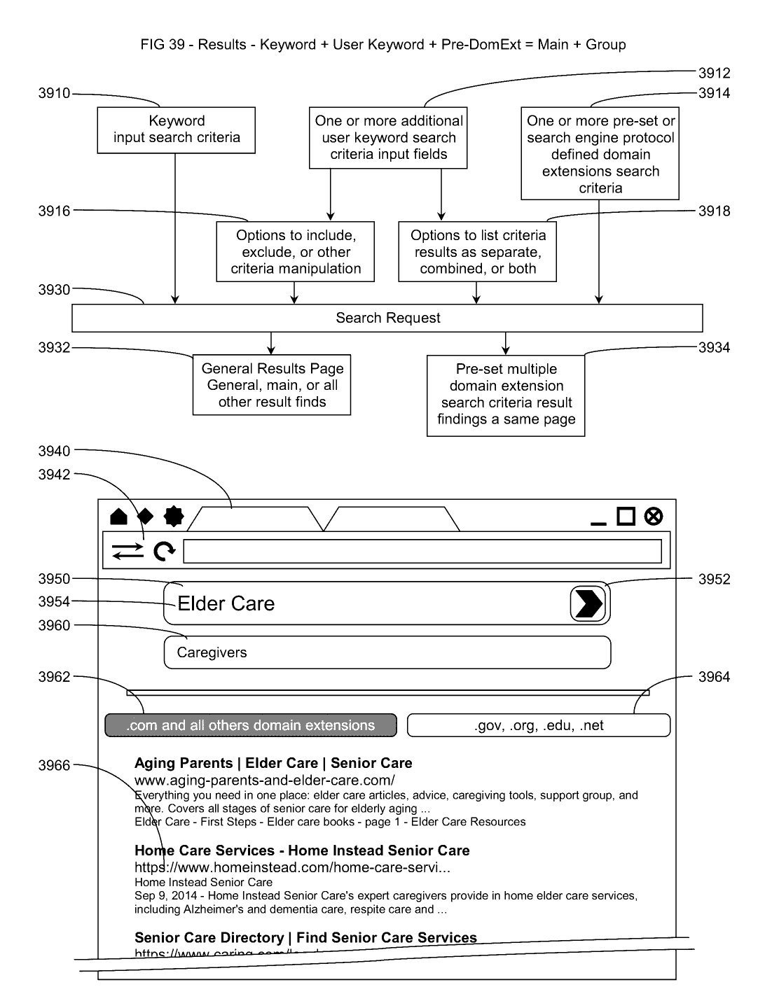

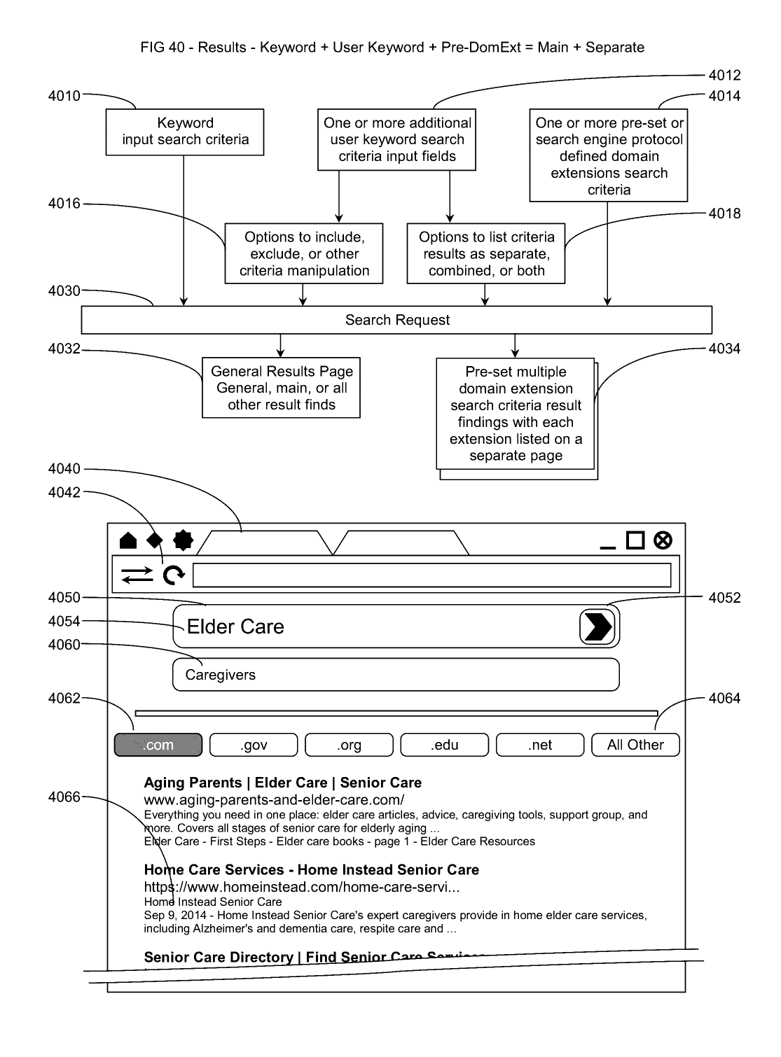

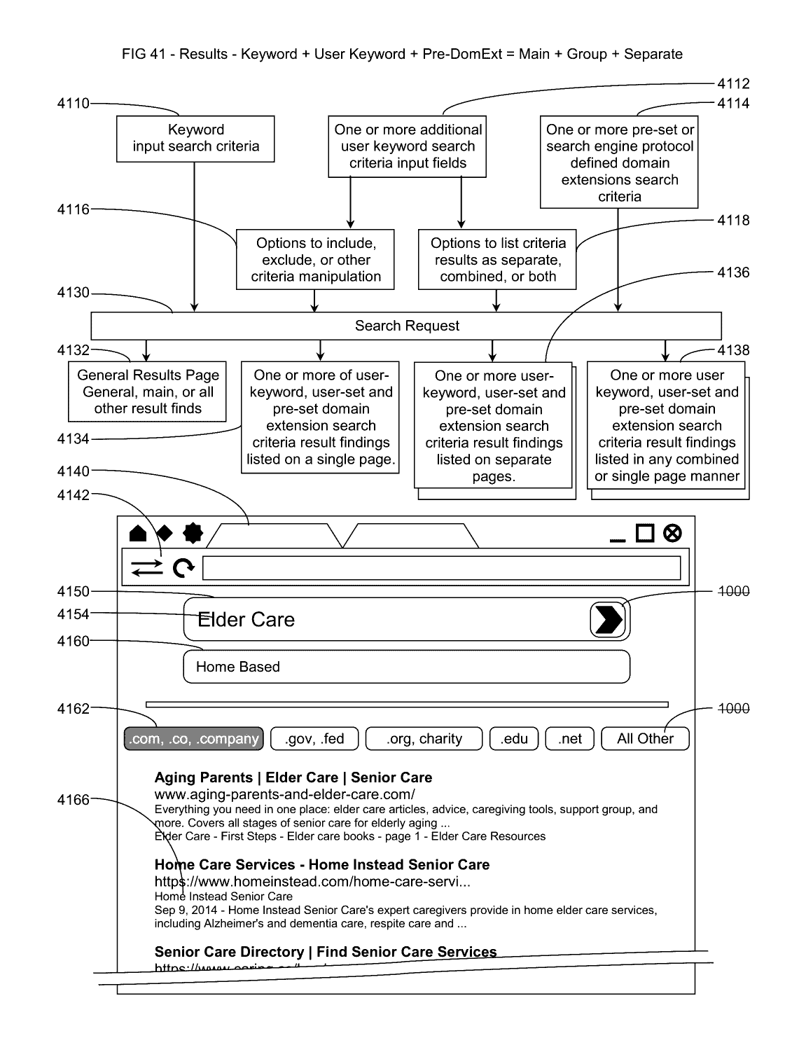

FIG. 38, FIG. 39, FIG. 40, and FIG. 41 are a collection of previous disclosures, now combined to create multiple functionality and benefits in more specific and relevant search criteria and culminating in more relevant and specific search results being presented in more clarifying, relevant, and useful manners. As examples, but not limited to these examples and their specific embodiments, this combination of features includes a keyword field, a second Content User keyword field, and a Content Manager Pre-Set Domain Extension with results presented on a main internet search results page string, a grouped, separated, or any of their combinations on the internet search interface or search results distribution interface. Although previously defined, the keyword field may accept any character, symbol, number, domain extension, by direct or indirect means, by interface or remotely by a physical tethered or by wireless untethered connection, and any of their combinations. Further when referring to input fields be it the keyword input field or other type of input fields as elsewhere herein defined, the keyword, Content User keyword, and Content Manager Pre-Set Domain Extension may be the same input field, separate input fields, or any of their combinations. The keyword field may be a keyword field, drop down list, radio button, scrolls, or other direct and indirect inputs, and as elsewhere defined, and any of their combinations. Represented are combinations all including a main internet search result page string, but this disclosure also includes internet search results that may be just grouped, all separated, or any of their combinations with or without the main internet search results page string. If not explicitly noted or displayed, it is implied that none, some, all, or any of the previously disclosed functionality of internet search interface and internet search results interface functionality and manipulations, biographical and performance data, geographical data, and all other disclosures, and any of their combinations may be incorporated and used to improve search and result display specificity, relevance, clarity, and utility.

FIG. 38—Results—KW+User KW+PreS DExt=Main

FIG. 38 is an example, and not limited to this example, and incorporates all relevant disclosure herein, of a Semi-Simple Search Screen Interface including: (1) a primary keyword input field for one or more keywords, (2) one or more additional keyword input fields for one or more keywords, (3) one or more Content Manager defined domain extensions, and (4) any of their combinations as previously more specifically defined. This disclosure specifically addresses solutions incorporating internet search result formats using: (1) a main page string as previously more specifically defined. The combination of the features of the Semi-Simple Search Interface and the more organized internet search result formats is a more Content User control, more accurate search results, and more effective results. The focus of this disclosure is the primary keyword input field, one or more additional keyword input fields, removal of the Content User defined domain extensions, but with Content Manager Pre-Set domain extensions with results reported on the main page string.

Disclosed in this method is a primary keyword search criteria input field 3810 for one or more keywords, one or more Content User defined internet search keyword input fields 3812 for one or more keywords, one or more Content Manager Pre-Set domain extensions 3814 and any of their full or partial present or absent combinations. A specific feature of this disclosure and a relevant possibility to any of the disclosures within this document's many disclosures is the ability to have inclusive or exclusive search criteria 3816. This disclosure also shows that the one or more primary keywords and one or more additional Content User keywords may be used in addition to search criteria as criteria to parse internet search results to the main page string, grouped page strings or separate page strings 3818, and lastly shows the Content Manager Pre-Set domain extensions having a direct influence upon internet search and results formatting. Alterations and variations in contribution of the primary keyword input field and keywords, additional input fields and keywords, and Content Manager Pre-Set domain extensions has been previously addressed. With Content User defined one or more keywords in a primary input field, one or more Content User keywords in one or more other keyword input fields, the presence of Content Manager Pre-Set domain extensions, and any of their full or partial present or absent combinations the search request 3830 may follow and internet search results returned. A main page string 3832 of internet search results is populated with all internet search results from all search criteria.

The system apparatus is shown, and as a reference the illustration shows an active webpage tab 3840 with general search engine functions and URL bar 3842 as common elements among search engines. Also universal among search engines is the simple search field 3850 and search request button 3852. Shown also is the Content User defined two keyword phrase 3854 written in an inclusive form to return search results. Further disclosed on the Semi-Simple Search Interface and in this case a Semi-Simple Search interface on the internet search results page is the presence of a one or more multiple keyword input fields 3860 and one or more Content User keyword input fields with one or more keywords 3862, and in this case allowing for direct character input. Expressed in other specific disclosures is direct options to chose inclusion and exclusion, but in this particular example the keyword is input in an inclusive form, but keywords may be input in an exclusionary format. In this particular example there is an emphasis on a Semi-Simple Search Interface with a one or more additional input field and Content Manager Pre-Set domain extensions. With respect to the presentation of internet search results what is show is an example of a main page string 3862 with all search results collected together. This is just one option of various discussed as to how internet search results may be presented.

It is apparent how the Semi-Simple Search Interface and related search results interface now become much more effective and useful for the Content User. This disclosure provides for a more Content User controlled internet experience and more effective internet search result experience.

FIG. 39—Results—KW+User KW+PreS DExt=Main+Group

FIG. 39 is an example, and not limited to this example, and incorporates all relevant disclosure herein, of a Semi-Simple Search Screen Interface including: (1) a primary keyword input field for one or more keywords, (2) one or more additional keyword input fields for one or more keywords, (3) one or more Content Manager defined domain extensions, and (4) any of their combinations as previously more specifically defined. This disclosure specifically addresses solutions incorporating internet search result formats using: (1) a main page string and (2) grouped page strings, and (3) any of their combinations as previously more specifically defined. The combination of the features of the Semi-Simple Search Interface and the more organized internet search result formats is a more Content User control, more accurate search results, and more effective results. This disclosure differs from the previous by the inclusion of parsing internet search results on a main page string and grouped page strings.

Disclosed in this method is a primary keyword search criteria input field 3910 for one or more keywords, one or more Content User defined internet search keyword input fields 3912 for one or more keywords, one or more Content Manager Pre-Set domain extensions 3914 and any of their full or partial present or absent combinations. A specific feature of this disclosure and a relevant possibility to any of the disclosures within this document's many disclosures is the ability to have inclusive or exclusive search criteria 3916. This disclosure also shows that the one or more primary keywords and one or more additional Content User keywords may be used in addition to search criteria as criteria to parse internet search results to the main page string, grouped page strings or separate page strings 3918, and lastly shows the Content Manager Pre-Set domain extensions having a direct influence upon internet search and results formatting. Alterations and variations in contribution of the primary keyword input field and keywords, additional input fields and keywords, and Content Manager Pre-Set domain extensions has been previously addressed. With Content User defined one or more keywords in a primary input field, one or more Content User keywords in one or more other keyword input fields, the presence of Content Manager Pre-Set domain extensions, and any of their full or partial present or absent combinations the search request 3830 may follow and internet search results returned. A main page string 3932 of internet search results is populated with, all, some, left over, odd, outlier, or other results not categorized by other criteria, and any of their combinations. It is possible that there may not be a main page string of results at all, but whether there is or is not is within the scope of this and other disclosures herein. A grouped page string 3934 directs that any combination of two or more criteria from any keyword or domain extension are listed on a single page string creating one or more grouped page strings. Further included within the scope of this disclosure is any form of combination of a main page string and grouped page strings of search results presentation, parsing, and organizing.

The system apparatus is shown, and as a reference the illustration shows an active webpage tab 3940 with general search engine functions and URL bar 3942 as common elements among search engines. Also universal among search engines is the simple search field 3950 and search request button 3952. Shown also is the Content User defined two keyword phrase 3954 written in an inclusive form to return search results. Further disclosed on the Semi-Simple Search Interface and in this case a Semi-Simple Search interface on the internet search results page is the presence of a one or more multiple keyword input fields 3960 allowing for direct character input. Note that in this example the keywords input fields are accompanied by options to include the criteria in search results or exclude the criteria, as well as options on how the internet search results will be presented or parsed on to the main page string and grouped page strings. These mentioned fields are just one example of how a Content Manager may choose to build their Semi-Simple Search interface for the original search interface or as in this case returned with search results on the page string.

More specific to the return of the internet search results disclosed in this figure is the presence of two groups of page strings. In this disclosure the keywords bring forward search results that are parsed by Content Manager Pre-Set defined domain extensions. One grouped page string is a type of main page string that includes all .com and all other domain extension not otherwise included in the second page string 3962. This is a type of main or catch-all grouped page string. The second grouped page string shows it is composed of four domain extensions of .gov, .org, .edu, and .net 3964. Shown is that the .com and all other domain extensions 3962 is highlighted or selected and as such the associated internet search results item listing 3966 is shown. The result is a more effective search with one or more additional search criteria input and more utility and clarity with a separation of internet search results by largely commercial and non-commercial internet listings. This specific choice of separation is just an example, but not intended to be a limiting example as group among a main page and one or more grouped pages may take various forms.

It is apparent how the Semi-Simple Search Interface and related search results interface now become much more effective and useful for the Content User. Made available is the ability to quickly seek results specifically associated with their search request by topic in this case identified by the Content Manager Pre-Set domain extensions. This disclosure provides for a more Content User controlled internet experience and more effective internet search result experience.

FIG. 40—Results—KW+User KW+PreS DExt+Main+Separate

FIG. 40 is an example, and not limited to this example, and incorporates all relevant disclosure herein, of a Semi-Simple Search Screen Interface including: (1) a primary keyword input field for one or more keywords, (2) one or more additional keyword input fields for one or more keywords, (3) one or more Content Manager defined domain extensions, and (4) any of their combinations as previously more specifically defined. This disclosure specifically addresses solutions incorporating internet search result formats using: (1) a main page string, (2) separate page strings, and (3) any of their combinations as previously more specifically defined. The combination of the features of the Semi-Simple Search Interface and the more organized internet search result formats is a more Content User control, more accurate search results, and more effective results. This disclosure differs from the previous by the inclusion of parsing internet search results on a main page string and separated page strings.

Disclosed in this method is a primary keyword search criteria input field 4010 for one or more keywords, one or more Content User defined internet search keyword input fields 4012 for one or more keywords, one or more Content Manager Pre-Set domain extensions 4014 and any of their full or partial present or absent combinations. A specific feature of this disclosure and a relevant possibility to any of the disclosures within this document's many disclosures is the ability to have inclusive or exclusive search criteria 4016. This disclosure also shows that the one or more primary keywords and one or more additional Content User keywords may be used in addition to search criteria as criteria to parse internet search results to the main page string, grouped page strings or separate page strings 4018, and lastly shows the Content Manager Pre-Set domain extensions having a direct influence upon internet search and results formatting. Alterations and variations in contribution of the primary keyword input field and keywords, additional input fields and keywords, and Content Manager Pre-Set domain extensions has been previously addressed. With Content User defined one or more keywords in a primary input field, one or more Content User keywords in one or more other keyword input fields, the presence of Content Manager Pre-Set domain extensions, and any of their full or partial present or absent combinations the search request 3830 may follow and internet search results returned. As with other specific disclosure examples the Content Manager Pre-Set domain extensions may be used as search criteria, but in this and other cases shows a focus on guiding the presentation and parsing of internet search results listings. A main page string 4032 of internet search results is populated with, all, some, left over, odd, outlier, or other results not categorized by other criteria, and any of their combinations. It is possible that there may not be a main page string of results at all, but whether there is or is not is within the scope of this and other disclosures herein. One or more separate page strings 4034 is disclosed to occur for any one criteria parsed onto their own separate page string as identified for a particular keyword or domain extension from any source. Further included within the scope of this disclosure is any form of combination of a main page string and separate page strings of search results presentation, parsing, and organizing.

The system apparatus is shown, and as a reference the illustration shows an active webpage tab 4040 with general search engine functions and URL bar 4042 as common elements among search engines. Also universal among search engines is the simple search field 4050 and search request button 4052. Shown also is the Content User defined two keyword phrase 4054 written in an inclusive form to return search results. Further disclosed on the Semi-Simple Search Interface and in this case a Semi-Simple Search interface on the internet search results page is the presence of a one or more multiple keyword input fields 4060 and one or more multiple Content User definable domain extension input fields 4062, and in this case allowing for direct character input to build the domain extension or select from a drop down list. Note that in this example the keyword and domain extension input fields are accompanied by options to include the criteria in search results or exclude the criteria, as well as options on how the internet search results will be presented or parsed on to the main page string or separate page strings. These mentioned fields are just one example of how a Content Manager may choose to build their Semi-Simple Search interface for the original search interface or as in this case returned with search results on the page string.

More specific to the return of the internet search results disclosed in this figure is the presence of two keywords with resulting internet search results items listings parsed across multiple separate page strings plus a main page string containing all search results not parsed onto the separate page strings. Noticed is that the search criteria 4054 and 4060 do not specify a domain extensions, but search results are shown to be separated on a .com, .gov, .org, .edu, and .net page strings 4062 and a catch all main page string 4064. As such, it is concluded that the Content Manager Pre-Set domain extensions include .com, .gov, .org, .edu, and .net. Shown is the selection of the .com separated page string 4062 and associated internet search results items listing 4066.

Immediately apparent is the increased specificity to the search by Content User input of one or more additional search criteria and the separation of search results into practical, understandable, and equivalent page strings. Equivalent page strings by virtue that to a Content User a .gov page string may be the most important to them for government opinion, benefits, or programs. Similarly a Content User may see content for them equally important contained in .org, .edu, or other domain extensions. As such the content is equivalent, the first pages are equivalently important, and the first and first few page positions on each separated page string are also equivalent. All of these features represent increased specificity, accuracy, utility, and clarity from the ever increasing internet in capability and content. This disclosure provides for a more Content User controlled internet experience and more effective internet search result experience.

FIG. 41—Results—KW+User KW+PreS DExt=Main+Group+Separate

FIG. 41 is an example, and not limited to this example, and incorporates all relevant disclosure herein, of a Semi-Simple Search Screen Interface including: (1) a primary keyword input field for one or more keywords, (2) one or more additional keyword input fields for one or more keywords, (3) one or more Content Manager defined domain extensions, and (4) any of their combinations as previously more specifically defined. This disclosure specifically addresses solutions incorporating internet search result formats using: (1) a main page string, (2) grouped page strings, (3) separate page strings, and (4) any of their combinations as previously more specifically defined. The combination of the features of the Semi-Simple Search Interface and the more organized internet search result formats is a more Content User control, more accurate search results, and more effective results. This disclosure differs from the previous by the inclusion of parsing internet search results on a main page string, and both grouped page strings and separated page strings.

Disclosed in this method is a primary keyword search criteria input field 4110 for one or more keywords, one or more Content User defined internet search keyword input fields 4112 for one or more keywords, one or more Content Manager Pre-Set domain extensions 4114 and any of their full or partial present or absent combinations. A specific feature of this disclosure and a relevant possibility to any of the disclosures within this document's many disclosures is the ability to have inclusive or exclusive search criteria 4116. This disclosure also shows that the one or more primary keywords and one or more additional Content User keywords may be used in addition to search criteria as criteria to parse internet search results to the main page string, grouped page strings or separate page strings 4118, and lastly shows the Content Manager Pre-Set domain extensions having a direct influence upon internet search and results formatting. Alterations and variations in contribution of the primary keyword input field and keywords, additional input fields and keywords, and Content Manager Pre-Set domain extensions has been previously addressed. With Content User defined one or more keywords in a primary input field, one or more Content User keywords in one or more other keyword input fields, the presence of Content Manager Pre-Set domain extensions, and any of their full or partial present or absent combinations the search request 3830 may follow and internet search results returned. A main page string 4132 of internet search results is populated with, all, some, left over, odd, outlier, or other results not categorized by other criteria, and any of their combinations. It is possible that there may not be a main page string of results at all, but whether there is or is not is within the scope of this and other disclosures herein. One or more grouped page string 4134 stating that any combination of two or more criteria from any keyword or domain extension are listed on a single page string creating one or more grouped page strings. One or more separate page string 4136 is disclosed to occur for any one criteria parsed onto their own separate page string as identified for a particular keyword or domain extension from any source. A further reinforcement that any combination of grouped or separate page string formats 4138 may occur as designated by one or more Content User keywords and Content Manager Pre-Set domain extensions, and any of their combinations. 4134, 4136, and 4138 show a full inclusion of Content User-Set and Content Manager Pre-Set options, but in this disclosure only the Content Manager Pre-Set features are active. Further included within the scope of this disclosure is any form of combination of a main page string, grouped page strings, and separate page strings of search results presentation, parsing, and organizing.

The system apparatus is shown, and as a reference the illustration shows an active webpage tab 4140 with general search engine functions and URL bar 4142 as common elements among search engines. Also universal among search engines is the simple search field 4150 and search request button 4152. Shown also is the Content User defined two keyword phrase 4154 written in an inclusive form to return search results. Further disclosed on the Semi-Simple Search Interface and in this case a Semi-Simple Search interface on the internet search results page is the presence of a one or more multiple keyword input fields 4160 and one or more multiple Content Manager Pre-Set definable domain extensions show upon search completion by the domain extension tabs 4162. This Semi-Simple Search Interface and follow on results interface do not offer explicit options for inclusion or exclusion of search results, but such is achieved with or without search modifiers, currently such as: keyword only, +, −, NOT, AND, etc. In this case each keyword is inclusive or search results associated with the keyword will be included in the internet search results. Note that in this example the keyword input fields are not accompanied by options to include the criteria in search results or exclude the criteria by input into the keyword input field. It is the option of the Content Manager to recognize a domain extension in the keyword input field and then use that domain extension for parsing search results based upon one or more domain extensions. Use of the domain extension for parsing search results may be an automatic function if there is a domain extension present, by a field that appears when there is a domain extension recognized, by use of a modified to the keyword or domain extension, such as SORT .club, other mechanisms practices, and any of their combinations.

More specific to the return of the internet search results disclosed in this figure is the presence of the search results from the two keyword phrase search criteria being separated and parsed among grouped page strings 4162 with more than one domain extension associated on the page string, single domain extensions separated on a single page strings 4162, and a main or catch all page string 4164. As the Semi-Simple Search Interface did not offer domain extension choices in or about the input field 4150 and 4160 the parsing into domain extension is based on page strings as a results of Content Manager Pre-Set domain extensions and associations. Content Manager Pre-Set domain extensions may exist whether or not there are Content User options to interface with these or other domain extensions. Another instructive disclosure unmarked is the inclusion of general results returned under the main page string button or tab called All Others and contains all other search results not included on other page strings or not under another tab. Specifically shown is the association into a grouped page string of commercial based domain extensions 4162 with .com, .co, and .company. 4162 also shows a government grouped page string with .gov and .fed, a non-profit grouped page string with .org and the keyword charity, a single domain extension of .edu on a separate page string, as well as .net associated finding on a separate page string. Again, also follows in the collection of all other search results under the main page string or All Other pages string 4164. Specifically shown is the selection of the .com, .co. and .company grouped page string tab and associated internet search results items listing 4166.

It is apparent how the Semi-Simple Search Interface and related search results interface becomes much more effective and useful for the Content User. Made available is the ability to more accurately target search results with the added specificity of one or more additional search criteria input fields and then more effectively use those results with their rational association among major or minor search result topics, in this case being association by domain extensions or keywords. This disclosure provides for a more Content User controlled internet experience and more effective internet search result experience.

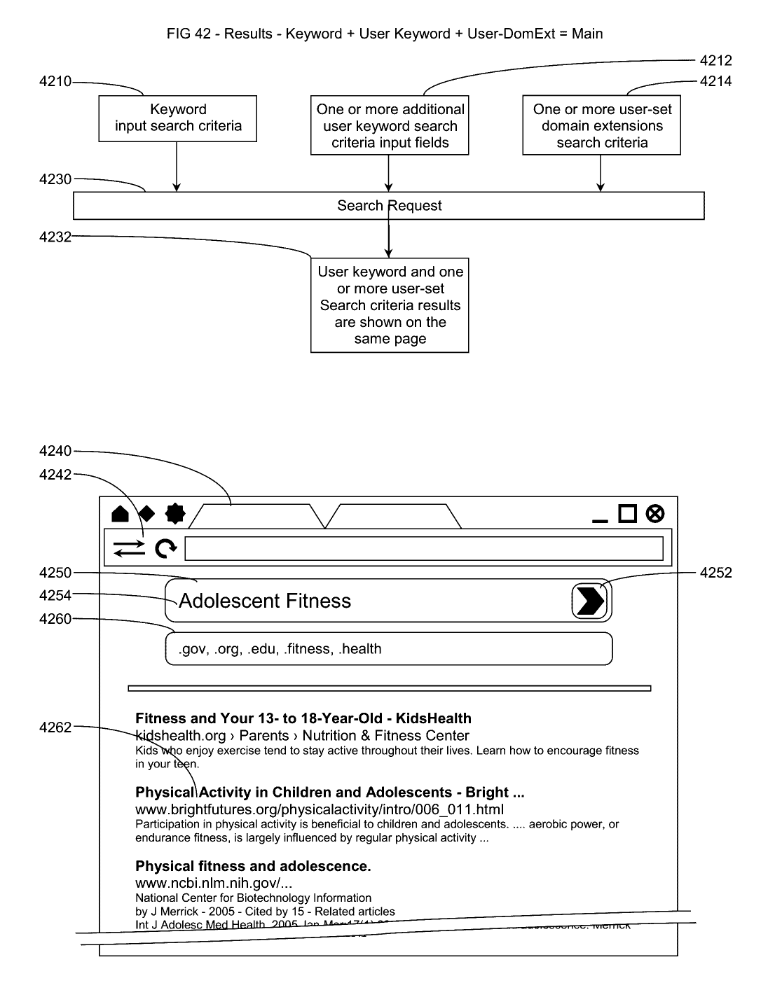

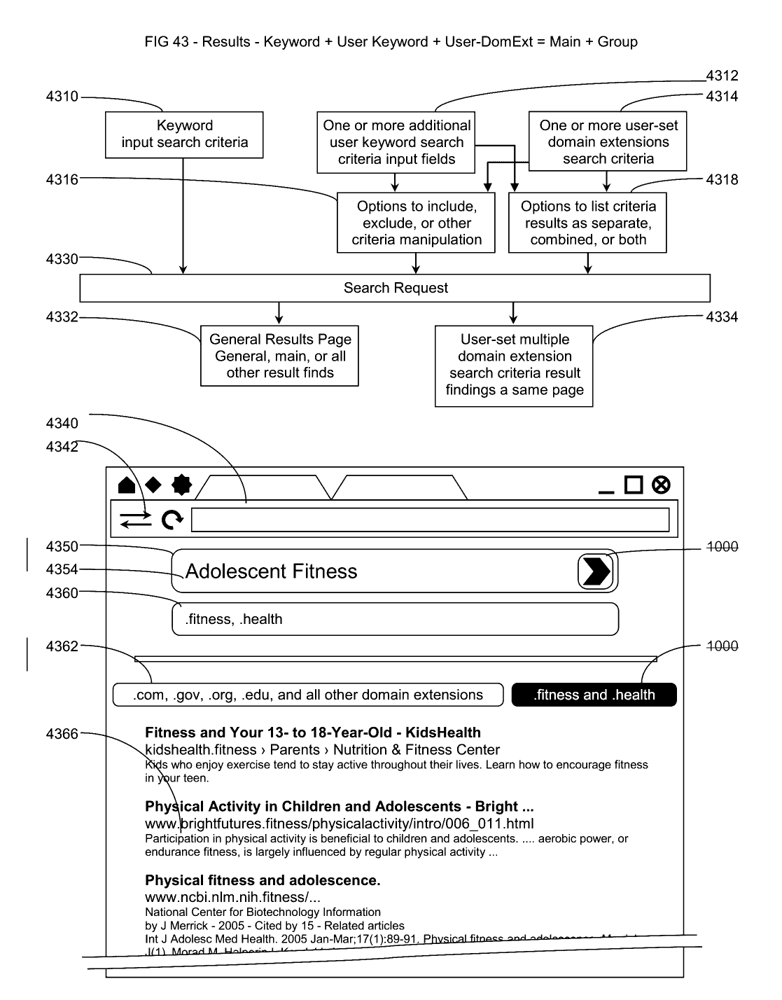

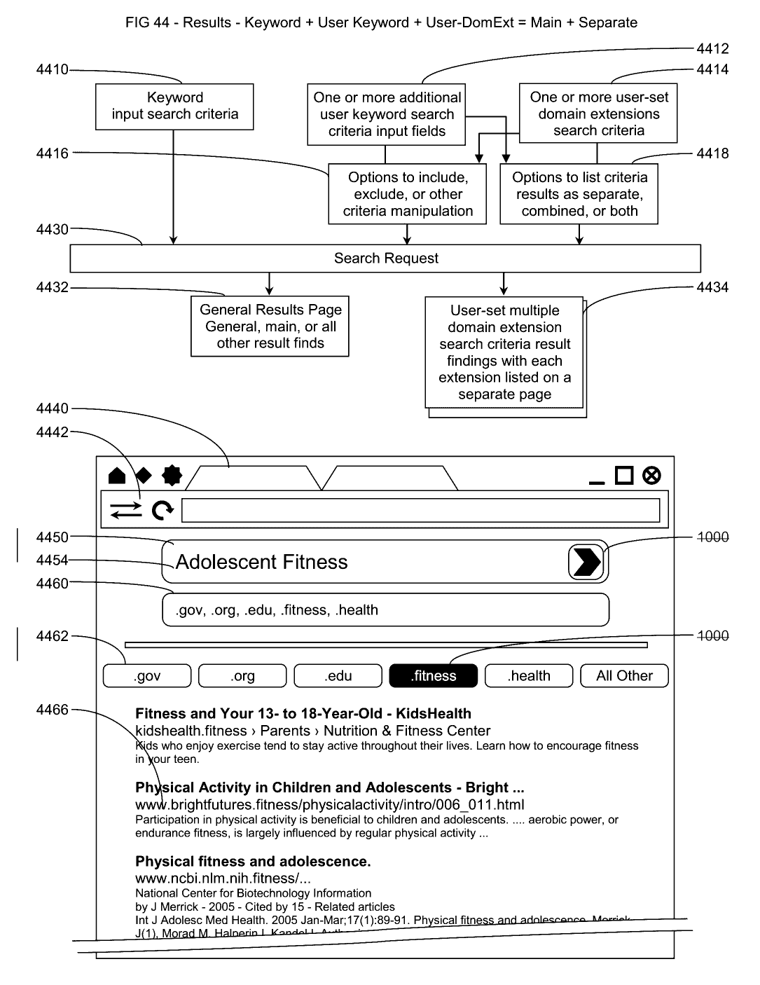

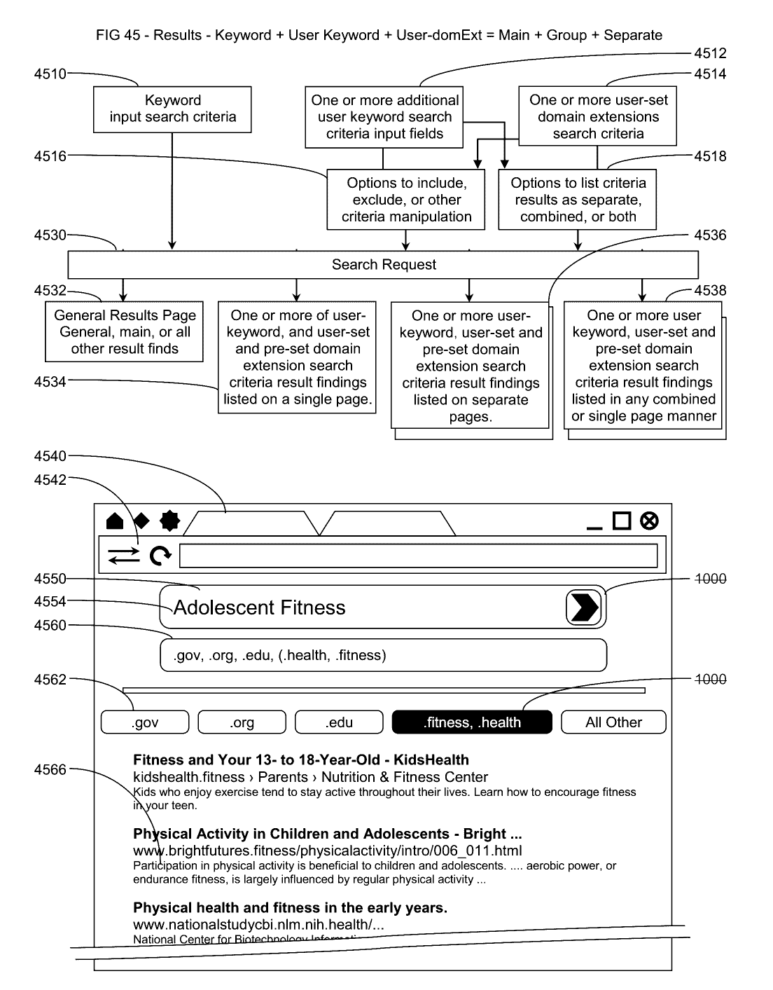

FIG. 42, FIG. 43, FIG. 44, and FIG. 45 are a collection of previous disclosures, now combined to create multiple functionality and benefits in more specific and relevant search criteria and culminating in more relevant and specific search results being presented in more clarifying, relevant, and useful manners. As examples, but not limited to these examples and their specific embodiments, this combination of features includes a keyword field, a second Content User keyword field, a Content User Domain Extension input field with results presented on a main internet search results page string, a grouped, separated, or any of their combinations on the internet search interface or search results distribution interface. Although previously defined, the keyword field may accept any character, symbol, number, domain extension, by direct or indirect means, by interface or remotely by a physical tethered or by wireless untethered connection, and any of their combinations. One combination may even be the use of more than one domain extension, such as .com.club.restaurant at a Content User level or code level. Further when referring to input fields be it the keyword input field or other type of input fields as elsewhere herein defined, the keyword, Content User keyword, and Content User Domain Extension may be the same input field, separate input fields, or any of their combinations. The keyword field may be a keyword field, drop down list, radio button, scrolls, or other direct and indirect inputs, and as elsewhere defined, and any of their combinations. Represented are combinations all including a main internet search result page string, but this disclosure also includes internet search results that may be just grouped, all separated, or any of their combinations with or without the main internet search results page string. If not explicitly noted or displayed, it is implied that none, some, all, or any of the previously disclosed functionality of internet search interface and internet search results interface functionality and manipulations, biographical and performance data, geographical data, and all other disclosures, and any of their combinations may be incorporated and used to improve search and result display specificity, relevance, clarity, and utility.

FIG. 42—Results—KW+User KW+User DExt=Main

FIG. 42 is an example, and not limited to this example, and incorporates all relevant disclosure herein, of a Semi-Simple Search Screen Interface including: (1) a primary keyword input field for one or more keywords, (2) one or more additional keyword input fields for one or more keywords, (3) one or more additional Content User defined domain extension input fields for one or more domain extensions, (4) any of their combinations as previously more specifically defined. This disclosure specifically addresses solutions incorporating internet search result formats using: (1) a main page string as previously more specifically defined. The combination of the features of the Semi-Simple Search Interface and the more organized internet search result formats is a more Content User control, more accurate search results, and more effective results. This disclosure differs from the previous by the removal of the Content Manager Pre-Set domain extensions and inclusion of Content User defined domain extensions with results reported on the main page string.

Disclosed in this method is a primary keyword search criteria input field 4210 for one or more keywords, one or more Content User defined internet search keyword input fields 4212 for one or more keywords, one or more Content User defined domain extensions specific input fields 4214 for one or more domain extensions, and any of their full or partial present or absent combinations. The fact that there are specific Content User domain extension input fields is simply an example of the type of input fields available, but domain extensions are not limited from being added to other fields. A specific feature of this disclosure that is a relevant possibility to any of the disclosures within this document's many disclosures is the ability to have inclusive or exclusive search criteria 4216. The application of the indicated inputs is show that the primary keyword has a direct relationship on the internet search and search results formatting, that the one or more additional Content User keywords and one or more Content User defined domain extensions have the option for being included or excluded 4216 from internet search results as well as being used to parse internet search results to the main page string. Alterations and variations in contribution of the primary keyword input field and keywords, additional input fields and keywords, Content User defined domain extensions has been previously addressed. With Content User defined one or more keywords in a primary input field, one or more Content User keywords in one or more other keyword input fields, one or more Content User defined domain extension criteria, and any of their full or partial present or absent combinations the search request 4230 may follow and internet search results returned. A main page string 4232 of internet search results is populated with all internet search results from all search criteria.

The system apparatus is shown, and as a reference the illustration shows an active webpage tab 4240 with general search engine functions and URL bar 4242 as common elements among search engines. Also universal among search engines is the simple search field 4250 and search request button 4252. Shown also is the Content User defined two keyword phrase 4254 written in an inclusive form to return search results. Further disclosed on the Semi-Simple Search Interface and in this case a Semi-Simple Search interface on the internet search results page is the presence of a one or more multiple keyword input fields 4260 shown in this case to contain multiple Content User domain extensions. The use of one or more additional keyword type input field is just one example of how a Content Manager may choose to build their Semi-Simple Search interface for the original search interface or as in this case returned with search results on the page string as shown in the internet search result main page string listing 4262.

It is apparent how the Semi-Simple Search Interface and related search results interface now become much more effective and useful for the Content User. This disclosure provides for a more Content User controlled internet experience and more effective internet search result experience.

FIG. 43—Results—KW+User KW+User DExt=Main+Group

FIG. 43 is an example, and not limited to this example, and incorporates all relevant disclosure herein, of a Semi-Simple Search Screen Interface including: (1) a primary keyword input field for one or more keywords, (2) one or more additional keyword input fields for one or more keywords, (3) one or more additional Content User defined domain extension input fields for one or more domain extensions, (4) any of their combinations as previously more specifically defined. This disclosure specifically addresses solutions incorporating internet search result formats using: (1) a main page string and (2) grouped page strings, and (3) any of their combinations as previously more specifically defined. The combination of the features of the Semi-Simple Search Interface and the more organized internet search result formats is a more Content User control, more accurate search results, and more effective results. This disclosure differs from the previous by the inclusion of parsing internet search results on a main page string and grouped page strings.

Disclosed in this method is a primary keyword search criteria input field 4310 for one or more keywords, one or more Content User defined internet search keyword input fields 4312 for one or more keywords, one or more Content User defined domain extensions specific input fields 4314 for one or more domain extensions, and any of their full or partial present or absent combinations. The fact that there are specific Content User domain extension input fields is simply an example of the type of input fields available, but domain extensions are not limited from being added to other fields. A specific feature of this disclosure that is a relevant possibility to any of the disclosures within this document's many disclosures is the ability to have inclusive or exclusive search criteria 4316. The application of the indicated inputs is show that the primary keyword has a direct relationship on the internet search and search results formatting, that the one or more additional Content User keywords and one or more Content User defined domain extensions have the option for being included or excluded 4316 from internet search results as well as being used to parse internet search results to the main page string, grouped page strings or separate page strings 4318, and having a direct influence upon internet search and results formatting. Alterations and variations in contribution of the primary keyword input field and keywords, additional input fields and keywords, and Content User defined domain extensions has been previously addressed. With Content User defined one or more keywords in a primary input field, one or more Content User keywords in one or more other keyword input fields, one or more Content User defined domain extension criteria, and any of their full or partial present or absent combinations the search request 4330 may follow and internet search results returned. A main page string 4332 of internet search results is populated with, all, some, left over, odd, outlier, or other results not categorized by other criteria, and any of their combinations. It is possible that there may not be a main page string of results at all, but whether there is or is not is within the scope of this and other disclosures herein. A grouped page string 4334 stating that any combination of two or more criteria from any keyword or domain extension are listed on a single page string creating one or more grouped page strings. Further included within the scope of this disclosure is any form of combination of a main page string and grouped page strings of search results presentation, parsing, and organizing.

The system apparatus is shown, and as a reference the illustration shows an active webpage tab 4340 with general search engine functions and URL bar 4342 as common elements among search engines. Also universal among search engines is the simple search field 4350 and search request button 4352. Shown also is the Content User defined two keyword phrase 4354 written in an inclusive form to return search results. Further disclosed on the Semi-Simple Search Interface and in this case a Semi-Simple Search interface on the internet search results page is the presence of a one or more multiple keyword input fields 4360 with one or more keywords or domain extensions. In this case there is displayed two domain extensions in an inclusive format.

The example of this disclosure shows that with a search call 4352 that internet search results are parsed and presented into two grouped page strings. One is the main page string 4362 that is shown to contain various domain extensions, but essentially represents all internet search results from keywords and domain extension not parsed out as fitness and .health grouped page string 4364. Shown is the highlighted .fitness and .health page string tab 4364 showing internet search results items listing 4366. These mentioned fields are just one example of how a Content Manager may choose to build their Semi-Simple Search interface for the original search interface or as in this case returned with search results on the page string.

It is apparent how the Semi-Simple Search Interface and related search results interface now become much more effective and useful for the Content User. Made available is the ability to quickly seek results specifically associated with their search request by topic they identify or identified by the Content Manager. This disclosure provides for a more Content User controlled internet experience and more effective internet search result experience.

FIG. 44—Results—KW+User KW+User DExt=Main+Separate

FIG. 44 is an example, and not limited to this example, and incorporates all relevant disclosure herein, of a Semi-Simple Search Screen Interface including: (1) a primary keyword input field for one or more keywords, (2) one or more additional keyword input fields for one or more keywords, (3) one or more additional Content User defined domain extension input fields for one or more domain extensions, (4) any of their combinations as previously more specifically defined. This disclosure specifically addresses solutions incorporating internet search result formats using: (1) a main page string, (2) separate page strings, and (3) any of their combinations as previously more specifically defined. The combination of the features of the Semi-Simple Search Interface and the more organized internet search result formats is a more Content User control, more accurate search results, and more effective results. This disclosure differs from the previous by the inclusion of parsing internet search results on a main page string and separated page strings.

Disclosed in this method is a primary keyword search criteria input field 4410 for one or more keywords, one or more Content User defined internet search keyword input fields 4412 for one or more keywords, one or more Content User defined domain extensions specific input fields 4414 for one or more domain extensions, and any of their full or partial present or absent combinations. The fact that there are specific Content User domain extension input fields is simply an example of the type of input fields available, but domain extensions are not limited from being added to other fields. A specific feature of this disclosure that is a relevant possibility to any of the disclosures within this document's many disclosures is the ability to have inclusive or exclusive search criteria 4416. The application of the indicated inputs is show that the primary keyword has a direct relationship on the internet search and search results formatting, that the one or more additional Content User keywords and one or more Content User defined domain extensions have the option for being included or excluded 4416 from internet search results as well as being used to parse internet search results to the main page string, grouped page strings or separate page strings 4418, and having a direct influence upon internet search and results formatting. Alterations and variations in contribution of the primary keyword input field and keywords, additional input fields and keywords, and Content User defined domain extensions has been previously addressed. With Content User defined one or more keywords in a primary input field, one or more Content User keywords in one or more other keyword input fields, one or more Content User defined domain extension criteria, and any of their full or partial present or absent combinations the search request 4430 may follow and internet search results returned. A main page string 4432 of internet search results is populated with, all, some, left over, odd, outlier, or other results not categorized by other criteria, and any of their combinations. It is possible that there may not be a main page string of results at all, but whether there is or is not is within the scope of this and other disclosures herein. A separate page string 4434 is disclosed to occur for any one criteria parsed onto their own separate page string as identified for a particular keyword or domain extension from any source. Further included within the scope of this disclosure is any form of combination of a main page string and separate page strings of search results presentation, parsing, and organizing.

The system apparatus is shown, and as a reference the illustration shows an active webpage tab 4440 with general search engine functions and URL bar 4442 as common elements among search engines. Also universal among search engines is the simple search field 4450 and search request button 4452. Shown also is the Content User defined two keyword phrase 4454 written in an inclusive form to return search results. Further disclosed on the Semi-Simple Search Interface and in this case a Semi-Simple Search interface on the internet search results page is the presence of a one or more multiple keyword input fields 4460. Displayed in this disclosure is one or more additional keyword and domain extension input field 4460 that takes keywords and character input for one or more keywords and domain extensions. Further in this disclosure all the domain extensions are shown to be inclusion, but could be made exclusive. These mentioned fields are just one example of how a Content Manager may choose to build their Semi-Simple Search interface for the original search interface or as in this case returned with search results on the page string.

More specific to the return of the internet search results disclosed in this figure is the presence of separate page strings and the main or “all other” page string 4462. Shown are multiple Content User defined domain extensions for searching, parsing, or any other combinations onto separate page string tabs in this case being .gov, .org, .edu, .fitness, .health, and all others. Further disclosed is the selection of the .fitness page string tab 4464. By selecting this .fitness page string what is displayed are the internet search results item list 4466. Again, immediately disclosed is the utility of greater Content User control, greater internet search results accuracy, and better Content User experience with more rational internet search results items organization.

It is apparent how the Semi-Simple Search Interface and related search results interface now become much more effective and useful for the Content User. Made available is the ability to quickly seek results specifically associated with their search request by topic they identify or identified by the Content User. In this specific case that means internet search results parsed across multiple page strings with access tabs that create additional control and top level categorization, while also including a catch all page string. This disclosure provides for a more Content User controlled internet experience and more effective internet search result experience.

FIG. 45—Results—KW+User KW+User DExt=Main+Group+Separate

FIG. 45 is an example, and not limited to this example, and incorporates all relevant disclosure herein, of a Semi-Simple Search Screen Interface including: (1) a primary keyword input field for one or more keywords, (2) one or more additional keyword input fields for one or more keywords, (3) one or more additional Content User defined domain extension input fields for one or more domain extensions, (4) any of their combinations as previously more specifically defined. This disclosure specifically addresses solutions incorporating internet search result formats using: (1) a main page string, (2) grouped page strings, (3) separate page strings, and (4) any of their combinations as previously more specifically defined. The combination of the features of the Semi-Simple Search Interface and the more organized internet search result formats is a more Content User control, more accurate search results, and more effective results. This disclosure differs from the previous by the inclusion of parsing internet search results on a main page string, and both grouped page strings and separated page strings.

Disclosed in this method is a primary keyword search criteria input field 4510 for one or more keywords, one or more Content User defined internet search keyword input fields 4512 for one or more keywords, one or more Content User defined domain extensions specific input fields 4514 for one or more domain extensions, and any of their full or partial present or absent combinations. The fact that there are specific Content User domain extension input fields is simply an example of the type of input fields available, but domain extensions are not limited from being added to other fields. A specific feature of this disclosure that is a relevant possibility to any of the disclosures within this document's many disclosures is the ability to have inclusive or exclusive search criteria 4516. The application of the indicated inputs is show that the primary keyword has a direct relationship on the internet search and search results formatting, that the one or more additional Content User keywords and one or more Content User defined domain extensions have the option for being included or excluded 4516 from internet search results as well as being used to parse internet search results to the main page string, grouped page strings or separate page strings 4518, and having a direct influence upon internet search and results formatting. Alterations and variations in contribution of the primary keyword input field and keywords, additional input fields and keywords, and Content User defined domain extensions has been previously addressed. With Content User defined one or more keywords in a primary input field, one or more Content User keywords in one or more other keyword input fields, one or more Content User defined domain extension criteria, and any of their full or partial present or absent combinations the search request 4530 may follow and internet search results returned. A main page string 4532 of internet search results is populated with, all, some, left over, odd, outlier, or other results not categorized by other criteria, and any of their combinations. It is possible that there may not be a main page string of results at all, but whether there is or is not is within the scope of this and other disclosures herein. A grouped page string 4534 stating that any combination of two or more criteria from any keyword or domain extension are listed on a single page string creating one or more grouped page strings. One or more separate page string 4536 is disclosed to occur for any one criteria parsed onto their own separate page string as identified for a particular keyword or domain extension from any source. A further reinforcement that any combination of grouped or separate page string formats 4538 may occur as designated by the Content User keywords, domain extensions, and any of their combinations from a particular or any of the input fields. 4534, 4536, and 4538 show a full inclusion of Content User-Set and Content Manager Pre-Set options, but in this disclosure only the Content User-Set features are active. This disclosure example is focused on Semi-Simple Search Interface input criteria and internet search results parsing criteria that is Content User focused. Further included within the scope of this disclosure is any form of combination of a main page string, grouped page strings, and separate page strings of search results presentation, parsing, and organizing.

The system apparatus is shown, and as a reference the illustration shows an active webpage tab 4540 with general search engine functions and URL bar 4542 as common elements among search engines. Also universal among search engines is the simple search field 4550 and search request button 4552. Shown also is the Content User defined two keyword phrase 4554 written in an inclusive form to return search results. Further disclosed on the Semi-Simple Search Interface and in this case a Semi-Simple Search interface on the internet search results page is the presence of a one or more multiple keyword, domain extension, and any of their combination input fields 4560. A simple one or more additional input field is shown to add greatly to the specificity, control, and utility in accuracy and sorting of internet search results.

More specific to this disclosure is the parsing and presentation or sorting of internet search results among five page strings available through tabs .gov, .org, .edu, .fitness and .heath, and a main page string or catch-all page string in this case titled All Others. This embodiment of the disclosure shows that these page strings were Content User defined in the one or additional input field 4554. Further that each page string is as important and legitimate as the next. That is if the Content User was interested in .gov related internet search results for adolescent fitness in this case then that page string, the first page of that page string, and the first positions of that page string, the advertisements of that page string would be as important as the current practice of including all search results on a single page string, but much more organized and specific. Also disclosed is the association of .health, and .fitness to form a grouped association of internet search results under a common tab 4564 and as it is selected as the active page string then shown is the internet search results .health and .fitness items listing 4564. These mentioned fields are just one example of how a Content Manager may choose to build their Semi-Simple Search interface for the original search interface or as in this case returned with search results on the page string.

It is apparent how the Semi-Simple Search Interface and related search results interface now become much more effective and useful for the Content User. Made available is the ability to achieve more accurate results as defined by the Content User and to see those results presented in a more effective and useful form. This disclosure provides for a more Content User controlled internet experience and more effective internet search result experience.

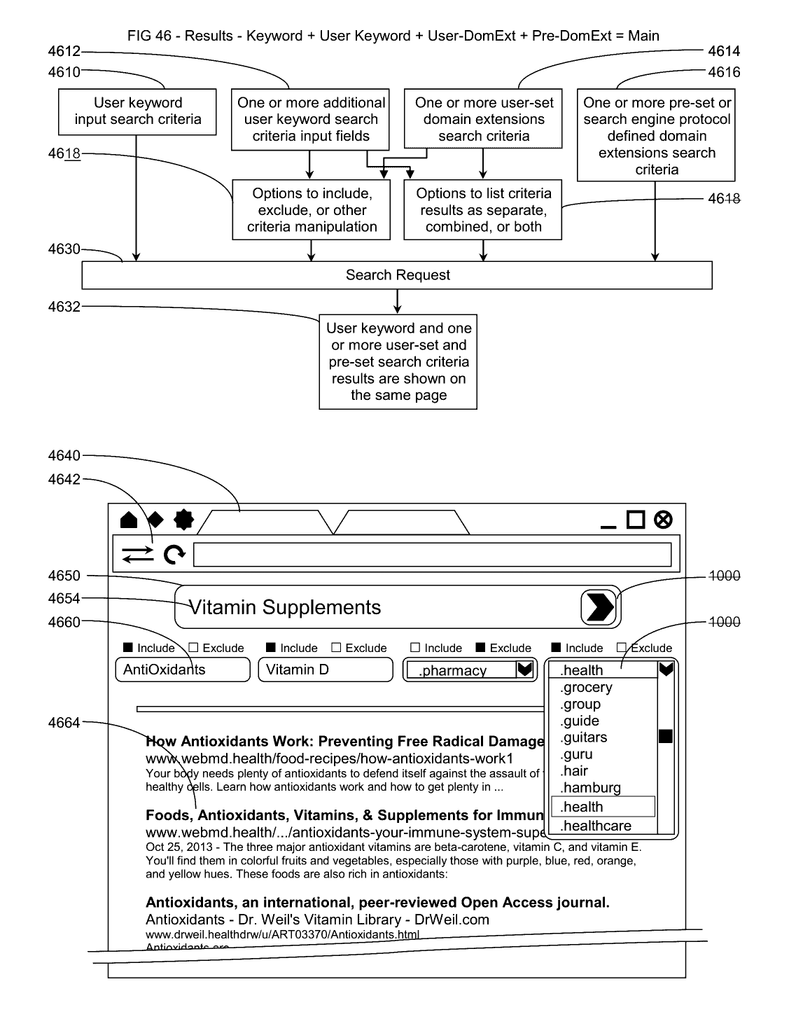

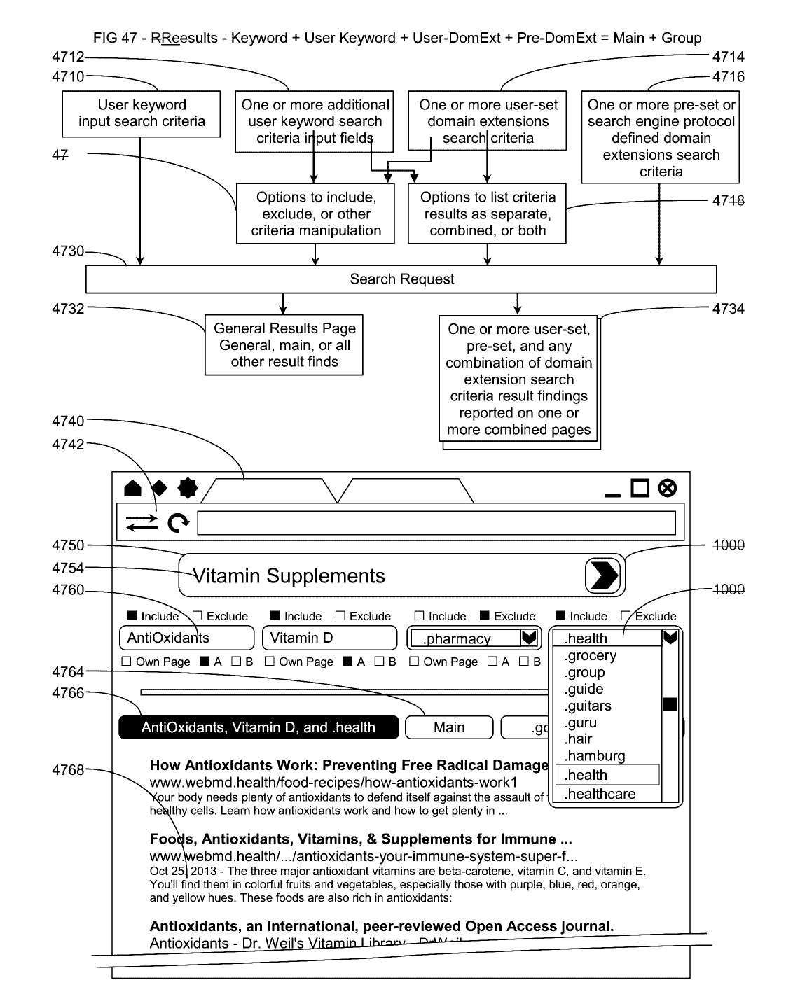

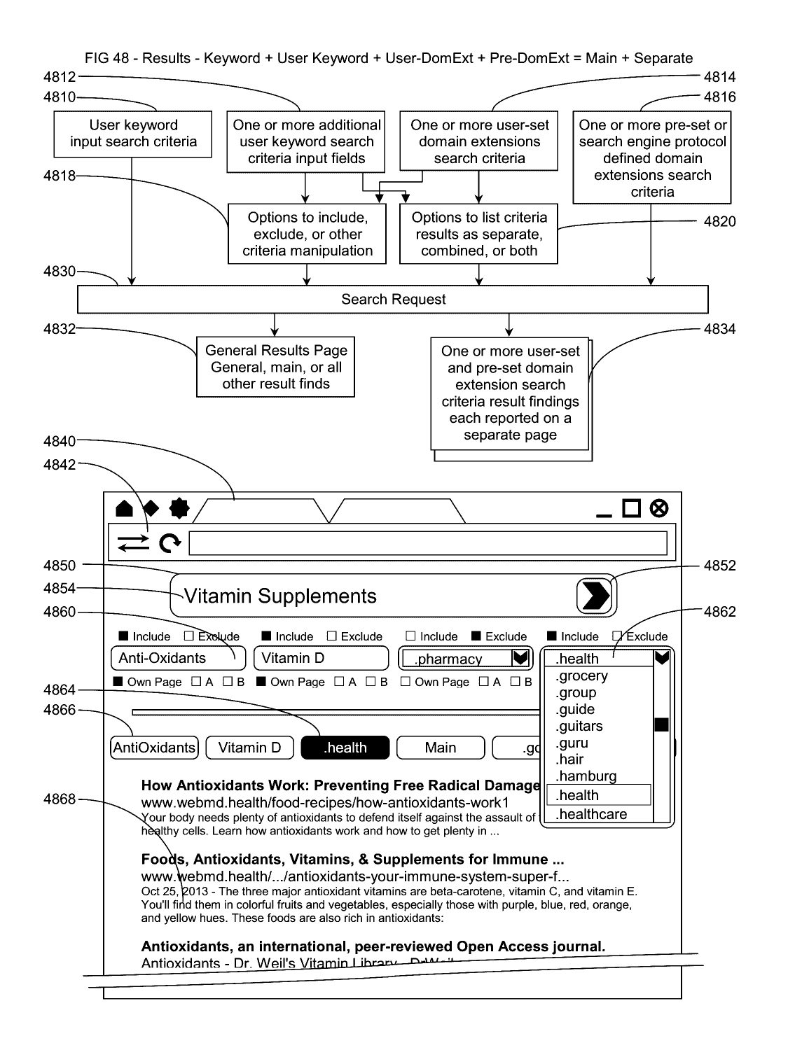

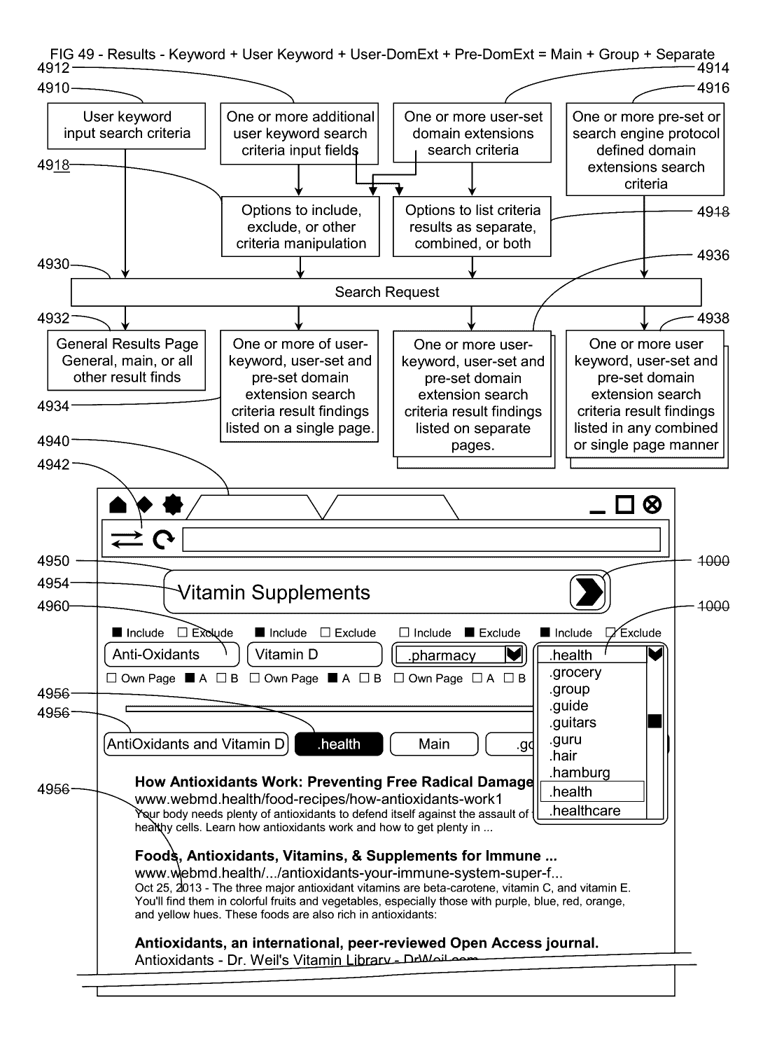

FIG. 46, FIG. 47, FIG. 48, and FIG. 49 are a collection of previous disclosures, now combined to create multiple functionality and benefits in more specific and relevant search criteria and culminating in more relevant and specific search results being presented in more clarifying, relevant, and useful manners. As examples, but not limited to these examples and their specific embodiments, this combination of features incorporates all relevant disclosure herein, of a common Semi-Simple Search Screen Interface among the following four figures and those figures varying in their retrieved internet search result formats.

The five search related features include: (S1) main keyword search criteria Content User input field for one or more keywords, (S2) one or more additional keyword search criteria Content User input field with one or more keywords, (S3) one or more Content User defined domain extension criteria separate or combined or specific or general input fields, (S4) one or more Content Manager Pre-Set domain extensions, and (S5) any of their full or partial present or absent criteria input combinations shown as a flow chart and as an apparatus system images.

The four varying internet search retrieved result format features among the following four figures include (1) a main page string for the presentation of all, part, remaining, left over, or other such catch-all depository of retrieved results, (2) one or more grouped page strings containing internet search retrieved results associated with two or more results presentation or parsing criteria such as two or more domain extensions, biographic criteria, demographic criteria, performance criteria, included keywords, excluded keywords, and any of their full or partial present or absent combinations, (3) one or more separate page strings containing internet search retrieved results associates with one results presentation or parsing criteria such as a domain extension, biographic criteria, demographic criteria, performance criteria, included keyword, excluded keyword, or other like criteria, and any of their full or partial present or absent combinations, and (4) any of the internet search retrieval results presentation or parsing main, grouped, and separated formats, and any of their full or partial present or absent combinations. Represented are disclosure combinations all including a main internet search result page string, but this disclosure also includes internet search results that may be just grouped, all separated, or any of their combinations with or without the main internet search results page string. If not explicitly noted or displayed, it is implied that none, some, all, or any of the previously disclosed functionality of internet search interface and internet search results interface functionality and manipulations, biographical and performance data, geographical data, and all other disclosures, and any of their combinations may be incorporated and used to improve search and result display specificity, relevance, clarity, and utility expressed in the following figures and disclosures.

FIG. 46—Results—KW+User KW+PreS DExt+User DExt=Main

FIG. 46 is an example, and not limited to this example, and incorporates all relevant disclosure herein, of a Semi-Simple Search Screen Interface including: (1) a primary keyword input field for one or more keywords, (2) one or more additional keyword input fields for one or more keywords, (3) one or more additional Content User defined domain extension input fields for one or more domain extensions, (4) one or more Content Manager defined domain extensions, and (5) any of their combinations as previously more specifically defined. This disclosure specifically addresses solutions incorporating internet search result formats using: (1) a main page string as previously more specifically defined. The combination of the features of the Semi-Simple Search Interface and the more organized internet search result formats is a more Content User control, more accurate search results, and more effective results. This disclosure differs from the previous by the inclusion of Content User defined domain extensions and Content Manager Pre-Set domain extensions with results reported on the main page string.

Disclosed in this method is a primary keyword search criteria input field 4610 for one or more keywords, one or more Content User defined internet search keyword input fields 4612 for one or more keywords, one or more Content User defined domain extensions specific input fields 4614 for one or more domain extensions, one or more Content Manager Pre-Set domain extensions 4616 and any of their full or partial present or absent combinations. The fact that there are specific Content User domain extension input fields is simply an example of the type of input fields available, but domain extensions are not limited from being added to other fields. A specific feature of this disclosure that is a relevant possibility to any of the disclosures within this document's many disclosures is the ability to have inclusive or exclusive search criteria 4618. The application of the indicated inputs is show that the primary keyword has a direct relationship on the internet search and search results formatting, that the one or more additional Content User keywords and one or more Content User defined domain extensions have the option for being included or excluded 4618 from internet search results as well as being used to parse internet search results to the main page string, grouped page strings or separate page strings 4620, and lastly shows the Content Manager Pre-Set domain extensions having a direct influence upon internet search and results formatting. Alterations and variations in contribution of the primary keyword input field and keywords, additional input fields and keywords, Content User defined domain extensions, and Content Manager Pre-Set domain extensions has been previously addressed. With Content User defined one or more keywords in a primary input field, one or more Content User keywords in one or more other keyword input fields, one or more Content User defined domain extension criteria, the presence of Content Manager Pre-Set domain extensions, and any of their full or partial present or absent combinations the search request 4630 may follow and internet search results returned. A main page string 4632 of internet search results is populated with all internet search results from all search criteria.

The system apparatus is shown, and as a reference the illustration shows an active webpage tab 4640 with general search engine functions and URL bar 4642 as common elements among search engines. Also universal among search engines is the simple search field 4650 and search request button 4652. Shown also is the Content User defined two keyword phrase 4654 written in an inclusive form to return search results. Further disclosed on the Semi-Simple Search Interface and in this case a Semi-Simple Search interface on the internet search results page is the presence of a one or more multiple keyword input fields 4660 and one or more multiple Content User definable domain extension input fields 4662, and in this case allowing for direct character input to build the domain extension or select from a drop down list. Note that in this example the keyword and domain extension input fields are accompanied by options to include the criteria in search results or exclude the criteria, as well as options on how the internet search results will be presented or parsed on to the main page string and grouped page strings. These mentioned fields are just one example of how a Content Manager may choose to build their Semi-Simple Search interface for the original search interface or as in this case returned with search results on the page string as shown in the internet search result main page string listing 4664.

Not specifically numbered, but present in the illustration are other informative features descriptive of the disclosure. One includes the .pharmacy domain extension that is noted for exclusion or any results identified with a pharmacy, or presumably but not necessarily a drug, not to be shown and so there is no single or group page string and any associated results should not be showing even on the main page string. Lastly, there is the presence of the .gov or .(dot)gov tab that does not show an option elsewhere on the Semi-Simple Search Interface and is therefore presumed to have been a Content Manager Pre-Set domain extension and in this case combined with all other search criteria on the main page string.

It is apparent how the Semi-Simple Search Interface and related search results interface now become much more effective and useful for the Content User. This disclosure provides for a more Content User controlled internet experience and more effective internet search result experience.

FIG. 47—Results—KW+User KW+PreS DExt+User DExt=Main+Group

FIG. 47 is an example, and not limited to this example, and incorporates all relevant disclosure herein, of a Semi-Simple Search Screen Interface including: (1) a primary keyword input field for one or more keywords, (2) one or more additional keyword input fields for one or more keywords, (3) one or more additional Content User defined domain extension input fields for one or more domain extensions, (4) one or more Content Manager defined domain extensions, and (5) any of their combinations as previously more specifically defined. This disclosure specifically addresses solutions incorporating internet search result formats using: (1) a main page string and (2) grouped page strings, and (3) any of their combinations as previously more specifically defined. The combination of the features of the Semi-Simple Search Interface and the more organized internet search result formats is a more Content User control, more accurate search results, and more effective results. This disclosure differs from the previous by the inclusion of parsing internet search results on a main page string and grouped page strings.

Disclosed in this method is a primary keyword search criteria input field 4710 for one or more keywords, one or more Content User defined internet search keyword input fields 4712 for one or more keywords, one or more Content User defined domain extensions specific input fields 4714 for one or more domain extensions, one or more Content Manager Pre-Set domain extensions 4716 and any of their full or partial present or absent combinations. The fact that there are specific Content User domain extension input fields is simply an example of the type of input fields available, but domain extensions are not limited from being added to other fields. A specific feature of this disclosure that is a relevant possibility to any of the disclosures within this document's many disclosures is the ability to have inclusive or exclusive search criteria 4718. The application of the indicated inputs is show that the primary keyword has a direct relationship on the internet search and search results formatting, that the one or more additional Content User keywords and one or more Content User defined domain extensions have the option for being included or excluded 4718 from internet search results as well as being used to parse internet search results to the main page string, grouped page strings or separate page strings 4720, and lastly shows the Content Manager Pre-Set domain extensions having a direct influence upon internet search and results formatting. Alterations and variations in contribution of the primary keyword input field and keywords, additional input fields and keywords, Content User defined domain extensions, and Content Manager Pre-Set domain extensions has been previously addressed. With Content User defined one or more keywords in a primary input field, one or more Content User keywords in one or more other keyword input fields, one or more Content User defined domain extension criteria, the presence of Content Manager Pre-Set domain extensions, and any of their full or partial present or absent combinations the search request 4730 may follow and internet search results returned. A main page string 4732 of internet search results is populated with, all, some, left over, odd, outlier, or other results not categorized by other criteria, and any of their combinations. It is possible that there may not be a main page string of results at all, but whether there is or is not is within the scope of this and other disclosures herein. A grouped page string 4734 stating that any combination of two or more criteria from any keyword or domain extension are listed on a single page string creating one or more grouped page strings. Further included within the scope of this disclosure is any form of combination of a main page string and grouped page strings of search results presentation, parsing, and organizing.

The system apparatus is shown, and as a reference the illustration shows an active webpage tab 4740 with general search engine functions and URL bar 4742 as common elements among search engines. Also universal among search engines is the simple search field 4750 and search request button 4752. Shown also is the Content User defined two keyword phrase 4754 written in an inclusive form to return search results. Further disclosed on the Semi-Simple Search Interface and in this case a Semi-Simple Search interface on the internet search results page is the presence of a one or more multiple keyword input fields 4760 and one or more multiple Content User definable domain extension input fields 4762, and in this case allowing for direct character input to build the domain extension or select from a drop down list. Note that in this example the keyword and domain extension input fields are accompanied by options to include the criteria in search results or exclude the criteria, as well as options on how the internet search results will be presented or parsed on to the main page string and grouped page strings. These mentioned fields are just one example of how a Content Manager may choose to build their Semi-Simple Search interface for the original search interface or as in this case returned with search results on the page string.

More specific to the return of the internet search results disclosed in this figure is the presence of two keywords parsed on the AntiOxidant and Vitamin D grouped page string 4766. Further in this disclosure is the combination of the Content User defined domain extensions and Content User defined keyword for an AntiOxidants, Vitamin D, and .health grouped tab 4766. Also shown in this disclosure are the internet search results listings 4768. Not specifically numbered, but present in the illustration are other informative features descriptive of the disclosure. One includes the .pharmacy domain extension that is noted for exclusion or any results identified with a pharmacy, or presumably but not necessarily a drug, not to be shown and so there is no single or group page string and any associated results should not be showing even on the main page string. Another instructive disclosure unmarked is the inclusion of general results returned under the Main button or tab and containing all other search results not included on other page strings or not under another tab. Lastly, there is the presence of the .gov or .(dot)gov tab that does not show an option elsewhere on the Semi-Simple Search Interface and is therefore presumed to have been a Content Manager Pre-Set domain extension and contains search results collected that are all government related.

It is apparent how the Semi-Simple Search Interface and related search results interface now become much more effective and useful for the Content User. Made available is the ability to quickly seek results specifically associated with their search request by topic they identify or identified by the Content Manager. In this specific case that means all information that at not a drug, not cluttered on just one main page string, and does not include government sites, yet if the Content User wanted to know what is said by the government concerning AntiOxidants and Vitamin D that they could go where it is conveniently collected. This disclosure provides for a more Content User controlled internet experience and more effective internet search result experience.

FIG. 48—Results—KW+User KW+PreS DExt+User DExt=Main+Separate

FIG. 48 is an example, and not limited to this example and incorporates all relevant disclosure herein, of a Semi-Simple Search Screen Interface including: (1) a primary keyword input field for one or more keywords, (2) one or more additional keyword input fields for one or more keywords, (3) one or more additional Content User defined domain extension input fields for one or more domain extensions, (4) one or more Content Manager defined domain extensions, and (5) any of their combinations as previously more specifically defined. This disclosure specifically addresses solutions incorporating internet search result formats using: (1) a main page string, (2) separate page strings, and (3) any of their combinations as previously more specifically defined. The combination of the features of the Semi-Simple Search Interface and the more organized internet search result formats is a more Content User control, more accurate search results, and more effective results. This disclosure differs from the previous by the inclusion of parsing internet search results on a main page string and separated page strings.

Disclosed in this method is a primary keyword search criteria input field 4810 for one or more keywords, one or more Content User defined internet search keyword input fields 4812 for one or more keywords, one or more Content User defined domain extensions specific input fields 4814 for one or more domain extensions, one or more Content Manager Pre-Set domain extensions 4816 and any of their full or partial present or absent combinations. The fact that there are specific Content User domain extension input fields is simply an example of the type of input fields available, but domain extensions are not limited from being added to other fields. A specific feature of this disclosure that is a relevant possibility to any of the disclosures within this document's many disclosures is the ability to have inclusive or exclusive search criteria 4818. The application of the indicated inputs is show that the primary keyword has a direct relationship on the internet search and search results formatting, that the one or more additional Content User keywords and one or more Content User defined domain extensions have the option for being included or excluded 4818 from internet search results as well as being used to parse internet search results to the main page string, grouped page strings or separate page strings 4820, and lastly shows the Content Manager Pre-Set domain extensions having a direct influence upon internet search and results formatting. Alterations and variations in contribution of the primary keyword input field and keywords, additional input fields and keywords, Content User defined domain extensions, and Content Manager Pre-Set domain extensions has been previously addressed. With Content User defined one or more keywords in a primary input field, one or more Content User keywords in one or more other keyword input fields, one or more Content User defined domain extension criteria, the presence of Content Manager Pre-Set domain extensions, and any of their full or partial present or absent combinations the search request 4830 may follow and internet search results returned. A main page string 4832 of internet search results is populated with, all, some, left over, odd, outlier, or other results not categorized by other criteria, and any of their combinations. It is possible that there may not be a main page string of results at all, but whether there is or is not is within the scope of this and other disclosures herein. A separate page string 4834 is disclosed to occur for any one criteria parsed onto their own separate page string as identified for a particular keyword or domain extension from any source. Further included within the scope of this disclosure is any form of combination of a main page string and separate page strings of search results presentation, parsing, and organizing.

The system apparatus is shown, and as a reference the illustration shows an active webpage tab 4840 with general search engine functions and URL bar 4842 as common elements among search engines. Also universal among search engines is the simple search field 4850 and search request button 4852. Shown also is the Content User defined two keyword phrase 4854 written in an inclusive form to return search results. Further disclosed on the Semi-Simple Search Interface and in this case a Semi-Simple Search interface on the internet search results page is the presence of a one or more multiple keyword input fields 4860 and one or more multiple Content User definable domain extension input fields 4862, and in this case allowing for direct character input to build the domain extension or select from a drop down list. Note that in this example the keyword and domain extension input fields are accompanied by options to include the criteria in search results or exclude the criteria, as well as options on how the internet search results will be presented or parsed on to the main page string or separate page strings. These mentioned fields are just one example of how a Content Manager may choose to build their Semi-Simple Search interface for the original search interface or as in this case returned with search results on the page string.

More specific to the return of the internet search results disclosed in this figure is the presence of two keywords each parsed on their separate AntiOxidant and Vitamin D page string 4866, the domain extension .health or .(dot)health as a single or separate page string 4864 and associated .health internet search result listings 4868. Not specifically numbered, but present in the illustration are other informative features descriptive of the disclosure. One includes the .pharmacy domain extension that is noted for exclusion or any results identified with a pharmacy, or presumably but not necessarily a drug, not to be shown and so there is no single or group page string and any associated results should not be showing even on the main page string. Another instructive disclosure unmarked is the inclusion of general results returned under the Main button or tab and containing all other search results not included on other page strings or not under another tab. Lastly, there is the presence of the .gov or .(dot)gov tab that does not show an option elsewhere on the Semi-Simple Search Interface and is therefore presumed to have been a Content Manager Pre-Set domain extension and contains search results collected that are all government related.

It is apparent how the Semi-Simple Search Interface and related search results interface now become much more effective and useful for the Content User. Made available is the ability to quickly seek results specifically associated with their search request by topic they identify or identified by the Content Manager. In this specific case that means all information that at not a drug, not cluttered on just one main page string, and does not include government sites, yet if the Content User wanted to know what is said by the government concerning AntiOxidants and Vitamin D that they could go where it is conveniently collected. This disclosure provides for a more Content User controlled internet experience and more effective internet search result experience.

FIG. 49—Results—KW+User KW+PreS DExt+User DExt=Main+Group+Separate

FIG. 49 is an example, and not limited to this example, and incorporates all relevant disclosure herein, of a Semi-Simple Search Screen Interface including: (1) a primary keyword input field for one or more keywords, (2) one or more additional keyword input fields for one or more keywords, (3) one or more additional Content User defined domain extension input fields for one or more domain extensions, (4) one or more Content Manager defined domain extensions, and (5) any of their combinations as previously more specifically defined. This disclosure specifically addresses solutions incorporating internet search result formats using: (1) a main page string, (2) grouped page strings, (3) separate page strings, and (4) any of their combinations as previously more specifically defined. The combination of the features of the Semi-Simple Search Interface and the more organized internet search result formats is a more Content User control, more accurate search results, and more effective results. This disclosure differs from the previous by the inclusion of parsing internet search results on a main page string, and both grouped page strings and separated page strings.

Disclosed in this method is a primary keyword search criteria input field 4910 for one or more keywords, one or more Content User defined internet search keyword input fields 4912 for one or more keywords, one or more Content User defined or Content User-Set domain extensions specific input fields 4914 for one or more domain extensions, one or more Content Manager Pre-Set domain extensions 4916 and any of their full or partial present or absent combinations. The fact that there are specific Content User domain extension input fields is simply an example of the type of input fields available, but domain extensions are not limited from being added to other fields. A specific feature of this disclosure that is a relevant possibility to any of the disclosures within this document's many disclosures is the ability to have inclusive or exclusive search criteria 4918. The application of the indicated inputs is show that the primary keyword has a direct relationship on the internet search and search results formatting, that the one or more additional Content User keywords and one or more Content User defined domain extensions have the option for being included or excluded 4918 from internet search results as well as being used to parse internet search results to the main page string, grouped page strings or separate page strings 4920, and lastly shows the Content Manager Pre-Set domain extensions having a direct influence upon internet search and results formatting. Alterations and variations in contribution of the primary keyword input field and keywords, additional input fields and keywords, Content User defined domain extensions, and Content Manager Pre-Set domain extensions has been previously addressed. With Content User defined one or more keywords in a primary input field, one or more Content User keywords in one or more other keyword input fields, one or more Content User defined domain extension criteria, the presence of Content Manager Pre-Set domain extensions, and any of their full or partial present or absent combinations the search request 4930 may follow and internet search results returned. A main page string 4932 of internet search results is populated with, all, some, left over, odd, outlier, or other results not categorized by other criteria, and any of their combinations. It is possible that there may not be a main page string of results at all, but whether there is or is not is within the scope of this and other disclosures herein. A grouped page string 4934 stating that any combination of two or more criteria from any keyword or domain extension are listed on a single page string creating one or more grouped page strings. A separate page string 4936 is disclosed to occur for any one criteria parsed onto their own separate page string as identified for a particular keyword or domain extension from any source. A further reinforcement that any combination of grouped or separate page string formats 4938 may occur as designated by the Content User keywords and domain extensions or Content Manager Pre-Set or otherwise designated keywords and domain extensions. Further included within the scope of this disclosure is any form of combination of a main page string, grouped page strings, and separate page strings of search results presentation, parsing, and organizing.

The system apparatus is shown, and as a reference the illustration shows an active webpage tab 4940 with general search engine functions and URL bar 4942 as common elements among search engines. Also universal among search engines is the simple search field 4950 and search request button 4952. Shown also is the Content User defined two keyword phrase 4954 written in an inclusive form to return search results. Further disclosed on the Semi-Simple Search Interface and in this case a Semi-Simple Search interface on the internet search results page is the presence of a one or more multiple keyword input fields 4960 and one or more multiple Content User definable domain extension input fields 4962, and in this case allowing for direct character input to build the domain extension or select from a drop down list. Note that in this example the keyword and domain extension input fields are accompanied by options to include the criteria in search results or exclude the criteria, as well as options on how the internet search results will be presented or parsed on to the main page string, grouped page strings, or separate page strings. These mentioned fields are just one example of how a Content Manager may choose to build their Semi-Simple Search interface for the original search interface or as in this case returned with search results on the page string.

More specific to the return of the internet search results disclosed in this figure is the presence of two keywords parsed on the AntiOxidant and Vitamin D grouped page string 4966, the domain extension .health or .(dot)health as a single or separate page string 4964 and associated .health internet search result listings 4968. Not specifically numbered, but present in the illustration are other informative features descriptive of the disclosure. One includes the .pharmacy domain extension that is noted for exclusion or any results identified with a pharmacy, or presumably but not necessarily a drug, not to be shown and so there is no single or group page string and any associated results should not be showing even on the main page string. Another instructive disclosure unmarked is the inclusion of general results returned under the Main button or tab and containing all other search results not included on other page strings or not under another tab. Lastly, there is the presence of the .gov or .(dot)gov tab that does not show an option elsewhere on the Semi-Simple Search Interface and is therefore presumed to have been a Content Manager Pre-Set domain extension and contains search results collected that are all government related.

It is apparent how the Semi-Simple Search Interface and related search results interface now become much more effective and useful for the Content User. Made available is the ability to quickly seek results specifically associated with their search request by topic they identify or identified by the Content Manager. In this specific case that means all information that at not a drug, not cluttered on just one main page string, and does not include government sites, yet if the Content User wanted to know what is said by the government concerning AntiOxidants and Vitamin D that they could go where it is conveniently collected. This disclosure provides for a more Content User controlled internet experience and more effective internet search result experience.

The disclosures of this application represent the innovations of Interactive Internet Interfaces, but the figures and their methods and system apparatuses, as well as written disclosures are examples, not to be limiting, to the total associated scope of the innovation. Again, what is associated in one specific figure of disclosure may readily be ascribed to another specific disclosure. The breadth and depth associated with the sparks of innovation and leaps of advancements extend well beyond what this simple, but even exhaustive attempt at capturing the totality of this invention. Persons having ordinary skill in the art will recognize the explicit and implicit reach of variation truly encompassed by the sparks of innovation of this disclosure.

### COMMON ELEMENTS, TERMINOLOGY, AND DEFINITIONS

Below is listed the terms of this disclosure provided in this consolidated manner for ease of location and understanding. There are many terms with some being similar and mutually supportive. Unless specifically identified, the terms below should be interpreted by both their specific definition, and how that definition fits with other terms and definitions listed below. Further, where the definition in whole or part is consistent with understanding of what is commonly understood as the definition of the word, term, or phrase then that definition is also supportive. The terms and definitions below are not so much to provide a new definition inconsistent with what is known popularly or technically among people having skill in the art, but more for clarification. It will be clear where a definition listed below seeks to uniquely define a word, term, or phrase and where known definitions remain supportive. There are also small variations of definitions that may occur throughout the disclosure which are intended to mean the same as the formal word, term, or phrase and the slight variation of the word, term, or phrase.

Act Independently

i. This term or concept, a variation or an equivalent, and their plural forms means the keyword search still remains the primary search criteria. The search engine and search protocol still need to know what the main topic of interest is and from that topic further refinement can be gained with additional keywords that specify what to include, keywords that specify what not to include, domain extension to include or exclude, biographical and performance criteria to include or exclude, and more.

Additional Input Interfaces

i. This term or concept, a variation or an equivalent, and their plural forms refers to any form of search criteria input by way of a text field, text area, drop down list, radio buttons, choice boxes, range selector, text choices, lists, second interface box, slider, dial, external wire or wireless communication, fields, relevance indicator, search parameter protocol interface, additional internet search result pages and their search inputs, or any other commonly used form of search influencing input. The field, relevance indicator, search parameter protocol interface, and other terms referring to the input of data would include what is mean by additional input interfaces, and the reciprocal also being true.

Additional Search Result Page

i. This term or concept and concept, a variation or an equivalent, and their plural forms represents search result pages created in addition to a main search result page. When referring to an Additional Search Result Page, it naturally means an additional first search result page with its unique search result criteria, or manually assembled individual search result items, on the first additional page and then the page string that follows that first additional page onto any needed page two, three, four, and more. An additional search result page may be created automatically as a part of the search function as it separates out a criteria such as .gov, .club, or vitamin D, etc. An additional search result page may be created after an initial search has been performed and individual search result items identified for separation to the additional search result page, and do so automatically upon identification or after refreshing the screen, after a new search, after a parse button click or other subsequent function. An additional search result page may be created as a blank page and then filled by drag and drop, after identification of individual search results are identified and a subsequent action taken, or other form or population. As with the main search result page the additional search result pages may have more or less of the same functionality to perform their own searches, with a primary keyword field, additional keyword inclusion and exclusion fields, domain extension inclusion and exclusion fields, and other search criteria. Like the main page, these additional search result pages can search by page content defined search criteria as an indicator or what is a better representation of desired search results. The additional search result page may be the combination of one or more criteria that separates away a class of search results. This criteria might be for instance the separation of government or .gov, education or .edu, organizations or .org, or other extension designations, keyword designations, or their combination. Additional search result page may be configured as accessible from within the main search page by a tab, clickable text, horizontal slide, segment at the bottom of the page, a new main or independent tab, or any other display.

Advanced Search

i. This term or concept, a variation or an equivalent, and their plural forms refers to a search criteria page with several or an abundant number of search criteria. It is also characteristic of search criteria that require certain standards or protocols to be used or some moderate to elevated search knowledge, linguistic knowledge, computer software or hardware knowledge, and the like. An advanced search would not be considered simple or semi-simple to most people. That is evident by the fact that most people do not use the advanced search criteria available with most search engines. The advanced search engine is complicated enough to deter use. All other search criteria pages and platforms that do not deter the moderately interested and compelled searcher is considered a simple, intuitive, or semi-simple search criteria or search criteria set, or search criteria page, and the like.

Content Manager

i. This term or concept, a variation or an equivalent, and their plural forms means the individual, organization, or other entity that provides Search Engine and Search Protocol, and Search Interface that provide internet interface, search results, and the internet experience as commonly known. Manager represents that these organizations design their interface, their protocols determine what is made available, and make other determinations on behalf of Content Users and Content Providers as to their internet results and experience. Typical examples would be Google, Bing, Yahoo, Ask, and several other entities, as well as government, university, organizations, and individuals that provide access to content. Although this could be its own definition, it has little to do with the focus of this invention, and that is the Content Manager will also include all infrastructure and infrastructure managers. Essentially, Content Manager represents the totality of the internet from hardware, software, and policies.

Content Provider

i. This term or concept, a variation or an equivalent, and their plural forms means a person, organization, or any source of information that makes a website, blog, or otherwise makes information available on the internet. Content Providers includes all content related to information, commerce, entertainment, education, public information, government service, and all else. The Content Provides is further defined in the broadest sense as including providing information not commonly available to search engines but made available to by direct internet address or other protocol access. In its broadest sense a Content Provider also includes any information that they may directly or indirectly make available to others to include that others provide such information that then becomes searchable, identifiable, retrievable, and available to Content Users by Content Mangers and their associated search engines, algorithms, and protocols to provide internet results and the general expectation of internet experience.

Content User

i. This term or concept, a variation or an equivalent, and their plural forms means a person, organization, or any input guidance, criteria, or stimulus from any direct or indirect internet interface that guides and directs a Content Managers or search engine to deliver results of internet content for viewing, manipulation, commerce, education, awareness, or any other purpose available from the results. The Content User is the internet user. If a computer of internet access device is used by more than one individual, and there is not a sign in, then the Content User is associated with the computer and will be the combination of all user preferences. When a log in to search is used, the Content User is the preferences and direction from the users of that log in. If the log in or sign in is for an individual then it will be an individual's preferences and guidance. If the log in is shared by other then it will be the combination of all log in user preferences, behaviors, and direction.

Content User Interface

i. This term or concept, a variation or an equivalent, and their plural forms refers to locations on the internet interface, the page, screen, and as commonly understood to allow for input of search criteria information, or other parameters as may be desired or required. It may also be considered a Content User Interface. The use of a search Content User Interface is common in the populous of those using the internet. When the term input, criteria, search, information, or other term is implying it is being used for a search, and input, or otherwise manipulate search results, an individual internet search site, or otherwise information is needed to be transfer for use by search engines, search protocols, or other electronic means, then a Content User Interface is assumed present and used as expected for that entry. That Content User Interface may be a small box of defined character length or a space of undefined input amount, a radio button, and check box, a slider, or any other commonly known and used points of information input and activation. The Content User Interface applies to fields, input areas for words or numbers or both, buttons, check boxes, sliders, or other input intakes for searches. The Content User Interface also applies to non-search internet interaction. A add on a screen is accompanied by a Content User Interface that allows for the Content User to indicate their interest in the ad. If a person searches for a car part or a unique gift and that moment is past, then the Content Provider and the Content Manager are wasting their resources on the Content User when the likelihood of calling the Content User to action is small, or is not disturbing to the Content User and their internet experience. Better for the Content Manager is to take that advertising space and offer it to another Content Provider that is currently relevant and not now irrelevant. Presenting irrelevant advertisement make the Content Provider less attractive for future relevance, but also make the Content Manager look and feel incompetent to the Content User. Having a Content User Interface associated with an ad in a list, or a pop up ad, remarketing ad, display ad, or any other paid or unpaid advertisement allows the Content User to define the internet experience they value, not what is forced on them by a past interest or need. The Content User Interface allows for present interests of the Content User and not an internet experience based on past Content User needs and Interests. The benefit to the Content Provider is that their ads are placed with potentially more interested Content Users. The Content Manager benefits by have a service that is more relevant and satisfying to the Content User and providing Content Providers more potential from their ads giving a better association of the Content Managers platform, services, experience and drawing the Content User back and recommending to others the Content Managers unique platform.

Content User Added Search Criteria

i. This term or concept, a variation or an equivalent, and their plural forms refers to any input required to effectuate a search and the process of requesting the search. Content User Added Search Criteria also adopts the definitions of search criteria and keywords.

Content User Keyword Search Criteria

i. This term or concept, a variation or an equivalent, and their plural forms refers to any input required to effectuate a search and the process of requesting the search. Content User Keyword Search Criteria also adopts the definitions of search criteria and keywords.

Content User search criteria interface

i. This term or concept, a variation or an equivalent, and their plural forms refers to any method of Content User interaction, input, and directives for a search. It includes, but is not limited to keyword fields; word phrases and fields; lists to choose from whether they are presented as drop-downs, radio buttons, choice boxes, or other form; suggested content; or any other form of input. Adopts the same definition as Content User Interface and Field.

Disposition Interfaces

i. This term or concept, a variation or an equivalent, and their plural forms refers to any method of Content User interaction, input, and directives to guide search results to be reported separate, grouped, or their combination based on one or more additional Content User search criteria. As in all cases with this disclosure and its various embodiments, that Content User interface may be radio buttons, check boxes, lists, drop downs, drag and drops, associated fields, fields that groups any criteria in them and so separate grouping would mean only one criteria is in the field, an attached page number to show relevant association, a field with an associated page by a button or drop down that shows any with the same page would be associated and all others disassociated or disassociated as indicated by the different button or drop downs, and other methods, and their combinations. The disposition being moving up the page or priority, moving down page or priority, moving in any direction or priority, deleting permanently from showing up, deleting temporarily or for a time, hiding, waiting, delaying, increasing frequency, or other change in location, direction, priority, or ranking.

Domain Extensions

i. This term or concept, a variation or an equivalent, and their plural forms means that a domain extension is define as known in the industry. This includes the “.” period or dot followed by a set of letter, such as .gov, .edu, .org, .net, .us, etc. Contained in the expression of domain as known in the industry and expressed elsewhere herein, includes any domain extension designation “.”, “xn--”, or other followed by letters, characters, symbols, images, or any of their combinations. Another common industry name of the domain extension is Top-Level Domains or TLD and additions to former TLDs are Generic Top-Level Domains of gTLDs. When referring to domain extensions this includes TLDs, gTLDs, and any other “.” period or dot format to include strings of “.” period or dot formats, for example second-level domains .co.uk, .gov.uk, .fs.usda.gov, etc. A domain name as known in the industry also includes various international forms such as those starting with xn-- or other domain extension designations. A domain extension is any format that is used in the internet industry, in whatever format of symbols, characters, numbers, or other manifestations, and their combinations. The domain extension is recognized for its unique authority and classification among symbols, characters, numbers, other manifestations and their combinations. Further a basic level, a domain extension in this disclosure is also recognized as a form of keyword. Meaning it is simply a set of letters, symbols, numbers or other manifestations that can be used as an internet search criteria or internet search result criteria for sorting, parsing, formatting, separating, grouping, or other clarifying use action, and their combinations. Although a domain extension may be considered a keyword, or type of keyword, it will usually be separated out as a domain extension for emphasis, clarity, and acknowledgement of its unique character within the internet.

Domain Extension and Keyword Association

i. This term or concept, a variation or an equivalent, and their plural forms means that a domain extension may not be specified as part of the search criteria, but the keyword or other search criteria used in the search criteria are associated with by convention, by word root, by context, by affiliated words with the keyword, other means, or their combinations. As an example if a Content User typed Generic Name Drug, then the search engine would associate that search at least in part with the .pharmacy domain extension. More than one extension may be used. Further search results may be ordered by domain extension or may be placed on one or more additional pages. As another example a Content User may type the word restaurant and have it associated with the domain extension of .restaurant, .cafe, .club, etc. Further the search engine may preferentially then place sites with domain extensions most closely related to the keyword to the top of the search results page and one ranking criteria. The reverse association may also occur with a person selecting a domain and adding keywords. The algorithm may find preferential associations based upon the domain extension and the keyword and other Content User search criteria, and of course Content Manager criteria to make final ranking.

Enhanced Internet Interface

i. This term or concept, a variation or an equivalent, and their plural forms means a title or term descriptive of an internet search method that will accept one or more two or more search inputs in addition to keyword entry, or that provide one or more post search refinements in addition to new keyword entry, or that will deliver Internet organic search results that are parsed in two or more ways, or that will deliver Internet organic search results that can be parsed in two or more ways by the Content User, or any combination the these same elements.

Fields

i. This term or concept, a variation or an equivalent, and their plural forms refers to locations on the internet interface, the page, screen, and as commonly understood to allow for input of search criteria information, or other parameters as may be desired or required. The use of a search field is common in the populous of those using the internet. When the term input, criteria, search, information, or other term is implying it is being used for a search, and input, or otherwise manipulate search results, an individual internet search site, or otherwise information is needed to be transfer for use by search engines, search protocols, or other electronic means, then a field is assumed present and used as expected for that entry. That field may be a small box of defined character length or a space of undefined input amount, a radio button, and check box, a slider, or any other commonly known and used points of information input and activation. This also includes data input by other devices remotely by wire or wireless communication means.

General Search Results

i. This term or concept, a variation or an equivalent, and their plural forms refers to the search that typically occurs under current search engine processes. This term would also be referred to as the main search results. Keywords are added and then a result is returned. It is a general search result as every element that could be identified an separated out remains grouped. In the example of a .gov domain extension being used to separate out all such related websites and placed onto an additional internet search result page, then there would be a specialized additional page with presumably all .gov websites and content and the main or general search result that still contains all information, all domains of all extensions, and so on.

Inclusion and Exclusion Searching

i. These terms, variations, equivalents, and their plural forms mean that a search, internet search relevant search, or any inquiry of the internet or of already provides search results include that the search may use keywords and other search criteria to include or exclude individual search results associated with the search criteria.

Identifiers

i. This term or concept, a variation or an equivalent, and their plural forms refers to the use of identifying information or identifiers such as biographic, demographic, geographic, performance data, and other unique information characteristic of a person or organization, and any of their combinations. Information not connected or indirectly connected to the performance of the website on the web or with search engines and search protocols. The information is used as it is representative of the organization and how they fulfill upon their internet messages, services, and products. Biographical information relates to what the individual or organization is, their values, what they stand for, their principles, although this in an example of attributes and not an exhaustive list. Such information includes, but is not limited to: financial information in total sale, not just internet sales; revenue, profits, cash, stocks, and other financial information; size of the organization by counting employees, total assets, or other metrics; social measure of general diversity, minority ownership or leadership, greenness, charitable giveback; brand awareness, likely followership around the web to a different page, degree of authority, and other measures. In this disclosure the use of this information may place large retailers onto a separate. Some biographical search factors can be similar or exact to those of performance factors and in general there is little need to distinguish between the two and their larger definition places them in a similar category. Demographic information would relate to how the person or organization fits into society or as an organization, what their internal society or collective character can be defined, such as: number of ethnicity, education, gender, and other general group factors. Geographic information relates to where a person or organization resides, travels, often frequents, has operations, manufacturing, sales activity, product distribution, and other location based type information. Performance information relates to what the individual or organization accomplishes, does, action, and more; although this in an example of attributes and not an exhaustive list. Such information includes, but is not limited to: financial information in total sale, not just internet sales; revenue, profits, cash, stocks, and other financial information; size of the organization by counting employees, total assets, or other metrics; social measure of general diversity, minority ownership or leadership, greenness, charitable giveback; brand awareness, likely followership around the web to a different page, degree of authority, and other measures. In this disclosure the use of this information may place large retailers onto a separate page string. Some performance search factors can be similar or exact to those of biographical factors and in general there is little need to distinguish between the two and their larger definition places them in a similar category.

Individual Relevance

i. This term or concept, a variation or an equivalent, and their plural forms means that individual search result items are assessed as to their relevancy to many factors. Depending upon the context, those factors may be assessable criteria by the search engine and search protocols, it may be a judgment call by the Content User as to their relevance against the search results, it may be a judgment by the Content User that the information hold unexpected interest to the search results or to them personally, or other criteria and their combinations. True relevancy is in the mind of the Content User.

Individual Search Result or Individual Search Result Item

i. This term or concept, a variation or an equivalent, and their plural forms refers to a website, blog, paper, advertisement, or other single element of internet content that is displayed to the Content User. An individual search result is expected to act independent of other search results, such as it can be opened independently, its contents viewed independently, and so on, and then the Content User can return to the search result page to find the search result in tact.

Interfaces

i. This term or concept, a variation or an equivalent, and their plural forms means any interactive bridge between the Content User and the internet. It refers to the internet simple search criteria input screen, the internet Semi-Simple Search criteria input screen, the internet search results screens in any format, and any internet interaction means whether direct such as an input or indirectly such as remotely or from some other tethered or wired or wireless device, and any of their combinations.

Intra-Page

i. This term or concept, a variation or an equivalent, and their plural forms means the internet search result site is listed at some position and ranking within the main search result page or an additional internet search result page it is on.

Inter-Page

i. This term or concept, a variation or an equivalent, and their plural forms refers to an individual internet search result site being positioned and ranked on a different page or tab showing somewhat of a disconnect or independence to other information. It may have shown upon originally the tab or other page or on an additional internet search result page or from that page to a main page or more main pages.

Internet

i. This term or concept, a variation or an equivalent, and their plural forms means the Internet is also referred to as the World Wide Web is a system of private and public interconnected local to global computers and networks using universal software protocols to accept, store, and make available content on the system to be found, identified, retrieved, and delivered by the combination of Content Providers, Content Managers, and Content Users.

Internet Content

i. This term or concept, a variation or an equivalent, and their plural forms means any information residing on the Internet that is accessible directly, indirectly, with or without permission, or their combination that is made available and accessible by the combination of Content Providers, Content Managers, and Content Users. Internet content would be the same as the word content if such is used.

Internet Interface

i. This term or concept, a variation or an equivalent, and their plural forms means a term referring to any device or method that a Content User interacts by sight, touch, hearing, or other senses directly or indirectly to provide search or address criteria. It is also the means by which Content Providers and Content Managers interact with the Internet to create what is common known as the internet and expectations around interacting with the internet.

Internet Search Criteria Interface

i. This term or concept, a variation or an equivalent, and their plural forms included the above Internet Interface and Internet Interface included Internet Search Criteria Interface. These terms also distinguish themselves from intranet searches. Intranet searches being referred to as searches done within a website which can have more search options, than presently experienced with internet searches.

Intranet and Intranet Searches

i. This term or concept, a variation or an equivalent, and their plural forms refers to searches done within a website or related websites, not just website linked, but otherwise not related. An Internet search is conducted across all websites or with the World Wide Web infrastructure.

Individual Internet Search Result Item

i. This term or concept, a variation or an equivalent, and their plural forms refers to any element brought forward from a search and placed on a page. This may include, but not limited to lists of web addresses, domains, images, videos, web pages, websites, and all other commonly seen and experienced content resulting from an internet search. This term refers to the individual items that can be acted upon to open up specific content. Often this placement is in a list form, but takes many other forms as well. The use of the work internet in this definition does not exclude results and items or sites from an intranet search.

Intuitive

i. This term or concept, a variation or an equivalent, and their plural forms refers Content Users acting based on what they sense to be true even without conscious reasoning. As an example, Content Users will look at a semi-simple search page and layout and at first experience largely understand the components and their purpose and largely understand they can take an action and that action will largely lead to an expected result. The number of search criteria in the layout need not detract from the intuitive nature of each component. With some limited experience the semi-simple search become increasing understood, intuitive, and more simple. Intuitive can be defined by such current levels of semi-simple searches as shown in FIG. 2 where there may be numerous search criteria, but each largely suggesting the needed action and the expected result. Intuitive does not necessarily dismiss the need for a modest amount of knowledge or understanding either already held or needed to be gained. In this disclosure intuitive extends from what is defined as the simple search and up to but not inclusive of an advanced search.

Keyword

i. This term or concept, a variation or an equivalent, and their plural forms includes one or more words or a phrase, symbol, character, number, biographic information, geographic information, demographic information, performance information, SEC code, domain extension, or other acceptable single or multiple criteria, and any of their combinations input directly or indirectly by remote, wireless, other device, or by an action assigned to a button, tab, or other input entry device or other acceptable single or multiple criteria to guide and direct the search engine, search protocol, and Content Manager to return internet search results. Often a keyword is assumed to indicate the inclusion of a search result similar or representative of the keyword. The use of This term or concept of keyword also include words, phrases, symbols, biographical information, performance information, SEC code, domain extension, consecutive domain extensions, or other acceptable single or multiple criteria in word or action assigned to a button, tab, or other input entry device that are intended to exclude search results of similar or representative of the keyword. Keywords also include any set or string of characters, alphabet characters of any language, numbers of any language, symbols, images, or other designator input, and any of their combinations. A Keyword is just information useful for directing a search. Keyword also means keywords and keywords also means keyword.

Main Search Results

i. This term or concept, a variation or an equivalent, and their plural forms means the depository or all or primary collection of search results. Secondary search results or additional search result pages may take content from the search and move search results identified by an additional criteria to other search result pages. The main search result page will likely contain search results of more varied form, more varied extensions, and capture the totality of the search minus any selectively relocated search results. Note that there will likely be, but need not be a primary search result page, but that search results may by search engine and search protocols automatically populate pages, additional search result pages, or search results subpages.

Manipulate

i. This term or concept, a variation or an equivalent, and their plural forms refers to an action taken by a Content User with a search, search result, search result page, and individual internet search result item, or other available content on a page such that a variable about that item has changed. These variable change occur by any of the means discussed in this disclosure such as, but not limited to keywords, fields, relevance interface, search parameter protocol interface, and the like. Manipulate carries its common meaning, but relevant to the functions described herein.

Means for Providing Domain Extensions

i. This term or concept, a variation or an equivalent, and their plural forms refers to all of the ways that information is input for use on the internet. It includes the definition of fields above. Not only for domain extensions, but for all information, it includes text accepting fields, lists from which selection occurs, selection of multiple domain extensions at a time, radio buttons and check boxes associated with a domain extension or information, sliders, dials, up or down arrows, and all commonly used data input, even input from other electronic devices.

Organic Content User Interface

i. This term or concept, a variation or an equivalent, and their plural forms represents any means by which an internet or intranet Content User can indicate an opinion or judgment as to the relevancy of a site in their search or search results. It also may include the ability of the Content User to judge the site generally. As like sites are provide in a search and the Content User sees other sites then there is a type of value added comparison that search engines and search protocol can now use in site selection to present in a search. The means of indicating judgment, opinion, preference can vary and include many sliders, spectrums, radio buttons, selection boxes, typed in numbers or letters, yes or no selection, more or less selection, scale of percentages, how the site ranks among other like sites, turning up a dial, or other distinct choice or gradient based choice. This of course is in addition to what is currently being used as number of clicks, openings, resident time, etc. which however are more indirect interpretations of a site, rather than the more direct, value added, and judgment based results of an organic Content user interface.

Organic Search Positioning

i. This term or concept, a variation or an equivalent, and their plural forms refers to search results from the internet that are not paid positions. The results of an internet search were placement is based upon the Content User criteria and associated relevance, the nature and quality of the content available on the internet, and placement and ranking without Content Provider payment for search result page positioning.

Organic Search Result Relevance Interface

i. This term or concept, a variation or an equivalent, and their plural forms refers to search results from the internet that are not paid positions. The results of an internet search were placement is based upon the Content User criteria and associated relevance, the nature and quality of the content available on the internet, and placement and ranking without Content Provider payment for search result page positioning. Here the relevance interface allows the Content User to show their perception of the relevance of the search item. That item will spontaneously move to its now indicated relevance among other search result items or a subsequent search will make that placement. Interestingly, is that the search protocol or search engine learns more about what is currently relevant to the Content User and their next search will improve its general relevance.

Organic Search Results

i. This term or concept, a variation or an equivalent, and their plural forms refers to search results from the internet that are not paid positions. The results of an internet search were placement is based upon the Content User criteria and associated relevance, the nature and quality of the content available on the internet, and placement and ranking without Content Provider payment for search result page positioning.

Page

i. This term or concept, a variation or an equivalent, and their plural forms refers to an internet page, screen, view, tab, download, box, dropdown, sheet, window, other type of independent association (page tab) or other description of how to view information on the internet. The word page should simply represent the collection of presented information that moves, is used, is collected, and so forth as a unit and is well known by the web and internet experience. A page, screen, etc. is used for first actions on the internet, search platforms and inputs, search results lists, specific web pages, and all other interactions to do with the internet will be consider to occur on a page or its equivalent.

Page—SubPage

i. This term or concept, a variation or an equivalent, and their plural forms refers to an internet a collection of internet search result items associated within a page (a sub page) such as a box, expanding text, a link to content, or some other means of storing or associating content under an existing page tab or independent page. The term subpage will also include the definition of a full page as defined by the term page.

Page—Page String

i. This term or concept, a variation or an equivalent, and their plural forms refers to an internet a collection of internet search results that flow from a page one to a next page two, page three, and so on to form the search result record for that combination of search criteria. A page string need not be a page string in the format of flowing from one page to the next, but may be a subsequent page by access to a type of scroll, tab, button, slider or other means of accessing additional search results.

Page Content Defined Search

i. term or concept and concept, a variation or an equivalent, and their plural forms clarifies that the content of a search once altered or manipulated by the Content User can become more representative of the character desired in the search. The selection of individual internet search result items to include in defining the character of a subsequent search can take many forms. The next search may be simply keyword and other top level criteria, it may be the character of all items on the first or second pages, only items specifically selected, items deselected as what not to return, items specifically manipulated upward in priority since the last search, everything included on an additional search result page, and other such formats. The page Content Defined Search may also indicate to search engines and search protocols as to what not to searchPerformance Search Factors

Page Ones and Page Position Ones

This term or concept, a variation or an equivalent, and their plural forms refers to more Page Ones is critical to the Internet being a viable place of information and commerce. Custom Page Ones refers to aspects of the invention that allow Content Users to have tools to actively manipulate search results to reprioritize, remove, hide, separate to new pages like a file and directory system, save not just favored pages, but searches and their pages. Further this invention recognizes that a new first and second page directly manipulated by the Content User expressly indicates the character of the search that is desired. A second and follow on searches can then take the parameters represented by the selective content to define their next search and then truly offer value added content much more targeting to the Content User's current needs. This new viability is in lieu of current protocol assumptions about Content User preferences, that may be based on frivolously dabbling about the internet a few hours prior Content Users want to find information and Content Providers want to be found. The problem is there are only four or five meaningful spots on the top of the one first page offered by search engines. This invention develops ways to create more than one first page. Having more than one first page requires splitting a search into different categories, each with their own first page. There will only be more than one first page if the first page of each category is nearly similar in potential relevance. This invention creates one or more additional first pages of meaningful interest to the Content User. More Top Of Pages come with more pages. More first pages also create more favorable first, second, and so forth marketing positions per page. The availability of the first, second, and so forth most viable positions on the first page for Content Providers increases as the Content Users can eliminate less relevant advertisements which makes room for other Content Providers to fill in and gain exposure. The ability of the Content User to assess an ad and delete or remove it from their search and begin increasing the value of their search causes them to loiter longer and improves their experience and information access. One is to move less relevant information to other pages that the Content User would go to with confidence knowing the alternative information is there if they needed it. An example would be to move all government or .gov information to one website. In legal, health, medical, law, environment, and many other topics, as general search will bring up the most apparent relevant information. An authoritative and often visited government site will frequently look most relevant, when that is the last information desired by the Content User. Move all government or .gov information to another tab or page, ideally that is readily recognizable so the Content User if needed or desires will readily know there is another site. It is ironic that given the massive amount of information on the web, that search engine technology has developed around the principle of limited user interaction. This invention gets back to the value of Content User interaction as real time input to guide search engine and search protocols to deliver more accurate search result. A couple more inputs from the Content User make remarkable improvements to the value and viability of the Internet. Content Managers of the internet are also subject to the experience they provide to Content Users and Content Providers. With better search results for Content Users and more and better market positioning for Content Providers, the Content Managers can improve the use experience they are providing and create a more viable internet experience. The terms parsing and presenting or parsing and organizing are equivalent to parsing as this inherently requires presenting and organizing from the slightest extent of parsing or seemingly only parsing to parsing and organizing results to the fullest extent of results organization, and any of their combinations. This parsing may be done by keyword, domain extension, person or business identifier and any of their combinations and may be known as parsing criteria. Keywords represents any inputs or characters, numbers, letters, symbols, other descriptors, and any of their combinations as herein disclosed.

Pre-Set Internet Search Criteria

i. This term or concept, a variation or an equivalent, and their plural forms refers to the Content Manager through search engine or search protocols setting search, retrieval, and presentation criteria that provide internet search results on one or more additional search result pages without the input of the Content User. Pre-Set Domain Extensions may be fixed for all searches, such as .gov, .edu., etc. or may be fluid depending upon the keyword search input. If a Content User is looking for a restaurant then the Content Manager may create search criteria and search result distribution on single or grouped page strings by relevant domain extensions. Only by way of example, this may be for instance separate page strings for .restaurant, .club, .pizza, dining, etc. Separation can be dependent upon any distinguishing characteristic available to the Content Manager and recognized by their search engine and search protocols. These could include but are not limited to domain extensions, keyword, biographical, performance, country, or other distinguishing factor that identifies an individual internet search result site different from others and the same as others in a yes or no manner or by a gradient of difference.

Preferential Positioning on Internet Search

i. This term or concept, a variation or an equivalent, and their plural forms refers to the use of biographical or performance information associated with a domain as additional search engine and search protocol factors in positioning a domain name within a search result. Important is the necessity of factors that allow for parsing search results more meaningfully on one or more additional search result pages that still make those search result pages meaningful. For instance, knowing that a North American population knows about Wal-Mart, Home Depot, Office Depot, Amazon, Ebay, a University, Wikipedia, Disneyland, Delta Airlines or the airlines, etc. that knowing what business it is and how large these types of firms can be separated for the main or general search results into an additional internet search result page because the populous will follow them. If they were located under a tab called “Big Box” or “Big Business” then Content Users will simply open that tab. The businesses in this group, and also the Federal and state governments, education, and many other well branded and know organization would not lose viewers or click through significantly by going to another tab. Today on the internet the first page is populated by one or two ads, then often by Wikipedia, The Federal Government, WalMart, etc. The challenge with the internet is not finding the known and obvious, but the unknown and not obvious. With the aforementioned off the first page the internet become more useful. If a Content User need Walmart they know how to find them online and off line. The additional benefit that occurs is that these equally compelling pages of .gov., .org, .edu, Big Retail, Big Business, Medium Business, Small Business, Religion, and any other pre-set or Content User defined page set up before or after a search that a Content User would not hesitate to view, creates now one or more nearly equivalent or substantially equivalent first pages, first positions on a first page, and favorable top of page positioning. The general search result page now becomes more relevant and not an often usual display of the same entities. Now the relevance and experience of the internet dramatically improves. Now even an additional specialty page can be create by a Content User, called for instance, Patterned Fabric, that can be loaded by the Content User with specific websites and information and relevant advertisements may appear that can be seen, assessed, and dispositioned as to their relevance to that search. Further that a custom search result page or any search result page can be saved for later use. That is not just a website to a favorites list, but now a favorite search of several favorite websites. The above separation of Content Providers among common and relevant Content Providers can be made by the domain name extension, but with Content Provider added biographical and performance information associated with the domain name, email address, telephone number or other unique identifier, that a parsing of internet search results into a more useful format can begin. What is needed is more definitive information such as biographical or performance information. Gather some or all of that information may be required, or even optionally required. The motivation for optionally obtained biographical and performance is to provide preferential positioning in an internet search result. Conversely, intentional misrepresentation of information and malicious information would degrade the preferential positioning of a Content Provider. The internet is now based upon assumptions and automation that does not benefit from small amounts of additional guidance, and the results are becoming increasingly unsatisfactory. A little additional information transforms the internet experience and utility into a next generation.

Primary Keyword Search

i. This term or concept, a variation or an equivalent, and their plural forms refers to the keyword search field so common with today's search engines. This is the primary keyword search criteria field. It is termed the primary keyword search to distinguish it from other keyword search fields that may be made available. Other keyword search field to include or exclude search results or just another keyword search to form a type of find this then from that find this more specific word. It is acknowledged that sophisticated searchers and capable search engines may be able to do this is one keyword field, but most internet users are not experts in search techniques. A simple, semi-simple, and intuitive method for querying is needed.

Provided Separate

i. This term or concept, a variation or an equivalent, and their plural forms is suggesting the and internet search result need not be delivered on a single page, but that search results may be separated by a search criteria or some other natural or reasonable association of information. Provided separate is to provide such information on an additional internet search result page, horizontally on an expanded internet page, vertically on the internet page in a distinguishable manner, in pop up windows, downloadable formats, separate tabs and unrelated pages, and in all format that provide distinction between separated information.

Relevance Disposition

i. This term or concept, a variation or an equivalent, and their plural forms capture all actions of manipulating a individual search result. Moving the individual search result means a protocol or Content User generated move of the individual search result from the main search result page or any other page to a different search result page to associate like search elements, or create examples of relevant search results, and more. The method of moving an individual internet search result item incorporates all the method known to word processing, intranets, and more to include cut and paste, copy and paste, drag and drop, directory selection, field filling, selection associated with a final disposition such as a folder named Best Sites has a selection by an item named Best, file and directory system, and other commonly used methods. A relevance disposition move also includes the Content User moving the an individual search result item or a paid advertisement or other internet returned image or element up, down, or leave the same on a relevance scale or above, below, or leave unmanipulated in relationship to another advertisement as the Content User determines the ad to be more, less, or equivalently relevant. Remove or delete of an individual search result provides an important function of indicating irrelevance, moving the individual search result out of the way and allow another search result to fill in and creating a upper list of individual search results, advertisements, or other element that are more relevant to improve the Content User experience and to guide Content Manager, search engine, and search protocol to return more relevant results with a next search. Removal or deletion may mean immediate and permanent deletion from that search, or as long as the primary search terms remain substantially the same, or for a period of time, or for all time. As our interests change, websites change, our needs change, and so on, permanently deleting a page from ever being served again to an individual is a choice that should be used with discretion. Further the current state of technology may not be able to personalize searches separated in time and space on different computers from ever being shown again. Removal or deletion also means moving an individual search result from its current location and placing it on a delete sheet where it can be held for permanent deletion or restored to the search result page from which it came. Hide is a choice not to delete, but not desiring of consideration at the time. Hiding can take different executional forms of collapsing in place or being moved to a hide sheet where those items could be reviewed and restored to the search result page from which it came. Relevance disposition means any change to the given order and priority of search results caused by a protocol or action by the Content Manager or facilitated by the Content Manager and acted upon by the Content User. Relevance disposition also means that the Content User noticed the Content Providers ad and by either clicking and opening or by looking at the ad and determining it does not contain the desired content is a recognition of the Content Provider's ad. As such, a full or partial charge to the ad will occur if a relevance interface is acted upon and the ad moves, hides, is removed, or other action is taken. This is because the ad was noticed and was acted upon.

Relevance Interfaces

i.—This term or concept, a variation or an equivalent, and their plural forms means providing an indicator of relevancy such as a drop down list, words or symbols to the side, a slider, a toggle that adds to or detracts from, or other indicator. By way of example only, indicators could include 4, 2, N, −2, −4; [ ] Best, [ ] Good, [ ] N, [ ] Poor, [ ] Bad; +, N, −; 100, 90, 80, 70, 50, 40, 30, 20, 10, 0; or any other letter, word, symbol, or indicator. Considering additional coding, memory, processing, or other software or hardware considerations, these Relevancy Indicators may be included on all results returned and shown or on a select number of results returned and shown, such as for results on the first two pages, etc.

Relevance Reorder

i. This term or concept, a variation or an equivalent, and their plural forms means that search results are reordered with the most relevant positioned search result repositioning itself to the top of the list and less relevant moving down the list and to different pages to a position appropriate to their relevancy.

Relevance Search

i. This term or concept, a variation or an equivalent, and their plural forms means the choices of the Content User will influence the next search. Ideally, the search results of the next search will maintain the previous search results having specifically chosen relevancy now positioned among new search results the Content Manager, the search engine, and search protocol now deem the order of specifically indicated results relevance and new results. There is no limit to new or iterative searches that may be conducted.

Search (Combined)

i. This term or concept, a variation or an equivalent, and their plural forms is generalized term to mean access internet content, whether originating from a simple, semi-simple, advanced search, or some other search. Also, throughout this disclosure, the absence of the word search or statement to then search, where it is common that the action would occur by clicking on a button, lettering or otherwise requesting or demanding a search in the internet and intranet environment will be assumed to follow. There is no limit to new or iterative searches that may be conducted.

Search and Auto Separate

i. This term or concept, a variation or an equivalent, and their plural forms is interpreted to have equivalent meaning and definition as Separate Internet Search Results.

Search And Content User Post-Search

i. This term or concept, a variation or an equivalent, and their plural forms is interpreted to have equivalent meaning and definition as Separate Internet Search Results. In that interpretation is the availability for a Content User to manipulate an individual internet search result item and that a search will need to be done after any changes are set by the Content User.

Search Criteria

i. This term or concept, a variation or an equivalent, and their plural forms refers to the Content User provided keywords and any other guidance, input, or stimulus to direct search engines, search protocols, and Content Manager for identification, retrieval, and offerings as a search result. There is no limit to new or iterative searches that may be conducted.

Search Engine

i. This term or concept, a variation or an equivalent, and their plural forms means programs, software, code, and all necessary hardware that searches for, identifies, retrieves, and makes available items in a database that correspond to keywords or characters specified by the Content User, used especially for finding particular sites on the World Wide Web.

Search Engine Provider

i. This term or concept, a variation or an equivalent, and their plural forms means a sub-group of the Content Manager that more specifically refers that segment of Content Manager that provides a general internet search interface for the Content User. It is recognized that internet infrastructure is needed for search of the internet as well as the intranet, but in this case Search Engine Provider is referring to the search and use of the general internet.

Search Only for

i. This term or concept, a variation or an equivalent, and their plural forms

Search Protocol

i. This term or concept, a variation or an equivalent, and their plural forms is inclusive of the Search Engine, but acknowledges unique code, focus, emphasis, priority, ranking, sorting, benefit, or other methods, tactics, and strategies, that may vary within the search engine that allow for search results, but also allows for competitive differences among search engines and Content Managers

Search Protocol Parameter

i. This term or concept, a variation or an equivalent, and their plural forms refers to the existence of factors associated with a website, block, article, download, image, video, or other website content that are used to determine whether the page of content will be recognized, retrieved, and in what placement. These factors include, but are not limited to the presence of keywords in the content, how frequently the page content visited, how much content is on the website, how authoritative is the page content, and many more to include locality, nationality, language, and more. Search Protocol Parameter recognized that the Content Manager or those manipulating search engines or search protocol know how much weight or variable weight each parameter of the search engine or search protocol has been assigned. Search protocol parameter recognized that a Content User Search Protocol Parameter Interface can be adjusted by the Content User to adjust the outcome of the search. One or more Search protocol Parameter interfaces would change the outcome of the internet search results while otherwise all other search criteria remains the same.

Search Parameter Protocol Interface

i. This term or concept, a variation or an equivalent, and their plural forms refers to a information or factor input a Content User can adjust to vary the weight of a search engine or search protocol to alter the search results with otherwise all other search criteria remaining the same. This interface should be considered to be of any construction similar to the Relevance Interface, Fields, or even Keyword inputs as previously defined.

Search Result

i. This term or concept, a variation or an equivalent, and their plural forms refers to the content of the Internet found, identified, retrieved, delivered, and otherwise made available to Content Users based upon their keywords, input, stimulus, or other guidance and determined as an offering based upon search protocols.

Search Result Page

i. This term or concept, a variation or an equivalent, and their plural forms means search results as listed on all pages whether a main search result page or additional search result pages and are delivered to an internet interface associated together in the form of lists, tabs, tags, images, and other formats. This association is in the form of a screen, a window, a page, a webpage, a sheet, or some other association of which is commonly known. Most important to this definition is to recognize the common form of search result delivery, but to also acknowledge that the term search result page, also includes any subsequent length of the page beyond the first screen or any associated pages or screens resulting from the search. Page means the first and all other following pages of associated information.

Search Result Parsing and Presentation

i. This term or concept, a variation or an equivalent, and their plural forms means the use of input criteria for organizing search results according to Content Manager protocols, Content User preferences, and any combination. The input criteria is the Content Manager Pre-Set parameters in their protocols and algorithms, domain extensions, and other specifications and any of their combinations, Content User keywords in it broadest definition, and any of their combinations.

Search Result Subpage

i. This term or concept, a variation or an equivalent, and their plural forms means the same as an additional search result page but bring a slight more specificity. The Additional search result page is inclusive of placing search results from the primary search onto any area of display, even its own independent tab. The concept of the search result subpage is that the individual search results parsed from the main search results will reside on pages or displays associated with or level below the current main page or tab.

Search Results Provided Separate

i. This term or concept, a variation or an equivalent, and their plural forms is interpreted to have equivalent meaning and definition as Separate Internet Search Results.

Secondary Search Results

i. This term or concept, a variation or an equivalent, and their plural forms are results that the Content User deems to be not of primary interest or relevant to the search they had intended. Secondary search results also includes the concept that a primary search is later parsed or secondarily parsed into categories that permit more associated result relevance or search results more associated by like category, such as government or .gov, education or .edu, and more.

Seen, Assessed, and Dispositioned

i. This term or concept, a variation or an equivalent, and their plural forms refers to the concept that paid ads are charged based upon being clicked open. Clicking open allows for an assessment of the website. The fact that based upon the ads introductory presentation, the Content User has seen the ad, assessed their interest or disinterest by a relevance interface such as a slider or by clicking on a radio button to hid the ad temporarily, give the ad a priority as to when to be shown again, or a type of one out of three rotations instead of one out of one or two, hide the ad, delete the ad, or other action. Any such action has a likeness to interacting with the ad, even as if opened, and the ad accomplished its purpose of being seen, assessed, and dispositioned. No ad charge, a partial ad charge, or a full ad charge could be assessed for an ad that created Content User interaction. A partial ad fee would be representative of a lower value, but some recognition the paid ad was seen, assessed, and dispositioned somewhat less than opening the paid ad. Dispositioning the ad makes room for another ad based upon historical searches, Content User inputs, paid ad priority, or just next in que for general visibility. The ad screen could also be removed.

Semi-Simple Interface

i. This term or concept, a variation or an equivalent, and their plural forms refers to a search criteria page that has some intuitiveness to its search criteria. The semi-simple interface or the semi-simple search interface, or semi-simple results interface, or other search formats of two or more search input fields. The semi-simple search refers to a layout of a keyword search input field as commonly known and experienced and one or more other search criteria input fields on the same page, screen, or other presentation as otherwise defined that act together as a search criteria upon request of the search, such as clicking a search button, arrow, or other common symbol. The keyword search criteria and the one or more other search input criteria may search, sort, parse, present, and all other search functions in a simultaneous, sequential, or any combination of simultaneous and sequential. The semi-simple search also is not limited to one event, but subsequent search under the above definition also remains semi-simple. The semi-simple search means that there may be one or more search criteria available for use. It is not the number of search criteria that are available and that may be used, or not used, it is the modest intuitiveness and relative straightforwardness of use. Does a semi-simple search platform require some orientation, some use experience to be fluid and comfortable, some modest knowledge of the purpose of keywords, or that there are different domain extensions, or the like. The fact that a Content User must become familiar with the placement, the use, or other orientational factors does not make the search criteria and layout advanced. An advanced search criteria is characteristic of having several or an abundant number of search criteria. It is also characteristic of search criteria that require certain standards or protocols to be used or some moderate to elevated search knowledge, linguistic knowledge, computer software or hardware knowledge, and the like. An advanced search would not be considered simple or semi-simple to most people. That is evident by the fact that most people do not use the advanced search criteria available with most search engines. The advanced search engine is complicated enough to deter use. All other search criteria pages and platforms that do not deter the moderately interested and compelled searcher is considered a simple, intuitive, or semi-simple search criteria or search criteria set, or search criteria page, and the like. This term may also take the forms of semi-simple search criteria, semi-simple search layout, semi-simple search platform, and the like, all considered to be equivalent as is also the case for all other terms and their rational deviations. The Semi-Simple Search engine interface may suggest the need for separate input fields, but more importantly is the concept that there are distinct search criteria influences upon the internet search derived from separate input fields or a same input field. Except where specifically referring to current, simple, or advanced search engine interfaces, the use of the term search engine interface refers to the Semi-Simple Search engine interface. The concept of the Semi-Simple Search also extends to the Semi-Simple Results page with characteristics such as the retained Semi-Simple Search features, sorting results, prioritizations, etc. and their combinations and disclosed within this application.

Separate Internet Search Results

i. This term or concept, a variation or an equivalent, and their plural forms mean that the search results will be parsed or separated by given criteria to different pages, tabs, sheets, boxes, drop downs, horizontal or vertical extensions of the page, pop ups, additional search result pages, or other means of display. It acknowledges that the results may be parsed from the given search results seemingly automatically with pre-set search criteria with the first search and returned results. In another format a new search will need to occur after Content User input has changed general search criteria or individual internet search item relevance and the then a new search results will be parsed to their different points of access. It is also defined that upon Content User manipulation of a search page or individual internet search result item that they may immediately be dispositioned to their new position, ranking, and relevance. It is acknowledged that subsequent searches may not be an exact equivalent to the first.

Separates Search Results

i. This term or concept, a variation or an equivalent, and their plural forms is interpreted to have equivalent meaning and definition as Separate Internet Search Results.

Simple Search

i. This term or concept, a variation or an equivalent, and their plural forms refers to the current search criteria of a single keyword criteria field. That is just one opportunity per search initiation to define a search direction. This disclosure introduces a semi-simple search. This can be considered to be the simple keyword search field plus one or more other search criteria to create a semi-simple up to what is determined to be an advanced search, which is also define in this disclosure.

Simultaneously

i. This term or concept, a variation or an equivalent, and their plural forms means that a search result may be returned automatically or by Content User action onto one or more additional search result pages at the same time. At the same time or simultaneously may mean, but need not mean visible simultaneously. Simultaneously also refers to the fact that the result are available and read on a different webpage, a different tab, in a different window, through a menu, or some other connective means. Simultaneously means a new search is not necessary and that moving from an additional search result page to a main page or other additional search result page will be available and that the content will not change from one view to the next until another search is requested.

Site

i. This term or concept, a variation or an equivalent, and their plural forms is identifying a website that is identified from an internet search and listed along with other websites in some positioning and ranking. Site is defined to mean any search result returned to include, but not limited to a website, an ad of any kind, blogs, images, video, posting, text messages of all forms, articles, attachments, and any other result presented from an internet search. It may also be referred to and inclusive of the individual internet search result item or individual internet search result site.

Tweaked Search

i. This term or concept, a variation or an equivalent, and their plural forms means the simplified search is the populous and commonly used search interface that is usually requires just keyword input. The advanced search recognizes that Content Managers may have a second interface or screen with multiple search criteria. The tweaked search is a semi-simplified search that is on the main search screen first offered to Content Users or the populous search screen, but that includes one or more additional search criteria. The tweak search is not as exhaustive as the advanced search but provide for a quick and intuitive additional search criteria.
b. The above definitions are not all intended to redefine terms associated with the Internet, but to simply assure clarity. Where the definitions are known and the intent of the above definitions are consistent with commonly understood terms and definitions then that consistency in definition will persist.

Their Combination

i. This term or concept, a variation or an equivalent, and their plural forms means when referring to any of their combinations from the inclusion of all, the inclusion of more than one or all, the inclusion of some or the exclusion of some. Said another way, it refers to any mix of the list from the extremes of all but one being absent to all being present more than once and all variations between these extremes.

### GENERAL INTERPRETATION

The following paragraphs are a grouping of common Elements of the Interactive Internet, common terminology, and useful definitions to facilitate an organized and clear understanding of the Interactive Internet.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The singular forms “a,” “an,” and “the” are intended to include plural forms as well, unless the context clearly dictates otherwise. Thus, for example, reference to “a particle” includes reference to one or more of such materials and reference to “subjecting” refers to one or more such steps.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y” As used herein, phrases such as “from about X to Y” mean “from about X to about Y”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context. References to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

As used herein with respect to an identified property or circumstance, “substantially” refers to a degree of deviation that is sufficiently small so as to not measurably detract from the identified property or circumstance. The exact degree of deviation allowable may in some cases depend on the specific context.

A plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein.

### CLAIM DESCRIPTION

This section includes the claims in paragraph form. The claims clearly set out what is owned and claimed. Through an abundance of caution and stratagem the claims are reproduced as written or nearly as written to provide a record in the description. Due to time and claim evolution, there may be reference problems within each claim paragraph that attempt to refer back to another claim within the same paragraph. The references will need to be reassembled, but the reference always pointing towards an element within its own paragraph.

10—17 Claim Set—KEYWORD and C/P DOMAIN 10—An enhanced internet interface method comprising the use of keywords and one or more domain extensions, an internet search, and internet search results reported. 11—The method of claim 10 comprising said one or more domain extensions entered as a separate keyword in the primary keyword input field. 12—The method of claim 10 comprising said one or more domain extensions entered as a separate keyword in one or more additional keyword input fields. 13—The method of claim 10 comprising the one or more domain extensions entered by one or more additional input interfaces other than entering text in a text field and separate from the primary keyword search input field. 14—The method of claim 10 comprising the combination of one or more additional keyword input interfaces and one or more additional input interfaces other than entering text in a text field and separate from the primary keyword search input field. 15—The method of claim 10 comprising a pre-set domain extension criteria being government or .gov. 16—The method of claim 10 comprising a pre-set domain extension criteria being noncommercial, organization, or .org. 17—The method of claim 10 comprising a pre-set domain extension criteria being education or .edu. 18—The method of claim 10 comprising a pre-set domain extension criteria being commercial or .com. 19—The method of claim 10 comprising a pre-set domain extension criteria being network services or .net. 20—The method of claim 10 comprising a pre-set domain extension criteria identifying a country or state. 21—The method of claim 10 comprising one or more other pre-set domain extension criteria identifying a commercial or noncommercial public or private organizations and activities. 22—The method of claim 10 comprising any domain extension. 23—The method of claim 10 comprising any combination of domain extensions. 24—The method of claim 10 comprising a keyword search and one or more pre-search Content User interfaces to better achieve Content User internet search results. 25—The method of claim 10 comprising a keyword search and one or more post-search Content User interfaces to refine internet search results or the separate internet search results. 26—The method as in claims 11 to 25 further comprising pre-set search criteria that exclude the return of associated search results. 27—The method of claim 10 comprising a system of searching the internet by keywords and one or more domain extensions.

40—14 Claim Set—KEYWORD and ADDITIONAL USER (Semi-simple) 40—An enhanced internet interface method comprising searching the internet with a keyword search field and one or more additional Content User search criteria input fields, an internet search, and internet search results reported. 41—The method of claim 40 not comprising an advanced search. 42—The method of claim 40 comprising a simple search or semi-simple search. 43—The method of claim 40 comprising a keyword search field and one additional Content User internet search criteria input. 44—The method of claim 40 comprising a keyword search field and one to two additional Content User internet search criteria input. 45—The method of claim 40 comprising a keyword search field and one to three additional Content User internet search criteria input. 46—The method of claim 40 comprising a keyword search field and one to four additional Content User internet search criteria input. 47—The method of claim 40 comprising a keyword search field and one to five additional Content User internet search criteria input. 48—The method of claim 40 comprising a keyword search field and one to six additional Content User internet search criteria input. 49—The method of claim 40 comprising a keyword search field and one to eight additional Content User internet search criteria input. 50—The method of claim 40 comprising a keyword search field and one to ten additional Content User internet search criteria input. 51—The method of claim 40 comprising a keyword search and one or more pre-search Content User interfaces to better achieve Content User internet search results. 52—The method of claim 40 comprising a keyword search and one or more post-search Content User interfaces to refine internet search results or the separate internet search results. 26—The method as in claims 43 to 52 further comprising pre-set search criteria that exclude the return of associated search results. 53—The method of claim 40 comprising a system of searching the internet with a keyword search field and one or more additional Content User search criteria input.

60—16 Claim Set—KEYWORD and PRE-SET DOMAIN—SEPARATE PAGES: 60—An enhanced internet interface method comprising the use of keywords and one or more pre-set search criteria, an internet search, and internet search results of the pre-set search criteria reported separate from the general search result. 61—The method of claim 60 comprising one or more of the said pre-set search criteria results reported separately or combined, while remaining separate from the general search results. 62—The method of claim 61 comprising a pre-set domain extension criteria being government or .gov. 63—The method of claim 61 comprising a pre-set domain extension criteria being noncommercial, organization, or .org. 64—The method of claim 61 comprising a pre-set domain extension criteria being education or .edu. 65—The method of claim 61 comprising a pre-set domain extension criteria being commercial or .com. 66—The method of claim 61 comprising a pre-set domain extension criteria being network services or .net. 67—The method of claim 61 comprising a pre-set domain extension criteria identifying a country or state. 68—The method of claim 61 comprising one or more other pre-set domain extension criteria identifying a commercial or noncommercial public or private organizations and activities. 68—The method of claim 61 comprising any domain extension. 70—The method of claim 61 comprising any combination of domain extensions. 71—The method of claim 61 comprising a pre-set search criteria that separates internet search results based on one or more individual or organizational biographical factors. 72—The method of claim 61 comprising a pre-set search criteria that separates internet search results based on one or more individual or organizational performance factors. 73—The method of claim 61 comprising a keyword search, one or more pre-set domain extension criteria, and one or more additional Content User determined search criteria. 74—The method as in any preceding claim further comprising one or more additional keyword, domain extension, biographical, performance, other criteria, and their combinations as Content User determined search criteria. 75—The method as in claims 62 to 74 further comprising pre-set search criteria that exclude the return of associated search results. 76—The method of claim 61 comprising a system having a keyword search field and one or more pre-set search criteria with search results provided separate from the general search results.

80—9 Claim Set—KEYWORD and USER—SEPARATE PAGES 80—An enhanced internet interface method comprising a keyword search interface field and one or more additional Content User search criteria interface, an internet search, and internet search results reported. 81—The method of claim 80 comprising additional results presented separately or combined, while remaining separate from the general search results. 82—The method of claim 81 comprising the one or more domain extensions entered as a separate keyword in the primary keyword input field. 83—The method of claim 81 comprising the one or more domain extensions entered as a separate keyword in one or more additional keyword input fields. 84—The method of claim 81 comprising the one or more domain extensions entered by one or more additional input interfaces other than entering text in a text field and separate from the primary keyword search input field. 85—The method of claim 81 comprising the combination of one or more additional keyword input interfaces and one or more additional input interfaces other than entering text in a text field. 86—The method of claim 81 comprising a one or more individual or organizational biographical factors as search criteria. 87—The method of claim 81 comprising one or more on individual or organizational performance factors search criteria. 88—The method as in claims 22 to 87 further comprising pre-set search criteria that exclude the return of associated search results. 89—The method of claim 81 comprising a system having a keyword search interface field and one or more additional Content User search criteria interface with search results provided separate from the general search result.

100—5 Claim Set—SAME PARAMETERS—DIFFERENT RESULT 100—An enhanced internet interface method where a subsequent internet search result using the same search criteria produces a different internet search result comprising initial search criteria and adjustable search protocol parameters, an internet search, and internet search results reported. 101—The method of claim 100 comprising a said search protocol parameter known by the Content Manager to cause a different internet search results when adjusted before a subsequent internet search, with otherwise using the same search criteria. 102—The method of claim 101 comprising a Content User input interface for adjusting known said search protocol parameter to produce a different internet search result, otherwise using the same search criteria. 103—The method of claim 102 comprising one or more said Content User input adjustment interfaces of known said search protocol parameters that are label to guide Content User of which need not disclose the specific functionality of the said search protocol parameter. 104—The method of claim 103 comprising a system of internet search criteria inputs to include one or more Content User adjustable input interface of known said search protocol parameters that changes internet search results, while otherwise maintaining search criteria.

110—9 Claim Set—POST-SEARCH RREPRIORITIZING 110—An enhanced internet interface method comprising a Content User relevance interface to provide judgment as to the relevance of individual search result item as additional search criteria, an internet search, and internet search results reported. 111—The method of claim 110 comprising said one or more Content User relevance interfaces per individual internet search result item that when changed register an adjusted relevance having a greater, smaller, or same relevance as compared to other individual internet search result items. 112—The method of claim 111 comprising the adjusted relevance of the individual search result item causing it to repositions to the representative position of relevance among other individual internet search result items. 113—The method of claim 112 comprising the movement of the individual internet search result item does not move spontaneously, but after another internet search or other action. 114—The method as of claim 111 or 112 further comprising a request for a new search using an altered internet search criteria combining previous search criteria and search criteria learned from said adjusted relevance of one or more individual internet search result items. 115—The method of claim 115 comprising a returned internet search result with a different set of individual internet search result items based upon the combination of learned adjusted relevance search criteria, an internet search, and internet search results with the specifically and previously adjusted individual internet search result items positioned in the new internet search result at the specific adjusted relevance. 116—The method of claim 115 comprising an improved search result considering more search protocol priority given to Content User relevance interface search criteria than other search engine and search protocols originally used search criteria. 117—The method of claim 116 comprising a system where the primary search criteria and one or more relevance interfaces are adjusted to show specific relevance of an individual internet search result item and where one or more specifically altered relevance interfaces combine with previous internet search criteria to create a more accurate internet search criteria of the Content User at the time of the search.

130—8 Claim Set—MOVE, DELETE, HIDE 130—An enhanced internet interface method comprising relevance disposition of individual search result items to improve search results. 131—The method of claim 130 comprising the individual search result items with relevance interfaces to move up, move down, move to an additional search result page, delete or remove, hide, and restore an individual search result. 132—The method of claim 131 comprising the use of said Content User relevance interface input to move up, move down, or move to an additional search result page as additional internet search criteria of the order of relevance, relevance association, and relevance disassociation of individual internet search result items, an internet search, and internet search reported. 133—The method of claim 131 comprising the use of said relevance interface delete or remove to purge the search results of a lesser relevant individual internet search result items and with its departure the list of individual internet search result items move upward to fill the void and set as additional internet search criteria of the order of relevance, relevance association, and relevance disassociation of individual internet search result items, an internet search, and internet search reported. 134—The method of claim 131 comprising the use of said relevance interface hide to remove, but not fully disasociate the individual internet search result item from the search, but it is removed from the search list and the individual internet search result items move up to fill the void and set as additional internet search criteria of the order of relevance, relevance association, and relevance disassociation of individual internet search result items, an internet search, and internet search reported. 135—The method as in claim 132, 133, or 134 further comprising the result of improving the relevance of the internet search and in combination with previous search results and newly defined search criteria by what individual internet search result items remain and in their order a call for a new search will provide new results/136—The method of claim 135 comprising said new internet search results shows the specifically positioned individual internet search result items positioned among the new internet search results in the order of their priority among all current individual internet search result items. 137—The method of claim 136 comprising a system with relevance interfaces on individual internet search result items through Content User input direct relevance disposition of individual search result items to create an association and ranking of individual internet search result items more representative of the Content Users immediate interests.

150—16 Claim Set—PARSED ON ONE OR MORE PAGES 150—An enhanced internet interface method comprising search results reported on one or more search result pages and which individual internet search result items may be parsed or divided on one or more additional search result pages. 152—The method of claim 150 comprising the use of said option for a Content User to elect to use a additional keyword or combination of keywords as criteria to combine or separate search result among a main search result page and one or more additional search result subpages simultaneously. 153—The method of claim 150 comprising the option for a Content User to elect to exclude a keyword or combination of keywords, as criteria to combine or separate search result among a main search result page and one or more additional search result subpages simultaneously. 154—The method of claim 150 comprising the option for a Content User to elect to use a domain extension or combination of domain extensions as criteria to combine or separate search result among a main search result page and one or more additional search result subpages simultaneously. 155—The method of claim 150 comprising the option for a Content User to elect to exclude a domain extension or combination of domain extensions, as criteria to combine or separate search result among a main search result page and one or more additional search result subpages simultaneously. 156—The method of claim 150 comprising the use of .gov domain extension to create a government content focused additional search result subpage. 157—The method of claim 150 comprising the use of .org domain extension to create a noncommercial or organizational content focused additional search result subpage. 158—The method of claim 150 comprising the use of .edu domain extension and an extension associated with scholarly research and writing to create scholarship focused additional search result subpage. 159—The method of claim 150 comprising the use of .com domain extension to create a commercial content focused additional search result subpage. 160—The method of claim 150 comprising one or more other pre-set domain extension criteria identifying a commercial or noncommercial public or private organizations and activities. 161—The method of claim 150 comprising any domain extension. 162—The method of claim 150 comprising any combination of domain extensions. 163—The method of claim 150 comprising the use of .adult, .porn, sexy, .sex, .erotic, and other similar domain extension for removal, hiding, or viewing on an additional search result subpage. 164—The method of claim 150 comprising a system where the primary search criteria and the additional search criteria are available on the same page and subpages. 165—The method of claim 150 comprising a system of search results reported on one or more search result pages and which individual internet search result items may be parsed or divided on one or more additional search result pages.

180—5 Claim Set—SAVING SEARCH RESULTS 180—An enhanced internet interface method comprising saving search results 181—The method of claim 180 comprising the option to the Content User to save internet search results. 182—The method of claim 180 comprising the option to the Content User to save internet search results separated to additional search result pages. 183—The method of claim 180 comprising the option to the Content User to save a select number of search results. 184—The method of claim 180 comprising a system with an internet search result page having an option to save a select number of individual search result items.

200—18 Claim Set—MORE PAGES, MORE POSITION ONE 200—An enhanced internet interface method that creates more favorable, more visible, and more substantially equal pages providing more favorable Content Provider positioning to the Content User comprising internet search criteria that separates internet search results on one or more search result pages creating more page ones and more page one positions. 201—The method of claim 200 comprising keyword search and one or more pre-set internet search criteria provides internet search results separated to one or more additional search result pages creating one or more additional organic internet search result page one positions, more organic search top of page positions and rankings for Content Providers, and other organic page positioning and ranking. 202—The method of claim 201 comprising internet search results provided on a main internet search result page and the one or more pre-set search criteria results provided together on one additional internet search result page or on individual internet search result pages. 203—The method of claim 202 comprising selection of one or more domain extensions that create a meaningful and favorable additional page, a meaningful and favorable additional position one, meaningful and favorable top of page positioning and ranking, and meaningful and favorable additional advertizing space. 204—The method of claim 202 comprising said pre-set internet search criteria being government or .gov. 205—The method of claim 202 comprising said pre-set internet search criteria being noncommercial, organization, or .org 206—The method of claim 202 comprising said pre-set internet search criteria being education or .edu. 207—The method of claim 202 comprising said pre-set internet search criteria being commercial or .com. 208—The method of claim 202 comprising said pre-set internet search criteria being network services or .net. 209—The method of claim 202 comprising said pre-set internet search criteria being one or more domain extensions identifying a country or state. 210—The method of claim 202 comprising said pre-set internet search criteria being one or more other domain extensions identifying a commercial or noncommercial public or private organizations and activities. 211—The method of claim 202 comprising a pre-set search criteria based on individual or organizational biographical factors. 212—The method of claim 202 comprising a pre-set search criteria based on individual or organizational performance factors. 213—The method of claim 200 comprising one or more non-pre-set search criteria input fields for additional keywords, domain extensions, and other search criteria a Content User determines. 214—The method of claim 200 comprising one or more pre-set domain extension search criteria and one or more non-pre-set search criteria input fields for additional keywords, domain extensions, and other search criteria a Content User determines. 215—The method of claim 200 comprising a system with keyword input field and pre-set search criteria that separate an internet search into a main search result page and one or more additional search result pages based upon the pre-set search criteria. 216—The method of claim 200 comprising a system of one or more non-pre-set search criteria input fields for additional keywords, domain extensions, and other search criteria a Content User determines. 217—The method of claim 200 comprising a system of one or more pre-set domain extension search criteria and one or more non-pre-set search criteria input fields for additional keywords, domain extensions, and other search criteria a Content User determines.

220—5 Claim Set—MORE ADS IN FAVORABLE POSITIONS 220—An enhanced internet interface method to provide more favorable and more visible paid advertisement opportunities for the Content Provider to the Content User comprising paid advertisements listed on internet pages accompanied by relevancy interfaces. 221—The method of claim 220 comprising paid advertisements with relevancy interfaces that change the relevance and then disposition of an individual paid advertisement using. 222—The method of claim 221 comprising the charging of a full or partial advertising fee based on a Content User relevance interface disposition action. 223—The method of claim 221 comprising a reordering of current advertisements, reloading of the next advertisement in queue, if it exists, or a combination of both. 224—The method of claim 221 comprising a system to provide more favorable and more visible paid advertisement opportunities for the Content Provider to the Content User by relevance disposition that moves, removes, hides, or otherwise sets ads aside the Content User finds irrelevant allowing more ads to enter a page or rise to more favorable page positions.

230—4 Claim Set—GENERIC DOMAIN EXTENSIONS TO SPECIFIC 230—An enhanced internet interface method comprising the compulsion by market forces for domains to move away from generic or unrelated domain extensions to more descriptive domain extensions. 231—The method of claim 230 comprising search criteria that specifies one or more specific domain extensions. 232—The method of claim 231 comprising one or more specific domain extension that matches one or more specific domain extension search criteria to be most favorably ranked, followed by closely related domains with extensions closely related to the specific domain search criteria to be next most favorably ranked, the next most closely related domain extensions being the next ranked, and through the extensions and there relative rankings. 233—The method of claim 230 comprising a system by market forces causes domains to move away from generic or unrelated domain extensions to more descriptive domain extensions by providing preferential search result positioning as domain extensions match or more closely match domain extension related search criteria.

240—4 Claim Set—ORGANIC JUDGMENT 240—An enhanced internet interface method used to gain site quality assessment by direct Content User input comprising organic search result site being associated with one or more organic search Content User interface. 241—The method of claim 240 comprising said organic search content user interface for a Content User to manipulate and indicate judgment about the site. 242—The method of claim 241 comprising said judgment to be used by search protocols and other internet soft and hard infrastructure to use in determining subsequent organic search rankings. 243—The method of claim 240 comprising a system where organic internet search results of individually listed sites is associated with one or more organic search Content User interfaces by which judgment or opinion about the site is directly input for use by internet soft and hard infrastructure for subsequent organic internet search site placement.

250—7 Claim Set—BIOGRAPHICAL AND PERFORMANCE CRITERIA 250—An enhanced internet interface method that uses biographical and performance criteria for organic internet search results comprising the association of information for site intra-page and inter-page positioning and ranking not directly based on site performance and analytics. 251—The method of claim 250 comprising the use of sales, revenue, or other financial magnitudes to place a site on an internet main search page or additional internet search page. 252—The method of claim 250 comprising the use of number of employees to place a site on an internet main search page or additional internet search page. 253—The method of claim 250 comprising the use of likelihood of web followership to place a site on an internet main search page or additional internet search page. 254—The method of claim 250 comprising the use of biographical information to place a site on an internet main search page or additional internet search page. 255—The method of claim 250 comprising the use of performance information to place a site on an internet main search page or additional internet search page. 256—The method of claim 250 comprising a system that uses biographical and performance criteria for organic internet search results based on the association of information for site intra-page and inter-page positioning and ranking not directly based on site performance and analytics.

270—12 Claim Set—BIOGRAPHICAL AND PERFORMANCE CRITERIA GATHERING 270—An enhanced internet interface method that collects biographical and performance information for use on the internet comprising the collection of Content Provider information not directly derived from an internet presence and used to position a Content Providers organic internet position. 271—The method of claim 270 comprising a requirement upon registration of a domain name what domain extension will be used. 272—The method of claim 270 comprising the option or requirement upon registration of a domain name if the domain is for personal (non-revenue), business use (revenue), or non-profit purposes. 273—The method of claim 270 comprising a option or requirement upon registration of a domain name what current annual revenue is associated with the domain name. 274—The method of claim 270 comprising a option or requirement upon registration of a domain name what current number of employees is associated with the domain name. 275—The method of claim 270 comprising a option or requirement of providing other biographical information associated with the domain name. 276—The method of claim 270 comprising a option or requirement of providing other performance information associated with the domain name. 277—The method of claim 270 comprising an option or requirement at domain name renewal to update biographical and performance information. 278—The method of claim 270 comprising an option to update domain name associated biographical and performance information at any time. 279—The method as in claims 271 to 278 further comprising the providing of optional or required biographical or performance information associated with the domain name improves Content Provider organic positioning in a search result. 280—The method of claim 270 comprising a system using unique identifiers is used to return more relevant search results. 281—The method of claim 270 comprising the said system uses unique identifiers to separate internet search results among the general internet search result page and one or more additional internet search result pages by common unique identifier association.

290—7 Claim Set—SEMI-SIMPLE SEARCH 290—An enhanced internet interface method comprising a semi-simple search using a keyword search criteria input and one or more additional intuitive search criteria inputs. 291—The method of claim 290 comprising said semi-simple search use for an internet search. 292—The method of claim 290 comprising said semi-simple search used for an intranet search. 293—The method as in claim 291 or 292 further comprising said additional intuitive search criteria being one or more pre-set domain extensions. 294—The method as in claim 291 or 292 further comprising said additional intuitive search criteria being one or more Content User determined domain extensions. 295—The method as in claim 291 or 292 further comprising said additional intuitive search criteria being one or more keywords. 296—The method of claim 290 comprising a system having a semi-simple search using a keyword search criteria input and one or more additional intuitive search criteria inputs present on the same page.

300—9 Claim Set—MORE AD REVENUE 300—An enhanced internet interface method to provide more favorable and more visible paid advertisement opportunities for more advertisement revenue to Content Managers comprising paid advertisements that change on a web page based upon Content User action. 301—The method of claim 300 comprising said paid advertisements that moves up to more valued advertisement space as a Content User deletes or hides a previously higher said paid advertisement and now whose advertisement value increases. 302—The method of claim 300 comprising said paid advertisements that moves onto a higher value page as a Content User deletes or hides a previously higher said paid advertisement or and now whose advertisement value increases. 303—The method of claim 300 comprising said paid advertisements that moves up to more valued advertisement space as a Content User move to another search result page, adjusts relevance, priority, or moves the previously higher said paid advertisement below said paid advertisement that just moved upward, and now whose advertisement value increases. 304—The method of claim 300 comprising said paid advertisements that moves onto a higher value page as a Content User move to another search result page, adjusts relevance, priority, or moves the previously higher said paid advertisement below said paid advertisement that just moved onto the page, and now whose advertisement value increases. 305—The method as in claim 301, 302, 303, or 304, further comprising charging an immediate full, partial, to no advertisement fee for an advertisement directly manipulated but not opened by the Content User as being seen, assessed, and dispositioned. 306—The method as in claim 301, 302, 303, or 304, further comprising charging an increased to original placement paid advertisement fee upon Content User opening the paid advertisement based upon the paid ads moving to a higher value advertisement position, page, or position and page combination. 307—The method as in claim 301, 302, 303, or 304, further comprising charging full, partial, to no advertisement fee for ads deleted, hidden, moved down, or moved to another page as the advertisement was seen, assessed, and dispositioned. 308—The method of claim 1 comprising a system of paid advertisements placed on an internet page or search result and the ad position changes based upon Content User action and with higher ad position on a page or moved more to the first page there is higher value to the advertisement.

320—9e Claim Set—DOMAIN EXTENSION AS KEYWORD TO SEARCH 320—An enhanced internet interface method comprising the use of one or more domain extensions as the keyword search term. 321—The method of claim 320 comprising the said one or more domain extension keyword search terms followed by an internet keyword search and related internet search results reported. 322—The method of claim 321 comprising said one or more domain extensions as a keyword in the keyword Search term field. 323—The method of claim 321 comprising said one or more domain extensions as a .keyword in the keyword Search term field. 324—The method of claim 321 comprising said one or more domain extensions with one or more wildcard characters or combinations as a wildcard.keyword in the keyword Search term field. 325—The method of claim 321 comprising said one or more domain extensions selected from a list of one or more domain extensions as keyword search terms. 326—The method of claim 321 comprising said one or more domain extensions being selected from a list suggested based on first letters entered in a keyword Search term field. 327—The method of claim 321 comprising any domain extension. 328—The method of claim 321 comprising any domain extension format. 329—The method of claim 321 comprising any combination of domain extensions. 340—An enhanced internet interface system comprising the acceptance of one or more domain extensions as keyword search terms, then an internet search request, and internet search results reported. 341—The system of claim 340 comprising the said one or more domain extensions being accepted by a keyword search term field. 342—The system of claim 340 comprising the said one or more domain extensions being accepted from a list of domain extensions. 343—The system of claim 340 comprising the said one or more domain extensions being selected from a list suggested based on first letters entered in a keyword Search term field.

350—5e 5 xClaim Set—KEYWORD FIELD AND ONE OR MORE OTHER INPUTS 350—Increasing the relevance of information retrieved from the internet by a method comprising the use of the keyword search field and one or more other search criteria inputs. 351—The method of claim 350 comprising a search activated by the Content user and content retrieved and reported. 352—The method of claim 350 comprising a search activated automatically and content retrieved and reported. 353—The method of claim 350 comprising a system using the keyword search field and one or more other search criteria inputs. 354—The method of claim 350 comprising a system having an internet search criteria established by using the keyword search field and one or more other search criteria inputs.

360—5e 5 xClaim Set—ONE OR MORE INPUT WITH ORGANIC SEARCH RESULTS 360—Increasing the relevance of information retrieved from the internet by a method comprising the use of organic delivered content and one or more Content User inputs defining new retrieval criteria. 361—The method of claim 350 comprising new search criteria, a new search called by the Content user and content retrieved and reported. 362—The method of claim 350 comprising new search criteria, a new search automatically made and content retrieved and reported. 363—The method of claim 350 comprising a system using organic delivered content and one or more Content User inputs defining new retrieval criteria. 364—The method of claim 350 comprising a system having an internet search criteria established by using the organic delivered content and one or more Content User inputs defining new retrieval criteria.

370—9e 6 xClaim Set—PAST TO PRESENT INTERNET INPUT 370—Increasing the relevance of information retrieved from the internet by a method comprising the internet ads with a Content User Interface that directs the behavior of the ad for that Content User. 371—The method of claim 370 comprising said Content User Interface being a relevance interface on an ad. 372—The method of claim 371 comprising said relevance interface being an indication of interest, priority, ranking, order, and other interrelationship among like items, and their combinations on an ad. 373—The method of claim 370 comprising said Content User Interface being a disposition interface on an ad. 374—The method of claim 373 comprising said disposition interface being an action to move up, move down, move in another direction, delete permanently, delete temporarily, hide, hide for a period, unhide, create priority when to reemerge, or other action or relocation action on an ad. 375—The method of claim 370 comprising a system having internet ads with a Content User Interface that directs the behavior of the ad for that Content User.

380—10e xClaim Set—CUSTOMER USER LONG IN SAVED SEARCH CRITERIA AND SEARCHES 380—Increasing the relevance of information retrieved from the internet by a method comprising an internet log in to set Content User search and search history preferences and other interface use preferences. 381—The method of claim 380 comprising said user log in where the Content Manager remembers the search protocols of the Content User. 382—The method of claim 380 comprising said user log in where the Content Manager remembers a set number of last search protocols of the Content User. 383—The method of claim 380 comprising said user log in where the Content Manager remembers a set of last search protocols indicated by the Content User to be retained. 384—The method of claim 380 comprising said user log in where the Content Manager remembers a type of average or pattern is specific Content User preferences to be used to guide further searches. 385—The method of claim 380 comprising said user log in where the Content Manager saved the contents of the last set number of search criteria of the Content User. 386—The method of claim 380 comprising said user log in where the Content Manager saved the contents of specific search criteria identified by the Content User. 387—The method of claim 380 comprising said user log in where the Content Manager saved the contents of a search result page containing individual search results manipulated to be on that page. 388—The method of claim 380 comprising said user log in where the Content Manager saved the contents of a web page as containing individual paid advertisements manipulated or dispositioned to be on that page. 389—The method of claim 380 comprising a system to increase the relevance of information retrieved from the internet by an internet log in to set Content User search and search history preferences and other use interface preferences.

400—10e xClaim Set—CUSTOMER USER LONG IN SAVED PREFERENCES 400—Increasing the relevance of information retrieved from the internet by a method comprising an internet log in to set, alter, and save Content User internet interface preferences. 401—The method of claim 400 comprising the choice of how simple or complex the semi-simple search is by the inclusion or exclusion of search criteria beyond the initial keyword search input field. 402—The method of claim 400 comprising the choice of predefined domain extensions. 403—The method of claim 400 comprising the choice of predefined domain extension additional page access placement, order, or their combination. 404—The method of claim 400 comprising the relocation of internet interface elements about the interface Content User screen. 405—The method of claim 400 comprising the disposition of internet interface elements from the screen temporarily during the log in session or permanently during the log in session. 406—The method of claim 400 comprising the personalization of the internet interface. 407—The method as in any of the preceding claims, further comprising saving the said personalization and tailorability of the internet interface and having the setting returned upon log in. 408—The method as in any of the preceding claims, further comprising an internet based interface allowing for multiple log in per internet interface tool or computer that will retrieve a specific Content User's saved preferences. 409—The method of claim 400 comprising a system of increasing the relevance of information retrieved from the internet by a method comprising an internet log in to set, alter, and save Content User internet interface preferences.

1. A method comprising the use of one or more domain extensions as internet criteria.

2. The method of claim 1 comprising said internet criteria used as internet search criteria.

3. The method of claim 1 comprising said internet criteria used as internet search results parsing criteria.

20. A method comprising the use of one or more internet identifier criteria.

21. The method of claim 20 comprising said internet identifier criteria being biographic, demographic, and geographic data.

22. The method of claim 20 comprising said internet identifier criteria being performance data.

23. The method of claim 20 comprising said internet identifier criteria used as internet search criteria.

24. The method of claim 20 comprising said internet identifier criteria used as internet search results parsing criteria.

25. The method of claim 20 comprising gathering said internet identifier criteria at the time of registration, renewal, and verification.

26. The method of claim 20 comprising migration to said internet identifier criteria by increasingly favorable internet service.

40. A method for interactive internet interfaces comprising a semi-simple internet interface with two or more Content User internet inputs.

40. The method of claim 40 wherein the said content user internet inputs are criteria for internet searching and retrieval.

40. The method of claim 40 wherein the said content user internet inputs are criteria to direct search results parsing and organizing.

60. A method for parsing internet search results comprising one or more page ones by one or more page one parsing criteria.

61. The method of claim 60 comprising said one or more page ones by said parsing using said parsing criteria being domain extensions.

62. The method of claim 60 comprising said one or more page ones by said parsing using said parsing criteria being keywords.

63. The method of claim 60 comprising said one or more page ones by said parsing using said parsing criteria being identifiers.

80. A method for tailoring internet search results comprising Content User determined search result item parsing and prioritization.

81. The method of claim 80 comprising said search result item parsing of individual search result items across page strings.

82. The method of claim 80 comprising said search result item prioritization of individual search result items within a page string.

83. The method of claim 80 comprising said search result item disposition of individual search results items from a page string allowing appearance of the next search result item.

84. The method of claim 80 comprising page strings having Content User defined content that determines subsequent internet search criteria.

85. The method of claim 80 comprising page strings having Content User defined content that may be saved and the search criteria created defined by the content saved.
